(19) United States
(12) Patent Application Publication
(10) Pub. No.: US 2021/0408580 A1
(43) Pub. Date: Dec. 30, 2021

(54) SOLID STATE BATTERIES

(71) Applicant: President and Fellows of Harvard College, Cambridge, MA (US)

(72) Inventors: Luhan YE, Cambridge, MA (US); William FITZHUGH, Somerville, MA (US); Fan WU, Cambridge, MA (US); Xin LI, Belmont, MA (US)

(73) Assignee: President and Fellows of Harvard College, Cambridge, MA (US)

(21) Appl. No.: 17/297,228

(22) PCT Filed: Nov. 26, 2019
(86) PCT No.: PCT/US2019/063354

§ 371 Date: May 26, 2021

Related U.S. Application Data
(60) Provisional application No. 62/771,319, filed on Nov. 26, 2018.

(51) Int. Cl. H01M 10/0562; H01M 4/505; H01M 4/485; H01M 4/58; H01M 10/0525; H01M 10/44; H01M 4/525

(52) U.S. Cl. CPC H01M 10/0562; H01M 4/505; H01M 4/485; H01M 2300/0068; H01M 10/0525; H01M 10/44; H01M 4/525; H01M 4/58

(57) ABSTRACT

The invention provides rechargeable batteries including a solid state electrolyte (SSE) containing an alkali metal disposed between two electrodes. The batteries are volumetrically constrained imparting increased stability under voltage cycling conditions, e.g., through microstructure mechanical constriction on the solid state electrolyte and the electrolyte-electrode interface. These batteries of the invention are advantageous as they may be all-solid-state batteries, e.g., no liquid electrolytes are necessary, and can achieve higher voltages with minimal electrolyte degradation.

### FIELD OF THE INVENTION

The invention is directed to the field of solid state batteries with alkali metal sulfide solid state electrolytes.

### BACKGROUND OF THE INVENTION

Solid-state lithium ion conductors, the key component to enabling all solid-state lithium ion batteries, are one of the most pursued research objectives in the battery field. The intense interest in solid-state electrolytes, and solid-state batteries more generally, stems principally from improved safety, the ability to enable new electrode materials and better low-temperature performance. Safety improvements are expected for solid-state battery cells as the currently used liquid-electrolytes are typically highly-flammable organic solvents. Replacing these electrolytes with non-flammable solids would eliminate the most problematic aspect of battery safety. Moreover, solid-electrolytes are compatible with several high energy density electrode materials that cannot be implemented with liquid-electrolyte based configurations. Solid-electrolytes also maintain better low temperature operation than liquid-electrolytes, which experience substantial ionic conductivity drops at low temperatures. Such low temperature performance is critical in the burgeoning electric-vehicles market.

Of the currently studied solid-electrolytes, sulfides remain one of the highest-performance and most promising families. Sulfide glass solid-electrolytes and glass-ceramic solid-electrolytes, where crystalline phases have precipitated within a glassy matrix, have demonstrated ionic conductivities on the order of 0.1-1 mS cm⁻¹ and above 1 mS cm⁻¹, respectively. The ceramic-sulfide electrolytes, most notably Li₁₀GeP₂S₁₂ (LGPS) and Li₁₀SiP₂S₁₂ (LSPS), are particularly promising as they maintain exceptionally high ionic conductivities. LGPS was one of the first solid-electrolytes to reach ionic conductivities comparable to liquid-electrolytes at 12 mS cm⁻¹, only to be displaced by LSPS, which achieved an astonishingly high ionic conductivity of 25 mS cm⁻¹. Despite these promising conductivities, the ceramic-sulfide family is plagued by a narrow stability window. That is, LGPS and LSPS both tend to reduce at voltages below approximately 1.7 V vs lithium metal or oxidize above approximately 2.1 V. This limited stability window has proven a major barrier for battery cells that need to operate in a voltage range of approximately 0-4 V.

Thus, there is a need for improved solid state batteries incorporating solid state electrolytes with controllable structural properties and surface chemistry.

### SUMMARY OF THE INVENTION

We have developed rechargeable solid state batteries using solid state electrolytes with improved cycling performance. The rechargeable solid state batteries disclosed herein are advantageous as the solid state electrolytes have superior voltage stability and excellent battery cycle performance.

Batteries of the invention may be stabilized against the formation of lithium dendrites and/or can operate at high current density for an extended number of cycles.

In one aspect, the invention features a rechargeable battery including a first electrode, a second electrode, and a solid state electrolyte disposed therebetween. The solid state electrolyte includes a sulfide that includes an alkali metal, such as lithium. In certain embodiments, the solid state electrolyte is under a volumetric constraint sufficient to stabilize the solid state electrolyte during electrochemical cycling. In particular embodiments, the volumetric constraint exerts a pressure of about 70 to about 1,000 MPa, e.g., about 100-250 MPa, on the solid state electrolyte, e.g., to enforce mechanical constriction on the microstructure of solid electrolyte on the order of 15 GPa. In certain embodiments, the volumetric constraint provides a voltage stability window of between 1 and 10 V, e.g., 1-8V, 5.0-8 V, or greater than 5.7 V, or even greater than 10V.

In some embodiments, the solid state electrolyte has a core shell morphology. In certain embodiments the alkali metal is Li, Na, K, Rb, or Cs, e.g., Li. In some embodiments, the solid state electrolyte includes SiPS, GePS, SnPS, PSI, or PS. In some embodiments, the solid state electrolyte is Li₁₀SiP₂S₁₂, Li₁₀GeP₂S₁₂, or Li_{9.54}Si_{1.74}P_{1.44}S_{11.7}ClO_{0.3}. In some embodiments, the first electrode is the cathode, which can include LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄. In certain embodiments, the second electrode is anode and can include lithium metal, lithiated graphite, or Li₄Ti₅O₁₂. In particular embodiments, the volumetric constraint provides a mechanical constriction on the solid state electrolyte between about 1 to about 100 GPa, e.g., about 15 GPa.

In another aspect, the invention features a rechargeable battery including a first electrode, a second electrode, and a solid state electrolyte disposed therebetween, wherein the second electrode is an anode comprising an alkali metal and graphite. In some embodiments, the battery is under a pressure of about 70-1000 MPa, e.g., about 100-250 MPa. In particular embodiments, the alkali metal and graphite form a composite. In some embodiments, the alkali metal is Li, Na, K, Rb, or Cs, e.g., Li. In some embodiments, the solid state electrolyte includes SiPS, GePS, SnPS, PSI, or PS. In certain embodiments, the solid state electrolyte is Li₁₀SiP₂S₁₂, Li₁₀GeP₂S₁₂, or Li_{9.54}Si_{1.74}P_{1.44}S_{11.7}Cl_{0.3}. In particular embodiments, the first electrode is the cathode and can include LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄. In some embodiments, the battery is under an external stress that provides a mechanical constriction on the solid state electrolyte between about 1 to about 100 GPa, e.g., about 15 GPa.

In another aspect, the invention features a rechargeable battery including a first electrode, a second electrode, and a solid state electrolyte disposed therebetween, wherein the solid state electrolyte may include a sulfide including an alkali metal; and the battery is under isovolumetric constraint. In some embodiments, the isovolumetric constraint is provided by compressing the solid state electrolyte under a pressure of about 3-1000 MPa, e.g., about 100-250 MPa. In certain embodiments, the alkali metal is Li, Na, K, Rb, or Cs, e.g., Li. In some embodiments, the solid state electrolyte includes SiPS, GePS, SnPS, PSI, or PS. In certain embodiments, the solid state electrolyte is Li₁₀SiP₂S₁₂, Li₁₀GeP₂S₁₂, or Li_{9.54}Si_{1.74}P_{1.44}S_{11.7}Cl_{0.3}. In particular embodiments, the first electrode is the cathode and can include LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄. In some embodiments, the isovolumetric constraint provides a mechanical constriction on the solid state electrolyte between about 1 to about 100 GPa, e.g., about 15 GPa. In another aspect, the invention features a rechargeable battery having a first electrode, a second electrode, and a solid state electrolyte disposed therebetween. The solid state electrolyte includes a sulfide that includes an alkali metal, and optionally has a core-shell morphology. The first electrode includes an interfacially stabilizing coating material. In certain embodiments, the first and second electrodes independently include an interfacially stabilizing coating material. In certain embodiments, one of the first and second electrodes includes a lithium-graphite composite.

In some embodiments, the first electrode comprises a material as described herein, e.g., in Table 1. In some embodiments, the coating material of the first electrode is a coating material as described herein, e.g., LiNbO₃, AlF₃, MgF₂, Al₂O₃, SiO₂, graphite, or in Table 2. In certain embodiments, the alkali metal is Li, Na, K, Rb, or Cs, e.g., Li. In some embodiments the solid state electrolyte includes SiPS, GePS, SnPS, PSI, or PS. In certain embodiments, the solid state electrolyte is Li₁₀SiP₂S₁₂, Li₁₀GeP₂S₁₂, or Li_{9.54}Si_{1.74}P_{1.44}S_{11.7}Cl_{0.3}. In some embodiments, the first electrode is the cathode and can include LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄. In some embodiments, the battery is under an external stress that provides a mechanical constriction on the solid state electrolyte between about 1 to about 100 GPa, e.g., about 15 GPa. In certain embodiments, the battery is under a pressure of about 70-1000 MPa, e.g., about 100-250 MPa.

In another aspect, the invention features a method of storing energy by applying a voltage across the first and second electrodes and charging the rechargeable battery of the invention. In another aspect, the invention provides a method of providing energy by connecting a load to the first and second electrodes and allowing the rechargeable battery of the invention to discharge.

### BRIEF DESCRIPTION OF THE DRAWINGS

FIGS. 1A-1B: Cyclic Voltammetry (CV) tests of LGPS in liquid (A) and solid (B) states at different pressures. LGPS/C thin film with the ratio of 90:10 was tested in the liquid electrolyte (black curve in (A)). The CV tests were also conducted by replacing liquid electrolyte with LGPS pellets, which is all-solid-state CV, at different pressures. The decomposition intensity is decreased significantly with increasing applied pressure. At a reasonably low pressure of 6 T (420 MPa), there is already no notable decomposition peaks before 5.7 V (purple curve), which indicates applying external pressure or volume constriction on the battery cell level can widen the electrochemical window of the solid-state electrolyte.

FIGS. 2A-2B: Capacity (A) and cycling performance (B) of LiCoO₂ (LCO)-Li₄Ti₅O₁₂ (LTO) all-solid-state full battery. As the chemical potential of LTO is 1.5 V (vs. Li), the working plateau in cathode side is higher than 4 V (vs. Li).

FIGS. 3A-3B: Capacity (A) and cycling performance (B) of LiNi_{0.5}Mn_{1.5}O₄ (LNMO)-LTO all-solid-state full battery. As the chemical potential of LTO is 1.5 V (vs. Li), the working plateau in cathode side is higher than 4.7 V (vs. Li).

FIG. 4: High voltage cathode candidates for 6V and greater all solid state Li-ion battery technology. The legend labels are: F are fluorides, 0 are oxides, P,O are phosphates, and S,O: sulfates. The complete list of these high voltage fluorides, oxides, phosphates, and sulfates is provided in Table 1. Commercial LiCoO₂ (LCO) and LMNO are labeled as stars.

FIGS. 5A-5B: (A) Illustration of the impact of strain on LGPS decomposition, where x_{D} is the fraction of LGPS that has decomposed. The lower dashed line represents the Gibbs energy (G⁰(x_{D})) of a binary combination of pristine LGPS and an arbitrary set of decay products (D) when negligible pressure is applied (isobaric decay with p≈0 GPa). The solid line shows the Gibbs when a mechanical constraint is applied to the LGPS. Since LGPS tends to expand upon decomposition, the strain Gibbs (Gₛₜᵣₐᵢₙ) increases when such a mechanical constraint is applied. At some fracture point, denoted x_{f}, the Gibbs energy of the system exceeds the energy needed to fracture the mechanical constraints (the upper dashed line). The highlighted path is the suggested ground state for a mechanically constrained LGPS system. The region x_{D}<x_{f} is metastable ∂ₓ_{_{D}}G′>0. (B) Schematic representation of work differentials in the cases of “fluid” and “solid” like systems. For the top, “fluid-like”, system, the system undergoes an internal volume expansion due to decomposition rather than an applied stress (“stress-free” strain). The bottom system represents the elastic deformation away from an arbitrary reference state.

FIG. 6: Stability windows for LGPS and LGPSO (Li₁₀GeP₂S_{11.5}O_{0.5}) in the mean field limit. βₛₕₑₗₗ=V_{core}⁻¹∂ₚV_{core} indicates how rigid the constraining mechanism is. The limits βₛₕₑₗₗ→0 and βₛₕₑₗₗ→∞ represent the isovolumetric and isobaric limits. In the isobaric case, the intrinsic material stability (˜1.7-2.1 V) is recovered.

FIGS. 7A-7B: (A) Illustration of the nucleated decay mechanism. A pristine LGPS particle of radius R₀ undergoes a decay within a region of radius Rᵢ at its center. The decomposed region's radius in the absence of stress is now R_{d}, which must be squeezed into the void of Rᵢ. The final result is a nucleated particle (iv) where the strain is non-zero. (B) ∂ₓ_{_{D}}Gₛₜᵣₐᵢₙ in units of KV for both the hydrostatic/mean field and nucleated models. For typical Poisson ratios, it is seen that the strain term is comparable to or better than an ideal core-shell model (Rₛₕₑₗₗ=0).

FIGS. 8A-8E: Voltage (ϕ), lithium chemical potential (μ_{Li}_{⁺}) and Fermi level (ε_{f}) distributions in various battery configurations. (A) Conventional battery design. (B) Conventional battery with hybrid solid-electrolyte/active material cathode. χₗ gives the interface voltage that forms between the active material and the solid-electrolyte because of the different lithium ion chemical potentials. (C) Illustration of previous speculation of how insulating layers could lead to variable lithium metal chemical potentials within the cell. (D) Expectation of how the voltage from part (C) would relax given the effective electronic conduction that occurs due to lithium hole migration. (E) The result of part (D) once the applied voltage exceeds the intrinsic stability window of the solid-electrolyte. Local lithium is seen to form within the insulated region with an interface voltage (χₗ) equal to the applied voltage.

FIGS. 9A-9D: Comparison between microstructures and chemical composition of LGPS and ultra-LGPS particles. (A, C) Typical TEM bright-field images of LGPS and ultra-LGPS particles respectively, showing a distinct surface layer for ultra-LGPS particle. (B, D) Statistically analyzed STEM EDS linescans performed on various LGPS and ultra-LGPS particles with different sizes, showing a uniform distribution of sulfur concentration from surface to bulk for LGPS particles, but a decreased sulfur concentration in surface layer for ultra-LGPS.

FIG. 10: STEM EDS linescans across individual LGPS particles with different particle sizes ranging from 100 nm to 3 μm, showing that the sulfur concentration variation from surface to the bulk has no regular pattern.

FIG. 11: STEM EDS linescans across individual LGPS particles sonicated in dimethyl carbonate (DMC) for 70 h with different particle sizes ranging from 60 nm to 4 μm, showing that sulfur concentration is obviously smaller at surface region compared to that in the bulk.

FIG. 12: STEM EDS linescans across individual LGPS particles sonicated in diethyl carbonate (DEC) for 70h with different particle sizes ranging from 120 nm to 4 μm, showing that sulfur concentration is obviously smaller at surface region compared to that in the bulk.

FIG. 13: Quantitative STEM EDX analyses of LGPS particles before and after ultrasonic preparation show that surface/bulk ratio of S is obviously lower after sonication in organic electrolytes (DEC and DMC).

FIG. 14: STEM EDS linescans across individual LGPS particles soaked in DMC for 70h without sonication with different particle sizes ranging from 160 nm to 3 μm, showing that the sulfur concentration variation from surface to the bulk has no regular pattern.

FIGS. 15A-15H: Comparison between electrochemical performances of LGPS and ultra-LGPS particles, and LIBs made from LGPS and ultra-LGPS particles. (A, B) Cyclic voltammograms (CV) of Li/LGPS/LGPS+C/Ta and Li/ultra-LGPS/ultra-LGPS/Ta cells respectively, with a lithium reference electrode at a scan rate of 0.1 mVs⁻¹ and a scan range of 0.5 to 5 V. (C, D) Sensitive electrochemical impedance spectra (EIS) for LGPS and ultra-LGPS cells in panel (A,B) before and after CV tests. (E, F) Charge-discharge profiles of LGPS-LIB (LTO+LGPS+C/Glass fiber separator/Li) and ultra-LGPS-LIB (LTO+ultra-LGPS+C/Glass fiber separator/Li) cycled at 0.5C current rate in the voltage range of 1.0-2.2 V. (G, H) Cyclic capacity curves of LGPS LIB and ultra-LGPS-LIB.

FIGS. 16A-16B: Cycling performance of (A) LGPS-ASSLIB (LTO+LGPS+C as cathode, LGPS as solid electrolyte, and Li as anode) and (B) ultra-LGPS-ASSLIB (LTO+ultra-LGPS+C as cathode, ultra-LGPS as solid electrolyte, and Li as anode) at low current rate (0.02C).

FIGS. 17A-17B: Cycling performance of (A) LGPS-ASSLIB (LTO+LGPS+C as cathode, LGPS as solid electrolyte, and Li as anode) and (B) ultra-LGPS-ASSLIB (LTO+ultra-LGPS+C as cathode, ultra-LGPS as solid electrolyte, and Li as anode) at medium current rate (0.1 C).

FIG. 18A-18B: Cycling performance of (A) LGPS-ASSLIB (LTO+LGPS+C as cathode, LGPS as solid electrolyte, and Li as anode) and (B) ultra-LGPS-ASSLIB (LTO+ultra-LGPS+C as cathode, ultra-LGPS as solid electrolyte, and Li as anode) at high current rate (0.8C).

FIGS. 19A-19G: Microstructural and compositional (S)TEM studies of LTO/LGPS interfaces after cycling in LGPS ASSLIB. (A) FIB sample prepared from LGPS ASSLIB after 1 charge-discharge cycle, in which the cathode layer (LTO+LGPS+C) and SE layer (LGPS) are included. (B) TEM BF images of LTO/LGPS primary interface, showing a transit layer with multiple dark particles. (C) HRTEM image of LTO particle and its corresponding FFT pattern. (D) STEM DF image of LTO/LGPS primary interface shows super bright particles within the transit layer, indicating the accumulation of heavy elements. (E) STEM EELS linescans performed across the primary interface, indicating that the bright particles within the transit layer are sulfur-rich. (F) STEM DF image of LTO/LGPS secondary interface, in which a higher density of bright particles with similar morphology show up again. (G) STEM EELS linescans performed across the secondary interface, indicating that the bright particles are sulfur-rich.

FIG. 20: TEM bright-field images and STEM dark-field image of primary LTO/LGPS interface (interface between cathode and LGPS solid electrolyte layer) of LGPS-ASSLIB (LTO+LGPS+C as cathode, LGPS as solid electrolyte, and Li as anode), showing an obvious transit layer between the cathode and solid electrolyte layer.

FIGS. 21A-21B: (A) STEM dark-field image of and (B) EELS linescan on primary LTO/LGPS interface (interface between cathode and LGPS solid electrolyte layer) of LGPS-ASSLIB (LTO+LGPS+C as cathode, LGPS as solid electrolyte, and Li as anode), showing that Li_{K} and Ge_{M4,5} peaks exist for regions both inside and outside bright particles within the transit layer.

FIGS. 22A-22B: (A) STEM dark-field image of and (B) EELS linescan on primary LTO/LGPS interface (interface between cathode and LGPS solid electrolyte layer) of LGPS-ASSLIB (LTO+LGPS+C as cathode, LGPS as solid electrolyte, and Li as anode), showing that SU peak intensity is stronger on those S-rich bright-contrast particles within the transit layer.

FIGS. 23A-23F: Microstructural and compositional (S)TEM studies of LTO/ultra-LGPS interfaces after cycling in ultra-LGPS ASSLIB. (A) TEM BF image of LTO/ultra-LGPS primary interface, showing a smooth interface with no dark particles that exist in FIG. 6B. (B) STEM EELS linescan spectra corresponding to the dashed arrow in FIG. 23A. (C) STEM DF image of LTO/ultra-LGPS secondary interface. (D) STEM EDS linescans show a continuously decreasing atomic percentage of sulfur from inner ultra-LGPS particle to secondary LTO/ultra-LGPS interface, and finally into LTO+C composite region. (E) STEM EDS mapping shows that the large particle in FIG. 22C is LGPS particle. (F) STEM EDS quantitative analyses show that the atomic percentage of sulfur inside ultra-LGPS particle is as high as ˜38%, while that of secondary LTO/ultra-LGPS interface is as low as 8%.

FIG. 24A-24B: Additional (A) STEM dark filed images and (B) STEM EDX linescans showing a much lower S concentration at the secondary LTO/ultra-LGPS interface than inner ultra-LGPS particle region.

FIG. 25A-25C: (A) The number of hulls required to evaluate the stability of the 67 k materials considered if the evaluation schema is material iteration (left columns) or elemental set iteration (right columns). (B) An illustration of the pseudo-binary approach to interfacial stability between LSPS and an arbitrary material A. Gₕᵤₗₗ⁰ represents the materials-level decomposition energy that exists even in the absence of the interface, whereas G′ₕᵤₗₗ represents the added instability due to the presence of the interface. The most kinetically driven reaction occurs when x=xₘ. D_{A} and D_{LSPS} are the decomposed coating material and LSPS in the absence of an interface (e.g. at x=0,1). (C) Correlation of elemental fraction with the added chemical interfacial instability (G′ₕᵤₗₗ(xₘ)). Negative values are those atomic species such that increasing the concentration decreases G′ₕᵤₗₗ and improves interfacial stability. Conversely, positive values are those atomic species that tend to increase G′ₕᵤₗₗ and worsen interfacial stability. Elements that are only present in less than 50 crystal structures are grayed out due to lack of high-volume data.

FIGS. 26A-26C: (A-C) Correlation of elemental species fraction with the added electrochemical interfacial instability (G′ₕᵤₗₗ(xₘ)) at 0, 2 and 4 V, respectively. Negative values are those species such that increasing concentration decreases G′ₕᵤₗₗ and improves interfacial stability. Conversely, positive values are those species that tend to increase G′ₕᵤₗₗ and worsen interfacial stability. Elements that are only present in less than 50 crystal structures are grayed out due to lack of high-volume data.

FIGS. 27A-27D: (A) Hull energy vs voltage relative to lithium metal for LSPS. Darker Gray [Mid-Gray] shading highlights where the decomposition is oxidative [reductive]. Light gray shading represents the region where LSPS decays to without consuming or producing lithium (e.g. lithium neutral). The oxidation [reduction] region is characterized by a hull energy that increases [decreases] with increasing voltage. (B) and (C) Hull energies at the boundary voltages for the anode and cathode ranges, respectively, in terms of anionic species (e.g., oxygen containing compounds vs sulfur containing compounds, etc.). Data points below [above] the neutral decay line are net oxidative [reductive] in the anode/cathode ranges. Those compounds on the neutral decay line are decaying without reacting with the lithium ion reservoir. (D) Average hull energy for material-level electrochemical decompositions versus voltage.

FIGS. 28A-28C: Comparison of average LSPS interfacial stability of compounds sorted by anionic species. (A) The average total maximum kinetic driving energy (Gₕᵤₗₗ(xₘ)) and the contribution due to the interface (G′ₕᵤₗₗ(xₘ)) for chemical reactions between LSPS and each of the considered anionic classes. (B) The total electrochemical instability (Gₕᵤₗₗ(xₘ)) of each anionic class at a given voltage. (C) The average contribution of the interface (G′ₕᵤₗₗ(xₘ)) to the electrochemical instability of each anionic class at a given voltage.

FIGS. 29A-29B: Functionally stable results for compounds sorted by anionic species. (A) and (B) The total number (line) and percentage (bar) of each anionic class that was determined to be functionally stable. The bottom bar represented the percentage of materials that are functionally stable and the top bar represents the percentage of materials that are potentially functionally stable depending on the reversibility of lithiation/delithiation.

FIGS. 30A-30F: (A-D) Comparison of XRD patterns to show structural decay of LCO, SnO₂, LTO and SiO₂ at the solid-electrolyte material interface (with no applied voltage). In (A) ▴, [symbol] , •, ▪, ▾, [symbol] stand for LCO(PDF #44-0145), LSPS(ICSD #252037), SiO₂(PDF #48-0476), Li₃PO₄(PDF #45-0747), Cubic Co₄S₃(PDF #02-1338), Monoclinic Co₄S₃(PDF #02-1458) respectively. In (B), ▴, [symbol] , •, ▪, [symbol] stand for SnO₂(PDF #41-1445), LSPS(ICSD #252037), SiO₂(PDF #34-1382), P₂S₅(PDF #50-0813), and Li₂S(PDF #23-0369) respectively. In (C), ▴, [symbol] , [symbol] : stand for LTO(PDF #49-0207), LSPS(ICSD #252037) and Li_{1.95}Ti_{2.05}S₄ (PDF #40-0878) respectively. In (D), ▴, [symbol] stand for SiO₂(PDF #27-0605) and LSPS(ICSD #252037) respectively. The shaded regions in (A-D) highlight where significant phase change happened after heating to 500° C. The interfacial chemical compatibility decreases from (A) to (D), corresponding well with the predicted interfacial decay energies of 200, 97, 75, and 0 meV/atom for LCO, SnO₂, LTO and SiO₂, respectively. (E, F) CV results for Li₂S and SnO₂. The shaded regions predict if the curve in that region will be dominantly oxidation, reduction, neutral.

FIGS. 31A-31E: Comparison of XRD patterns for each individual phase: (A) LiCoO₂, (B) LSPS, (C) Li₄Ti₅O₁₂, (D) SnO₂ and (E) SiO₂, at room temperature and 500° C. No significant change between room temperature and 500° C. can be observed for each phase.

FIGS. 32A-32D: Comparison of XRD patterns for mixture powders: (A) LiCoO₂+LSPS, (B) SnO₂+LSPS, (C) Li₄Ti₅O₁₂+LSPS, and (D) SiO₂+LSPS) at various temperatures (room temperature, 300° C., 400° C. and 500° C.). The onset reaction temperature is observed to be 500° C., 400° C. and 500° C. for LiCoO₂+LSPS, SnO₂+LSPS and Li₄Ti₅O₁₂+LSPS, respectively. No reaction is observed to happen for SiO₂+LSPS up to 500° C.

FIGS. 33A-33F (A, B, C) XRD of different powder mixtures before and after heat treatment at 500° C. for 36 hours ((A) Li+LGPS; (B) Graphite+LGPS; (C) Lithiated graphite+LGPS). The symbols and corresponding phases are: [symbol] LGPS; +Li; * Graphite; x LiS₂; ∇ GeS₂; [symbol] GeLi₅P₃. (D) The structure of Li/Graphite anode in LGPS based all-solid-state battery; (E) SEM image of the cross section of Li/Graphite anode; (F) FIB-SEM of the interface of Li and Graphite.

FIGS. 34A-34E (A) The comparison of cyclic performance between Li/G-LGPS-G/Li and Li-LGPS-Li symmetric batteries; (B) The SEM images of symmetric batteries after cycling. Li/G-LGPS-G/Li symmetric battery after 300 hours' cycling (B1,2) and Li-LGPS-Li symmetric battery after 10 hours' cycling (B3,4); (C) The rate performance of Li/G-LGPS-G/Li symmetric batteries under different pressures. (D) The SEM images of Li/G-LGPS-G/Li symmetric batteries under different pressures after rate tests. (E) The ultra-high rate performance up to 10 mA/cm² of Li/G-LGPS-G/Li symmetric batteries. The pressure applied in (E) is 250 MPa. Insets are the cycling profiles plotted in the range of −0.3V to 0.3V, showing that there is no obvious change of overpotential after high rate cycling. More voltage profile enlargements are shown in supplementary information FIG. 42.

FIGS. 35A-35D (A) The comparison of initial charge/discharge curves, (B) the initial Coulombic efficiencies and (C) the open circuit voltages after 1 h rest, among different capacity ratios of Li to Graphite in Li/G-LGPS-LCO (LiNbO₃ coated) system. The Li/G capacity ratio of 0, 0.5, 0.8, 1.5, 2.5 and 4 can be translated into Li/G thickness ratio of around 0, 0.3, 0.4, 0.8, 1.3, and 2.1 respectively. Without specific explanation, the Li/graphite thickness ratio is 1.0-1.3 by default in this work. (D) Cyclic performance of Li/G-LGPS-LCO (LiNbO₃ coated) battery.

FIGS. 36A-36B. (A) Voltage profiles of LGPS decomposition at different effective modules (K_{eff}). (B) Reduction reaction pathways corresponding to different K_{eff} and the products in different phase equilibria within each voltage range. All decomposition products here are the ground state phases within each voltage range.

FIGS. 37A-37F. XPS measurement of Ge and P for anode-LGPS-anode symmetric batteries with the X-ray beam focused on (A) the center part LGPS away from the interface to Li/G and (B) the interface between Li/G and LGPS in Li/G-LGPS-G/Li cell under 100 MPa after 12 hours cycle at 0.25 mA cm⁻²; (C) the interface between Li and LGPS in Li-LGPS-Li symmetric battery under 100 MPa after 10 hours cycles at 0.25 mA cm⁻² (failed); (D) The Li/G-LGPS interface after rate test at 2 mA cm⁻² under 100 MPa and (E) 10 mA cm⁻² under 250 MPa; (F) The Li/G-LGPS interface at 2 mA cm⁻² under 3 MPa.

FIG. 38. XRDs of graphite and the mixture of Li and graphite after heating under 500° C. for 36 h.

FIGS. 39A-39C. SEM images of (A) graphite particles; the surface (B) and cross section (C) of graphite film after applying high pressure.

FIG. 40. Cyclic performance of Li/G-LGPS-G/Li symmetric battery with relatively smaller overpotential.

FIGS. 41A-44B. Comparison of SEM images of Li/G anode before (A) and after (B) long-term cycling in FIG. 34(A).

FIGS. 42A-42C. (A) Rate test of Li/G-LGPS-G/Li symmetric battery. When the pre-cycling time is reduced to 5 cycles at 0.25 mA cm⁻², the battery “fails” at 6 mA cm⁻² or 7 mA cm⁻², however, when the current density is set back to 0.25 mA cm⁻², it always comes back normal without significant overpotential increase. (B) Enlarged FIG. 34(E2), battery cycled at 10 mA cm⁻² plotted in a smaller voltage scale (B1) or time scale (B2). (C) SEM images of Li/Graphite composite after testing showing in B with different area and magnification. No lithium dendrite was observed. A clear 3D structure showing this is in FIG. 42(C2).

FIGS. 43A-43B. (A) cycling profiles of LCO-LGPS-Li/G batteries in FIG. 35D. (B) Cyclic performance based on Li anode. Both batteries were tested at current density of 0.1 C at 25° C.

FIGS. 44A-44B. Bader charge analysis from DFT simulations. (A) Phosphorus element in all the P-related compounds from the decomposition product list; (B) Ge element in all the Ge-related compounds from the decomposition product list.

FIGS. 45A-45D. (A) Comparison of CV curves of Li/G-LGPS-LGPS/C battery tested under 3 and 100 MPa; (B,C) comparison of impedance change before and after these two CV tests; (D) Model used in impedance fitting. R_{bulk} stands for the ionic diffusion resistance and Ret represents the charge transfer resistance. All EIS data are fitted with Z-view.

FIGS. 46A-46G. (A) A CV test of Swagelok battery after they are pressed with 1 T, 3 T, 6 T and pressurized cell initially pressed with 6 T. 10% carbon is added in the cathode. The voltage range is set from open circuit to 9.8 V. (B) The CV scans in (A) plotted in a magnified voltage and current ranges. (C) In-situ impedance tests during CV scans for batteries shown in (A). (D) Synchrotron XRD of pressurized cells after no electrochemical process (black), CV scan to 3.2V, 7.5V and 9.8V. All CVs were followed by a voltage holding at the same high cutoff voltages for 10 hours and then discharged back to 2.5V. Green line: Synchrotron XRD of LGPS tested in liquid electrolyte after CV scan to 3.2V and held for 10 hours. (E) Synchrotron XRD peak of different batteries at 2θ=18.5°, showing the broadening of XRD peak after high-voltage CV scan and hold. (F) Strain versus size broadening analysis for LGPS after high voltage hold. Dots are the broadening of different peaks in 7.5V SXRD measurement, with the corresponding XRD peaks shown in FIG. 52. The angle dependences of size and strain broadenings are represented by dashed lines. (G) XAS measurement of S (g1) and P (g2) after high voltage CV scan and hold. (g3) The simulation of P XAS peak shift after straining in the c-direction.

FIGS. 47A-47D. (A) LGPS decomposition energy (a1), ground state pressure (a2), and ground state capacity versus voltage at different effective modules (K_{eff}). (B) Decomposition reaction pathways at different K_{eff} and the products induced by different phase equilibriums in different voltage ranges. (C,D) XPS measurement of S (c) and P (d) element for pristine LGPS (c1, d1), battery after 3.2 V CV scan in liquid electrolyte (c2, d2), pressurized cell after 3.2 V CV scan (c3, d3) and pressurized cell after 9.8 V CV scan (c4, d4). Each CV scan is followed by a 10 hour hold at the high cutoff voltage.

FIGS. 48A-48E. Galvanostatic charge and discharge voltage curves for all-solid-state batteries using: (A1) LCO, (A2) LNMO and (A3) LCMO as cathode material versus LTO. The cyclability of the batteries is represented in (B1), (B2) and (B3) for LCO, LNMO and LCMO, respectively. Here, LCO and LNMO are charged and discharged at 0.3C, whereas LCMO is charged at 0.3 C and discharged at 0.1 C. All batteries are tested at room temperature, in the pressurize cell initially pressed with 6 T and activate materials are coated with LiNbO₃, as shown in FIG. 54. (C,D) XPS measurement of LCO, LNMO, LCMO-LGPS before and after 5 cycles. (E) XAS measurement of LCO, LNMO, LCMO-LGPS before (E1) and after (E2) 5 cycles for element S.

FIGS. 49A-49G. (A-D) Pseudo phase simulations of the interface between LGPS and (A) LNO, (B) LCO, (C) LCMO, (D) LNMO. Plots depict the reaction energy of the interface versus the atomic fraction of the non-LGPS phase consumed. The value of the atomic fraction that has the most severe decomposition energy is defined to be xₘ. (E-G) Mechanically-induced metastability plots for the LGPS-LNO interphase (the set of products that result from the decomposition in FIG. 49A). (E) Energy over hull of the interphase show significant response to mechanical constriction. (D) and (E) Show analogous behavior to the pressure and capacity responses to pressure that were observed for bulk phase LGPS (FIGS. 47A-47D).

FIGS. 50A-50C. (A) Galvanostatic charge and discharge profiles for all-solid-state batteries using LCO and LCMO as cathode and graphite coated lithium metal as anode, with cut-off voltage from 2.6-4.5 V(LCO) and 2.6-(6-9) V (LCMO). The batteries are charged at 0.3C and discharged at 0.1C. Cycling performance of LCMO lithium metal battery using (B) 1 M LiPF₆ in EC/DMC and (C) constrained LGPS as electrolyte, with cut-off voltage from 2.5-5.5V with charge rate of 0.3C and discharge rate of 0.1 C.

FIG. 51. Pellet thickness change in response of force applied. The original thickness of pellet is 756 μm, the weight of the pellet is 0.14 g, the area of the pellet is 1.266 cm², the compressed thickness of the pellet is 250 μm. the calculated density is 2.1 g/cm³, which is close to the theoretical density of LGPS of 2 g/cm³.

FIGS. 52A-52F. (A)-(F) Synchrotron XRD peaks of batteries at different 20 angles, showing the broadening of XRD peak after high-voltage CV scan and hold. The pressurized cell after 3.2V CV scan and hold doesn't show XRD broadening.

FIG. 53. (top) Illustration of decomposition front propagation. Decomposed phases are marked with α . . . γ. Such propagation is seen to require tangential ionic conduction. (bottom) Energy landscape for reaction coordinates. The final result is a shift in Gibbs energy by ΔG, which is positive or negative based on equation 2. Even when ΔG is negative (reaction is thermodynamically favorable), the presence of a sufficient overpotential due to tangential currents can significantly reduce the front's propagation rate.

FIG. 54. STEM image and EDS maps of LiNbO₃ coated LCO.

FIG. 55. Rate testing of LCO-LTO battery using LGPS thin film as electrolyte, battery was tested at 0.3 C-2.5 C.

FIG. 56. XAS measurement of LCO, LNMO, LCMO-LGPS before (represented as p) and after (represented as 5c) 5 cycles for element P.

FIGS. 57A-57B (A) Charge and (B) discharge profiles of LCO all-solid-state batteries using LGPS as electrolyte tested with Swagelok, Al pressurized cell, and Stainless steel (SS) pressurized cell with voltage cut-off between 3V-4.15V. Swagelok applied almost no pressure; Al cell is soft compared with Stainless steel and which applied low constrain while stainless steel applied the strongest constant constrain during battery test.

FIGS. 58A-58B. Comparison of CV current density of LGPS+Cathode and LGPS+C. CV measurement of LGPS+LCO (30+70) (A) and LGPS+LCMO (30+70) (B) in pressurized cells and CV measurement of LGPS+C (90+10) in pressurized cells.

FIGS. 59A-59D LCMO/LGPS/Li all-solid-state batteries assembled with (A) bare lithium metal, (B) graphite and (C) graphite coated Li as anode. (D) Cycling performance of LCMO solid battery using different anodes. At first cycle, all the three sample could be charged to around 120 mAh/g, while apparently Li/graphite shows the highest discharging capacity at about 83 mAh/g. It is clear to see that both of Li and Graphite anode suffer from quick fading within the first 5 cycles and after 20 cycles, both of their capacities dropped below 20 mAh/g. In comparison, the capacity of Li/Graphite anode maintains.

### DETAILED DESCRIPTION OF THE INVENTION

The invention provides rechargeable batteries including a solid state electrolyte (SSE) containing an alkali metal and a sulfide disposed between two electrodes. The solid state electrolytes may have a core-shell morphology, imparting increased stability under voltage cycling conditions. These batteries of the invention are advantageous as they may be all-solid-state batteries, e.g., no liquid electrolytes are necessary, and can achieve higher voltages with minimal electrolyte degradation.

Core-shell morphologies in which a core of ceramic-sulfide solid-electrolyte is encased in a rigid amorphous shell have been shown to improve the stability window. The mechanism behind this stabilization is believed to be tied to the tendency of ceramic-sulfides to expand during decay by up to more than 20%. Applying a volume constraining mechanism, this expansion is resisted which in turn inhibits decay. We have generalized this theory and provide experimental evidence using post-synthesis creation of a core-shell morphology of LGPS to show improved stability. Based on the decay morphology, the magnitude of stabilization will vary. A mean-field solution to a generalized strain model is shown to be the lower limit on the strain induced stability. The second decay morphology explored, nucleated decay, is shown to provide a greater capability for stabilization. Moreover, experimental evidence suggests the decay is in fact the later (nucleated) morphology, leading to significant potential for ceramic-sulfide full cell batteries.

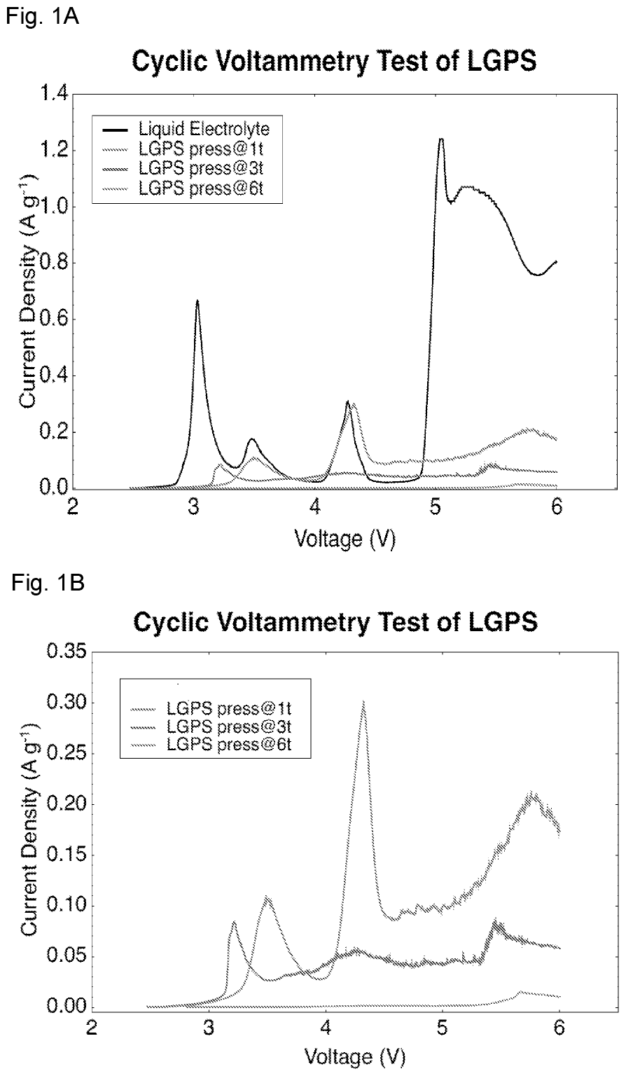

Further developments of the theory underpinning the enhanced stability and performance of core-shell electrolytes have revealed that the strain stabilization mechanism is not limited to the materials level but can also be applied on the battery cell level through external stress or volume constriction. The strain provided by the core-shell structure stabilizes the solid electrolyte through a local energy barrier, which prevents the global decomposition from happening. Such stabilization effect provided by local energy barrier can also be created by applying an external stress or volume constriction from the battery cell, where up to 5.7 V voltage stability window on LGPS can be obtained as shown in FIGS. 1A-1B. Higher voltage stability window beyond 5.7 V can be expected with higher pressure or volume constriction in the battery cell design based on this technology.

In solid state batteries, lithium dendrites form when the applied current density is higher than a critical value. The critical current density is often reported as 1-2 mA cm⁻² at an external pressure of around 10 MPa. In the present invention, a decomposition pathway of the solid state electrolyte, e.g., LGPS, at the anode interface is modified by mechanical constriction, and the growth of lithium dendrite is inhibited, leading to excellent rate and cycling performances. No short-circuit or lithium dendrite formation is observed after the batteries are cycled at a current density up to 10 mA cm⁻².

Solid State Electrolytes

A rechargeable battery of the invention includes a solid electrolyte material and an alkali metal atom incorporated within the solid electrolyte material. In particular, solid state electrolytes for use in batteries of the invention may have a core-shell morphology, with the core and shell typically having different atomic compositions.

Suitable solid state electrolyte materials include sulfide solid electrolytes, e.g., SiₓP_{y}S_{z}, e.g., SiP₂S₁₂ such as Li₁₀SiP₂S₁₂, or β/γ-PS₄. Other solid state electrolytes include, but are not limited to, germanium solid electrolytes, e.g., GeₐP_{b}S_{c}, e.g., GeP₂S₁₂ such as Li₁₀GeP₂S₁₂, tin solid electrolytes, e.g., Sn_{d}PₑS_{f}, e.g., SnP₂S₁₂, iodine solid electrolytes, e.g., P₂S₈I crystals, glass electrolytes, e.g., alkali metal-sulfide-P₂S₅ electrolytes or alkali metal-sulfide-P₂S₅-alkali metal-halide electrolytes, or glass-ceramic electrolytes, e.g., alkali metal-P_{g}Sₕ₋ᵢ electrolytes. Another material includes Li_{9.54}Si_{1.74}P_{1.44}S_{11.7}Cl_{0.3}. Other solid state electrolyte materials are known in the art. The solid state electrolyte material may be in various forms, such as a powder, particle, or solid sheet. An exemplary form is a powder.

Alkali metals useful for the solid state electrolytes for use in batteries of the invention include Li, Na, K, Rb, and Cs, e.g., Li. Examples of Li-containing solid electrolytes include, but are not limited to, lithium glasses, e.g., xLi₂S(1−x)P₂S₅, e.g., 2Li₂S—P₂S₅, and xLi₂S-(1-x)P₂S₅—LiI, and lithium glass-ceramic electrolytes, e.g., Li₇P₃S_{11-z}.

Electrode Materials

Electrode materials can be chosen to have optimum properties for ion transport. Electrodes for use in a solid state electrolyte battery include metals, e.g., transition metals, e.g., Au, alkali metals, e.g., Li, or crystalline compounds, e.g., lithium titanate such as Li₄Ti₅O₁₂ (LTO). An anode may also include a graphite composite, e.g., lithiated graphite. Other materials for use as electrodes in solid state electrolyte batteries are known in the art. The electrodes may be a solid piece of the material, or alternatively, may be deposited on an appropriate substrate, e.g., a fluoropolymer or carbon. For example, liquefied polytetrafluoroethylene (PTFE) has been used as the binder when making solutions of electrode materials for deposition onto a substrate. Other binders are known in the art. The electrode material can be used without any additives. Alternatively, the electrode material may have additives to enhance its physical and/or ion conducting properties. For example, the electrode materials may have an additive that modifies the surface area exposed to the solid electrolyte, such as carbon. Other additives are known in the art.

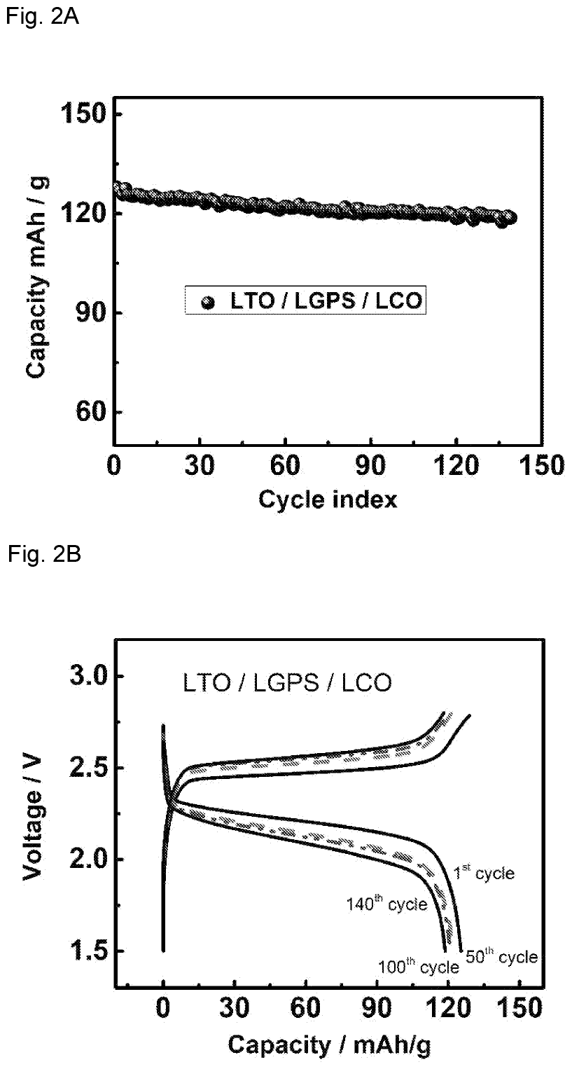

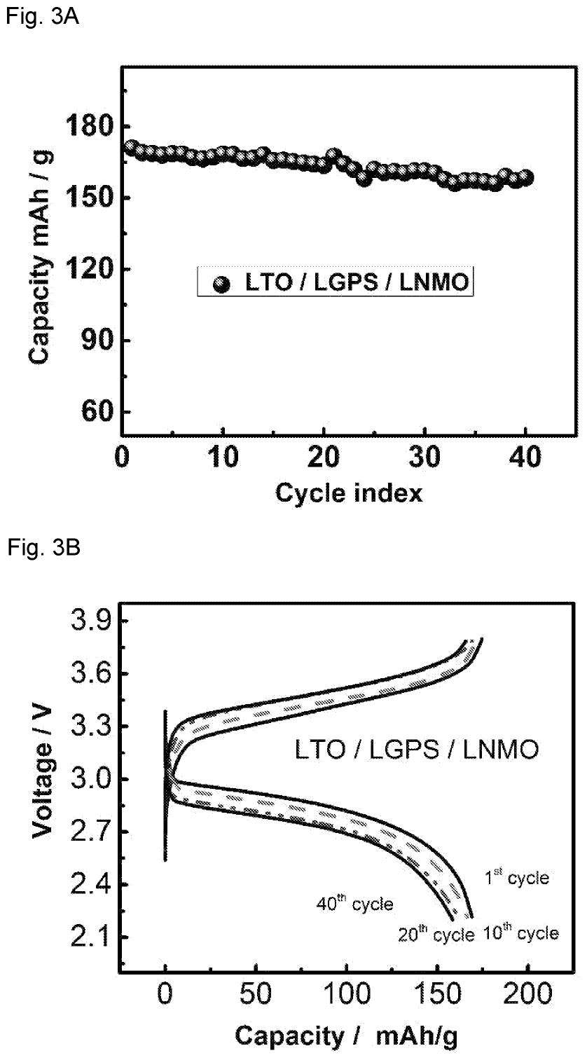

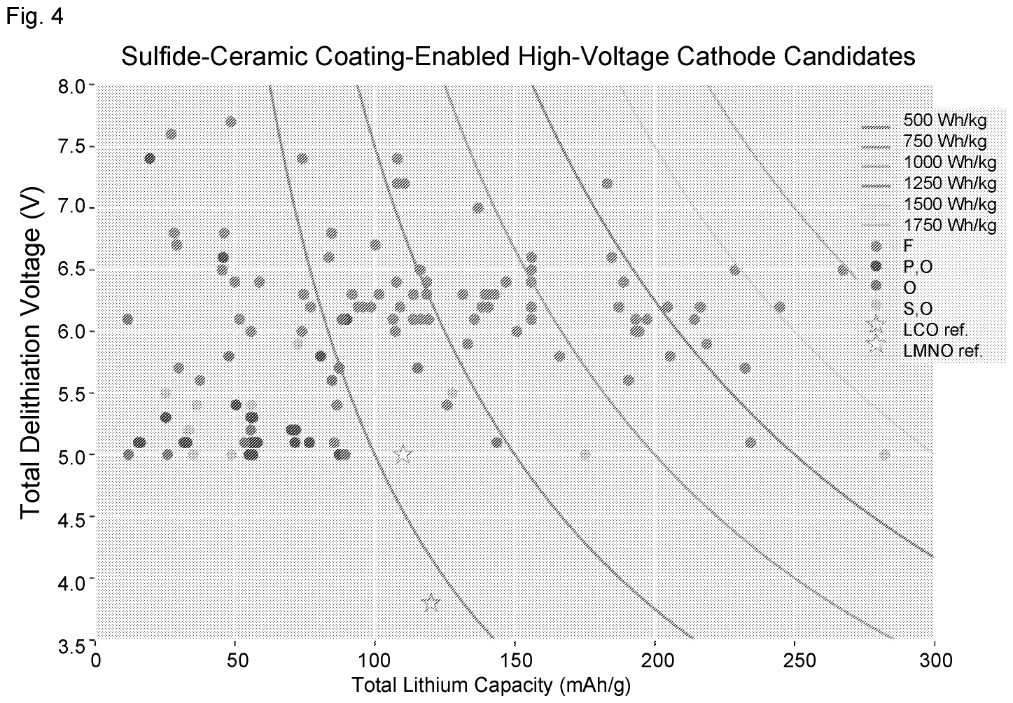

High voltage cathodes of 4 volt LiCoO₂ (LCO, shown in FIGS. 2A-2B) and 4.8V LiNi_{0.5}Mn_{1.5}O₄ (LNMO, shown in FIGS. 3A-3B) are demonstrated to run well in all-solid-state batteries of the invention. Higher voltage cathodes, such as the 5.0V Li₂CoPO₄F, 5.2V LiNiPO₄, 5.3V Li₂Ni(PO₄)F, and 6V LiMnF₄ and LiFeF₄ may also be used as electrode materials in all-solid-state batteries of the invention. Voltage stability windows beyond 5.7 V, e.g., up to 8 or 10 V or even higher, may be achieved. Another cathode is LiCo_{0.5}Mn_{1.5}O₄ (LCMO). Exemplary cathode materials are listed in Table 1, with the calculated stability of the electrodes in Table 1 shown in FIG. 4.

TABLE 1
High voltage (greater than 6 V) electrode candidates
with individual Materials Project Identifiers.

| | |
|---|---|
| 1. | Li2Ca2Al2F12: mp-6134 |
| 2. | Li2Y2F8: mp-3700 |
| 3. | Yb2Li2Al2F12: mp-10103 |
| 4. | K20Li8Nd4F40: mp-557798 |
| 5. | Ba2Li2B18O30: mp-17672 |
| 6. | Na12Li12In8F48: mp-6527 |
| 7. | Ba18Li2Si20C2Cl14056: mp-559419 |
| 8. | Li4Pt2F12: mp-13986 |
| 9. | Li2Bi2F8: mp-28567 |
| 10. | Ba1Li1F3: mp-10250 |
| 11. | Na12Li12Cr8F48: mp-561330 |
| 12. | Rb4Li2Ga2F12: mp-14638 |
| 13. | Ba4Li4Co4F24: mp-554566 |
| 14. | Li4Zr12H72N16F76: mp-601344 |
| 15. | Li1Ir1F6: mp-11172 |
| 16. | Li1As1F6: mp-9144 |
| 17. | Li4Ag4F16: mp-752460 |
| 18. | Li1Cr3Ni1S6O24: mp-767547 |
| 19. | K4Li4Y4F20: mp-556237 |
| 20. | Li2Y2F8: mp-556472 |
| 21. | Li12La8H24N36O120: mp-722330 |
| 22. | Li2Ag2F8: mp-761914 |
| 23. | Li2Au2F8: mp-12263 |
| 24. | Cs2Li1Al3F12: mp-13634 |
| 25. | Li6Zr8F38: mp-29040 |
| 26. | Na12Li12Fe8F48: mp-561280 |
| 27. | Li3Cr13Ni3S24O96: mp-743984 |
| 28. | Li12Nd8H24N36O120: mp-723059 |
| 29. | Sr4Li4Al4F24: mp-555591 |
| 30. | Cs6Li4Ga2Mo8O32: mp-642261 |
| 31. | K4Li2Al2F12: mp-15549 |
| 32. | K6Li3Al3F18: mp-556996 |
| 33. | Na12Li12Al8F48: mp-6711 |
| 34. | Li16Zr4F32: mp-9308 |
| 35. | Li2Ca2Cr2F12: mp-565468 |
| 36. | K2Li1Al1F6: mp-9839 |
| 37. | Ba2Li2Zr4F22: mp-555845 |
| 38. | Na12Li12Co8F48: mp-557327 |
| 39. | Ba2Li2B18O30: mp-558890 |
| 40. | Ba4Li4Cr4F24: mp-565544 |
| 41. | Rb4Li2As2O8: mp-14363 |
| 42. | Li6Er2Br12: mp-37873 |
| 43. | Li1Mg1Cr3S6O24: mp-769554 |
| 44. | Li1Zn1Cr3S6O24: mp-769549 |
| 45. | Li1Ag1F4: mp-867712 |
| 46. | Cs1Li1Mo1O4: mp-561689 |
| 47. | Sr4Li4Co4F24: mp-567434 |
| 48. | Cs4K1Li1Fe2F12: mp-561000 |
| 49. | K16Li4H12S16O64: mp-709186 |
| 50. | Na6Li8Th12F62: mp-558769 |
| 51. | Cs4Li4F8: mp-7594 |
| 52. | Na4Li2Al2F12: mp-6604 |
| 53. | Li4Au4F16: mp-554442 |
| 54. | Na9Li1Fe10Si20O60: mp-775304 |
| 55. | Li2Ag2F8: mp-765559 |
| 56. | Li2As2H4O2F12: mp-697263 |
| 57. | Ba2Na10Li2Co10F36: mp-694942 |
| 58. | Li2La4S4O16F6: mp-557969 |
| 59. | Li3B3F12: mp-12403 |
| 60. | Li4B24O36F4: mp-558105 |
| 61. | Cs4K1Li1Ga2F12: mp-15079 |
| 62. | Ba4Li4Al4F24: mp-543044 |
| 63. | Li2Ca2Ga2F12: mp-12829 |
| 64. | Na12Li12Sc8F48: mp-14023 |
| 65. | Rb16Li4H12S16O64: mp-709066 |
| 66. | Rb16Li4Zr12H8F76: mp-557793 |
| 67. | Li8Zr4F24: mp-542219 |
| 68. | Cs6Li2F8: mp-559766 |
| 69. | Sr4Li4Fe4F24: mp-567062 |
| 70. | Li4Pd2F12: mp-13985 |
| 71. | Li2Zr1F6: mp-4002 |
| 72. | Li2Ca1Hf1F8: mp-16577 |
| 73. | Li4In4F16: mp-8892 |
| 74. | Li2Lu2F8: mp-561430 |
| 75. | Na2Li2Y4F16: mp-558597 |
| 76. | Li8Pr4N20O60: mp-555979 |
| 77. | Cs2Li1Tl1F6: mp-989562 |
| 78. | Li2Y2F8: mp-3941 |
| 79. | K5Ba5Li5Zn5F30: mp-703273 |
| 80. | Rb4Li8Be8F28: mp-560518 |
| 81. | Li18Ga6F36: mp-15558 |
| 82. | Li2Mg2Cr6S12O48: mp-694995 |
| 83. | Li4Pr4S8O32: mp-559719 |
| 84. | Sr2Li2Al2F12: mp-6591 |
| 85. | Li18Sc6F36: mp-560890 |
| 86. | K2Li2Be2F8: mp-6253 |
| 87. | Na4Li2Be4F14: mp-12240 |
| 88. | Li12Be6F24: mp-4622 |
| 89. | Li12Zr2Be2F24: mp-559708 |
| 90. | Cs4Li4Be4F16: mp-18704 |
| 91. | Na12Li4Be8F32: mp-556906 |
| 92. | Li8B8S32O112: mp-1020060 |
| 93. | Li4B4S8O32: mp-1020106 |
| 94. | Li4B4S16Cl16O48: mp-555090 |
| 95. | Cs2Li1Ga1F6: mp-6654 |
| 96. | Li2Eu2P8O24: mp-555486 |
| 97. | Li2Nd2P8O24: mp-18711 |
| 98. | Li4Mn8F28: mp-763085 |
| 99. | Li4Ca36Mg4P28O112: mp-686484 |
| 100. | Li4Fe4P16O48: mp-31869 |
| 101. | Cs8Li8P16O48: mp-560667 |
| 102. | Li4Cr4P16O48: mp-31714 |
| 103. | Li4Al4P16O48: mp-559987 |
| 104. | Li1P1F6: mp-9143 |
| 105. | Li8S8O28: mp-1020013 |
| 106. | Li4Fe4F16: mp-850017 |
| 107. | Li4Cu8F24: mp-863372 |
| 108. | Li4Ru2F12: mp-976955 |
| 109. | Cs4Li4B4P8O30: mp-1019606 |
| 110. | Li1F1: mp-1138 |
| 111. | Li1Ti3Mn1Cr1P6O24: mp-772224 |
| 112. | Li18Al6F36: mp-15254 |
| 113. | Tb2Li2P8O24: mp-18194 |
| 114. | Li4Rh2F12: mp-7661 |
| 115. | Li1H1F2: mp-24199 |
| 116. | Li4Cu4P12O36: mp-12185 |
| 117. | Li2Sb6O16: mp-29892 |
| 118. | Li4Mn4P16O48: mp-32007 |
| 119. | Li4V4P16O48: mp-32492 |
| 120. | Li4Ni2F8: mp-35759 |
| 121. | Li1Sb1F6: mp-3980 |
| 122. | Li2Ni4P8H6O28: mp-40575 |
| 123. | Li2Co4P8H6O28: mp-41701 |
| 124. | Li1Mo8P8O44: mp-504181 |
| 125. | Li2Bi2P8O24: mp-504354 |
| 126. | Li6Ge3F18: mp-5368 |
| 127. | Li4Co4P16O48: mp-540495 |
| 128. | Li2Re2O4F8: mp-554108 |
| 129. | Li4U16P12O80: mp-555232 |
| 130. | Li2Ho2P8O24: mp-555366 |
| 131. | Li12Al4F24: mp-556020 |
| 132. | Li2Mn2F8: mp-558059 |
| 133. | Li2U3P4O20: mp-558910 |
| 134. | Li12Er4N24O72: mp-559129 |
| 135. | Li2La2P8O24: mp-560866 |
| 136. | Li18Cr6F36: mp-561396 |
| 137. | Li4Cr2F12: mp-555112 |
| 138. | Li2Co2F8: mp-555047 |
| 139. | Rb4Li2Fe2F12: mp-619171 |
| 140. | Li2Gd2P8O24: mp-6248 |
| 141. | K2Li1Ta6P3O24: mp-684817 |
| 142. | K6Li2Mg8Si24O60: mp-694935 |
| 143. | Li8H16S12O48: mp-720254 |
| 144. | Li6Cu2F12: mp-753063 |
| 145. | Li1Cu5F12: mp-753031 |
| 146. | Li2Cu2F8: mp-753257 |
| 147. | Li5Cu1F8: mp-753202 |
| 148. | Li1Ti3Nb1P6O24: mp-757758 |
| 149. | Li2Cu4F12: mp-758265 |
| 150. | Li5Cu1F8: mp-759224 |
| 151. | Li12Cu4F24: mp-759234 |
| 152. | Rb4Li4F8: mp-7593 |
| 153. | Li6Cu2F12: mp-759901 |
| 154. | Li18Cu6F36: mp-760255 |
| 155. | Li4Ti2F12: mp-7603 |
| 156. | Li4Cu2F10: mp-762326 |
| 157. | Li8Mn4F24: mp-763147 |
| 158. | Li2Mn4F14: mp-763425 |
| 159. | Li8Mn8F32: mp-763515 |
| 160. | Li2Ni2F6: mp-764362 |
| 161. | Li4Mn4F16: mp-764408 |
| 162. | Li6Mn3F18: mp-765003 |
| 163. | Li4V4F24: mp-765122 |
| 164. | Li8V8F48: mp-765129 |
| 165. | Li1V1F6: mp-765966 |
| 166. | Li1Ti3Sb1P6O24: mp-766098 |
| 167. | Li2V2F12: mp-766901 |
| 168. | Li2V2F12: mp-766912 |
| 169. | Li1V1F6: mp-766917 |
| 170. | Li2V2F12: mp-766937 |
| 171. | Li2Mn2F8: mp-773564 |
| 172. | Li2S2O6F2: mp-7744 |
| 173. | Li1Fe1F4: mp-776230 |
| 174. | Li2Fe2F8: mp-776264 |
| 175. | Li18Fe6F36: mp-776627 |
| 176. | Li12Fe4F24: mp-776684 |
| 177. | Li2Mn2F8: mp-776670 |
| 178. | Li4Fe8F28: mp-776692 |
| 179. | Li2Fe2F8: mp-776791 |
| 180. | Li4Fe2F10: mp-776810 |
| 181. | Li4Mn4F16: mp-776813 |
| 182. | Li2Fe2F8: mp-776881 |
| 183. | Li4Fe4F16: mp-777008 |
| 184. | Li4Mn2F12: mp-777332 |
| 185. | Li6Fe2F12: mp-777459 |
| 186. | Li4Fe4F16: mp-777875 |
| 187. | Li4Fe2F10: mp-778345 |
| 188. | Li4Fe4F16: mp-778347 |
| 189. | Li4Mn2F12: mp-778394 |
| 190. | Li4Fe4F16: mp-778510 |
| 191. | Li4Mn4F16: mp-778687 |
| 192. | Li4Ge2F12: mp-7791 |
| 193. | Li4Mn4F16: mp-780919 |

Electrode Coatings

In some cases, the electrode materials may further include a coating on their surface to act as an interfacial layer between the base electrode material and the solid state electrolyte. In particular, the coatings are configured to improve the interface stability between the electrode, e.g., the cathode, and the solid electrolyte for superior cycling performance. For example, coating materials for electrodes of the invention include, but are not limited to graphite, LiNbO₃, AlF₃, MgF₂, Al₂O₃, and SiO₂, in particular LiNbO₃ or graphite.

Based on a new high-throughput analysis schema to efficiently implement computational search to very large datasets, a library of different materials was searched to find those coating materials that can best stabilize the interface between sulfide solid-electrolytes and typical electrode materials, using Li₁₀SiP₂S₁₂ as an example to predict over 1,000 coating materials for cathodes and over 2,000 coating materials for anodes with both the required chemical and electrochemical stability. These are generally applicable for LGPS. Table 2 provides the predicted effective coating materials.

TABLE 2
Atomic compositions for predictive effective coating materials
with individual Materials Project Identifiers.

FUNCTlONALLY STABLE ANODE COATlNGS
Ac1: mp-10018
Ac1H2: mp-24147
Ac1O1F1: mp-36526
Ac2Br2O2: mp-30274
Ac2Cl2O2: mp-30273
Ac2O3: mp-11107
Al1Co1: mp-284
Al1Cr1Fe2: mp-16495
Al1Cr1Ru2: mp-862781
Al1Fe1: mp-2658
Al1Fe1Co2: mp-10884
Al1Fe2B2: mp-3805
Al1Fe2Si1: mp-867878
Al1Fe2W1: mp-862288
Al1Fe3: mp-2018
Al1Ir1: mp-1885
Al1N1: mp-1700
Al1Ni1: mp-1487
Al1Ni3: mp-2593
Al1Os1: mp-875
Al1Re2: mp-10909
AHRh1: mp-364
Al1Ru1: mp-542569
Al1Si1Ru2: mp-862778
Al1Tc2: mp-1018166
Al1V1Co2: mp-4955
Al1V1Fe2: mp-5778
Al1V1Os2: mp-862700
Al1V1Ru2: mp-866001
Al1Zn1Rh2: mp-866033
Al2Co1Ir1: mp-867319
Al2Co1Os1: mp-984352
Al2Co1Ru1: mp-862695
Al2Fe1Co1: mp-862691
Al2Fe1Ni1: mp-867330
Al2Ir1Os1: mp-866284
Al2Ir1Rh1: mp-862694
Al2N2: mp-661
Al2Ni1Ru1: mp-867775
Al2Os1: mp-7188
Al2Ru1Ir1: mp-865989
Al2Ru1Rh1: mp-867326
Al3Ni2: mp-1057
Al3Ni5: mp-16514
Al3Os2: mp-16521
Al4Ru2: mp-10910
Ar1: mp-23155
Ar2: mp-568145
B1Os1: mp-997617
B2Mo2: mp-999198
B2W2: mp-1008487
B2W4: mp-1113
B4Mo2: mp-2331
B4Mo4: mp-1890
B4W4: mp-7832
B8W4: mp-569803
Ba1: mp-10679
Ba1: mp-122
Ba1Cl2: mp-568662
Ba1S1: mp-1500
Ba1Se1: mp-1253
Ba1Sr1I4: mp-754852
Ba1Sr2I6: mp-754212
Ba1Te1: mp-1000
Ba2Br2F2: mp-23070
Ba2Cl2F2: mp-23432
Ba2H2Br2: mp-24424
Ba2H2Cl2: mp-23861
Ba2H2I2: mp-23862
Ba2H3I1: mp-1018651
Ba2I2F2: mp-22951
Ba2P1Cl1: mp-27869
Ba2Sr1I6: mp-760418
Ba2Sr4I12: mp-754224
Ba3I6: mp-568536
Ba3Sr1I8: mp-756235
Ba4Br4Cl4: mp-1012551
Ba4Br8: mp-27456
Ba4Ca2I12: mp-756725
Ba4Cl8: mp-23199
Ba4I4O2: mp-551835
Ba4I8: mp-23260
Ba4Sr2I12: mp-752397
Ba4Sr2I12: mp-756202
Ba4Sr8I24: mp-772876
Ba6Sr3I18: mp-752671
Ba8Br12O2: mp-555218
Ba8Cl12O2: mp-23063
Ba8I12O2: mp-29909
Ba8Sr4I24: mp-756624
Ba8Sr4I24: mp-772875
Ba8Sr4I24: mp-772878
Be1Al1Ir2: mp-865966
Be1Al1Rh2: mp-862287
Be1Co1: mp-2773
Be1Co2Si1: mp-865901
Be1Cu1: mp-2323
Be1Fe2Si1: mp-862669
Be1Ni1: mp-1033
Be1O1: mp-1778
Be1Rh1: mp-11276
Be1Si1Os2: mp-867107
Be1Si1Ru2: mp-867835
Be1V1Os2: mp-867275
Be2: mp-87
Be2C1: mp-1569
Be2Co1Ir1: mp-867274
Be2Co1Ni1: mp-867271
Be2Co1Pt1: mp-867270
Be2Cu1Ir1: mp-867273
Be2Cu1Rh1: mp-865308
Be2Cu1Ru1: mp-865147
Be2Ni1Ir1: mp-865229
Be2Ni1Rh1: mp-864895
Be2O2: mp-2542
Be3Fe1: mp-983590
Be3Ir1: mp-862714
Be3Ni1: mp-865168
Be3Ru1: mp-865562
Be3Tc1: mp-977552
Be4Cu2: mp-2031
Be4O4: mp-7599
Be5Pd1: mp-650
C12: mp-606949
C16: mp-568286
C2: mp-1040425
C2: mp-169
C2: mp-937760
C2: mp-990448
C4: mp-48
C4: mp-990424
C4: mp-997182
C8: mp-568806
Ca1Cd1: mp-1073
Ca1Cu5: mp-1882
Ca1F2: mp-2741
Ca1Hg1: mp-11286
Ca1I2: mp-30031
Ca1Nd1Hg2: mp-865955
Ca1O1: mp-2605
Ca1Pd1: mp-213
Ca1Pr1Hg2: mp-867217
Ca1S1: mp-1672
Ca1Se1: mp-1415
Ca1Si2Ni2: mp-5292
Ca1Te1: mp-1519
Ca2As1I1: mp-28554
Ca2Br1N1: mp-23009
Ca2Ge1: mp-1009755
Ca2H2Br2: mp-24422
Ca2H2Cl2: mp-23859
Ca2H2I2: mp-24204
Ca2H3Br1: mp-1018656
Ca2N1Cl1: mp-22936
Ca2P1I1: mp-23040
Ca3As1Br3: mp-27294
Ca3As1Cl3: mp-28069
Ca3P1Cl3: mp-29342
Ca8Cl12O2: mp-23326
Ce1: mp-28
Ce1Al3Pd2: mp-4785
Ce1As1: mp-2748
Ce1B6: mp-21343
Ce1Co2Si2: mp-3437
Ce1Cr2B6: mp-2873
Ce1Cr2Si2C1: mp-6258
Ce1Cu5: mp-761
Ce1Fe2Si2: mp-3035
Ce1Ga2: mp-2209
Ce1Mn2Si2: mp-2965
Ce1N1: mp-2493
Ce1Ni1C2: mp-19741
Ce1Ni2B2C1: mp-10860
Ce1O1: mp-10688
Ce1P1: mp-2154
Ce1Re4Si2: mp-27861
Ce1S1: mp-1096
Ce1Si2Cu2: mp-5452
Ce1Si2Ir2: mp-4433
Ce1Si2Mo2C1: mp-1018666
Ce1Si2Ni2: mp-4537
Ce1Si2Os2: mp-4767
Ce1Si2Rh2: mp-4090
Ce1Si2Ru2: mp-3566
Ce1Zn1: mp-986
Ce2Cu2Ge2: mp-20766
Ce2Si2Cu2: mp-22740
Ce4Ge1S3: mp-675328
Co1: mp-102
Co1B2W2: mp-7573
Co2: mp-54
Cr1: mp-90
Cr1Ni2: mp-784631
Cr1Ni3: mp-1007923
Cr1Ni3: mp-1007974
Cr1Si1Ru2: mp-865791
Cr2B2: mp-260
Cr4B2: mp-15809
Cr6Si2: mp-729
Cs1: mp-1
Cs1Br1: mp-571222
Cs1Ca1Br3: mp-30056
Cs1Ca1I3: mp-998333
Cs1Cl1: mp-573697
Cs1I1: mp-614603
Cs1Li2Br3: mp-606680
Cs1Li2Cl3: mp-569117
Cs1Sr1Br3: mp-998297
Cs1Sr1I3: mp-998417
Cs2: mp-11832
Cs2Ca1Br4: mp-1025267
Cs2Ca1Cl4: mp-1025185
Cs2Li2Br4: mp-23057
Cs2Li2Cl4: mp-23364
Cs2Li3Br5: mp-571409
Cs2Li3I5: mp-608311
Cs2Li6Cl8: mp-571666
Cs2Na2Te2: mp-5339
Cs2Sr2Br6: mp-998433
Cs2Sr2Cl6: mp-998561
Cs3C24: mp-28861
Cs3Li2Cl5: mp-570756
Cs4Ba8Br20: mp-541722
Cs4Ca4I12: mp-998428
Cs4Eu4Br12: mp-638685
Cs4Li2Cl6: mp-571390
Cs6Li2I8: mp-569238
Cs8Te4: mp-573763
Dy1Ag1: mp-2167
Dy1Al1: mp-11843
Dy1As1: mp-2627
Dy1B2: mp-2057
Dy1Co1C2: mp-3847
Dy1Co2Si2: mp-5976
Dy1Cu1: mp-2334
Dy1Cu5: mp-30578
Dy1Fe1C2: mp-1018065
Dy1Fe2Si2: mp-4939
Dy1H2: mp-24151
Dy1Mn2Si2: mp-4985
Dy1N1: mp-1410
Dy1Ni1C2: mp-4587
Dy1Ni2B2C1: mp-6223
Dy1P1: mp-2014
Dy1Pd1: mp-2226
Dy1Rh1: mp-232
Dy1S1: mp-2470
Dy1Si2Ir2: mp-4065
Dy1Si2Ni2: mp-4692
Dy1Si2Os2: mp-12088
Dy1Si2Rh2: mp-2893
Dy1Si2Ru2: mp-4177
Dy1Zn1: mp-2303
Dy2Au2: mp-1007918
Dy2Cu2Ge2: mp-20010
Dy2Ge2: mp-20122
Dy2S1O2: mp-12669
Dy2Si2Cu2: mp-5365
Er1Ag1: mp-2621
Er1As1: mp-1688
Er1Au1: mp-2442
Er1B2: mp-1774
Er1Co1C2: mp-13501
Er1Co2Si2: mp-3239
Er1Cu1: mp-1955
Er1Cu5: mp-30579
Er1Fe1C2: mp-1018064
Er1Fe2Si2: mp-5688
Er1H2: mp-24192
Er1Ir1: mp-2713
Er1Mn2Si2: mp-4729
Er1N1: mp-19830
Er1Ni1C2: mp-11723
Er1P1: mp-1144
Er1Pd1: mp-851
Er1Rh1: mp-2381
Er1Si2Ir2: mp-3907
Er1Si2Ni2: mp-4881
Er1Si2Os2: mp-3958
Er1Si2Rh2: mp-5386
Er1Si2Ru2: mp-5022
Er1Zn1: mp-1660
Er2Au2: mp-11243
Er2S1O2: mp-12671
Er2Si2Cu2: mp-8122
Eu1B6: mp-20874
Eu1C2: mp-1018177
Eu1Cd1: mp-580236
Eu1Co2Si2: mp-672294
Eu1Cu5: mp-2066
Eu1Fe2Si2: mp-582357
Eu1Hg1: mp-11375
Eu1Li1H3: mp-541365
Eu1N1: mp-20340
Eu1Ni2B2C1: mp-21064
Eu1O1: mp-21394
Eu1S1: mp-20587
Eu1Se1: mp-21009
Eu1Si2Ir2: mp-21849
Eu1Si2Ni2: mp-4768
Eu1Si2Rh2: mp-21383
Eu1Si2Ru2: mp-581736
Eu1Te1: mp-542583
Eu1Zn1: mp-1261
Eu2C1N2Cl2: mp-582618
Eu2H3Br1: mp-1018691
Eu2H3Cl1: mp-1018693
Eu2H6Ru1: mp-634945
Eu2P1Br1: mp-613052
Eu2P1I1: mp-569689
Eu2Si2: mp-21279
EU4I4O2: mp-558258
Eu8Cs4I20: mp-29613
Eu8Rb4I20: mp-29612
Fe1: mp-13
Fe1Co1: mp-2090
Fe1Ni3: mp-1007855
Fe1Ni3: mp-1418
Fe1Si1Ru2: mp-3464
Fe1Si1Tc2: mp-862790
Fe2B2: mp-1007881
Fe2B4Mo1: mp-15722
Fe2Ni2: mp-2213
Fe3Si1: mp-2199
Gd1Ag1: mp-542779
Gd1Al1: mp-12753
Gd1As1: mp-510374
Gd1Au1: mp-635426
Gd1C2: mp-12765
Gd1Cd1: mp-1031
Gd1Co1C2: mp-1018146
Gd1Co2Si2: mp-542985
Gd1Cu1: mp-614455
Gd1Cu4Pd1: mp-1025013
Gd1Cu5: mp-636253
Gd1Fe1C2: mp-1018176
Gd1Fe2Si2: mp-542986
Gd1H2: mp-24092
Gd1N1: mp-940
Gd1Ni2B2C1: mp-20728
Gd1P1: mp-510401
Gd1Rh1: mp-1742
Gd1S1: mp-510402
Gd1Si2Cu2: mp-20677
Gd1Si2Ir2: mp-20700
Gd1Si2Ni2: mp-20956
Gd1Si2Os2: mp-21408
Gd1Si2Rh2: mp-21240
Gd1Si2Ru2: mp-569302
Gd1Zn1: mp-2497
Gd2S1O2: mp-4805
Gd2Se1O2: mp-13973
Gd2Si2Cu2: mp-607182
Gd2Te1O2: mp-16035
He1: mp-23158
He1: mp-614456
He1: mp-754382
He2: mp-23156
Hf1Al1Cu2: mp-10887
Hf1Al1Ni2: mp-5748
Hf1Al1Rh2: mp-864671
Hf1Al1Ru2: mp-864909
Hf1B2: mp-1994
Hf1Be2: mp-2553
Hf1C1: mp-21075
Hf1Co1: mp-2027
Hf1Co2Si2: mp-571367
Hf1N1: mp-2828
Hf1Nb1B4: mp-38818
Hf1Os1: mp-11452
Hf1Rh1: mp-11457
Hf1Ru1: mp-2802
Hf1Si1Ru2: mp-866062
Hf1Tc1: mp-11460
Hf2Be2Si2: mp-12571
Hf2Pt2: mp-1007691
Ho1: mp-10765
Ho1Ag1: mp-2778
Ho1As1: mp-295
Ho1B2: mp-2267
Ho1Co1C2: mp-9241
Ho1Co2Si2: mp-5835
Ho1Cu1: mp-1971
Ho1Cu4Pd1: mp-1025134
Ho1Cu5: mp-30585
Ho1Cu5: mp-580364
Ho1Fe1C2: mp-1018052
Ho1Fe2Si2: mp-3191
Ho1H2: mp-24152
Ho1Ir1: mp-11476
Ho1Lu1Au2: mp-973285
Ho1Mn2Si2: mp-5796
Ho1N1: mp-883
Ho1Ni1C2: mp-5154
Ho1Ni2B2C1: mp-6646
Ho1P1: mp-744
Ho1Pd1: mp-832
Ho1Rh1: mp-2163
Ho1Si2Ir2: mp-567513
Ho1Si2Ni2: mp-2924
Ho1Si2Os2: mp-5219
Ho1Si2Rh2: mp-3895
Ho1Si2Ru2: mp-5720
Ho1Zn1: mp-2249
Ho2Au2: mp-1007666
Ho2S1O2: mp-12670
Ho2Si2Cu2: mp-4476
K1: mp-10157
K1: mp-58
K1Br1: mp-23251
K1Cl1: mp-23193
K1I1: mp-22898
K2: mp-972981
K2C16: mp-28930
K2Ca2Br6: mp-998599
K2Ca2Cl6: mp-998421
K2Li2Te2: mp-4495
Kr1: mp-612118
Kr1: mp-974400
Kr2: mp-567365
Kr3: mp-975590
Kr4: mp-976347
La1: mp-156
La1Al3Pd2: mp-30815
La1As1: mp-708
La1B6: mp-2680
La1C2: mp-2367
La1Cd1: mp-776
La1Co2Si2: mp-5526
La1Cu2: mp-2051
La1Cu5: mp-2613
La1Fe2Si2: mp-4088
La1Ga2: mp-19839
La1H2: mp-24153
La1Mn2Si2: mp-5069
La1N1: mp-256
La1Ni1C2: mp-1018048
La1P1: mp-2384
La1S1: mp-2350
La1Se1: mp-1161
La1Si2Cu2: mp-3995
La1Si2Ir2: mp-3585
La1Si2Ni2: mp-5898
La1Si2Os2: mp-567203
La1Si2Rh2: mp-5936
La1Si2Ru2: mp-5105
La1Te1: mp-1560
La1Zn1: mp-2615
La2Br2O2: mp-23023
La2Cl2O2: mp-23025
La2Ge1I2: mp-570597
La2I2O2: mp-30993
La2O2F2: mp-7100
La2O2F2: mp-8111
La2O3: mp-1968
La2P1I2: mp-571647
La2S1O2: mp-4511
La2Se1O2: mp-7233
La2Te1O2: mp-4547
Li1Cl1: mp-22905
Li1F1: mp-1138
Li2Br2: mp-976280
Li2C1N2: mp-9610
Li2I2: mp-570935
Li2Lu2O4: mp-754605
Li2O1: mp-1960
Li2S1: mp-1153
Li2Se1: mp-2286
Li2Te1: mp-2530
Li4Hf2O6: mp-755352
Lu1As1: mp-2017
Lu1Au1: mp-11249
Lu1B2: mp-11219
Lu1Co1C2: mp-1001614
Lu1Cu5: mp-580136
Lu1Fe1C2: mp-1001606
Lu1Fe2Si2: mp-571098
Lu1H2: mp-24288
Lu1Ir1: mp-1529
Lu1Mg1Pd2: mp-865253
Lu1N1: mp-1102
Lu1Ni1C2: mp-1001603
Lu1P1: mp-10192
Lu1Pd1: mp-2205
Lu1Rh1: mp-377
Lu1Ru1: mp-11495
Lu1Si2Ni2: mp-12100
Lu1Si2Os2: mp-12101
Lu1Si2Rh2: mp-3108
Lu1Si2Ru2: mp-10453
Lu1Zn1: mp-11496
Lu2Ag1Au1: mp-865445
Lu2C1Cl2: mp-573376
Lu2S1O2: mp-12673
Lu2Si2: mp-1001612
Lu2Si2Cu2: mp-8125
Mg1Al1Rh2: mp-865155
Mg1Be2N2: mp-11917
Mg1Ni3C1: mp-10700
Mg1Rh1: mp-1172
Mg1Sc1Pd2: mp-977566
Mg2Cu4: mp-1038
Mg2Si1Ni3: mp-15779
Mn1Al1Co2: mp-3623
Mn1Al1Fe2: mp-31185
Mn1Al1Ni2: mp-4922
Mn1Al1Os2: mp-864951
Mn1Al1Rh2: mp-10894
Mn1Be2Co1: mp-978261
Mn1Be2Ir1: mp-864943
Mn1Be2Rh1: mp-864945
Mn1Be3: mp-973292
Mn1Co1: mp-1009133
Mn1Co2Si1: mp-4492
Mn1Fe2Si1: mp-5529
Mn1Ga1Co2: mp-21171
Mn1Ni3: mp-11501
Mn1Rh1: mp-417
Mn1Si1Ru2: mp-864966
Mn1Si1Tc2: mp-864970
Mn1V1: mp-316
Mn2Al1Cr1: mp-864988
Mn2Al1Re1: mp-864989
Mn2Al1V1: mp-10895
Mn2Al1W1: mp-864990
Mn2Al2: mp-771
Mn2B4W4: mp-19789
Mn2Co1Si1: mp-13082
Mn2Si1Ru1: mp-999576
Mn2V1Si1: mp-865026
Mn3Nb3Si3: mp-7829
Mn3Si1: mp-20211
Mn4B2: mp-20318
Mn4B4: mp-8365
Mo1: mp-129
Mo1C1: mp-2305
Na1: mp-127
Na1: mp-974558
Na1: mp-974920
Na1Br1: mp-22916
Na1Cl1: mp-22862
Na1I1: mp-23268
Na2C128: mp-571003
Na3: mp-973198
Na4: mp-982370
Nb1: mp-75
Nb1Al1Fe2: mp-865280
Nb1Al1Ni2: mp-4813
Nb1Al1Os2: mp-865278
Nb1Al1Ru2: mp-11537
Nb1Al3: mp-1842
Nb1B2: mp-450
Nb1Ga1Ru2: mp-977401
Nb1Ni3: mp-11513
Nb1Ru1: mp-11516
Nb1Ru1: mp-432
Nb1Si1Tc2: mp-864672
Nb2B2: mp-2580
Nb2C1: mp-2318
Nb2Ni2B2: mp-9985
Nb3B4: mp-10255
Nb4Si4Ir4: mp-21248
Nb4Si4Rh4: mp-10470
Nb5Si4Cu4: mp-13967
Nd1: mp-159
Nd1Al3Pd2: mp-12734
Nd1As1: mp-2602
Nd1B6: mp-1929
Nd1C2: mp-2297
Nd1Co2Si2: mp-4228
Nd1Cu5: mp-1140
Nd1Fe2Si2: mp-3489
Nd1Ga2: mp-2524
Nd1H2: mp-24096
Nd1Mn2Si2: mp-3018
Nd1N1: mp-2599
Nd1Ni1C2: mp-5383
Nd1Ni2B2C1: mp-6102
Nd1P1: mp-2823
Nd1S1: mp-1748
Nd1Si2Cu2: mp-2877
Nd1Si2Ir2: mp-567130
Nd1Si2Ni2: mp-4007
Nd1Si2Os2: mp-571586
Nd1Si2Rh2: mp-3651
Nd1Si2Ru2: mp-4013
Nd1Zn1: mp-1053
Nd2Au2: mp-999338
Nd2I2O2: mp-755336
Nd2S1O2: mp-3211
Nd2Se1O2: mp-13971
Nd2Si2Cu2: mp-8120
Nd2Te1O2: mp-5459
Ne1: mp-111
Ni1: mp-23
Ni1B2Mo2: mp-9999
Ni2: mp-10257
Ni2Mo1: mp-784630
Ni4B2: mp-2536
Ni4W1: mp-30811
Np1B2: mp-1083
Np1N1: mp-2596
Os2: mp-49
Pa1: mp-10740
Pa1: mp-62
Pa1C1: mp-567580
Pa1N1: mp-1009545
Pm1Al1Cu2: mp-862838
Pm1Ca1Hg2: mp-862883
Pm1N1: mp-1018160
Pr1: mp-97
Pr1As1: mp-10622
Pr1B6: mp-12762
Pr1C2: mp-1995
Pr1Co2Si2: mp-5112
Pr1Cu5: mp-2462
Pr1Fe2Si2: mp-5627
Pr1Ga2: mp-668
Pr1H2: mp-24095
Pr1Mn2Si2: mp-5423
Pr1N1: mp-343
Pr1Ni1C2: mp-9312
Pr1Ni2B2C1: mp-6140
Pr1P1: mp-601
Pr1Re4Si2: mp-1025309
Pr1S1: mp-2495
Pr1Si2Cu2: mp-4014
Pr1Si2Ni2: mp-4439
Pr1Si2Os2: mp-5852
Pr1Si2Rh2: mp-4815
Pr1Si2Ru2: mp-4904
Pr1Zn1: mp-460
Pr2I2O2: mp-29254
Pr2O3: mp-2063
Pr2S1O2: mp-3236
Pr2Se1O2: mp-4764
Pr2Si2Cu2: mp-8119
Pr2Si4Ni2: mp-5493
Pr2Te1O2: mp-16032
Pu1Co1C2: mp-999290
Pu1Co2Si2: mp-22383
Pu1N1: mp-1719
Pu1Ni1C2: mp-975570
Pu1Si2Ni2: mp-20171
Pu1Si2Ru2: mp-22559
Rb1: mp-639755
Rb1: mp-70
Rb1: mp-975519
Rb1Br1: mp-22867
Rb1Ca1Cl3: mp-998197
Rb1Cl1: mp-23295
Rb1I1: mp-22903
Rb2: mp-975129
Rb2: mp-975204
Rb2C16: mp-568643
Rb2Ca2Cl6: mp-998324
Rb2Li2Br4: mp-28237
Rb2Li2Cl4: mp-28243
Rb2Sr2Cl6: mp-998755
Rb4Ca4Br12: mp-998536
Rb4Ca4I12: mp-998592
Re2: mp-8
Re2B4: mp-1773
Re3: mp-975065
Re4C2: mp-974437
Re6B2: mp-15671
Ru2: mp-33
Sc1Al1: mp-331
Sc1Al1Cu2: mp-16497
Sc1Al1Ni2: mp-10898
Sc1Al1Rh2: mp-867922
Sc1B2: mp-2252
Sc1Co1: mp-2212
Sc1Co2Si2: mp-4131
Sc1Cu1: mp-1169
Sc1Cu2: mp-1018149
Sc1H2: mp-24237
Sc1Ir1: mp-1129
Sc1N1: mp-2857
Sc1Ni1: mp-11521
Sc1Pd1: mp-2781
Sc1Pt1: mp-892
Sc1Rh1: mp-1780
Sc1Ru1: mp-30867
Sc1Zn1: mp-11566
Sc2Si2: mp-9969
Si1Ru1: mp-381
Si4Ru4: mp-189
Sm1: mp-21377
Sm1Al3Pd2: mp-11539
Sm1As1: mp-1738
Sm1C2: mp-12764
Sm1Co1C2: mp-999190
Sm1Co2Si2: mp-15968
Sm1Cu5: mp-227
Sm1Fe1C2: mp-999178
Sm1Fe2Si2: mp-567859
Sm1Ga2: mp-477
Sm1H2: mp-24658
Sm1Mn2Si2: mp-13473
Sm1N1: mp-749
Sm1Ni1C2: mp-999144
Sm1Ni2B2C1: mp-9220
Sm1P1: mp-710
Sm1Rh1: mp-436
Sm1S1: mp-1269
Sm1Si2Ir2: mp-12097
Sm1Si2Ni2: mp-3939
Sm1Si2Os2: mp-567408
Sm1Si2Rh2: mp-3882
Sm1Si2Ru2: mp-4072
Sm1Zn1: mp-2165
Sm2Au2: mp-999193
Sm2S1O2: mp-5598
Sm2Se1O2: mp-13972
Sm2Si2Cu2: mp-8121
Sm2Te1O2: mp-16033
Sm4As2Se2: mp-38593
Sr1: mp-76
Sr1: mp-95
Sr10Br16Cl4: mp-28021
Sr10Br20: mp-32711
Sr1B6: mp-242
Sr1C1N2: mp-12317
Sr1Cd1: mp-30496
Sr1Cl2: mp-23209
Sr1Cu5: mp-2726
Sr1F2: mp-981
Sr1Hf1N2: mp-9383
Sr1Hg1: mp-542
Sr1O1: mp-2472
Sr1S1: mp-1087
Sr1Se1: mp-2758
Sr1Te1: mp-1958
Sr2Be6O8: mp-27791
Sr2Br1N1: mp-23056
Sr2Br2F2: mp-23024
Sr2C1N2Cl2: mp-567655
Sr2Cl2F2: mp-22957
Sr2H2Br2: mp-24423
Sr2H2Cl2: mp-23860
Sr2H2I2: mp-24205
Sr2H3I1: mp-1019269
Sr2H5Rh1: mp-35152
Sr2H6Ru1: mp-24292
Sr2Hf2O6: mp-13109
Sr2Hf2O6: mp-3721
Sr2Hf2O6: mp-550908
Sr2I1N1: mp-569677
Sr2I2F2: mp-23046
Sr2N1Cl1: mp-23033
Sr4Br8: mp-567744
Sr4I4O2: mp-551203
Sr4I8: mp-568284
Sr8Br12O2: mp-556049
Sr8Cl12O2: mp-23321
Sr8I12O2: mp-29910
Sr8I16: mp-23181
Ta1: mp-50
Ta1Al1Co2: mp-3340
Ta1Al1Fe2: mp-867249
Ta1Al1Ni2: mp-5921
Ta1Al1Os2: mp-862445
Ta1Al1Ru2: mp-862446
Ta1B2: mp-1108
Ta1C1: mp-1086
Ta1Ga1Os2: mp-867788
Ta1Ga1Ru2: mp-867781
Ta1Mn2Al1: mp-867120
Ta1Ni2: mp-1157
Ta1Ni3: mp-570491
Ta1Ru1: mp-1601
Ta1Tc1: mp-11572
Ta1Ti1Os2: mp-867123
Ta1Ti1Re2: mp-867846
Ta1W3: mp-979289
Ta1Zn1Os2: mp-979291
Ta2B2: mp-1097
Ta2C1: mp-7088
Ta2Cr1Os1: mp-867774
Ta2Mo1Os1: mp-864770
Ta2N1: mp-10196
Ta2Os1W1: mp-864650
Ta2Re1Mo1: mp-977353
Ta2Tc1W1: mp-972209
Ta3B4: mp-10142
Ta4Si2: mp-2783
Ta4Si4Rh4: mp-20436
Ta5B6: mp-28629
Tb1: mp-7163
Tb1Ag1: mp-2268
Tb1Al1: mp-1009839
Tb1Al1Cu2: mp-971985
Tb1As1: mp-2640
Tb1B2: mp-965
Tb1Co1C2: mp-5106
Tb1Co2Si2: mp-3292
Tb1Cu1: mp-1837
Tb1Cu5: mp-11363
Tb1Fe1C2: mp-999122
Tb1Fe2Si2: mp-5399
Tb1H2: mp-24724
Tb1Mn2Si2: mp-5677
Tb1N1: mp-2117
Tb1Ni1C2: mp-3061
Tb1Ni2B2C1: mp-6092
Tb1P1: mp-645
Tb1Rh1: mp-11561
Tb1S1: mp-1610
Tb1Si2Ir2: mp-5752
Tb1Si2Ni2: mp-4466
Tb1Si2Os2: mp-5429
Tb1Si2Rh2: mp-3097
Tb1Si2Ru2: mp-3678
Tb1Zn1: mp-836
Tb2Au2: mp-999141
Tb2Cu2Ge2: mp-9387
Tb2S1O2: mp-12668
Tb2Se1O2: mp-755340
Tb2Si2Cu2: mp-5514
Tc2: mp-113
Tc2B4: mp-1019317
Th1: mp-37
Th1Al2: mp-669
Th1C1: mp-1164
Th1Co1C2: mp-999088
Th1Co2Si2: mp-7072
Th1Cu2: mp-1377
Th1Fe2Si2: mp-7600
Th1Ga2: mp-11419
Th1Mn2Si2: mp-4458
Th1N1: mp-834
Th1Ni2: mp-220
Th1Ni2B2C1: mp-1025034
Th1O2: mp-643
Th1P1: mp-931
Th1Si2Cu2: mp-5948
Th1Si2Ni2: mp-5682
Th1Si2Os2: mp-3166
Th1Si2Rh2: mp-4413
Th1Si2Ru2: mp-5165
Th1Si2Tc2: mp-8375
Ti1Al1: mp-1953
Ti1Al1Co2: mp-5407
Ti1Al1Cu2: mp-4771
Ti1Al1Fe1Co1: mp-998980
Ti1Al1Fe2: mp-31187
Ti1Al1Ni2: mp-7187
Ti1Al1Os2: mp-865442
Ti1Al1Rh2: mp-866153
Ti1Al1Ru2: mp-866155
Ti1B2: mp-1145
Ti1Be1: mp-11279
Ti1Be1Rh2: mp-866143
Ti1Be2Ir1: mp-866139
Ti1C1: mp-631
Ti1Co1: mp-823
Ti1Co2Si1: mp-3657
Ti1Fe1: mp-305
Ti1Fe2Si1: mp-866141
Ti1Ga1Co2: mp-20145
Ti1Ga1Fe1Co1: mp-998964
Ti1Ga1Ru2: mp-865448
Ti1Mn2Si1: mp-865652
Ti1N1: mp-492
Ti1Os1: mp-291
Ti1Re1: mp-2179
Ti1Re2W1: mp-865664
Ti1Ru1: mp-592
Ti1Si1Ru2: mp-865681
Ti1Si1Tc2: mp-865669
Ti1Tc1: mp-11573
Ti1Zn1Cu2: mp-865930
Ti1Zn1Rh2: mp-861961
Ti2: mp-46
Ti2Cu1: mp-742
Ti2Cu2: mp-2078
Ti2N2: mvc-13876
Ti2Pd1: mp-13164
Ti2Rh1: mp-1018124
Ti3B4: mp-1025170
Ti3Co3Si3: mp-15657
Ti4Ga2N2: mp-1025550
Ti4N2: mp-7790
Ti4N2: mp-8282
Ti4Si4Ni4: mp-510409
Ti4Si4Rh4: mp-672645
Tm1Ag1: mp-2796
Tm1As1: mp-1101
Tm1Au1: mp-447
Tm1B2: mp-800
Tm1Co1C2: mp-13502
Tm1Co2Si2: mp-3262
Tm1Cu1: mp-985
Tm1Cu5: mp-30600
Tm1Fe2Si2: mp-2938
Tm1H2: mp-24727
Tm1Ir1: mp-11483
Tm1N1: mp-1975
Tm1Ni1C2: mp-4037
Tm1P1: mp-7171
Tm1Pd1: mp-348
Tm1Rh1: mp-11564
Tm1Si2Ni2: mp-4469
Tm1Si2Os2: mp-570217
Tm1Si2Rh2: mp-8528
Tm1Si2Ru2: mp-568371
Tm1Zn1: mp-2316
Tm2Au2: mp-1017507
Tm2Ge2: mp-998911
Tm2S1O2: mp-3556
Tm2Si2Cu2: mp-8123
U1B2: mp-1514
U1C1: mp-2489
U1C2: mp-2486
U1Fe2Si2: mp-20924
U1N1: mp-1865
U1Si2Os2: mp-5786
U1Si2Ru2: mp-3388
U2: mp-44
U2B2C2: mp-5816
U2B2N2: mp-5311
U2Re2B6: mp-28607
V1: mp-146
V1B2: mp-1491
V1Fe1: mp-1335
V1Fe2Si1: mp-4595
V1Ga1Fe2: mp-21883
V1Ga1Ru2: mp-865586
V1Ni2: mp-11531
V1Ni3: mp-171
V1Os1: mp-12778
V1Ru1: mp-1395
V1Si1Ru2: mp-865507
V1Si1Tc2: mp-865472
V1Tc1: mp-2540
V2B2: mp-9973
V2C1: mp-1008632
V2Co2B6: mp-10057
V2Cr1Os1: mp-865485
V2Cr1Re1: mp-865484
V2Re1W1: mp-971754
V3B4: mp-569270
V4B6: mp-9208
V4Co4Si4: mp-21371
V6B4: mp-2091
W1: mp-91
W1C1: mp-1894
Xe1: mp-611517
Xe1: mp-972256
Xe1: mp-979285
Xe1: mp-979286
Xe2: mp-570510
Y1Ag1: mp-2474
Y1Al1: mp-11229
Y1As1: mp-933
Y1B2: mp-1542
Y1Cd1: mp-915
Y1Co1C2: mp-4248
Y1Co2Si2: mp-5129
Y1Cu1: mp-712
Y1Cu5: mp-2797
Y1Fe2Si2: mp-5288
Y1H2: mp-24650
Y1Ir1: mp-30746
Y1Mn2Si2: mp-3854
Y1N1: mp-2114
Y1Ni2B2C1: mp-6576
Y1P1: mp-994
Y1Rh1: mp-191
Y1S1: mp-1534
Y1Si2Ir2: mp-4653
Y1Si2Ni2: mp-5176
Y1Si2Os2: mp-567749
Y1Si2Rh2: mp-3441
Y1Si2Ru2: mp-568673
Y1Zn1: mp-2516
Y2S1O2: mp-12894
Y2Si2Cu2: mp-8126
Y4Si1S3: mp-677445
Yb1: mp-162
Yb1: mp-71
Yb1Ag1: mp-2266
Yb1B6: mp-419
Yb1Cd1: mp-1857
Yb1Co2Si2: mp-5326
Yb1Cs1Br3: mp-568005
Yb1Cu5: mp-1607
Yb1Fe2Si2: mp-2866
Yb1Hg1: mp-2545
Yb1I2: mp-570418
Yb1Mg1Cu4: mp-1025021
Yb1O1: mp-1216
Yb1Pd1: mp-2547
Yb1Pm1Au2: mp-865894
Yb1Rh1: mp-567089
Yb1S1: mp-1820
Yb1Se1: mp-286
Yb1Si2Ni2: mp-5916
Yb1Si2Os2: mp-567093
Yb1Si2Rh2: mp-10626
Yb1Si2Ru2: mp-3415
Yb1Te1: mp-1779
Yb1Tl1: mp-11576
Yb1Zn1: mp-1703
Yb2Br4: mp-22882
Yb2Cl2F2: mp-557483
Yb2Cl4: mp-865716
Yb2F4: mp-865934
Yb2Pd1Au1: mp-864800
Yb2Rb8I12: mp-23347
Yb4Br8: mp-571232
Yb4Li2Cl10: mp-23421
Yb4Rb4Br12: mp-571418
Yb4Rb4I12: mp-568796
Yb8Br12O2: mp-850213
Yb8Cl12O2: mp-554831
Yb8Cl16: mp-23220
Zn1Cu1Ni2: mp-971738
Zn1Cu2Ni1: mp-30593
Zn1Ni3: mp-971804
Zn2Ni2: mp-429
Zr1Al1Cu2: mp-3736
Zr1Al1Ni2: mp-3944
Zr1Al1Rh2: mp-977435
Zr1B2: mp-1472
Zr1C1: mp-2795
Zr1Co1: mp-2283
Zr1Co2Si2: mp-569344
Zr1Cu1: mp-2210
Zr1Cu5: mp-30603
Zr1Fe2Si2: mp-569247
Zr1H2: mp-24155
Zr1H2: mp-24286
Zr1N1: mp-1352
Zr1Os1: mp-11541
Zr1Pt1: mp-11554
Zr1Ru1: mp-214
Zr1Zn1: mp-570276
Zr1Zn1Cu2: mp-11366
Zr1Zn1Ni4: mp-11533
Zr1Zn1Rh2: mp-977582
Zr2Be2Si2: mp-10200
Zr2Si2: mp-11322
Zr2Ti2As2: mp-30147
Zr2V2Si2: mp-5541
Zr3Cu4Ge2: mp-15985
Zr3Si2Cu4: mp-7930
Zr4Co4P4: mp-8418
Zr4Mn4P4: mp-20147
Zr4Si4: mp-893
Zr4Si4Pt4: mp-972187
Zr4V4P4: mp-22302
POTENTlALLY FUNCTlONALLY STABLE ANODE COATlNGS
Ba38Li88: mp-569841
Li12P28: mp-28336
Li12Sb6: mp-9563
Li12Te36: mp-27466
Li13Sn5: mp-30769
Li14Ge4: mp-29630
Li14Sn4: mp-30767
Li14Sn6: mp-30768
Li18Ge8: mp-27932
Li1Ag1: mp-2426
Li1Ag3: mp-862716
Li1Al2Os1: mp-982667
Li1Al3: mp-10890
Li1Al3: mp-975906
Li1Au3: mp-11248
Li1Au3: mp-975909
Li1Bi1: mp-22902
Li1Br1: mp-23259
Li1C12: mp-1021323
Li1C6: mp-1001581
Li1Cd3: mp-973940
Li1Co2Si1: mp-867293
Li1Cu3: mp-862658
Li1Cu3: mp-974058
Li1F1: mp-1009009
Li1Ga3: mp-867205
Li1Ge1Rh2: mp-13322
Li1H1: mp-23703
Li1Hf1: mp-973948
Li1Hg1: mp-2012
Li1Hg3: mp-973824
Li1Hg3: mp-976599
Li1I1: mp-22899
Li1In3: mp-867161
Li1In3: mp-973748
Li1Ir1: mp-279
Li1Lu1O2: mp-754537
Li1Mg2Pd1: mp-977380
Li1Mg2Pt1: mp-864614
Li1Pb1: mp-2314
Li1Pd1: mp-2743
Li1Pd1: mp-2744
Li1Pd3: mp-861936
Li1Pt1: mp-11807
Li1Rh1: mp-600561
Li1S1: mp-32641
Li1Si1Ni2: mp-10181
Li1Si1Rh2: mp-867902
Li1Tl1: mp-934
Li1Tl3: mp-973191
Li1Tm1O2: mp-777047
Li1Zn3: mp-865907
Li22Ge12: mp-29631
Li22S11: mp-32899
Li26In6: mp-510430
Li26Si8: mp-672287
Li27As10: mp-676620
Li27Sb10: mp-676024
Li28Si8: mp-27930
Li2Ag2: mp-1018026
Li2Al1Pd1: mp-30816
Li2Al1Pt1: mp-30818
Li2Al1Rh1: mp-30820
Li2Al2: mp-1067
Li2Al2Pt2: mp-1025063
Li2B2: mp-1001835
Li2C2: mp-1378
Li2Ca1Pb1: mp-865892
Li2Ca1Sn1: mp-865964
Li2Eu1Sn1: mp-867474
Li2Ga1Ir1: mp-31441
Li2Ga1Pt1: mp-3726
Li2Ga1Rh1: mp-2988
Li2Ga2: mp-1307
Li2I2: mp-568273
Li2In1Rh1: mp-31442
Li2In2: mp-22460
Li2P6: mp-1025406
Li2Pd1: mp-728
Li2Pt1: mp-2170
Li2S8: mp-995393
Li2Si6: mp-975321
Li2U2N4: mp-31066
Li30Au8: mp-567395
Li30Ge8: mp-1777
Li30Si8: mp-569849
Li3Ag1: mp-865875
Li3Ag1: mp-976408
Li3Au1: mp-11247
Li3Bi1: mp-23222
Li3C1: mp-976060
Li3Cd1: mp-867343
Li3Cd1: mp-975904
Li3Cu1: mp-975882
Li3Ga1: mp-976023
Li3Ga1: mp-976025
Li3Ga2: mp-9568
Li3Ge1: mp-867342
Li3Hg1: mp-1646
Li3Hg1: mp-976047
Li3In1: mp-867226
Li3In1: mp-976055
Li3In2: mp-21293
Li3La1As2: mp-1018766
Li3La1P2: mp-8407
Li3N1: mp-2251
Li3Pb1: mp-30760
Li3Pd1: mp-11489
Li3Pd1: mp-976281
Li3Pt1: mp-867227
Li3Pt1: mp-976322
Li3Sb1: mp-2074
Li3Sn3: mp-569073
Li3Tl1: mp-7396
Li40Pb12: mp-504760
Li48As112: mp-680395
Li4In2: mp-31324
Li4P20: mp-2412
Li4P20: mp-32760
Li4Si2: mp-27705
Li4Sn10: mp-7924
Li5Sn2: mp-30766
Li5Tl2: mp-12283
Li6Ag2: mp-977126
Li6As2: mp-757
Li6Ge6: mp-8490
Li6P2: mp-736
Li6Re2: mp-983152
Li6Sb2: mp-7955
Li6Sn6: mp-13444
Li7Pb2: mp-30761
Li84Si20: mp-29720
Li85Pb20: mp-574275
Li85Sn20: mp-573471
Li88Pb20: mp-573651
Li88Si20: mp-542598
Li8As8: mp-7943
Li8Ge8: mp-9918
Li8P56: mp-27687
Li8P8: mp-9588
Li8Pb3: mp-27587
Li8S4: mp-1125
Li8S4: mp-557142
Li8Si8: mp-570363
Li8Si8: mp-795
Li96Si56: mp-1314
Sr1Li1P1: mp-10614
Sr1Li2Pb1: mp-867174
Sr1Li2Sn1: mp-867171
Sr2Li2P2: mp-13276
Yb1Li2Pb1: mp-866180
Yb1Li2Sn1: mp-866192
FUNCTlONALLY STABLE CATHODE COATlNGS
Ac16S24: mp-32800
Ac2Br6: mp-27972
Ac2Cl6: mp-27971
Ag1: mp-124
Ag10Sb2S8: mp-4004
Ag12As12S24: mp-542609
Ag16Ge2Se12: mp-18474
Ag16P8S24: mp-561822
Ag16P8Se24: mp-13956
Ag16Sn2Se12: mp-17984
Ag16Te16: mp-568761
Ag1Au3: mp-867303
Ag1Bi1S2: mp-29678
Ag1Bi1Te2: mp-29656
Ag1H4W1S4N1: mp-643431
Ag1I1: mp-22925
Ag1I1: mp-684580
Ag1Sb1Te2: mp-12360
Ag1Te3: mp-28246
Ag2: mp-10597
Ag24Au8S16: mp-27554
Ag24P12S36: mp-558469
Ag28As4S24: mp-15077
Ag28P12S44: mp-683910
Ag28P4Se24: mp-8594
Ag2Au6: mp-985287
Ag2Bi2P4S12: mp-556434
Ag2Bi2P4Se12: mp-569126
Ag2Bi6S10: mp-23474
Ag2Hg1I4: mp-23485
Ag2Hg1I4: mp-570256
Ag2Hg2As2S6: mp-6215
Ag2I2: mp-22894
Ag2I2: mp-567809
Ag2Sb2Se4: mp-33683
Ag2Te8Au2: mp-3291
Ag3: mp-989737
Ag32Ge4S24: mp-9770
Ag32Sn4S24: mp-15645
Ag3Au1S2: mp-34460
Ag3Bi3Se6: mp-27916
Ag4: mp-8566
Ag4As4Pb4S12: mp-22665
Ag4As4S4: mp-984714
Ag4As4Se4: mp-985442
Ag4Ge2Pb2S8: mp-861942
Ag4Ge2S6: mp-9900
Ag4Hg2S2I4: mp-556866
Ag4Hg4S4I4: mp-23140
Ag4Hg4S4I4: mp-558446
Ag4S2: mp-31053
Ag4S2: mp-32669
Ag4S2: mp-32884
Ag4S2: mp-36216
Ag4S2: mp-556225
Ag4Sb4Pb4S12: mp-560848
Ag4Sb4S8: mp-3922
Ag4Se12I4: mp-569052
Ag4Sn2Hg2Se8: mp-10963
Ag4Te2S6: mp-29163
Ag6As2S6: mp-4431
Ag6As2S6: mp-555843
Ag6As2S8: mp-9538
Ag6As2Se6: mp-5145
Ag6As6S12: mp-13740
Ag6P2S8: mp-12459
Ag6P2Se8: mp-30908
Ag6Sb2S6: mp-4515
Ag8Ge1Te6: mp-685969
Ag8Hg28As16I24: mp-23592
Ag8Hg2Ge4S14: mp-542199
Ag8P4S14: mp-27482
Ag8S4: mp-610517
Ag8Se4: mp-568936
Ag8Se4: mp-568971
Ag8Se4: mp-754954
Ag8Te4: mp-1592
Al10B2O18: mp-3281
Al10F30: mp-555026
Al10H2O16: mp-626161
Al12B10O30F6: mp-6738
Al12S18: mp-2654
Al14Tl6S24: mp-28759
Al16F48: mp-1323
Al16O24: mp-2254
Al16S24: mp-684638
Al18P18O72: mp-558088
Al18P18O72: mp-667310
Al1F3: mp-8039
Al1N1: mp-1700
Al26Tl6S42: mp-28790
Al28Si12B4O72: mp-1019381
Al2Ag2S4: mp-5782
Al2Ag2Se4: mp-14091
Al2Cd1S4: mp-5928
Al2Cd1Se4: mp-3159
Al2Cu2S4: mp-4979
Al2Cu2S4: mvc-16090
Al2F6: mp-468
Al2Hg1S4: mp-7906
Al2Hg1Se4: mp-3038
Al2N2: mp-661
Al2P2S8: mp-27462
Al2Tl2Se4: mp-9579
Al32P32O128: mp-683883
Al4B6O15: mp-31408
Al4Cd2S8: mp-9993
Al4H16N4F16: mp-696815
Al4H60N20Cl12: mp-699469
Al4O6: mp-1143
Al4O6: mp-7048
Al4Si4O14: mp-755043
Al4Zn2S8: mp-4842
Al5Cu1S8: mp-35267
Al5Cu1S8: mvc-16094
Al6F18: mp-559871
Al6In6S18: mp-504482
Al8Bi4S16: mp-557737
Al8Bi4S16: mvc-16098
Al8H48N16O24: mp-740718
Al8Hg20Se32: mp-685952
Al8P12H36C12O36: mp-556858
Al8P8H36N4O44: mp-23819
Al8Si12H32N8O40: mp-706243
Al8Si4O16F8: mp-6280
Al8Si4O20: mp-4753
Al8Si4O20: mp-4934
Al8Si4O20: mp-5065
Al8Tl8S16: mp-985477
Al8Tl8Se16: mp-867359
Ar1: mp-23155
Ar2: mp-568145
As12Ir4: mp-540912
As12Rh4: mp-8182
As16Pb16S40: mp-608653
As16S12: mp-27543
As16S12: mp-557321
As16S16: mp-542810
As16S16: mp-556328
As16S18: mp-31070
As16Se16: mp-542570
As2: mp-11
As4: mp-158
As4Os2: mp-2455
As4Pb9S15: mp-27594
As4Pd4S4: mp-10848
As4Pd4Se4: mp-10849
As4Ru2: mp-766
As8Ir4: mp-15649
As8Pd4: mp-20465
As8Pt4: mp-2513
As8Rh4: mp-15954
As8S10: mp-502
As8S12: mp-641
As8S8: mp-542846
As8Se12: mp-909
Au1: mp-81
Au2: mp-1008634
Au2Se2: mp-2793
Au4S2: mp-947
Au4Se4: mp-570325
B16Pb16S40: mp-662553
B16S24: mp-572670
B16S32: mp-540668
B1N1: mp-13150
B24H24O48: mp-721851
B2N2: mp-604884
B2N2: mp-629015
B2N2: mp-7991
B2N2: mp-984
B6O9: mp-306
Ba11Ta6S26: mp-676889
Ba12Al24S48: mp-14246
Ba12Bi24S48: mp-28057
Ba12Dy8P16S64: mp-560798
Ba12Er8P16S64: mp-560534
Ba12Gd8P16S64: mp-684036
Ba12Ho8P16S64: mp-559171
Ba12P8S32: mp-554255
Ba12Si4S20: mp-27805
Ba12Sn8S28: mp-556291
Ba12Ti10S30O2: mp-555781
Ba16As16S40: mp-28134
Ba16Sn8S32: mp-540689
Ba1Ag2Ge1S4: mp-7394
Ba1Ag2Ge1Se4: mp-569790
Ba1Ag2Sn1S4: mp-555166
Ba1Ag2Sn1Se4: mp-569114
Ba1Cl2: mp-568662
Ba1Hf1S3: mp-998352
Ba1Sr1I4: mp-754852
Ba1Sr2I6: mp-754212
Ba1Tm2F8: mp-7693
Ba2Al8S14: mp-8258
Ba2B4S8: mp-30126
Ba2Bi2B2S8: mp-861618
Ba2Cu4Sn2Se8: mp-12364
Ba2Er2Cu2S6: mp-14969
Ba2Ga4Se8: mp-7841
Ba2La1Ag5S6: mp-553874
Ba2Li2B18O30: mp-17672
Ba2Li2B18O30: mp-558890
Ba2Na2B18O30: mp-17864
Ba2Pd4S8: mp-28967
Ba2Sr1I6: mp-760418
Ba2Sr4I12: mp-754224
Ba2Ti2S6: mp-7073
Ba2V2S6: mp-3451
Ba2V2S6: mp-4227
Ba2V2S6: mp-555857
Ba32Sn16Se80: mp-31307
Ba3Cu6Ge3S12: mp-17947
Ba3Cu6Ge3Se12: mp-17252
Ba3Cu6Sn3S12: mp-17954
Ba3I6: mp-568536
Ba3P2S8: mp-561443
Ba3Sr1I8: mp-756235
Ba4Ag32S20: mp-29682
Ba4B32O52: mp-27794
Ba4B4Sb4S16: mp-866301
Ba4Br4Cl4: mp-1012551
Ba4Br8: mp-27456
Ba4Ca2I12: mp-756725
Ba4Cl8: mp-23199
Ba4Cu24Ge8S32: mp-556714
Ba4Ge2Se8: mp-11902
Ba4Hf4S12: mp-998419
Ba4Hg4S8: mp-28007
Ba4I8: mp-23260
Ba4In2Bi2S10: mp-864638
Ba4La4Bi8S24: mp-555699
Ba4Lu8S16: mp-984052
Ba4P4S12: mp-11006
Ba4P4Se12: mp-11008
Ba4Sn4Hg4S16: mp-555954
Ba4Sr2I12: mp-752397
Ba4Sr2I12: mp-756202
Ba4Sr8I24: mp-772876
Ba4Te4S12: mp-27499
Ba4Y8S16: mp-29036
Ba4Zr4S12: mp-540771
Ba5Hf4S13: mp-557032
Ba6Bi12Pb2Se26: mp-669415
Ba6Hf5S16: mp-554688
Ba6Sr3I18: mp-752671
Ba8Cd8Ge8S32: mp-13831
Ba8Cd8Sn8S32: mp-12306
Ba8In16S32: mp-21943
Ba8In16Se32: mp-21766
Ba8Sb16S32: mp-28129
Ba8Sb16Se32: mp-4727
Ba8Si4S16: mp-5838
Ba8Sn4S16: mp-541832
Ba8Sr4I24: mp-756624
Ba8Sr4I24: mp-772875
Ba8Sr4I24: mp-772878
Ba8Ti4S16: mp-17908
Ba9Ta6S24: mp-29354
Be12F24: mp-559400
Be12F24: mp-561543
Be12Si6O24: mp-3347
Be16B8H8O3'2: mp-23883
Be1O1: mp-1778
Be1S1: mp-422
Be2O2: mp-2542
Be2Si2N4: mp-15704
Be3F6: mp-15951
Be3F6: mp-558118
Be4Al4Si4H4O20: mp-759686
Be4Al8O16: mp-3081
Be4B2O6F2: mp-554023
Be4H16N4F12: mp-696961
Be4H32N8F16: mp-604245
Be4H32N8F16: mp-720982
Be4O4: mp-7599
Be4Si4N8: mp-7913
Be6Al4Si12036: mp-6030
Be8Al48O80: mp-560974
Be8H64N16F32: mp-24614
Be8Si4H4O18: mp-707304
Bi14Te13S8: mp-557619
Bi16Pb16S40: mp-680181
Bi1Te1Br1: mp-33723
Bi1Te1I1: mp-22965
Bi2I6: mp-22849
Bi2I6: mp-569157
Bi2Pb1Se4: mp-675543
Bi2Pb2Se5: mp-570930
Bi2Se3: mp-541837
Bi2Te2S1: mp-27910
Bi2Te2Se1: mp-29666
Bi2Te3: mp-34202
Bi2Te4Pb1: mp-676250
Bi4Pb6S12: mp-629690
Bi4S4I4: mp-23514
Bi4Se4I4: mp-23020
Bi4Te7Pb1: mp-23005
Bi8P8S32: mp-27133
Bi8Pb4S16: mp-641924
Bi8S12: mp-22856
Bi8Se12: mp-23164
Bi8Te9: mp-580062
C12: mp-606949
C16: mp-568286
C2: mp-1040425
C2: mp-169
C2: mp-937760
C2: mp-990448
C4: mp-48
C4: mp-990424
C4: mp-997182
C8: mp-568806
Ca1F2: mp-2741
Ca1I2: mp-30031
Ca1Mn4S8: mvc-93
Ca1Pb1I4: mp-753670
Ca1Pb1I4: mp-754540
Ca1S1: mp-1672
Ca1Se1: mp-1415
Ca1Ti4S8: mvc-11744
Ca1Ti4S8: mvc-16037
Ca1Ti8S16: mvc-16026
Ca20Er10F69: mp-532089
Ca2Cl2F2: mp-27546
Ca2Gd4S8: mp-36358
Ca2La4S8: mp-35421
Ca2Mg5Si8O22F2: mp-557662
Ca2Nd4S8: mp-35876
Ca2Pr4S8: mp-34185
Ca2Sm4S8: mp-36100
Ca2Sn1S4: mp-866818
Ca4B24O40: mp-558358
Ca4Lu8S16: mp-505362
Ca4P4S12: mp-9789
Ca4P4Se12: mp-11007
Ca4Pb4I16: mp-756451
Ca4Y8S16: mp-18642
Ca8Al16S32: mp-14422
Ca8B20Br4O36: mp-554056
Ca8Ge4S16: mp-540773
Ca8Sb8S20: mp-29284
Ca8Sb8S20: mvc-16380
Ca8Sn4S16: mp-866503
Cd1Ag2I4: mp-1025377
Cd1Cu2Ge1Se4: mp-10967
Cd1Cu2Sn1Se4: mp-16565
Cd1Ga2Se4: mp-3772
Cd1In2Se4: mp-22304
Cd1In2Se4: mp-568032
Cd1In2Se4: mp-568661
Cd1S1: mp-2469
Cd1Sb6S8I4: mp-560411
Cd1Se1: mp-2691
Cd2Ag4Ge2S8: mp-554105
Cd2Ag8Ge4S14: mp-542200
Cd2Cu4Ge2S8: mp-13982
Cd2Hg8As4I8: mp-570838
Cd2In4S8: mp-559200
Cd2S2: mp-672
Cd2Se2: mp-1070
Cd2Si2Cu4S8: mp-6449
Cd4Ga2Ag2S8: mp-6356
Cd8Ge2S12: mp-5151
Cd8Ge2Se12: mp-18163
Cd8Si2S12: mp-18179
Cd8Si2Se12: mp-17791
Ce12Tm12S36: mp-683985
Ce16S24: mp-32629
Ce20S38: mp-645688
Ce20Se38: mp-652044
Ce2Pa2O8: mp-686050
Ce2S2F2: mp-4973
Ce2S4: mp-1018663
Ce2Se4: mp-1018665
Ce2Y6S12: mp-1006324
Ce3Se6: mp-1021484
Ce4Cr4S12: mp-21871
Ce4Cu4S8: mp-5766
Ce4Dy4S12: mp-20775
Ce4Lu11S22: mp-680039
Ce4S8: mp-13567
Ce4Sc4S12: mp-20953
Ce4Se8: mp-1320
Ce4Tl8P8S28: mp-638100
Ce6Ag2Ge2S14: mp-866604
Ce6Cu2Ge2S14: mp-558303
Ce6Cu2Ge2Se14: mp-570564
Ce6Cu2Sn2S14: mp-510567
Ce6Mg2Al2S14: mp-866517
Ce6Mn2Al2S14: mp-866500
Ce6Si2Ag2S14: mp-866605
Ce6Si2Cu2S14: mp-558375
Ce6Si4S16Br2: mp-669378
Ce6Si4S16Cl2: mp-542133
Ce6Si4S16I2: mp-555409
Ce8Hf4S20: mp-985298
Ce8P8S32: mp-561261
Ce8S12: mp-20973
Ce8S16: mp-20594
Ce8Si4S20: mp-558269
Ce8Tm8S24: mp-541836
Ce8U4S20: mp-985558
Co1Ni2Se4: mp-1025318
Co1Te2: mp-1009641
Co2As2S2: mp-553946
Co2As4: mp-1018672
Co2Ni1Se4: mp-1025190
Co2Ni4S8: mp-674355
Co2P2Pd2: mp-1018673
Co2Sb2S2: mp-4962
Co2Se4: mp-20862
Co2Te4: mp-9945
Co3Se4: mp-11800
Co4As12: mp-452
Co4As12: mp-672216
Co4As4S4: mp-16363
Co4As4S4: mp-4627
Co4Cu2S8: mp-3925
Co4Ni2S8: mp-22658
Co4P12: mp-1944
Co4P4: mp-22270
Co4P8: mp-14285
Co4S8: mp-2070
Co4S8: mp-850049
Co4Se8: mp-22309
Co6S8: mp-943
Co8As8Se8: mp-505511
Co8P8Se8: mp-10368
Co9S8: mp-1513
Cr1Ag1S2: mp-4182
Cr1Ag1Se2: mp-3532
Cr1Au1S2: mp-7113
Cr1Se2: mp-1009581
Cr4Cd2S8: mp-4338
Cr4Cu2S8: mp-22803
Cr4Cu2Se8: mp-3880
Cr4H48I6N18: mp-720712
Cr4Hg2S8: mp-15973
Cr4Hg2Se8: mp-5602
Cr4Sb4S12: mp-9130
Cr4Sb4Se12: mp-15236
Cr4Se8: mvc-11653
Cr9In7S24: mp-676500
Cs10Al10F40: mp-14866
Cs10Ti12Ag2Se54: mp-16000
Cs12Al12F48: mp-572702
Cs12B4S12: mp-30222
Cs12Cd4I20: mp-669317
Cs12Cu4Te4S36: mp-560345
Cs12Ge4As4Se20: mp-582708
Cs12La4Cl24: mp-582080
Cs12Nb8S44: mp-669313
Cs12Nd4P8S32: mp-572442
Cs12P4Se16: mp-583193
Cs12Re12S30: mp-653954
Cs12Sb4Se16: mp-17811
Cs12Sm4P8S32: mp-572833
Cs12Ta4S16: mp-17054
Cs12Ta8S44: mp-556091
Cs16As64S104: mp-650280
Cs16Mg8Si40O96: mp-1019610
Cs16Ta16P16S96: mp-555592
Cs16Th8P20Se68: mp-680198
Cs1Au3S2: mp-9384
Cs1Au3Se2: mp-9386
Cs1Br1: mp-571222
Cs1Ca1Br3: mp-30056
Cs1Ca1I3: mp-998333
Cs1Ce1S2: mp-7015
Cs1Cl1: mp-573697
Cs1Cu3S2: mp-7786
Cs1Dy1S2: mp-9086
Cs1Ho1S2: mp-505158
Cs1I1: mp-614603
Cs1In5S8: mp-22007
Cs1K5Zn4Sn5S17: mp-641018
Cs1La1S2: mp-561586
Cs1Lu1S2: mp-561619
Cs1Mg12Al25Si29O108: mp-695172
Cs1Mg4Al9Si9O36: mp-695133
Cs1Pb1Br3: mp-600089
Cs1Pr1S2: mp-9080
Cs1Sn1I3: mp-614013
Cs1Sr1Br3: mp-998297
Cs1Sr1I3: mp-998417
Cs1Tm1S2: mp-9089
Cs1V1P2S7: mp-12324
Cs24Hg8I40: mp-651121
Cs24Nd8Cl48: mp-582081
Cs2Ag6S4: mp-561902
Cs2Ag6Se4: mp-16234
Cs2Au2Se2: mp-574599
Cs2Au2Se6: mp-567913
Cs2Ca1Br4: mp-1025267
Cs2Ca1Cl4: mp-1025185
Cs2Cd2Au2S4: mp-560558
Cs2Ce2Cu2S6: mp-510569
Cs2Cu2Bi4S8: mp-558907
Cs2Dy2S4: mp-984555
Cs2Ga2S4: mp-5038
Cs2Hg3I8: mp-540574
Cs2Ho2Zn2Se6: mp-505712
Cs2K1Sc1Cl6: mp-571124
Cs2La2Hg2Se6: mp-11124
Cs2Li1Al3F12: mp-13634
Cs2Li1Lu1Cl6: mp-570379
Cs2Li1Y1Cl6: mp-567652
Cs2Li2B12O20: mp-5990
Cs2Mg2Br6: mp-29750
Cs2Mg2Cl6: mp-23004
Cs2Na1Al3F12: mp-12309
Cs2Na1Er1Cl6: mp-580589
Cs2Na1Ho1Cl6: mp-542951
Cs2Na1Y1Br6: mp-571467
Cs2Na1Y1Cl6: mp-23120
Cs2Np2Cu2S6: mp-862802
Cs2P2S6: mp-504838
Cs2Pd3S4: mp-510268
Cs2Pd3Se4: mp-11694
Cs2Pr2Hg2Se6: mp-7211
Cs2Pr2S4: mp-9037
Cs2Pt3S4: mp-13992
Cs2Pt4Se6: mp-573316
Cs2S2: mp-29266
Cs2Sb4S8: mp-8890
Cs2Sb4Se8: mp-3312
Cs2Sn2Hg3S8: mp-561185
Cs2Sn2I6: mp-616378
Cs2Sn2S6: mp-561710
Cs2Sn2Se6: mp-613162
Cs2Sr2Br6: mp-998433
Cs2Sr2Cl6: mp-998561
Cs2Ta2Ge2S10: mp-865606
Cs2Te2Au2: mp-573755
Cs2Th1Cl6: mp-27501
Cs2Ti2Cu6Se8: mp-570706
Cs2Tm2Zn2Se6: mp-505713
Cs2U2Ag2S6: mp-13346
Cs2U2Ag2Se6: mp-510662
Cs2U2Cu2S6: mp-13348
Cs2U2Cu2Se6: mp-7151
Cs2Y2Zn2Se6: mp-574620
Cs2Zr2Cu2Se6: mp-7152
Cs32Si8Se32: mp-29834
Cs3Al3F12: mp-554899
Cs3Bi7Se12: mp-650619
Cs3Mg2Cl7: mp-568137
Cs3Sb2I9: mp-541014
Cs3Te22: mp-620471
Cs4Ag20Se12: mp-10480
Cs4Ag20Te12: mp-9206
Cs4Ag2As2S8: mp-561622
Cs4Ag2Sb2S8: mp-510710
Cs4Ag4P4Se12: mp-865980
Cs4Ag4Sb16S28: mp-554408
Cs4Ag4Se16: mp-18105
Cs4Ag8As4S12: mp-866615
Cs4Ag8I12: mp-23496
Cs4Al4Si4O16: mp-561457
Cs4Au4Se6: mp-29194
Cs4B20O32: mp-1019710
Cs4B20O32: mp-510535
Cs4B36O56: mp-680683
Cs4Ba8Br20: mp-541722
Cs4Be16B12O36: mp-1019718
Cs4Be4F12: mp-12262
Cs4Be8F20: mp-27192
Cs4Bi12S20: mp-29531
Cs4Bi12Se20: mp-567928
Cs4Bi16Se26: mp-680317
Cs4Ca4I12: mp-998428
Cs4Ce4Si4Se16: mp-573969
Cs4Cu4S16: mp-18003
Cs4Cu4Se16: mp-17095
Cs4Er4Si4S16: mp-16972
Cs4Ga4S12: mp-562726
Cs4Ga4Se12: mp-510283
Cs4Gd4Si4S16: mp-630711
Cs4Ge4Bi4S16: mp-553970
Cs4Hg12S14: mp-17905
Cs4Hg2I8: mp-28421
Cs4Hg2I8: mp-567594
Cs4In4I16: mp-607987
Cs4Li4B24O40: mp-1019715
Cs4Mn2P4Se12: mp-867332
Cs4Nb2Ag2S8: mp-623028
Cs4Nb2Ag2Se8: mp-14637
Cs4Nb2Cu2Se8: mp-15223
Cs4Nb8P4S40: mp-641699
Cs4Ni6S8: mp-28486
Cs4P2Se10: mp-569060
Cs4P4Pb4S16: mp-562569
Cs4Pb4Br12: mp-567629
Cs4Pb4Br12: mp-567681
Cs4Pb4I12: mp-540839
Cs4Pu4P8S28: mp-680370
Cs4Sb4S24: mp-28701
Cs4Sb4S8: mp-561639
Cs4Se6: mp-7449
Cs4Si2Se8: mp-637251
Cs4Si4Bi4S16: mp-558426
Cs4Sm4Si4S16: mp-561635
Cs4Sn2As4Se18: mp-568403
Cs4Sn2Au4S8: mp-561641
Cs4Sn4I12: mp-27381
Cs4Sn4I12: mp-568570
Cs4Ta2Ag2S8: mp-15218
Cs4Te4Se12: mp-9462
Cs4Te6: mp-505634
Cs4Ti2Ag4S8: mp-10488
Cs4Ti2Cu4Se8: mp-10489
Cs4Ti2S6: mp-3247
Cs4Ti4P8S32: mp-645687
Cs4V2Ag2S8: mp-8684
Cs4Zn6S8: mp-505633
Cs6Bi4I18: mp-624214
Cs6Bi4I18: mp-669458
Cs6Nb4As2Se22: mp-683903
Cs6Sb4I18: mp-23029
Cs6Ti6S27: mp-680170
Cs8Ag4I12: mp-540881
Cs8Al8Si16O48: mp-562920
Cs8As16Se24: mp-645172
Cs8As8Se16: mp-28563
Cs8As8Se16: mp-581864
Cs8B40O64: mp-581194
Cs8Cd4I16: mp-568134
Cs8Dy4Cl20: mp-540695
Cs8Ge8S20: mp-572598
Cs8In8S16: mp-559459
Cs8Mg4Cl16: mp-568909
Cs8Mo4S16: mp-560635
Cs8P4Pd2Se16: mp-866688
Cs8P4Se18: mp-569193
Cs8Pb2Br12: mp-23436
Cs8Pd4Se32: mp-31285
Cs8Re12S26: mp-652494
Cs8Sb16S28: mp-27146
Cs8Sb28S46: mp-642535
Cs8Sb8Se16: mp-2969
Cs8Se20: mp-541055
Cs8Si16B8O48: mp-1019719
Cs8Si8Se20: mp-542550
Cs8Sn4S56: mp-505141
Cs8Ta8P8S48: mp-553976
Cs8Tc12S26: mp-579058
Cs8Te52: mp-505464
Cs8Th4P12S36: mp-640389
Cs8Ti6S28: mp-542011
Cs8W4S16: mp-17361
Cs8Zr6S28: mp-680246
Cs8Zr6Se28: mp-768674
Cu12Ag2Bi24Pb2S44: mp-651706
Cu12As4S13: mp-504753
Cu12As8S18: mp-28717
Cu12Bi28Pb12S60: mp-680135
Cu12Ge2W2S16: mp-557225
Cu12Sb4S12: mp-17691
Cu12Sb4S13: mp-647164
Cu12Sn21S48: mp-530411
Cu16Bi16S36: mp-559551
Cu16Sn4S16: mp-504536
Cu1Au3: mp-2103
Cu1S1: mp-760381
Cu24As24Se24: mp-574367
Cu24Sb8S24: mp-554272
Cu2Ag2S2: mp-8911
Cu2Au2Se8: mp-30151
Cu2B2S4: mp-12954
Cu2Bi2P4Se12: mp-569715
Cu2Bi6Pb2S12: mp-542302
Cu2Bi8Pb6S19: mp-669445
Cu2Ge1Se3: mp-4728
Cu2Hg1Ge1S4: mp-10952
Cu2Hg1Ge1Se4: mp-12855
Cu2Ir4S8: mp-15065
Cu2Rh4S8: mp-15613
Cu2Rh4Se8: mp-15614
Cu2Se4: mp-2000
Cu2Sn1Hg1S4: mp-1025467
Cu2Sn1Hg1Se4: mp-16566
Cu2W1S4: mp-557373
Cu2W1S4: mp-8976
Cu2W1Se4: mp-1025340
Cu32Ge8S32: mp-565590
Cu3As1S4: mp-20545
Cu3As1Se4: mp-675626
Cu3Sb1S4: mp-5702
Cu3Sb1Se4: mp-9814
Cu4Ag4S4: mp-5014
Cu4As4Pb4S12: mp-628643
Cu4As4S4: mp-5305
Cu4Bi20Pb4S36: mp-642316
Cu4Bi4P8Se24: mp-683998
Cu4Bi4Pb4S12: mp-624191
Cu4Bi4Pt4S12: mp-865018
Cu4Bi4S8: mp-22982
Cu4Bi5S10: mp-27124
Cu4Ge2S6: mp-15252
Cu4Ge2Se6: mp-677105
Cu4Hg2Ge2S8: mp-557574
Cu4Hg4S4I4: mp-542426
Cu4Pt8S16: mp-28888
Cu4Sb4Pb4S12: mp-649774
Cu4Sb4S8: mp-4468
Cu4Sb4Se8: mp-20331
Cu4Se8: mp-2280
Cu4Sn2S6: mp-10519
Cu4Sn2Se6: mp-11658
Cu4Sn7S16: mp-675137
Cu69Sb24S78: mp-686109
Cu6As2S8: mp-3345
Cu6Hg3As4S12: mp-6287
Cu6P2S8: mp-3934
Cu6P2Se8: mp-5756
Cu6S6: mp-504
Cu6S6: mp-555599
Cu6Sb2S8: mp-22171
Cu6Se4: mp-20683
Cu6Se6: mp-488
Cu6Se6: mp-571486
Cu75Se78: mp-684923
Cu8Bi16Pb8S36: mp-652196
Cu8Bi32Pb8S60: mp-680461
Cu9Se8: mp-673255
Dy16Cr48S96: mp-532220
Dy16S24: mp-32826
Dy16Si12S48: mp-10771
Dy1Tl1S2: mp-31166
Dy1Tl1Se2: mp-568062
Dy24Se44: mp-32633
Dy4Cd2S8: mp-16267
Dy6Cu2Ge2S14: mp-558740
Dy6Cu2Sn2S14: mp-561499
Dy6Si2Cu2S14: mp-557998
Dy8Cr24S48: mp-530588
Dy8P8S32: mp-5241
Er12Se12F12: mp-27123
Er1Tl1S2: mp-4123
Er1Tl1Se2: mp-570117
Er2Ag2P4Se12: mp-13384
Er4Cd2S8: mp-3041
Er4F12: mp-9371
Er6Si2Cu2S14: mp-558980
Eu12Sb16S36: mp-684111
Eu1Na1S2: mp-1007910
Eu1S1: mp-20587
Eu2Gd4S8: mp-675143
Eu2K2P2Se8: mp-10382
Eu2K8P4S16: mp-669560
Eu2Nd4S8: mp-37693
Eu2Pd6S8: mp-20961
Eu2Pr4S8: mp-34309
Eu2Tm2Cu2S6: mp-12728
Eu4Dy4Cu4S12: mp-542765
Eu4P4S12: mp-20217
Eu4P4Se12: mp-20742
Eu4Si2S8: mp-22504
Eu4Tl4P4S16: mp-657233
Eu6Sn4S14: mp-504621
Eu8K4Cu4S24: mp-680171
Eu8Sn4S16: mp-632490
Fe2As4: mp-2008
Fe2Ni4S8: mp-673824
Fe2S4: mp-1522
Fe2Se4: mp-760
Fe4As4S4: mp-561511
Fe4S8: mp-226
Ga2Ag2S4: mp-5342
Ga2Ag2S4: mp-556916
Ga2Ag2Se4: mp-5518
Ga2Cu2S4: mp-5238
Ga2Cu2Se4: mp-4840
Ga2Hg1Se4: mp-4730
Ga4Ag36Se24: mp-27163
Gd16S24: mp-684712
Gd1Tl1S2: mp-557655
Gd1Tl1Se2: mp-569393
Gd20S38: mp-646008
Gd2Lu6S12: mp-22563
Gd2Pa2O8: mp-37014
Gd2S2F2: mp-3799
Gd2S2I2: mp-556135
Gd2Se4: mp-1018707
Gd40S56O4: mp-556437
Gd4Cu4S8: mp-510471
Gd4Cu4Se8: mp-510528
Gd4Sn2S10: mp-561122
Gd6Cu2Ge2S14: mp-573114
Gd6Cu2Ge2Se14: mp-568189
Gd6Cu2Sn2S14: mp-556782
Gd6Cu2Sn2Se14: mp-568811
Gd6Si2Cu2Se14: mp-641576
Gd8S12: mp-608146
Gd8S12: mp-669509
Ge12Rh8Se12: mp-976401
Ge12S24: mp-553973
Ge16S32: mp-572892
Ge16S32: mp-622213
Ge16Se32: mp-540625
Ge16Se36: mp-680333
Ge1Bi4Te7: mp-29644
Ge1Sb4Te7: mp-29641
Ge1Se1: mp-10759
Ge1Te7As4: mp-8645
Ge2Pd2S6: mp-541785
Ge2S4: mp-7582
Ge2Se4: mp-10074
Ge3Pd6: mp-423
Ge4Pb4S12: mp-624190
Ge4Pb8S16: mp-560370
Ge4Pt4Se4: mp-20817
Ge6S12: mp-542613
Ge8Pb16S32: mp-531296
H16C4S4N8: mp-23930
H16C4S4N8: mp-721896
H16S8: mp-696805
H28C12N24Cl4: mp-761870
H28I4N8: mp-721084
H32S16: mp-721582
H32S20N8: mp-28143
H32W4S16N8: mp-697283
H48C12S12N24: mp-735023
H48C8N24Cl8: mp-707023
H4Br1N1: mp-36248
H4C1: mp-1021328
H4I1N1: mp-34381
H4N1Cl1: mp-34337
H8Br2N2: mp-23675
H8I2N2: mp-643062
H8N2F2: mp-23794
H8S4: mp-33024
He1: mp-23158
He1: mp-614456
He1: mp-754382
He2: mp-23156
Hf1S2: mp-985829
Hf1Te1Se4: mp-989651
Hf2O4: mp-776532
Hf2S6: mp-9922
Hf2Si2O8: mp-4609
Hf2Tl2Cu2S6: mp-9396
Hf2Tl2Cu2Se6: mp-9397
Hf3Tl2Cu2Se8: mp-570700
Hf4O8: mp-352
Hf4Pb4S12: mp-22147
Hf4S4O4: mp-7787
Hf4Sn4S12: mp-8725
Hf8O16: mp-1858
Hf8O16: mp-775757
Hg1: mp-1017981
Hg1: mp-121
Hg1: mp-569289
Hg1: mp-753304
Hg1: mp-982872
Hg10Au12: mp-1812
Hg12S8I8: mp-29956
Hg12Sb4As4S12: mp-554950
Hg12Se8I8: mp-29955
Hg12Se8I8: mp-571404
Hg12Te8I8: mp-28579
Hg16As4I20: mp-567798
Hg16I32: mp-583213
Hg1P1Pd5: mp-1025302
Hg1S1: mp-1123
Hg1Se1: mp-820
Hg1Te1: mp-2730
Hg2: mp-975272
Hg29: mp-864900
Hg2Bi4S8: mp-554921
Hg2Ge1Se4: mp-3167
Hg2I2: mp-22859
Hg2I4: mp-23192
Hg2S2: mp-973676
Hg3: mp-10861
Hg3: mp-569360
Hg32As16I24: mp-28590
Hg32Sb16I24: mp-29043
Hg3S3: mp-634
Hg3S3: mp-9252
Hg4As16S16I8: mp-554735
Hg4Sb16S32: mp-542596
Hg6As2Se8I2: mp-570084
Hg8I16: mp-567471
Hg8I16: mp-568742
Hg8Pb4S8I8: mp-557605
Ho16B48O96: mp-680713
Ho1Tl1S2: mp-1007665
Ho1Tl1Se2: mp-569178
Ho24Se44: mp-32833
Ho2S2F2: mp-10931
Ho4Cd2S8: mp-6942
Ho4F12: mp-561877
Ho4Sn6Pb6S24: mp-559287
Ho6Cu2Ge2S14: mp-555509
Ho6Si2Cu2S14: mp-17486
In10Bi6S24: mp-504646
In10Pb6S21: mp-622755
In10Pb6S21: mp-662823
In12Se18: mp-612740
In16S24: mp-22216
In16Se16I16: mp-505357
In18Pb8S34: mp-21934
In1As1Pd5: mp-1025293
In1P1Pd5: mp-1025161
In1P1S4: mp-20790
In2Ag2P4Se12: mp-20902
In2Ag2S4: mp-19833
In2Ag2Se4: mp-20554
In2Ag2Te4: mp-22386
In2Cu2S4: mp-22736
In2Cu2Se4: mp-22811
In2Hg1Se4: mp-20731
In2Hg1Te4: mp-19765
In2Sb4S8Br2: mp-559864
In2Sb4Se8Br2: mp-570321
In4Ag4Ge2S12: mp-560386
In4Ag4Ge2Se12: mp-505607
In4Ag4S8: mp-21459
In4Ga2Bi2S12: mp-556231
In4Hg2S8: mp-22356
In4Sb4S12: mp-21365
In4Si2Ag4S12: mp-558407
In4Si2Ag4Se12: mp-640614
In4Sn1S8: mp-675124
In5Ag1S8: mp-36751
In5Ag1Se8: mp-571103
In5Cu1S8: mp-674514
In8Bi16Pb16S52: mp-650840
In8Bi4S18: mp-27195
In8Pb4S16: mp-619279
Ir3Se8: mp-9888
Ir8S16: mp-2833
Ir8Se16: mp-1361
K10B38O62: mp-554996
K10Na2Ti12Se54: mp-569806
K12Al4B32O60: mp-561447
K12B36O60: mp-559636
K12Bi4P8S32: mp-554216
K12Ce4P8S32: mp-21557
K12Cr8P12S48: mp-559251
K12Cu12P12Se36: mp-568611
K12Cu4P8S28: mp-558415
K12Er4Cl24: mp-30197
K12La4P8S32: mp-16209
K12La4P8Se32: mp-542079
K12Nb4S16: mp-18383
K12Nb8Cu4Se48: mp-6168
K12Nb8S44: mp-680410
K12Nb8Se44: mp-28428
K12Nd4P8S32: mp-542974
K12P4S16: mp-17989
K12P4Se16: mp-31313
K12Ta4S16: mp-18148
K12Ta8S44: mp-558967
K12Ta8S44: mp-680400
K12Th8Cu12S28: mp-638086
K12V4S16: mp-3529
K16Ge16Se40: mp-569826
K16Nb8S44: mp-15148
K16Nb8S56: mp-574909
K16P8Se24: mp-31314
K16Sm16As16Se72: mp-571473
K16Ta16P16S96: mp-683955
K16Ta8S44: mp-4361
K16V4P8S36: mp-556552
K16Zr12Se61: mp-674338
K16Zr8S32: mp-560331
K18Bi2P8S32: mp-554554
K1Ag2P1S4: mp-12532
K1Ag2Sb1S4: mp-9490
K1Al11O17: mp-760755
K1Ba1Al3Si5O16: mp-677121
K1Br1: mp-23251
K1Ce1S2: mp-7329
K1Cl1: mp-23193
K1Cr1P2S7: mp-7147
K1Cu2Se2: mp-567657
K1Cu4Se3: mp-10092
K1Dy1S2: mp-15785
K1Er1S2: mp-4326
K1Gd1S2: mp-15784
K1H1S1: mp-38011
K1Ho1S2: mp-15786
K1I1: mp-22898
K1In1P2S7: mp-22583
K1In5S8: mp-22199
K1Lu1S2: mp-1007636
K1Mg4Al9Si9O36: mp-686653
K1Nd1S2: mp-1006885
K1Pr1S2: mp-15782
K1Sm1S2: mp-15783
K1Sm1Se2: mp-1006891
K1Th2Se6: mp-9522
K1U2Se6: mp-12414
K1Y1S2: mp-1006888
K20Ag8As12Se36: mp-570836
K20Th4P12S48: mp-628680
K20Th6P20S72: mp-680237
K24Mo24Se112: mp-651347
K24Nb16S100: mp-560348
K24P24Se72: mp-569702
K24Pd4Se80: mp-570241
K24U8Cu48S60: mp-559811
K2Ag6Se4: mp-9782
K2Al18O28: mp-1019803
K2Al2Si6O16: mp-697670
K2Au2S2: mp-7077
K2Au2Se2: mp-9881
K2Au2Se4: mp-29138
K2Bi2P4S12: mp-557437
K2Bi2P4Se12: mp-568802
K2Bi8Se13: mp-28800
K2Ca2Br6: mp-998599
K2Ca2Cl6: mp-998421
K2Ce2Ge2Se8: mp-21176
K2Ce2Si2S8: mp-11170
K2Ce2Si2S8: mp-22809
K2Cu2Bi4S8: mp-558063
K2Cu2Pd2Se10: mp-11114
K2Cu8As2S8: mp-557728
K2Dy4Cu4S9: mp-680676
K2Er6F20: mp-18451
K2Eu2As2S8: mp-867419
K2Gd4Cu2S8: mp-15553
K2H2S2: mp-634676
K2Hf2Cu2S6: mp-9855
K2Hg3Ge2S8: mp-11131
K2Ho2Be2F12: mp-558826
K2Ho4Cu2S8: mp-11606
K2Ho4Cu4S9: mp-680679
K2In12Se19: mp-675614
K2La2Ge2Se8: mp-21097
K2La2Si2S8: mp-12924
K2La2Si2S8: mp-861938
K2Li2Be2F8: mp-6253
K2Na4Si24B6O60: mp-15541
K2Nb2Ag4Se8: mp-567177
K2Nb2Cu4Se8: mp-6599
K2Nd2Ge2S8: mp-861866
K2Nd4Cu2S8: mp-11603
K2Np2Ag2S6: mp-865937
K2Np2Cu2S6: mp-867312
K2P2Au2Se6: mp-862850
K2P2S6: mp-8267
K2Pr2Ge2Se8: mp-12012
K2Pr2Si2Se8: mp-13538
K2Pt4S6: mp-30533
K2Sb2P4S12: mp-556609
K2Sb2P4Se12: mp-7123
K2Sb2S4: mp-11703
K2Sb4Se8: mp-9797
K2Sm2Ge2Se8: mp-11634
K2Sm4Cu2S8: mp-11604
K2Sn1As2S6: mp-10776
K2Sn1Hg1Se4: mp-568968
K2Sn4I10: mp-23534
K2Sn4Se8: mp-28769
K2Ta2Ag4Se8: mp-571288
K2Ta2Cu4Se8: mp-6013
K2Th1Cu2S4: mp-555425
K2Th2Cu2S6: mp-12365
K2Ti2P2S10: mp-560977
K2Ti2P2Se10: mp-571544
K2U2Cu2S6: mp-13349
K2U2Cu2Se6: mp-582421
K2V20S32: mp-27889
K2V2Cu4S8: mp-6376
K2V2Cu4Se8: mp-10091
K2Y2Si2S8: mp-867328
K2Y4Cu2S8: mp-11602
K2Zr2Cu2S6: mp-9317
K2Zr2Cu2Se6: mp-9318
K3B6Br1O10: mp-23612
K3Bi1As6Se12: mp-865961
K3Sb1S4: mp-9911
K48Sn16Se56: mp-29386
K4Ag12S8: mp-18577
K4Ag4Ge2S8: mp-558500
K4Ag4Sn2Se8: mp-570887
K4Ag8Se6: mp-573891
K4Al4Si6O20: mp-1019744
K4As2Au2S8: mp-9511
K4As4Se8: mp-14659
K4Au4S20: mp-3592
K4Au4Se20: mp-3257
K4B4S14: mp-4351
K4Ba4Nb4S16: mp-16780
K4Ba4P4S16: mp-17088
K4Ba4P4Se16: mp-18156
K4Be4Si12O30: mp-561549
K4Be8B12O28: mp-1019809
K4Bi4P8S28: mp-23572
K4Bi4P8Se24: mp-569435
K4Cd2Au8S8: mp-557832
K4Ce8Cu4Se24: mp-669330
K4Cu4P8Se20: mp-622199
K4Cu8As4S12: mp-554421
K4Er4P8S28: mp-554741
K4Eu4As4S12: mp-646548
K4Eu4P4S16: mp-628735
K4Eu4P4Se16: mp-628715
K4Ge2Se6: mp-9692
K4Ge4Bi4S16: mp-866646
K4Ge4Pb2S12: mp-561132
K4Hg4Sb4S12: mp-6678
K4Hg6Ge4S16: mp-17792
K4Hg6Ge4Se16: mp-17307
K4Ho8F28: mp-31030
K4In24Se38: mp-21836
K4In2P4S14: mp-862780
K4La4P8S24: mp-560649
K4La4P8Se24: mp-571662
K4Mg2P4Se12: mp-11643
K4Mn2P4S12: mp-542638
K4Mn2P4Se12: mp-867228
K4Mo6Se36: mp-542749
K4Nb2Ag2S8: mp-15214
K4Nb2Cu2S8: mp-9763
K4Nb2Cu2Se8: mp-9003
K4Nb8P4S40: mp-542972
K4Ni4P4S16: mp-662530
K4P2Au2S8: mp-9509
K4P2Pd1S8: mp-867268
K4P4Pb4S16: mp-638150
K4P4Pd4S16: mp-866637
K4P4Se24: mp-18625
K4P8Au20S32: mp-561218
K4Pa2F14: mp-542445
K4Pd6S8: mp-9910
K4Sb20S32: mp-15559
K4Sb4Se8: mp-542642
K4Sb4Se8: mp-9576
K4Sb8S14: mp-27749
K4Si4Bi4S16: mp-866651
K4Sm2P4S14: mp-555587
K4Sm4P8S28: mp-554581
K4Sm8Sb12Se32: mp-567322
K4Sn2Au4S8: mp-557121
K4Sn2Se6: mp-9693
K4Sn4As4S20: mp-554119
K4Sn4Hg6S16: mp-18115
K4Sn4S10: mp-8965
K4Sn4Se10: mp-8966
K4Ta2Ag2S8: mp-15216
K4Ta2Cu2Se8: mp-8972
K4Th4Sb8Se24: mp-568904
K4Ti2S6: mp-28766
K4U2Cu6S10: mp-557249
K4V2Ag2S8: mp-8900
K4V2Ag2Se8: mp-14634
K4V2Cu2S8: mp-15147
K4V2Cu2Se8: mp-15220
K4Y4P8Se24: mp-571057
K5Rb1Zn4Sn5S17: mp-694852
K6Ag2Sn6Se16: mp-571594
K6Au2Se26: mp-28606
K6B6S12: mp-15012
K6Be12B18O42: mp-1019808
K6Dy2As4S16: mp-866661
K6Gd6P8S32: mp-604889
K6Na2Sn6Se16: mp-628185
K6Nb4Ag6S16: mp-581115
K6Nb4As2Se22: mp-542545
K6Nb4Cu6S16: mp-581419
K6Nd2As4S16: mp-559059
K6Nd6P8S32: mp-555172
K6P10Ru2Se20: mp-568011
K6P2Se32: mp-29947
K6P4Au2Se16: mp-866660
K6P6Se18: mp-571452
K6Sb2S8: mp-9781
K6Sb2Se8: mp-8704
K6Sm2As4S16: mp-560964
K6Ta4Ag6S16: mp-573202
K6Ta4Ag6Se16: mp-582161
K6Ta4As2Se22: mp-683905
K8Ag24As16S40: mp-561304
K8Ag24Sn12S40: mp-559880
K8Ag4As12Se24: mp-541915
K8Ag4I12: mp-569943
K8Ag4Sb4S16: mp-553923
K8Al8Si16O48: mp-554433
K8Au12S10: mp-29341
K8B40O64: mp-12183
K8Ba2V4S16: mp-558121
K8Cu4P12S36: mp-559644
K8Er16F56: mp-27925
K8Er16F56: mp-558238
K8Er24F80: mp-683945
K8Eu4Ge4Se20: mp-628810
K8Ga12Cu4Se24: mp-10973
K8Ga8S16: mp-17650
K8Ge4Se16: mp-29022
K8Ge8Au8S24: mp-554859
K8Ge8S20: mp-541878
K8Ge8Se20: mp-29388
K8Hg4P8Se24: mp-568855
K8In12Ag4Se24: mp-21705
K8In12Ag4Se24: mp-680403
K8In12Cu4Se24: mp-21713
K8In4P8Se32: mp-581517
K8In8S16: mp-505412
K8In8Se16: mp-505700
K8In8Sn8Se32: mp-568379
K8La4P8S28: mp-542081
K8La4P8Se28: mp-542078
K8Mg8Be12F48: mp-13613
K8Mn4Sn8Se24: mp-669410
K8Na4B36O60: mp-558293
K8Nd4P8S28: mp-16690
K8Pd4Se40: mp-505138
K8S20: mp-17146
K8Se20: mp-18609
K8Sn6Se16: mp-4971
K8Sn8S32: mp-541379
K8Ta4S22: mp-18664
K8Ta8S40: mp-31308
K8Tc12Se24: mp-541354
K8Te4S12: mp-29692
K8Te4Se12: mp-28419
K8Th4P12Se36: mp-541946
K8Th4P12Se36: mp-568203
K8Ti6S28: mp-541735
K8U4P12Se36: mp-574428
K8Y16Sn8S44: mp-560785
Kr1: mp-612118
Kr1: mp-974400
Kr2: mp-567365
Kr3: mp-975590
Kr4: mp-976347
La12In4S24: mp-540877
La12Tm12S36: mp-556841
La16Bi8S36: mp-28727
La16S24: mp-32906
La20S38: mp-558229
La20Se38: mp-8866
La2Pd6S8: mp-2889
La2S2F2: mp-5394
La2Se4: mp-1019091
La40S58O2: mp-773116
La4Eu2S8: mp-677272
La4Pb2S8: mp-36538
La4Se8: mp-570668
La4Sn2S10: mp-12170
La5Tl1S8: mp-35714
La6Ag2Ge2S14: mp-617632
La6Ag2Sn2S14: mp-542888
La6Cu2Ge2S14: mp-582767
La6Cu2Ge2Se14: mp-510011
La6Cu2Sn2S14: mp-510566
La6Mn2Al2S14: mp-866692
La6Si2Ag2S14: mp-17719
La6Si2Cu2S14: mp-504650
La6Si4S16Br2: mp-560523
La6Si4S16Cl2: mp-556246
La6Si4S16I2: mp-23090
La8Cu4S16: mp-31273
La8Ge4S20: mp-622086
La8In10S26: mp-21571
La8P8S32: mp-560571
La8S12: mp-7475
La8S16: mp-1508
La8Si4S20: mp-558724
La8Tl8Ge8Se32: mp-684022
Li12Al4F24: mp-556020
Li12B44O72: mp-1020014
Li12Be6F24: mp-4622
Li18Al6F36: mp-15254
Li1F1: mp-1138
Li2Al2Si8O20: mp-6442
Li2Ca2Al2F12: mp-6134
Li2Lu2F8: mp-561430
Li2Y2F8: mp-3700
Li2Y2F8: mp-3941
Li2Y2F8: mp-556472
Li4Al20O32: mp-530399
Li4B12O20: mp-3660
Li4B20H8O36: mp-740714
Li4B24O36F4: mp-558105
Li4Mg12P12O44: mp-1020109
Li6B14O24: mp-16828
Li8Be6P6Br2O24: mp-554560
Li8Be6P6Cl2O24: mp-560894
Lu12B20O48: mp-554282
Lu16B48O96: mp-680724
Lu1Cu1S2: mp-1001780
Lu1Tl1S2: mp-1001604
Lu1Tl1Se2: mp-1001611
Lu2Ag2S4: mp-676410
Lu2B2O6: mp-7560
Lu2Cu2Pb2Se6: mp-865492
Lu2P2O8: mp-2940
Lu2S1O2: mp-12673
Lu2Si2O7: mp-7193
Lu4Cd2S8: mp-8269
Lu4Cu4S8: mp-12457
Lu4Mg2S8: mp-14304
Lu4Mn2S8: mp-14305
Lu4P4S16: mp-30287
Lu4S6: mp-2826
Lu8Si8O28: mp-18385
Lu8Zn4S16: mp-18332
Mg10Al20O40: mp-531530
Mg12B28Cl4O52: mp-23087
Mg12Si4O16F8: mp-558458
Mg14Al28O56: mp-530722
Mg14Al28O56: mp-531840
Mg16Si16O48: mp-1020115
Mg16Si16O48: mp-1020117
Mg16Si16O48: mp-1020118
Mg16Si16O48: mp-1020123
Mg16Si16O48: mp-1020124
Mg16Si16O48: mp-1020125
Mg16Si16O48: mp-1020361
Mg16Si16O48: mp-5834
Mg1Al10O16: mp-757911
Mg1Mn4S8: mvc-13559
Mg1S1: mp-13032
Mg1S1: mp-1315
Mg1Ti4S8: mvc-11283
Mg2Al4O8: mp-3536
Mg2Cr4S8: mvc-91
Mg2F4: mp-1249
Mg2H12N4Cl4: mp-697168
Mg2In4S8: mp-20493
Mg2P2S6: mp-675651
Mg2P2Se6: mp-30943
Mg2Ti16S32: mp-36982
Mg3Al14O24: mp-39003
Mg3Si4H2O12: mp-696497
Mg4Al4B4O16: mp-8376
Mg4Al8S16: mp-3872
Mg4Al8Si10O36: mp-6174
Mg4Al8Si10O36: mp-684265
Mg4B4O10: mp-5547
Mg4H24Br8N8: mp-697170
Mg4Si4O12: mp-4321
Mg6Al12O24: mp-34144
Mg6B14Cl2O26: mp-23617
Mg6B2O6F6: mp-554542
Mg6Be2Al16O32: mp-17313
Mg6Be2Al16O32: mp-554018
Mg8B32O56: mp-14234
Mg8B4O12F4: mp-7995
Mg8B8O20: mp-18256
Mg8B8O20: mp-560772
Mg8Ge4S16: mp-17441
Mg8Si8O24: mp-3470
Mg8Si8O24: mp-5026
Mg8Si8O24: mp-557803
Mg9In26S48: mp-685878
Mn1Cu2Sn1S4: mp-19722
Mn1Cu2Sn1Se4: mp-22400
Mn1S2: mvc-14047
Mn2Cu4Ge2S8: mp-20474
Mn2In4S8: mp-22168
Mn2Nb8S16: mp-3669
Mn2Sb12Pb8S28: mp-683891
Mn2Sb4S8: mp-10412
Mn2Si2Cu4S8: mp-12023
Mn4S8: mvc-34
Mo1S2: mp-1023924
Mo1S2: mp-1434
Mo1Se2: mp-1023934
Mo1Se2: mp-7581
Mo1W1S4: mp-1023954
Mo1W1Se2S2: mp-1023955
Mo1W2S6: mp-1025689
Mo1W2S6: mp-1026034
Mo1W2Se2S4: mp-1025663
Mo1W2Se2S4: mp-1025824
Mo1W3S8: mp-1027273
Mo1W3S8: mp-1029246
Mo1W3Se2S6: mp-1029037
Mo1W3Se2S6: mp-1030520
Mo1W3Se4S4: mp-1028930
Mo1W3Se4S4: mp-1028947
Mo1W3Se4S4: mp-1029026
Mo1W3Se4S4: mp-1029031
Mo1W3Se4S4: mp-1030536
Mo1W3Se4S4: mp-1030566
Mo2S4: mp-1018809
Mo2S4: mp-1023939
Mo2S4: mp-2815
Mo2Se2S2: mp-1018806
Mo2Se2S2: mp-1023953
Mo2Se4: mp-1018807
Mo2Se4: mp-1023940
Mo2Se4: mp-1634
Mo2W1S6: mp-1025911
Mo2W1S6: mp-1025922
Mo2W1Se2S4: mp-1025941
Mo2W1Se2S4: mp-1025948
Mo2W1Se2S4: mp-1026023
Mo2W1Se4S2: mp-1025748
Mo2W1Se4S2: mp-1025879
Mo2W2S8: mp-1027269
Mo2W2S8: mp-1027335
Mo2W2S8: mp-1027647
Mo2W2S8: mp-1030119
Mo2W2Se2S6: mp-1026975
Mo2W2Se2S6: mp-1027274
Mo2W2Se2S6: mp-1027292
Mo2W2Se2S6: mp-1027391
Mo2W2Se2S6: mp-1030146
Mo2W2Se2S6: mp-1030745
Mo2W2Se4S4: mp-1027671
Mo2W2Se4S4: mp-1029077
Mo2W2Se6S2: mp-1027672
Mo2W2Se6S2: mp-1028541
Mo2W2Se6S2: mp-1028998
Mo2W2Se6S2: mp-1030513
Mo2W2Se6S2: mp-1030519
Mo2W2Se6S2: mp-1030522
Mo3S6: mp-1025874
Mo3Se2S4: mp-1025925
Mo3Se2S4: mp-1025988
Mo3Se4S2: mp-1025819
Mo3Se4S2: mp-1025906
Mo3Se6: mp-1025799
Mo3W1S8: mp-1027569
Mo3W1S8: mp-1027645
Mo3W1Se2S6: mp-1026946
Mo3W1Se2S6: mp-1027294
Mo3W1Se2S6: mp-1027472
Mo3W1Se2S6: mp-1027537
Mo3W1Se2S6: mp-1027646
Mo3W1Se2S6: mp-1027795
Mo3W1Se4S4: mp-1026927
Mo3W1Se4S4: mp-1027051
Mo3W1Se4S4: mp-1027267
Mo3W1Se4S4: mp-1027524
Mo3W1Se4S4: mp-1027551
Mo3W1Se4S4: mp-1027714
Mo3W1Se6S2: mp-1027729
Mo3W1Se6S2: mp-1027802
Mo4S8: mp-1027525
Mo4Se2S6: mp-1027608
Mo4Se2S6: mp-1027890
Mo4Se4S4: mp-1026916
Mo4Se4S4: mp-1027492
Mo4Se4S4: mp-1027580
Mo4Se4S4: mp-1027687
Mo4Se6S2: mp-1026980
Mo4Se6S2: mp-1027483
Mo4Se8: mp-1027692
Na10Au2Se24: mp-29198
Na12B20S4O32: mp-560266
Na12B24P4O52: mp-556801
Na12B36O60: mp-556226
Na12B36O60: mp-557406
Na12Cr8P12S48: mp-559281
Na12Cu4Sn4Se16: mp-623030
Na12Ge4Se14: mp-18100
Na12Li12Al8F48: mp-6711
Na16As16Se32: mp-27374
Na16Be32B32O88: mp-1020144
Na16Ga48Se80: mp-570622
Na16Hg8S16: mp-28858
Na16Nb4Cu8S42: mp-554071
Na16Sn16Se40: mp-16167
Na16Ti16Se72: mp-680191
Na18B36O63: mp-1020142
Na1Al11O17: mp-759230
Na1Br1: mp-22916
Na1Ce1Se2: mp-999491
Na1Ce5S8: mp-37496
Na1Cl1: mp-22862
Na1Cr1S2: mp-5693
Na1Cr1S2: mp-637292
Na1Cu4S4: mp-29069
Na1Dy1S2: mp-999490
Na1Dy1Se2: mp-999488
Na1Er1S2: mp-3613
Na1Er1Se2: mp-8584
Na1Gd1S2: mp-8260
Na1Gd1Se2: mp-999489
Na1H1S1: mp-36582
Na1Ho1S2: mp-5694
Na1Ho1Se2: mp-999474
Na1I1: mp-23268
Na1In1S2: mp-20289
Na1In1Se2: mp-22473
Na1La1Se2: mp-999472
Na1Lu1S2: mp-9035
Na1Nd1S2: mp-999470
Na1Nd1Se2: mp-999471
Na1Pr1Se2: mp-999461
Na1Sc1S2: mp-999460
Na1Sm1S2: mp-999455
Na1Sm1Se2: mp-999450
Na1Tm1S2: mp-9076
Na1V2S4: mp-676586
Na1Y1S2: mp-10226
Na1Y1Se2: mp-999448
Na24Al8S24: mp-560538
Na24B40S72: mp-29000
Na24V8S32: mp-29143
Na28Au20S24: mp-28856
Na2Al22O34: mp-3405
Na2Al22O34: mp-676014
Na2Al22O34: mp-867577
Na2Al2Se4: mp-10166
Na2Al2Si6O16: mp-721988
Na2Bi2S4: mp-675531
Na2Bi2Se4: mp-35015
Na2Cd1Sn1S4: mp-561075
Na2Ce2S4: mp-36536
Na2Er2P4S12: mp-12384
Na2Hf4Cu2Se10: mp-571189
Na2La2S4: mp-675230
Na2Nb2Cu4S8: mp-6181
Na2Nd2S4: mp-676360
Na2P2Pd2S8: mp-559446
Na2Pr2S4: mp-675199
Na2Sb2S4: mp-5414
Na2Sb2S4: mp-557179
Na2Sb2Se4: mp-33333
Na2Si6B2O16: mp-696416
Na2Zr1Cu2S4: mp-556536
Na2Zr2Cu2S6: mp-9107
Na32Ge16Se40: mp-568762
Na38Zr22S60: mp-686139
Na3P1S4: mp-985584
Na3Pa1F8: mp-27478
Na3Ti10S20: mp-675056
Na48Sn24Se72: mp-571470
Na4Ag12S8: mp-16992
Na4Al3Si9Cl1024: mp-676431
Na4As4S8: mp-5942
Na4Au4Se8: mp-29139
Na4Be4B12O24: mp-1020624
Na4Ce4P8Se24: mp-569618
Na4Hf4Cu4Se12: mp-505448
Na4Li2Al2F12: mp-6604
Na4Mg2Al2F14: mp-19931
Na4Mg2Al2F14: mp-6319
Na4Nb8P4S40: mp-557436
Na4Sm4P8S24: mp-561232
Na4Ti4Cu4S12: mp-505171
Na4U2S6: mp-15886
Na4Zr2Se6: mp-7219
Na4Zr4Cu4Se12: mp-505172
Na6B2S6: mp-29976
Na6B6S12: mp-15011
Na6P2S6O2: mp-11738
Na6P2S8: mp-28782
Na6P4Pb3S16: mp-560831
Na8Al6Si6Br2O24: mp-23147
Na8Al6Si6Cl2O24: mp-23145
Na8Al6Si6I2O24: mp-23655
Na8Al8Se16: mp-17060
Na8Al8Si16O48: mp-1020661
Na8As8Se16: mp-984519
Na8B32O52: mp-542300
Na8B32O52: mp-764966
Na8B8S20: mp-29411
Na8Ca8Al8F48: mp-558169
Na8Cu4Sb4S12: mp-555871
Na8Ge4S12: mp-4068
Na8Ge4Se10: mp-28355
Na8Ge4Se12: mp-28278
Na8Ge8S20: mp-18568
Na8Ge8Se20: mp-17964
Na8Ge8Se20: mp-18619
Na8Hg12S16: mp-505121
Na8P4Se12: mp-567228
Na8Si8S20: mp-18104
Na8Si8Se20: mp-18562
Na8Sn2S8: mp-29628
Na8Sn2Se8: mp-28768
Na8Sn4Se12: mp-568543
Na8Sn6S16: mp-29626
Na8Te4Se12: mp-573581
Na8Ti8Se32: mp-28566
Nb12Se48I4: mp-23410
Nb12Se48I4: mp-567252
Nb1Cu3S4: mp-5621
Nb1Cu3Se4: mp-4043
Nb1Tl3Se4: mp-1025396
Nb2OSe8OI6: mp-569026
Nb2Cr2Se10: mp-28019
Nb4Co2Pd1Se12: mp-624253
Nb4Pd6Se16: mp-504898
Nb4Se18: mp-541106
Nb4Tl8S22: mp-17803
Nb4Tl8Se22: mp-638104
Nb6Pb2S12: mp-21852
Nb6Se18: mp-525
Nb6Sn2S12: mp-557640
Nb6Sn2S12: mp-9407
Nb8Tl12Cu4Se48: mp-570757
Nd12Si8S34: mp-555407
Nd16S24: mp-32586
Nd1Tl1S2: mp-3664
Nd1Tl1Se2: mp-568588
Nd20S38: mp-560786
Nd20Se38: mp-14650
Nd20Se38: mp-673692
Nd24Si8S48Cl8: mp-559779
Nd2Pd6S8: mp-15227
Nd2S2F2: mp-5760
Nd2Se2F2: mp-12620
Nd2Se4: mp-1018817
Nd40S56O4: mp-560608
Nd4Cu4S8: mp-10495
Nd4S8: mp-13568
Nd4Se8: mp-570707
Nd4Sn2S10: mp-555750
Nd5Ag1S8: mp-37449
Nd6Al2Ni2S14: mp-975614
Nd6Cu2Ge2S14: mp-554150
Nd6Cu2Ge2Se14: mp-568954
Nd6Cu2Sn2S14: mp-560300
Nd6Mn2Al2S14: mp-864652
Nd6Si2Ag2S14: mp-864666
Nd6Si2Cu2S14: mp-556975
Nd6Si4S16Br2: mp-559237
Nd6Si4S16I2: mp-561126
Nd8Ge6S24: mp-560086
Nd8In10S26: mp-21582
Nd8P8S32: mp-3694
Nd8S12: mp-438
Ne1: mp-111
Ni12P5: mp-2790
Ni18S16: mp-976920
Ni1Te2: mp-2578
Ni20P16: mp-1920
Ni23Te42: mp-684997
Ni2As4: mp-19814
Ni2P2Rh2: mp-1018823
Ni3S3: mp-1547
Ni3Se3: mp-15651
Ni3Se4: mp-573
Ni4As4S4: mp-3830
Ni4As4Se4: mp-10846
Ni4As8: mp-21873
Ni4Rh2S8: mp-675691
Ni4Sb2Te4: mp-3250
Ni4Sb4S4: mp-3679
Ni4Se8: mp-20901
Ni6P3: mp-21167
Ni6S8: mp-1050
Ni8As16: mp-505510
Ni8P8: mp-27844
Np12S20: mp-982385
Np2S2O2: mp-8137
Os4S8: mp-20905
Os4Se8: mp-2480
P12Ir4: mp-13853
P12Rh16: mp-621581
P12Rh4: mp-1357
P12Ru4: mp-28400
P1Rh2: mp-2732
P2Pd3S8: mp-3006
P4Os2: mp-2319
P4Pb4S12: mp-20199
P4Pb4Se12: mp-20316
P4Pd12: mp-19879
P4Ru2: mp-1413
P64Se48: mp-569094
P8Ir4: mp-10155
P8Pb12S32: mp-28140
P8Pd8S8: mp-7280
P8Pd8Se8: mp-3123
P8Pt4: mp-730
P8Rh4: mp-15953
Pa1O2: mp-2364
Pa2Br6O2: mp-540540
Pa2S6: mp-862857
Pa2Se6: mp-862867
Pa4S6: mp-862869
Pb10I20: mp-580202
Pb15I30: mp-680205
Pb1I2: mp-22883
Pb1I2: mp-22893
Pb1S1: mp-21276
Pb1Se1: mp-2201
Pb2I4: mp-540789
Pb2I4: mp-567503
Pb2I4: mp-569595
Pb3I6: mp-567178
Pb3I6: mp-640058
Pb3I6: mp-672671
Pb4I8: mp-567542
Pb4I8: mp-574189
Pb5I10: mp-567199
Pb5S2I6: mp-23066
Pb7I14: mp-567246
Pd1Au3: mp-973834
Pd1Au3: mp-973839
Pd24Se24: mp-571383
Pd34Se30: mp-21765
Pd4S8: mp-13682
Pd4Se8: mp-2418
Pd8S8: mp-20250
Pd8Se8: mp-21165
Pm4S6: mp-867180
Pr12Si8S34: mp-559955
Pr16S24: mp-32692
Pr1Tl1Se2: mp-999289
Pr20S38: mp-561375
Pr20Se38: mp-14613
Pr2Pb17Se20: mp-676516
Pr2S2F2: mp-3992
Pr2Se4: mp-1018940
Pr32Sb8S60: mp-554935
Pr4B4S12: mp-862754
Pr4S8: mp-555096
Pr4Se8: mp-570205
Pr4Sn2S10: mp-554244
Pr5Ag1S8: mp-34486
Pr6Ag2Ge2S14: mp-862792
Pr6Cu2Ge2S14: mp-556962
Pr6Cu2Ge2Se14: mp-571347
Pr6Cu2Sn2S14: mp-560014
Pr6Mn2Al2S14: mp-867323
Pr6Si2Ag2S14: mp-867322
Pr6Si2Ag2Se14: mp-17389
Pr6Si2Cu2S14: mp-555893
Pr6Si4S16Br2: mp-560468
Pr6Si4S16Cl2: mp-556179
Pr6Si4S16I2: mp-558259
Pr8Ge6S24: mp-542269
Pr8P8S32: mp-3954
Pr8S12: mp-15179
Pr8S16: mp-17329
Pt1S2: mp-762
Pt1Se2: mp-1115
Pt2S2: mp-288
Pt2S2: mp-558811
Pu16S24: mp-33239
Pu2Pa2O8: mp-675479
Pu2S4: mp-639690
Pu2Se4: mp-1018954
Pu4S6: mp-862796
Rb10B38O62: mp-553925
Rb10Sn2P6Se30: mp-571228
Rb10Ti12Ag2Se54: mp-16001
Rb12Bi8I36: mp-29895
Rb12Ce4P8Se32: mp-669351
Rb12Er12P16S64: mp-583084
Rb12Nb8S44: mp-541745
Rb12Sb4S16: mp-17154
Rb12Sn4P12Se44: mp-570167
Rb12Ta4S16: mp-17220
Rb12Ta8Ag4Se48: mp-569378
Rb12Ta8S44: mp-541975
Rb12Ta8S50: mp-680284
Rb12V4S16: mp-505721
Rb12Y4Cl24: mp-574571
Rb14Th4P12Se42: mp-585963
Rb16Hg8P8Se40: mp-569349
Rb16Sn16S64: mp-557059
Rb16Ta16P16S96: mp-680498
Rb16Ta8S44: mp-14577
Rb1Au3Se2: mp-9385
Rb1Bi1S2: mp-30041
Rb1Br1: mp-22867
Rb1Ca1Br3: mp-998198
Rb1Ca1Cl3: mp-998197
Rb1Cl1: mp-23295
Rb1Dy1S2: mp-7046
Rb1Gd1S2: mp-7045
Rb1Gd1Se2: mp-10781
Rb1I1: mp-22903
Rb1In5S8: mp-20938
Rb1Lu1S2: mp-9370
Rb1Nd1S2: mp-9363
Rb1Th2Se6: mp-9523
Rb1Tm1S2: mp-9368
Rb1U2Sb1S8: mp-559405
Rb1V1P2S7: mp-9102
Rb1Y1S2: mp-999265
Rb20Th4P12S48: mp-572864
Rb2Ag10Se6: mp-29685
Rb2Ag6Se4: mp-10477
Rb2Ag6Te4: mp-10481
Rb2Au2S2: mp-9010
Rb2Au2Se2: mp-9731
Rb2Ca2Cl6: mp-998324
Rb2Cu2Pd2Se10: mp-11115
Rb2Er4Cu6S10: mp-17344
Rb2Gd4Cu2S8: mp-12322
Rb2Gd4Cu2Se8: mp-574448
Rb2Gd4Cu4S9: mp-669578
Rb2Ho4Cu6S10: mp-17929
Rb2Mg1Cl4: mp-1025227
Rb2Na1Al6F21: mp-560570
Rb2Nb4P2S20: mp-6708
Rb2Nd4Cu2S8: mp-10834
Rb2Np2Cu2S6: mp-867188
Rb2P2S6: mp-556953
Rb2Pd3S4: mp-11695
Rb2Sb4Se8: mp-9798
Rb2Sm4Ag6Se10: mp-18710
Rb2Sm4Cu2S8: mp-10835
Rb2Sr2Cl6: mp-998755
Rb2Ta2Cu4Se8: mp-11925
Rb2Ta2Ge2S10: mp-867823
Rb2U2Ag2S6: mp-13350
Rb2U2Ag2Se6: mp-13351
Rb2U2Au2Se6: mp-867830
Rb2U2Cu2S6: mp-13352
Rb2V2Cu4S8: mp-15998
Rb3Ag6Sb3S12: mp-17756
Rb3In9S15: mp-542654
Rb4Ag4Ge2S8: mp-555852
Rb4Ag4Se16: mp-18585
Rb4Ag8As12Se24: mp-570593
Rb4B4S12: mp-9047
Rb4Ba4Ta4S16: mp-867884
Rb4Be16B12036: mp-556393
Rb4Be8B12O28: mp-1020621
Rb4Bi16Se26: mp-30145
Rb4Ca4Br12: mp-998536
Rb4Ca4I12: mp-998592
Rb4Cd2P4Se12: mp-541897
Rb4Cd4Au4S8: mp-558536
Rb4Cu4Se16: mp-18365
Rb4Er12F40: mp-555932
Rb4Eu4As4S12: mp-646129
Rb4Ge2S6: mp-11639
Rb4Ge2Se6: mp-9794
Rb4Ge4Bi4S16: mp-559227
Rb4Hg4Sb4Se12: mp-6300
Rb4La4Si4S16: mp-18658
Rb4Lu12F40: mp-558186
Rb4Mn2P4S12: mp-559643
Rb4Nb2Ag2S8: mp-14636
Rb4Nb2Ag2Se8: mp-9764
Rb4Nb2Cu2S8: mp-15221
Rb4Nb2Cu2Se8: mp-15222
Rb4Nb4P4S22: mp-554147
Rb4P4Pb4S16: mp-638009
Rb4P4Se24: mp-17945
Rb4Pb4I12: mp-23517
Rb4Pd2Se32: mp-31292
Rb4Pd6Se8: mp-14340
Rb4Sb12Se20: mp-4721
Rb4Sb4S8: mp-10621
Rb4Sb8S14: mp-4818
Rb4Sb8S14: mp-561051
Rb4Si2S6: mp-12016
Rb4Si4Bi4S16: mp-560051
Rb4Sm4Ge4Se16: mp-567873
Rb4Sn2Se6: mp-9145
Rb4Sn4Hg6S16: mp-561434
Rb4Sn4I12: mp-29405
Rb4Sn4Se10: mp-9322
Rb4Ta2Ag2S8: mp-15217
Rb4Ta2Cu2S8: mp-11923
Rb4Ta2Cu2Se8: mp-11924
Rb4Ti2Cu4S8: mp-7129
Rb4Ti4P4S20: mp-758985
Rb4V2Ag2S8: mp-8901
Rb4V2Ag2Se8: mp-14635
Rb4V2Cu2S8: mp-15219
Rb6Ag2Sn6Se16: mp-571164
Rb6Ag30S18: mp-28703
Rb6As2Se32: mp-29501
Rb6B6S12: mp-15013
Rb6Ge2P2Se14: mp-861898
Rb6In6I24: mp-28198
Rb6Nb4As2Se22: mp-683902
Rb6P6Se18: mp-571464
Rb6Pr6P8S32: mp-555448
Rb6Sm2P4S16: mp-17894
Rb6Zr4P10S36: mp-561527
Rb8Ag4As12Se24: mp-541916
Rb8Ag4I12: mp-23399
Rb8B40O64: mp-561814
Rb8Ga8S16: mp-561407
Rb8Ge8S20: mp-541879
Rb8Ge8Se20: mp-541880
Rb8In8S16: mp-601861
Rb8In8Se16: mp-31309
Rb8Na4Tm4Cl24: mp-567498
Rb8P4Pb2Se16: mp-867964
Rb8P4Se18: mp-569862
Rb8Pb2Br12: mp-28564
Rb8Sb16Au24S40: mp-558739
Rb8Sb4Au4S16: mp-556894
Rb8Th4P12Se36: mp-541947
Rb8Ti4P12Se50: mp-567491
Rb8Ti6S28: mp-542067
Rb8Zr6Se28: mp-542013
Re24Te28Se32: mp-667286
Re4Se8: mp-541582
Re8S16: mp-572758
Rh36Se80: mp-684800
Rh3Se8: mp-1407
Rh4S6: mp-974381
Rh4S8: mp-22555
Rh4Se8: mp-983
Rh6Se16: mp-32861
Rh8S12: mp-17173
Rh9S12: mp-29841
Ru4S8: mp-2030
Ru4Se8: mp-1922
S32: mp-77
S32: mp-96
S48: mp-557869
Sb12P12S48: mp-572597
Sb12Pb12S34: mp-630376
Sb12Pb8S26: mp-27907
Sb12Pd30: mp-569451
Sb12Pd32: mp-680057
Sb12Rh4: mp-2395
Sb16Pb14S38: mp-641987
Sb16Pb18S42: mp-649982
Sb16Pb6S30: mp-22737
Sb2Pd2: mp-1769
Sb2Te1Se2: mp-8612
Sb2Te2I2: mp-28051
Sb2Te2Se1: mp-3525
Sb2Te3: mp-1201
Sb2Te4Pb1: mp-31507
Sb32Pb40S88: mp-638022
Sb4Ir4S4: mp-8630
Sb4Ir4S4: mp-9270
Sb4Pd4Se4: mp-4368
Sb4Pd8: mp-542106
Sb4Rh4: mp-20619
Sb4S4I4: mp-23041
Sb4S4I4: mp-973217
Sb4Se4I4: mp-22996
Sb4Te4Pd4: mp-10850
Sb7Pd20: mp-30066
Sb8Pb8S20: mp-504814
Sb8Pd4: mp-1356
Sb8Pt4: mp-562
Sb8Rh4: mp-2682
Sb8S12: mp-2809
Sb8Se12: mp-2160
Sc1U8S17: mp-619571
Sc2Ag2P4Se12: mp-13383
Se3: mp-14
Se32: mp-542461
Se32: mp-542605
Se64: mp-570481
Si10O20: mp-600038
Si12N16: mp-2245
Si12O24: mp-16964
Si12O24: mp-17909
Si12O24: mp-18280
Si12O24: mp-556218
Si12O24: mp-557004
Si12O24: mp-557881
Si12O24: mp-558351
Si12O24: mp-558891
Si12O24: mp-559872
Si12O24: mp-560826
Si12O24: mp-600004
Si12O24: mp-600007
Si12O24: mp-600033
Si14O28: mp-615993
Si16O32: mp-17279
Si16O32: mp-554258
Si16O32: mp-554267
Si16O32: mp-555211
Si16O32: mp-555556
Si16O32: mp-555700
Si16O32: mp-556262
Si16O32: mp-556454
Si16O32: mp-556469
Si16O32: mp-556882
Si16O32: mp-557264
Si16O32: mp-559347
Si16O32: mp-600003
Si16O32: mp-600005
Si16O32: mp-600016
Si16O32: mp-639695
Si17O34: mp-600059
Si18O36: mp-556591
Si18O36: mp-560155
Si18O36: mp-560998
Si18O36: mp-639480
Si20O40: mp-639705
Si22O44: mp-680204
Si24O48: mp-542814
Si24O48: mp-556654
Si24O48: mp-557211
Si24O48: mp-557933
Si24O48: mp-559360
Si24O48: mp-559962
Si24O48: mp-560809
Si24O48: mp-561351
Si24O48: mp-600014
Si24O48: mp-600015
Si24O48: mp-600018
Si24O48: mp-600027
Si24O48: mp-600029
Si24O48: mp-600061
Si24O48: mp-639478
Si24O48: mp-639506
Si24O48: mp-639733
Si24O48: mp-640556
Si24O48: mp-733790
Si28O56: mp-560708
Si28O56: mp-561181
Si28O56: mp-600053
Si28O56: mp-651707
Si28O56: mp-662706
Si28O56: mp-667383
Si2Cu4Ni1S7: mp-557274
Si2Cu4S6: mp-15895
Si2Cu4S6: mp-9248
Si2H34S6N10: mp-557080
Si2Hg8S12: mp-17948
Si2Hg8Se12: mp-18230
Si2O4: mp-546794
Si2O4: mp-8352
Si2S4: mp-1602
Si32O64: mp-553945
Si32O64: mp-554755
Si32O64: mp-555521
Si32O64: mp-557894
Si32O64: mp-560064
Si32O64: mp-560336
Si32O64: mp-560920
Si32O64: mp-560941
Si32O64: mp-600022
Si32O64: mp-600024
Si32O64: mp-600037
Si32O64: mp-600041
Si32O64: mp-600045
Si32O64: mp-600070
Si32O64: mp-639511
Si32O64: mp-639724
Si32O64: mp-639734
Si32O64: mp-646895
Si32O64: mp-667368
Si34O68: mp-561090
Si34O68: mp-8602
Si36O72: mp-15078
Si36O72: mp-558025
Si36O72: mp-558326
Si36O72: mp-600078
Si36O72: mp-600091
Si3Cu6Pb3S12: mp-555818
Si3O6: mp-10851
Si3O6: mp-549166
Si3O6: mp-6922
Si3O6: mp-6930
Si3O6: mp-7000
Si40080: mp-558115
Si40080: mp-600023
Si40080: mp-600031
Si40080: mp-600052
Si46O92: mp-639512
Si48O96: mp-32895
Si48O96: mp-554682
Si48O96: mp-554946
Si48O96: mp-558947
Si48O96: mp-600028
Si48O96: mp-600032
Si48O96: mp-600051
Si48O96: mp-600057
Si48O96: mp-600060
Si48O96: mp-600063
Si48O96: mp-600065
Si48O96: mp-600071
Si48O96: mp-600072
Si48O96: mp-639741
Si48O96: mp-644923
Si4Ag32S24: mp-7614
Si4Cu10S14: mp-510418
Si4N4O2: mp-4497
Si4O8: mp-554089
Si4O8: mp-554151
Si4O8: mp-554573
Si4O8: mp-555235
Si4O8: mp-555251
Si4O8: mp-555483
Si4O8: mp-555891
Si4O8: mp-557118
Si4O8: mp-557837
Si4O8: mp-559091
Si4O8: mp-562490
Si4O8: mp-6945
Si4O8: mp-7029
Si4O8: mp-7087
Si4O8: mp-7648
Si4O8: mp-972808
Si4Pb8S16: mp-504564
Si4Pb8Se16: mp-27532
Si54O108: mp-530546
Si54O108: mp-532105
Si56O112: mp-600055
Si56O112: mp-639558
Si56O112: mp-653763
Si56O112: mp-667371
Si56O112: mp-667373
Si56O112: mp-667376
Si56O112: mp-667377
Si5O10: mp-600001
Si600120: mp-600083
Si600120: mp-600109
Si64O128: mp-600054
Si64O128: mp-600080
Si64O128: mp-600084
Si64O128: mp-600085
Si64O128: mp-600098
Si64O128: mp-600111
Si6N8: mp-988
Si6O12: mp-12787
Si6O12: mp-554243
Si6O12: mp-559550
Si6O12: mp-639463
Si8O16: mp-554543
Si8O16: mp-556961
Si8O16: mp-557465
Si8O16: mp-559313
Si8O16: mp-560527
Si8O16: mp-600000
Si8O16: mp-600002
Si8O16: mp-669426
Si8O16: mp-8059
Si8O16: mp-985570
Si8O16: mp-985590
Sm12In4S24: mp-21604
Sm12Si8S34: mp-557561
Sm16S24: mp-32645
Sm1Tl1S2: mp-999138
Sm1Tl1Se2: mp-999137
Sm20S38: mp-10534
Sm20Se38: mp-29832
Sm24Si8S48Cl8: mp-556910
Sm2S2F2: mp-3931
Sm2S2I2: mp-541073
Sm2Se4: mp-1019253
Sm3Eu3S8: mp-675396
Sm40S56O4: mp-560711
Sm4B4S12: mp-972448
Sm4Cr4S12: mp-15932
Sm4Cu4S8: mp-5081
Sm4Eu2S8: mp-675037
Sm4F12: mp-7384
Sm4Sn2S10: mp-7355
Sm5Ag1S8: mp-37923
Sm6Cu2Ge2S14: mp-555978
Sm6Cu2Si2S14: mp-554097
Sm6Cu2Sn2S14: mp-558042
Sm6Mn2Al2S14: mp-867965
Sm6Si2Ag2S14: mp-867929
Sm6Si4S16Br2: mp-555527
Sm6Si4S16I2: mp-560356
Sm8P8S32: mp-3897
Sm8S12: mp-1403
Sm8U4S20: mp-555276
Sn1Au5: mp-30418
Sn1Bi2Te4: mp-38605
Sn1Hg2Se4: mp-10955
Sn1P1Pd5: mp-1025296
Sn1Pd3: mp-718
Sn1S2: mp-1170
Sn1Sb2Te4: mp-27947
Sn1Se1: mp-2693
Sn1Se2: mp-665
Sn1Te1: mp-1883
Sn24S12I24: mp-23386
Sn2I4: mp-978846
Sn2S2: mp-559676
Sn2S4: mp-9984
Sn2Se2: mp-2168
Sn3I6: mp-27194
Sn4Ge4S12: mp-5045
Sn4Hg28As16I24: mp-571478
Sn4P4S12: mp-13923
Sn4P4S12: mp-4252
Sn4Pd8: mp-1851
Sn4S4: mp-2231
Sn4Se4: mp-691
Sn5Bi10Te20: mp-677596
Sn8S12: mp-1509
Sn8S2I12: mp-540644
Sn8Sb8S20: mp-17835
Sr10Br16Cl4: mp-28021
Sr10Br20: mp-32711
Sr12Mg12F48: mp-561022
Sr12Sb16S36: mp-29295
Sr16Bi16Se48: mp-28476
Sr16Ga16S40: mp-14680
Sr16Sn8Se36: mp-570983
Sr16Sn8Se40: mp-568525
Sr17Ta10S42: mp-531358
Sr17Ta10S42: mp-532315
Sr1Cl2: mp-23209
Sr1S1: mp-1087
Sr1Se1: mp-2758
Sr24Sb24S68: mp-16061
Sr24Ti21S63: mp-676818
Sr2Al44O68: mp-531590
Sr2Br2F2: mp-23024
Sr2Cl2F2: mp-22957
Sr2Cu4Ge2Se8: mp-16179
Sr2Gd4S8: mp-37183
Sr2I2F2: mp-23046
Sr2La4S8: mp-34141
Sr2Li2Al2F12: mp-6591
Sr2Li2B18O30: mp-18495
Sr2Lu2Cu2S6: mp-13189
Sr2Nd4S8: mp-37108
Sr2Pr4S8: mp-38240
Sr2Sb2Se4F2: mp-556194
Sr2Sm4S8: mp-34508
Sr3B6S12: mp-11012
Sr3Cu6Ge3S12: mp-18685
Sr3Cu6Sn3S12: mp-16988
Sr3Cu6Sn3S12: mp-17322
Sr4B8S16: mp-8947
Sr4Br8: mp-567744
Sr4Ca2I12: mp-756131
Sr4Dy8S16: mp-980666
Sr4Ge2S8: mp-4578
Sr4I8: mp-568284
Sr4P4S12: mp-9788
Sr4P4Se12: mp-7198
Sr4Si8B8O32: mp-6032
Sr4Sn2S8: mp-30294
Sr4Tl4P4S16: mp-17090
Sr4Y8S16: mp-29035
Sr4Zr4S12: mp-5193
Sr4Zr4S12: mp-558760
Sr6B4S12: mp-30239
Sr6Ca3I18: mp-756238
Sr8Al16S32: mp-14424
Sr8B20Cl4O36: mp-557330
Sr8B64O104: mp-684018
Sr8Bi12Se26: mp-28397
Sr8Ca4I24: mp-756798
Sr8Ca4I24: mp-771645
Sr8Ga16S32: mp-14425
Sr8I16: mp-23181
Sr8In16S32: mp-21781
Sr8In16Se32: mp-21733
Sr8Sn4S12F8: mp-17676
Sr8Sn4Se12F8: mp-17057
Ta1Cu3S4: mp-10748
Ta1Cu3Se4: mp-4081
Ta1Tl3S4: mp-7562
Ta1Tl3Se4: mp-10644
Ta2Ag14S12: mp-620369
Ta2Ag2S6: mp-561242
Ta2Ag2S6: mp-5821
Ta2Pd1S6: mp-8435
Ta2Pd1Se6: mp-8436
Ta2Tl2Cu4S8: mp-9815
Ta2Tl3Cu3S8: mp-554994
Ta4Co2Pd1Se12: mp-505133
Ta4Cu4S12: mp-3102
Ta4Ni2S10: mp-28308
Ta4Ni2Se14: mp-541183
Ta4Ni6S16: mp-562537
Ta4Ni6Se16: mp-541509
Ta4Pd6Se16: mp-18010
Ta4Pt6S16: mp-560046
Ta4Se12: mp-29652
Ta4Se16I2: mp-30531
Ta4Tl4S12: mp-10795
Ta4Tl8Ag4S16: mp-558241
Ta4Tl8S22: mp-18344
Ta4Tl8Se22: mp-542140
Ta6Pb2S12: mp-20784
Ta6S18: mp-30527
Ta6Sn2S12: mp-9132
Ta8Mn2S16: mp-3581
Tb16B48O96: mp-683867
Tb16S24: mp-673644
Tb16Si12S48: mp-16402
Tb16Si8S12O28: mp-16590
Tb1Cs1S2: mp-9085
Tb1Cs2K1Cl6: mp-580631
Tb1Cs2Na1Cl6: mp-568670
Tb1K1S2: mp-999129
Tb1Na1S2: mp-999126
Tb1Na1Se2: mp-999127
Tb1Rb1S2: mp-9365
Tb1Rb1Se2: mp-10782
Tb1Tl1S2: mp-999119
Tb1Tl1Se2: mp-569507
Tb2Cs2S4: mp-972199
Tb2Cs2Zn2Se6: mp-573710
Tb2K2Ge2S8: mp-12011
Tb2P2O8: mp-4340
Tb2S2F2: mp-10930
Tb2Se4: mp-1025077
Tb4B12O24: mp-559434
Tb4Ca2S8: mp-38327
Tb4Cs2Ag6Se10: mp-542164
Tb4Cu4S8: mp-5737
Tb4F12: mp-11347
Tb4K2Cu2S8: mp-11605
Tb4Sn2S10: mp-555069
Tb6Cu2Ge2S14: mp-557517
Tb6Cu2Sn2S14: mp-554781
Tb6In10S24: mp-20606
Tb6K2F20: mp-17838
Tb6Si2Cu2S14: mp-560501
Tb6Si4S16I2: mp-560853
Tb8Ba12P16S64: mp-554264
Tb8P8S32: mp-4672
Tb8S12: mp-9323
Tc4S8: mp-9481
Te16Au8: mp-20123
Te16Ir8: mp-569388
Te1Pb1: mp-19717
Te24Ir9: mp-32682
Te2Au1: mp-1662
Te2Au1: mp-567525
Te2Pd1: mp-782
Te2Pd2: mp-564
Te2Pt1: mp-399
Te2Rh1: mp-228
Te3: mp-19
Te3: mp-567313
Te3As2: mp-9897
Te6As4: mp-484
Te6Ir3: mp-1551
Te6Pt4: mp-541180
Te8Au4: mp-571547
Te8Ir4: mp-569322
Te8Rh3: mp-7273
Te8Rh4: mp-754
Th2P4S12: mp-14249
Th2S2O2: mp-8136
Th4S8: mp-1146
Th8S20: mp-1666
Th8Se20: mp-2392
Ti12Tl10Ag2Se54: mp-570021
Ti13S24: mp-684731
Ti16Cu1S32: mp-767157
Ti1Cu4S4: mp-29091
Ti1S2: mp-2156
Ti1S2: mp-558110
Ti1S2: mvc-11238
Ti1Se2: mp-2194
Ti2Ni1S4: mp-1025263
Ti2S6: mp-9920
Ti2Tl2P2S10: mp-558747
Ti36Cu12S72: mp-686094
Ti3Ni1S6: mp-13993
Ti4Ag32S24: mp-557833
Ti4Cu2S8: mp-3951
Ti4S8: mp-9027
Ti4S8: mvc-10843
Ti6Ag1S12: mp-675920
Ti6Ni2S12: mp-13994
Ti8Cu4S16: mp-559918
Tl10Ag10As20Pb10S50: mp-697231
Tl12Bi4I24: mp-571219
Tl12Bi8I36: mp-569203
Tl12P4S16: mp-16848
Tl12P4Se16: mp-4160
Tl12P4Se16: mp-614491
Tl12Pb4I20: mp-23380
Tl12S2Br8: mp-28518
Tl12S2I8: mp-27938
Tl12Se2I8: mp-28517
Tl16Bi8S20: mp-23408
Tl16In24Se40: mp-685385
Tl16P8Se24: mp-28394
Tl16Si4Se16: mp-28334
Tl1Bi1S2: mp-554310
Tl1Bi1Se2: mp-29662
Tl1Bi1Te2: mp-27438
Tl1Br1: mp-568560
Tl1Cu2S2: mp-8676
Tl1Cu2Se2: mp-5000
Tl1Cu4Se3: mp-1025447
TL1I1: mp-571102
Tl1In1S2: mp-22566
Tl1Sb1Te2: mp-4573
Tl1V3Cr2S8: mp-554140
Tl1V5S8: mp-29227
Tl24In16Se40: mp-686102
Tl2Ag2As4Pb2S10: mp-677611
Tl2Bi2P4S12: mp-556592
Tl2Br2: mp-568949
Tl2Cu2Se4: mp-14090
Tl2Ga2Se4: mp-9580
Tl2I2: mp-22858
Tl2In2P4Se12: mp-19985
Tl2In2S4: mp-20042
Tl2In2Se4: mp-22232
Tl2P2Au2Se6: mp-569287
Tl2Pb2I6: mp-27552
Tl2Pd4Se6: mp-7038
Tl2Pt4S6: mp-9272
Tl2Pt4Se6: mp-541487
Tl2Sb2S4: mp-676540
Tl2Sn1As2S6: mp-6023
Tl32P16S48: mp-28217
Tl3As1S3: mp-9791
Tl3As1Se3: mp-7684
Tl3V1S4: mp-5513
Tl3V1Se4: mp-1025549
Tl42Bi18I96: mp-684055
Tl4Ag4Se4: mp-29238
Tl4Ag4Te4: mp-5874
Tl4As12Pb4S24: mp-647900
Tl4As20S32: mp-28442
Tl4Au8S6: mp-29898
Tl4B4S12: mp-28809
Tl4Bi4P8S28: mp-556665
Tl4Bi4P8Se24: mp-567864
Tl4Cu4P4Se12: mp-569129
Tl4Ge2S6: mp-7277
Tl4Ge2Se6: mp-14242
Tl4Hg4As12S24: mp-6096
Tl4Hg4As4S12: mp-555199
Tl4P2Au2S8: mp-9510
Tl4P4Pb4S16: mp-510646
Tl4Pt10S12: mp-28805
Tl4Sb12S20: mp-27515
Tl4Sb20S32: mp-3267
Tl4Sb4S8: mp-28230
Tl4Sb4Se8: mp-567318
Tl4Si2S6: mp-8190
Tl4Si2Se6: mp-14241
Tl4Sn2S6: mp-542623
Tl4Sn4P4S16: mp-6057
Tl4Sn4S10: mp-7499
Tl6B2S6: mp-29337
Tl6B6S12: mp-8946
Tl6B6S20: mp-17823
Tl8As8S16: mp-4988
Tl8Bi4P8S28: mp-559093
Tl8Bi8P16Se48: mp-567917
Tl8Cd2I12: mp-570339
Tl8Ga8Se16: mp-17254
Tl8Ga8Se16: mp-680555
Tl8Ge4Pb4S16: mp-653561
Tl8Ge8S20: mp-12307
Tl8Ge8Se20: mp-540818
Tl8Hg6Sb4As16S40: mp-553948
Tl8In8S16: mp-865274
Tl8In8Si8S32: mp-556744
Tl8Pb2I12: mp-29212
Tl8Sb21As19Pb4S68: mp-581586
Tl8Sb24As16S64: mp-558174
Tl8Si2S8: mp-8479
Tl8Sn10S24: mp-29303
Tl8Te4S12: mp-17172
Tm12B20O48: mp-558534
Tm16B48O96: mp-680717
Tm16S24: mp-18529
Tm1Al3B4O12: mp-13516
Tm2Ag2P4Se12: mp-13385
Tm2P2O8: mp-5884
Tm2S1O2: mp-3556
Tm4Cd2S8: mp-4324
Tm4Cu4S8: mp-12455
Tm4S6: mp-14787
Tm8S12: mp-2309
Tm8S8O4: mp-8763
Tm8Zn4S16: mp-17043
U12Cu4S26: mp-28356
U12Rh4Se31: mp-37167
U2S6: mp-12406
U2Se6: mp-9429
U3S6: mp-2849
U4Pd2S8: mp-5335
U4S8: mp-639
U4Se4S4: mp-19924
U5S10: mp-685066
U6Cu4S14: mp-619067
U7Pd24S32: mp-531882
U8Cr1S17: mp-540544
U8Fe1S17: mp-559388
V10S16: mp-690772
V1Ag1P2Se6: mp-6543
V1Cu3S4: mp-3762
V1Cu3Se4: mp-21855
V1S2: mp-1013526
V1S2: mp-9561
V1S2: mvc-11241
V1Se2: mp-694
V2Au2S4: mp-11193
V2Ni1S4: mp-4909
V2S4: mp-1013525
V2S4: mp-557523
V2S4: mp-849060
V3Ni1S6: mp-676058
V3S4: mp-1081
V4Cu52Sn4As8S64: mp-720486
V4Ga1S8: mp-4474
V4Ge1S8: mp-8688
V4Ge1Se8: mp-8689
V4Ni1S8: mp-696867
V4Se18: mp-28256
V6S8: mp-799
W1S2: mp-1023937
W1S2: mp-9813
W2S4: mp-1023925
W2S4: mp-224
W3S6: mp-1025571
W3Se2S4: mp-1025577
W3Se2S4: mp-1025584
W4S8: mp-1028441
W4Se2S6: mp-1028487
W4Se2S6: mp-1028558
Xe1: mp-611517
Xe1: mp-972256
Xe1: mp-979285
Xe2: mp-570510
Y2Ag6P4S16: mp-561467
Y2Cu2Pb2S6: mp-865203
Y2S2F2: mp-10086
Y4Be8B20O44: mp-1020740
Y4Cd2S8: mp-35785
Y4Cu4Pb4S12: mp-542802
Y4Mg2S8: mp-1001024
Y6Cu2Ge2S14: mp-556781
Y6Cu2Sn2S14: mp-17747
Y6Si2Cu2S14: mp-561173
Y8Hf4S20: mp-16919
Y8P8S32: mp-31266
Yb1Cs1Br3: mp-568005
Yb1Cs1F3: mp-8398
Yb1S1: mp-1820
Yb1Se1: mp-286
Yb2B8O14: mp-752484
Yb2Cl2F2: mp-557483
Yb2Cl4: mp-865716
Yb2Dy4S8: mp-676154
Yb2F4: mp-865934
Yb2Gd4S8: mp-675856
Yb2K2Si2S8: mp-12376
Yb2La4S8: mp-675767
Yb2Li2Al2F12: mp-10103
Yb2Na2P4S12: mp-10838
Yb2Nd4S8: mp-675244
Yb2Pr4S8: mp-675668
Yb2Rb8I12: mp-23347
Yb2Sm4S8: mp-675677
Yb2Tb4S8: mp-673682
Yb2Y4S8: mp-675293
Yb4Er8S16: mp-865865
Yb4Rb4Br12: mp-571418
Yb8Cl16: mp-23220
Zn10S10: mp-18377
Zn10S10: mp-555858
Zn10S10: mp-556105
Zn10S10: mp-557308
Zn10S10: mp-561258
Zn12S12: mp-581258
Zn12S12: mp-581412
Zn12S12: mp-581476
Zn12S12: mp-581601
Zn12S12: mp-581602
Zn14S14: mp-556161
Zn14S14: mp-556392
Zn14S14: mp-556716
Zn14S14: mp-556815
Zn14S14: mp-557054
Zn14S14: mp-561196
Zn16S16: mp-555779
Zn16S16: mp-556775
Zn16S16: mp-556950
Zn16S16: mp-560725
Zn18S18: mp-555773
Zn18S18: mp-556152
Zn18S18: mp-556363
Zn18S18: mp-556448
Zn18S18: mp-556989
Zn18S18: mp-557026
Zn18S18: mp-557175
Zn18S18: mp-557346
Zn1Cd1S2: mp-971712
Zn1Cd1Se2: mp-1017534
Zn1Cu2Ge1S4: mp-6408
Zn1Cu2Ge1S4: mvc-16091
Zn1Cu2Ge1Se4: mp-10824
Zn1Cu2Ge1Se4: mvc-16079
Zn1Cu2Sn1S4: mp-1025500
Zn1Cu2Sn1Se4: mp-16564
Zn1Cu2Sn1Se4: mvc-16089
Zn1Cu4Sn2Se8: mvc-14983
Zn1Ga2Se4: mp-15776
Zn1In2Se4: mp-22607
Zn1In2Se4: mp-34169
Zn1S1: mp-10695
Zn1Se1: mp-1190
Zn20S20: mp-555782
Zn20S20: mp-556155
Zn20S20: mp-556207
Zn20S20: mp-556280
Zn20S20: mp-556732
Zn20S20: mp-557009
Zn20S20: mp-557062
Zn20S20: mp-557418
Zn20S20: mp-561286
Zn22S22: mp-556000
Zn22S22: mp-556543
Zn22S22: mp-556784
Zn24S24: mp-553916
Zn24S24: mp-554115
Zn24S24: mp-554630
Zn24S24: mp-554713
Zn24S24: mp-554829
Zn24S24: mp-554889
Zn24S24: mp-554999
Zn24S24: mp-555381
Zn24S24: mp-555543
Zn24S24: mp-555583
Zn24S24: mp-555594
Zn24S24: mp-555628
Zn24S24: mp-555664
Zn26S26: mp-553880
Zn26S26: mp-554253
Zn26S26: mp-554608
Zn26S26: mp-555214
Zn26S26: mp-555311
Zn28S28: mp-554004
Zn28S28: mp-554503
Zn28S28: mp-554681
Zn28S28: mp-554820
Zn28S28: mp-554961
Zn28S28: mp-555079
Zn28S28: mp-555151
Zn2Cr4S8: mp-4194
Zn2Cr4S8: mvc-11256
Zn2Cr4Se8: mp-4697
Zn2Cr4Se8: mvc-11651
Zn2Ge1S4: mp-675748
Zn2Ge1Se4: mp-35539
Zn2In4S8: mp-22052
Zn2In4S8: mp-674328
Zn2S2: mp-560588
Zn2Se2: mp-380
Zn2Si2Cu4S8: mp-977414
Zn32S32: mp-555666
Zn34S34: mp-554986
Zn36S36: mp-581425
Zn36S36: mp-582680
Zn3Cd1S4: mp-981379
Zn3S3: mp-555763
Zn40S40: mp-581405
Zn44S44: mp-680085
Zn44S44: mp-680087
Zn4S4: mp-10281
Zn4S4: mp-555410
Zn5S5: mp-13456
Zn5S5: mp-554405
Zn64S64: mp-647075
Zn6S6: mp-555280
Zn6S6: mp-9946
Zn7S7: mp-543011
Zn8S8: mp-556005
Zn8S8: mp-556395
Zn8S8: mp-556468
Zn8S8: mp-556576
Zn8S8: mp-557151
Zn8S8: mp-561118
Zr1S2: mp-1186
Zr1Se2: mp-2076
Zr1Ti1Se4: mp-570062
Zr2S6: mp-9921
Zr2Se6: mp-1683
Zr2Tl2Cu2S6: mp-7049
Zr2Tl2Cu2Se6: mp-7050
Zr4Cu2S8: mp-14025
Zr4Pb4S12: mp-20244
Zr4Sn4S12: mp-17324
POTENTlALLY FUNCTlONALLY STABLE CATHODE COATlNGS
Ba38Li88: mp-569841
K6Li3Al3F18: mp-722903
Li10Nb14S28: mp-767171
Li12Fe8S16: mp-768335
Li12Fe8S16: mp-768360
Li12Te36: mp-27466
Li12V4S16: mp-768423
Li14Ge4: mp-29630
Li16Fe8S16: mp-775931
Li16Ti16O32: mp-777167
Li16V4S16: mp-768414
Li17Ti20O40: mp-677305
Li18Ge8: mp-27932
Li1Ag1: mp-2426
Li1Ag3: mp-862716
Li1Au3: mp-11248
Li1Au3: mp-975909
Li1Br1: mp-23259
Li1C12: mp-1021323
Li1C6: mp-1001581
Li1Cl1: mp-22905
Li1Co1S2: mp-753946
Li1Co1S2: mp-757100
Li1F1: mp-1009009
Li1Fe1S2: mp-756094
Li1Gd1Se2: mp-15792
Li1Ge1Pd2: mp-29633
Li1Hg1: mp-2012
Li1Hg3: mp-973824
Li1Hg3: mp-976599
Li1I1: mp-22899
Li1N3: mp-2659
Li1S1: mp-32641
Li1Sb1Pd2: mp-861736
Li1Sn1Pd2: mp-7243
Li1Sn1S2: mp-1001783
Li1Sn1S2: mp-27683
Li1Ti1S2: mp-1001784
Li1Ti1S2: mp-9615
Li1Ti3S6: mp-19755
Li1Ti3Se6: mp-8132
Li1V1S2: mp-7543
Li1V1S2: mp-754542
Li22Ge12: mp-29631
Li22S11: mp-32899
Li23Mn20As20: mp-531949
Li24Cu24S24: mp-766467
Li24Cu24S24: mp-766480
Li24V8S32: mp-768440
Li24V8S32: mp-768476
Li26In6: mp-510430
Li26Si8: mp-672287
Li27Sb10: mp-676024
Li28Si8: mp-27930
Li2Ag2: mp-1018026
Li2Br2: mp-976280
Li2C2: mp-1378
Li2Co2S4: mp-752928
Li2Co4S8: mvc-16740
Li2Cu2S2: mp-774712
Li2Cu2S2: mp-867689
Li2Fe1S2: mp-753943
Li2Fe1S2: mp-754407
Li2Fe4S8: mp-1040470
Li2Gd2Se4: mp-37680
Li2Ge1Pd1: mp-30080
Li2I2: mp-568273
Li2I2: mp-570935
Li2Mn2P2: mp-504691
Li2Mn4S8: mvc-16742
Li2Mn4S8: mvc-16758
Li2Mn4S8: mvc-16773
Li2Nb2S4: mp-7936
Li2P6: mp-1025406
Li2Pr2S4: mp-675419
Li2S1: mp-1153
Li2S8: mp-995393
Li2Sb1Pd1: mp-10180
Li2Se1: mp-2286
Li2Sn1Pt1: mp-866202
Li2Te1: mp-2530
Li2Ti4S8: mvc-16738
Li2V4S8: mvc-16735
Li2V4S8: mvc-16776
Li30Au8: mp-567395
Li30Ge8: mp-1777
Li30Si8: mp-569849
Li3Ag1: mp-865875
Li3Ag1: mp-976408
Li3Au1: mp-11247
Li3C1: mp-976060
Li3Co4S8: mp-767412
Li3Cu1: mp-975882
Li3Hg1: mp-1646
Li3Hg1: mp-976047
Li3N1: mp-2251
Li3Ni18Ge18: mp-15949
Li3Sb1: mp-2074
Li3V1S4: mp-760375
Li40Pb12: mp-504760
Li48As112: mp-680395
Li4Cu4S4: mp-753371
Li4Cu4S4: mp-753508
Li4Cu4S4: mp-753605
Li4Cu4S4: mp-753826
Li4Cu4S4: mp-774736
Li4Fe2S4: mp-755796
Li4Fe2S4: mp-756187
Li4Fe4S8: mp-754660
Li4Mo4S8: mp-30248
Li4P20: mp-2412
Li4P20: mp-32760
Li4Ta6S12: mp-755664
Li4Ti4S8: mp-755414
Li4U2S6: mp-15885
Li4V6S12: mp-756195
Li4Zr8O16: mp-770731
Li6Ag2: mp-977126
Li6As2: mp-757
Li6Fe4S8: mp-753818
Li6Ge6: mp-8490
Li6N2: mp-2341
Li6P2: mp-736
Li6Re2: mp-983152
Li6Sb2: mp-7955
U6V2S8: mp-755642
Li84Si20: mp-29720
Li85Pb20: mp-574275
Li85Sn20: mp-573471
Li88Pb20: mp-573651
Li88Si20: mp-542598
Li8As8: mp-7943
Li8Fe4S8: mp-756348
Li8Ge8: mp-9918
Li8P8: mp-9588
Li8S4: mp-1125
Li8S4: mp-557142
Li96Si56: mp-1314
Li9Nb14S28: mp-767218
Sr4Li4Al4F24: mp-555591
Tb1Li1Se2: mp-15793
Tb2Li2Se4: mp-38695

External Stress

Strain stabilization mechanism for enhancing electrolyte stability is not limited to the materials level but can also be applied on the battery cell level through external stress or volume constriction. In certain embodiments, the external stress is a volumetric constraint applied to all or a portion, e.g., the solid state electrolyte, of the rechargeable battery, e.g., delivered by a mechanical press. The external stress can be applied by a housing, e.g., made of metal. In some cases, the volumetric constraint can be from about 70 MPa to about 1,000 MPa, e.g., about 70 MPa to about 150 MPa, about 100 MPa to about 300 MPa, about 200 MPa to about 400 MPa, about 300 MPa to about 500 MPa, about 400 MPa to about 600 MPa, about 500 MPa to about 700 MPa, about 600 MPa to about 800 MPa, about 700 MPa to about 900 MPa, or about 800 MPa to about 1,000 MPa, e.g., about 70 MPa, about 75 MPa, about 80 MPa, about 85 MPa, about 90 MPa, about 95 MPa, about 100 MPa, about 150 MPa, about 200 MPa, about 250 MPa, about 300 MPa, about 350 MPa, about 400 MPa, about 450 MPa, about 500 MPa, about 550 MPa, about 600 MPa, about 650 MPa, about 700 MPa, about 750 MPa, about 800 MPa about 850 MPa, about 900 MPa, about 950 MPa, or about 1,000 MPa. In the present invention, “about” means±10%.

The solid state electrolyte may also be compressed prior to inclusion in the battery. For example, the solid state electrolyte may be compressed with a force between about 70 MPa to about 1,000 MPa, e.g., about 70 MPa to about 150 MPa, about 100 MPa to about 300 MPa, about 200 MPa to about 400 MPa, about 300 MPa to about 500 MPa, about 400 MPa to about 600 MPa, about 500 MPa to about 700 MPa, about 600 MPa to about 800 MPa, about 700 MPa to about 900 MPa, or about 800 MPa to about 1,000 MPa, e.g., about 70 MPa, about 75 MPa, about 80 MPa, about 85 MPa, about 90 MPa, about 95 MPa, about 100 MPa, about 150 MPa, about 200 MPa, about 250 MPa, about 300 MPa, about 350 MPa, about 400 MPa, about 450 MPa, about 500 MPa, about 550 MPa, about 600 MPa, about 650 MPa, about 700 MPa, about 750 MPa, about 800 MPa about 850 MPa, about 900 MPa, about 950 MPa, or about 1,000 MPa. Once pressed, the solid state electrolyte can then be employed in a battery. Such a battery may also be subjected to external stress to enforce a mechanical constriction on the solid state electrolyte, e.g., at the microstructure level, i.e., to provide an isovolumetric constraint. The mechanical constriction on the solid state electrolyte may be from 1 to 100 GPa, e.g., 5 to 50 GPa, such as about 15 GPa. The external stress required to maintain the mechanical constriction may be from about 1 MPa to about 1,000 MPa, e.g., about 1 MPa to about 50 MPa, about 1 MPa to about 250 MPa, about 3 MPa to about 30 MPa, about 30 MPa to about 50 MPa, about 70 MPa to about 150 MPa, about 100 MPa to about 300 MPa, about 200 MPa to about 400 MPa, about 300 MPa to about 500 MPa, about 400 MPa to about 600 MPa, about 500 MPa to about 700 MPa, about 600 MPa to about 800 MPa, about 700 MPa to about 900 MPa, or about 800 MPa to about 1,000 MPa, e.g., about 70 MPa, about 75 MPa, about 80 MPa, about 85 MPa, about 90 MPa, about 95 MPa, about 100 MPa, about 150 MPa, about 200 MPa, about 250 MPa, about 300 MPa, about 350 MPa, about 400 MPa, about 450 MPa, about 500 MPa, about 550 MPa, about 600 MPa, about 650 MPa, about 700 MPa, about 750 MPa, about 800 MPa about 850 MPa, about 900 MPa, about 950 MPa, or about 1,000 MPa. The external stress employed may change depending on the voltage of the battery. For example, a battery operating at 6V may employ an external stress of about 3 MPa to about 30 MPa, and a battery operating at 10V may employ an external stress of about 200 MPa. The invention also provides a method of producing a battery using compression of the solid state electrolyte prior to inclusion in the battery, e.g., with subsequent application of external stress.

Methods

Batteries of the invention may be charged and discharged for a desired number of cycles, e.g., 1 to 10,000 or more. For example, batteries may be cycled 10 to 750 times or at least 50, 100, 200, 300, 400, 500, 600, 700, 800, 900, 1,000, 1,500, 2,000, 3,000, 4,000, or 5,000 times. In embodiments, the voltage of the battery ranges from about 1 to about 20V, e.g., about 1-10V, about 5-10V, or about 5-8V. Batteries of the invention may also be cycled at any appropriate current density e.g., 1 mA cm⁻² to 20 mA cm⁻², e.g., about 1-10 mA cm⁻², about 3-10 mA cm⁻², or about 5-10 mA cm-2.

### EXAMPLES

### Example 1

The cyclic voltammograms (CV) of Li/LGPS/LGPS+C were measured under different pressures between open circuit voltage (OCV) to 6 V at a scan rate of 0.1 mVs⁻¹ on a Solartron electrochemical potentiostat (1470E), using lithium (coated by Li₂HPO₄) as reference electrode. A liquid battery using LGPS/C thin film as cathode, lithium as anode and, 1 M LiPF₆ in EC/DMC as electrolyte was also assembled for comparison. The ratio of LGPS to C is 10:1 in both solid and liquid CV tests.

The cathode and anode thin films used in all-solid-state battery were prepared by mixing LTO/LCO/LNMO, LGPS, Polytetrafluoroethylene (PTFE) and carbon black with different weight ratios. The ratios of active materials/LGPS/C are 30/60/10, 70/27/3, 70/30/0 for LTO, LCO and LNMO thin film electrodes, respectively. This mixture of powder was then hand-grinded in a mortar for 30 minutes and rolled into a thin film inside an argon-filled glove box with 3% PTFE added. Solid electrolytes used in all-solid-state Li ion batteries were prepared by mixing LGPS and PTFE with a weight ratio of 97:3, then hand-grinding the mixed powder in a mortar for 30 minutes and finally rolling it into a thin film inside an argon-filled glove box. To assemble an all-solid-state Li ion battery cell, the prepared composite cathode (LCO or LNMO) thin film, LGPS thin film (<100 μm), and anode (LTO) thin film were used as cathode, solid electrolyte, and the anode, respectively. The three thin films of cathode, electrolyte and anode were cold-pressed together at 420 MPa, and the pressure was kept at 210 MPa by using a pressurized cell during battery cycling test. The charge and discharge behavior was tested using an ArbinBT2000 workstation (Arbin Instruments, TX, USA) at room temperature. The specific capacity was calculated based on the amount of LTO.

### Example 2—Strain-Stabilized LGPS Core-Shell Electrolyte Batteries

Theory—The Physical Picture

The mechanism by which strain can expand the LGPS stability window is depicted in FIG. 4A. Consider the decomposition of LGPS to some arbitrary set of decomposed products, denoted “D” (LGPS→D), at standard temperature and pressure. The Gibbs energy of the system as a function of the fraction of LGPS that has decomposed (x_{D}) is given by the dashed orange line in FIG. 4A and analytically in equation 1.

G⁰(x_{D})=(1−x_{D})G_{LGPS}+x_{D}G_{D} (1)

The lowest Gibbs energy state is x_{D}=1 (all decomposed) and the initial state is x_{D}=0 (pristine LGPS). Accordingly, the reaction energy is ΔG⁰=G⁰(1)−G° (0)=G_{D}−G_{LGPS}. This system is inherently unstable. That is, ∂ₓ_{_{D}}G⁰ is negative for all values of x_{D}. Hence, for any initial value of x_{D}, the system will move to decrease G⁰ by increasing x_{D}, ultimately ending at the final state x_{D}=1.

Next, consider the application of a mechanical system that constrains the LGPS particle. Given that LGPS tends to expand during decay, any mechanical constraint will require that decomposition induce strain in the surrounding neighborhood. Such a constraining system could be either materials-level (i.e. a core-shell microstructure) or systems-level (i.e. a pressurized battery cell) or a combination of the two. Ultimately, this mechanical system can only induce a finite strain before fracturing. The energy needed to fracture the system is denoted G_{fracture}.

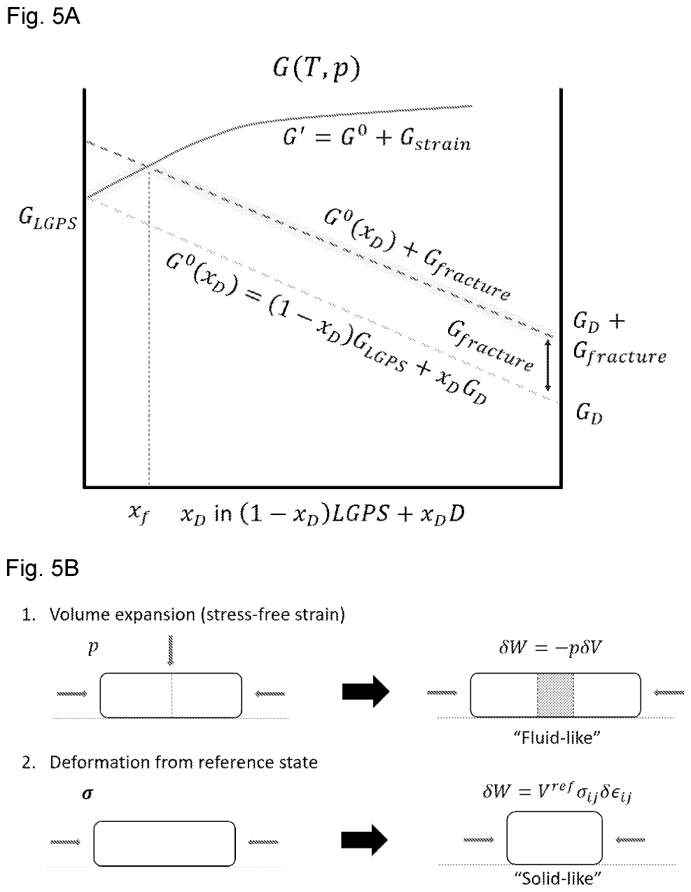

Prior to the fracturing of the constraining mechanism, any decomposition of the LGPS must lead to an increase in strain energy. The green line in FIGS. 5A-5B plots the constrained Gibbs energy (G′) in terms of the unconstrained Gibbs (G⁰) and the constraint induced strain (Gₛₜᵣₐᵢₙ). The highlighted curve indicates the decomposition pathway of the LGPS.
1. The particle begins as pristine LGPS (x_{D}=0) with an unfractured constraint mechanism
2. As the particle begins to decompose (x_{D}: 0→(x_{D}), the constraint mechanism requires an increase in Gₛₜᵣₐᵢₙ. The strain Gibbs is assumed to be a function of x_{D} that goes to zero as x_{D} goes to zero
3. Once the Gibbs energy of the strained system (G′(x_{D})) exceeds the Gibbs energy of the fractured system (G⁰(x_{D})+G_{fracture}), the constraining mechanism will fail. This occurs at the fracture point x_{D}=x_{f}
4. Once x_{D}>x_{f}, the system will proceed to completely decompose as ∂ₓ_{_{D}} (G⁰+G_{fracture})<0

If the constraint induced strain Gibbs (Gₛₜᵣₐᵢₙ) is sufficiently steep, the slope of the total Gibbs at x_{D}<x_{f} will be positive (as depicted in FIG. 5A). In this case, the LGPS will be metastable about the pristine state (x_{D}=0). This work focuses on the quantification of constraining systems such that ∂ₓ_{_{D}}G′>0 at x_{D}≈0, allowing metastable ceramic sulfide electrolytes.

Two Work Differentials

The presence of Gₛₜᵣₐᵢₙ as a function of x_{D} stems from the nature of LGPS to expand upon decomposition. Depending on the set of decomposed products, as determined by the applied voltage, this volume expansion can exceed 20-50%. As such, the process of LGPS decomposition is one that can include significant “stress-free” strain—that is, strain that is the result of decomposition and not an applied stress. Proper thermodynamic analysis of such decay pathways requires careful consideration of the multiple work differentials, which are reasonably neglected for other systems.

FIG. 5B schematically represents two sources of work which are frequently used, the “fluid-like” and the “solid-like” forms. In the fluid-like system, the change in work under isobaric conditions is proportional to the change in the system volume δW=−pδV. For solid-like systems, the work is defined in terms of a reference/undeformed state and has differential form δW=V^{ref}σᵢⱼδϵᵢⱼ, where V^{ref} is the undeformed volume, ϵ is the strain tensor relative to the undeformed state and σ is the stress tensor corresponding to ϵ.

The general approach to showing the equivalency of these two differential work expressions is as follows. The solid-like stress and strain tensors are separated into the compression and distortion terms via the use of deviatoric tensors as defined in equation 2. The pressure is generalized in terms of the stress matrix p≡⅓tr(σ)=−⅓σᵢᵢ and volume strain ϵ≡(V−V^{ref}/V^{ref}.

$${σ}_{i j}^{a} ≡ {σ}_{i j} + p {δ}_{ij} \\ {ϵ}_{{i}_{j}}^{d} ≡ {ϵ}_{i j} - \frac{ϵ}{3} {δ}_{i j} \qquad ( 2 )$$

Using these definitions, the solid-like work can be separated into one term that only includes compression and one term that only includes deformation.

δW=V^{ref}σᵢⱼδϵᵢⱼ=V^{ref}(σᵢⱼ^{d}δϵᵢⱼ^{d}−pδϵ) (3)

In the fluid limit, where there is no shape change, equation 3 reduces to δW=−V^{ref}pδϵ=pδV assuming that δV^{ref}=0, giving back the fluid-like work differential. In most mechanical systems, this assumption is valid as the undeformed reference volume does not change. However, it fails in describing LGPS decomposition because the undeformed volume changes with respect to x_{D} and, hence, δV^{ref}≠0.

V^{ref}(x_{D})=(1−x_{D})V_{LGPS}+x_{D}V_{D} (4)

Instead, proper thermodynamic analysis of LGPS decomposition requires consideration of both work terms. The fluid term−pδV^{ref} indicates the work needed to compress the reference volume (i.e., change x_{D}) in the presence of a stress tensor a and the solid term represents the work needed to deform the new reference state V^{ref}σᵢⱼδϵᵢⱼ. Considering this, the full energy differential is given by equation 5.

δE=TδS+μ_{α}N_{α}−pδV_{ref}+V_{ref}σᵢⱼδϵᵢⱼ (5)

Transforming to the Gibbs energy G=E−TS+pV^{ref}−V_{ref}σᵢⱼϵᵢⱼ=μ_{α}N_{α}, yields the differential form:

δG=−SdT+μ_{α}δN_{α}+Vδp−V_{ref}ϵᵢⱼδσᵢⱼ (6)

Note that the transformation used frequently in solid mechanics, G=E−TS−V^{ref}σᵢⱼϵᵢⱼ=μ_{α}N_{α}−pV^{ref}, is sufficient so long as V^{ref} is constant and, hence, −pV^{ref} can be set as the zero point.

At constant temperature, equation 6 gives the differential form of G′(x_{D}) of FIGS. 5A-5B in terms of the chemical terms (δG⁰=μ_{α}δN_{α}) and the strain term (δGₛₜᵣₐᵢₙ=Vδp−V^{ref}ϵᵢⱼδσᵢⱼ=V^{ref}δp−V^{ref}ϵᵢⱼ^{d}δσᵢⱼ^{d}).

δₓ_{_{D}}G′=μ_{α}∂ₓ_{_{D}}N_{α}+V∂ₓ_{_{D}}p−V_{ref}ϵᵢⱼ∂ₓ_{_{D}}σᵢⱼ=∂ₓ_{_{D}}G₀+∂ₓ_{_{D}}Gₛₜᵣₐᵢₙ

∂ₓ_{_{D}}G′=G_{D}−G_{LGPS}+∂ₓ_{_{D}}Gₛₜᵣₐᵢₙ (7)

In the following discussion we consider two limiting cases for Gₛₜᵣₐᵢₙ as a function of x_{D}, which provides a range of values for which LGPS can be stabilized. The first case is that of a LGPS particle that decomposes hydrostatically and is a mean field approximation. The fraction of decomposed LGPS is assumed to be uniform throughout the particle (x_{D}(\vec{r})=x_{D} for all \vec{r}). The second limiting case is that of spherically symmetric nucleation, where LGPS is completely decomposed within a spherical region of radius Rᵢ (x_{D}(\vec{r})=1: r≤Rᵢ) and pristine outside this region (x_{D}(\vec{r})=0: r>Rᵢ). As is shown below, the hydrostatic case yields a lower limit for ∂x_{D}Gₛₜᵣₐᵢₙ whereas the nucleation model shows how this value could, in practice, be much higher.

Hydrostatic Limit/Mean Field Theory

The local stress σ(\vec{r}) experienced by a subsection of an LGPS particle is directly a function of the decomposition profile x_{D}(\vec{r}) as well as the mechanical properties of the particle and, if applied, the mechanically constraining system. In the hydrostatic approximation, the local stress is said to be compressive and equal everywhere within the particle (σᵢⱼ(\vec{r})=−pδᵢⱼ). In the mean field approximation, the same is said for the decomposed fraction x_{D}(\vec{r})=x_{D}. Given the one-to-one relation between σ(\vec{r}) and x_{D}(\vec{r}), these two approximations are equivalent.

We restrict focus to the limit as x_{D}→0 to evaluate the metastability of LGPS about the pristine state. If ∂ₓ_{_{D}}G′(x_{D}=0)>0, then the particle is known to be at least metastable with total stability being determined by the magnitude of G_{fracture}. The relationship between the pressure and decomposed fraction was shown in ref²² to be, in this limit, p(x_{D})=x_{D}K_{eff}ϵ_{RXN}. Where K_{eff} is the effective bulk modulus of the system, accounting for both the compressibility of the material and the applied mechanical constraint. K_{eff} indicates how much pressure will be required to compress the system enough as to allow the volume expansion of LGPS (ϵ_{RXN}) that accompanies decomposition. The differential strain Gibbs can be solved from here assuming no deviatoric strain (justifiable for a fluid model) as shown in equation 8.

δₓ_{_{D}}Gₛₜᵣₐᵢₙ=V_{ref}∂ₓ_{_{D}}p (8)

∂ₓ_{_{D}}Gₛₜᵣₐᵢₙ=V^{ref}ϵ_{RXN}K_{eff} (9)

The reference volume is the volume in the unconstrained system, V^{ref}=(1−x_{D})V^{LGPS}+x_{D}V^{D}. Combining equation 7 and equation 9 with the metastability condition ∂ₓ_{_{D}}G′(x_{D}=0)>0, it is found that fluid-like LGPS will be stabilized whenever equation 10 is satisfied.

ϵ_{RXN}K_{eff}>(G_{LGPS}⁰−G_{D}⁰)V_{LGPS}⁻¹ (10)

Equation 9 is solved for in FIG. 5 for the case of a core-shell constriction mechanism with a core comprised of either LGPS or oxygen-doped LGPSO (Li₁₀GeP₂S_{11.5}O_{0.5}) and a shell of an arbitrary rigid material. The effective bulk modulus is given by K_{eff}=(β_{LGPS}+βₛₕₑₗₗ)⁻¹ where β_{LGPS} is the compressibility of the LGPS material and βₛₕₑₗₗ=V_{core}⁻¹∂ₚV_{core} is a parameter that represents the ability of the shell to constrain the particle²².

Spherical Nucleation Limit

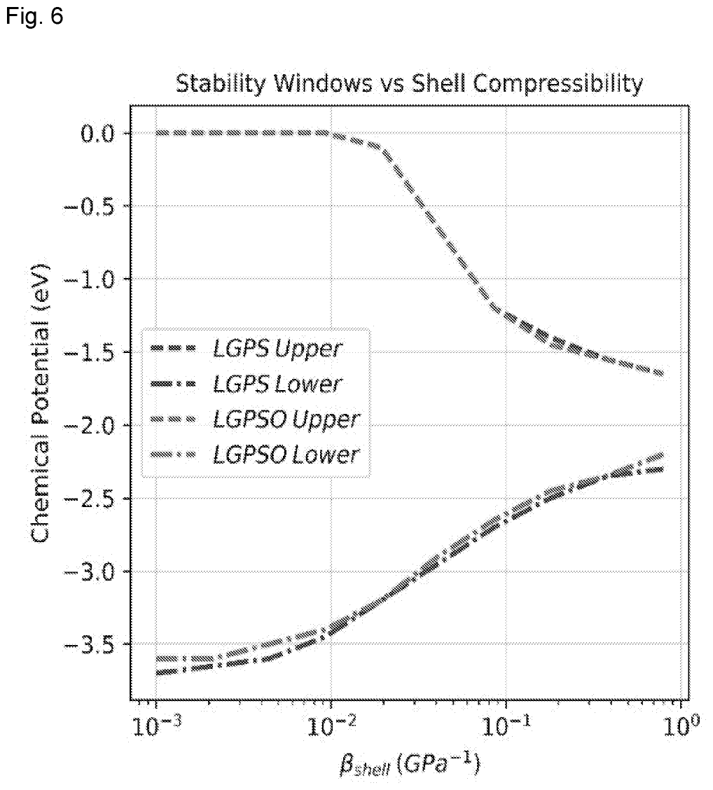

The maximally localized (i.e. highest local pressure) decomposition mechanism is that of spherical nucleation as shown in FIG. 6. In this model, an LGPS particle of outer radius Rₒ undergoes a decomposition at its center. The decomposed region corresponds to the material that was initially within a radius of Rᵢ. The new reference state is of higher volume than the pristine state as the material has decomposed to a larger volume given by 4/3πR_{D}³=4/3πRᵢ³(1+ϵ_{RXN}). The decomposed fraction is no-longer a constant in the particle as it was in the hydrostatic case. Instead, x_{D}(\vec{r})=1 for all material that was initially (prior to decomposition) within the region r<Rᵢ and x_{D}(\vec{r})=0 for all material initially outside this region, r>Rᵢ.

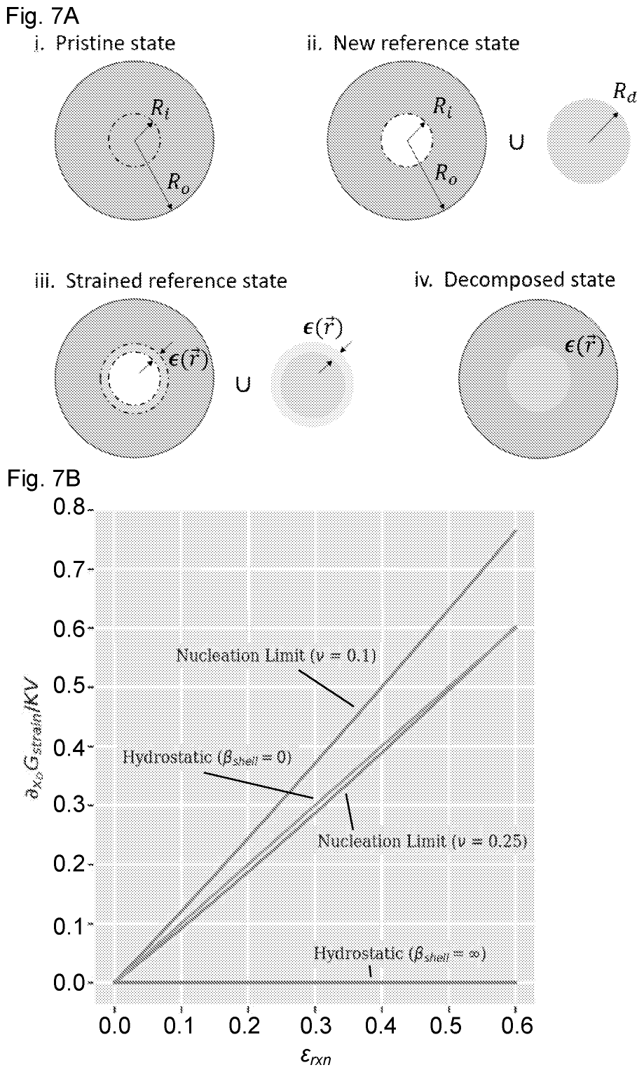

To fit the decomposed reference state of radius R_{D} into the void of radius Rᵢ, both the decomposed sphere and the remaining LGPS must become strained as shown in FIGS. 7A.iii and 7A.iv. Thus, solving for the stress in terms of the decomposed fraction x_{D} becomes the problem of a thick-walled spherical pressure vessel compressing a solid sphere. The pressure-vessel has reference state inner and outer radii given by Rᵢ and Rₒ and the spherical particle has an equilibrium radius of R_{D}=(1+ϵ_{RXN})^{1/3}Rᵢ.

In terms of the displacement vector of the decomposed and pristine materials, \vec{u}^{D}(\vec{r}) and \vec{u}^{P}(\vec{r}), and the radial stress components, σᵣᵣ^{D}(\vec{r}) and σᵣᵣ^{P}(\vec{r}), the boundary conditions are:
1. Continuity between the decomposed and pristine products: R_{D}+u^{D}(R^{D})=Rᵢ+u^{p}(Rᵢ). Where vector notation has been dropped to reflect the radial symmetry of the system.
2. Continuity between the radial components of stress for those materials at the interface between the decomposed and pristine products: σᵣᵣ^{D}(R_{d})=σᵣᵣ^{P}(Rᵢ).

For a spherically symmetric stress in an isotropic material, the displacement vector is known to be of the form u(r)=Ar+Br⁻², where the vector notation has been removed as displacement is only a function of distance from the center. The strain Gibbs for a compressed sphere under condition 2, defining p⁰=−σᵣᵣ^{(d)}(R_{D}), gives the compressive term σₓ_{_{D}}Gₛₜᵣₐᵢₙ=p⁰V(1+ϵ_{RXN}) with no deviatoric components. Likewise, a hollow pressurized sphere at the onset of decay (lim x_{D}→0↔Rᵢ<<R) has both a compressive and deviatoric component that combine to σₓ_{_{D}}Gₛₜᵣₐᵢₙ=p⁰V(1+¾p⁰Sₚ⁻¹), where Sₚ is the shear modulus of the pristine material. Combining these terms leads to the nucleated equivalent of equation 8.

(4/3πRₒ³)⁻¹∂x_{D}Gₛₜᵣₐᵢₙ=p⁰(2+ϵ_{RXN}+¾pSₚ⁻¹) (11)

FIG. 7B shows equation 11 solved for the case where the pristine and decomposed materials have the same elastic modulus (Eₚ=E_{d}) and Poisson's ratio (vₚ=v_{d}). The gray and purple lines reflect the no-shell and perfect-shell limits of the hydrostatic model, whereas the blue and red lines represent equation 10 for typical Poisson values. It is seen that, in general, the nucleation model provides a steeper strain Gibbs than the hydrostatic model due to the higher pressures involved. Intuitively, a smaller Poisson's ratio (harder to compress) improves the stability of the nucleation limit.

Passivation Layer Theory

Electrolytes, either liquid or solid, are likely to react with electrodes where the electrode potential is outside of the electrolyte stability window. To address this, it is suggested that electrolytes be chosen such that they form a passivating solid-electrolyte-interface (SEI) that is at least kinetically stable at the electrode potential. Many works on the topic of improving sulfide electrolytes have speculated that by forming electronically insulating layers on the surface of sulfide electrolytes such passivation layers can be formed. In this section, we discuss the role of such passivation layers and provide a quantitative analysis of the mechanism by which we believe an electronically insulating surface layer improves stability.

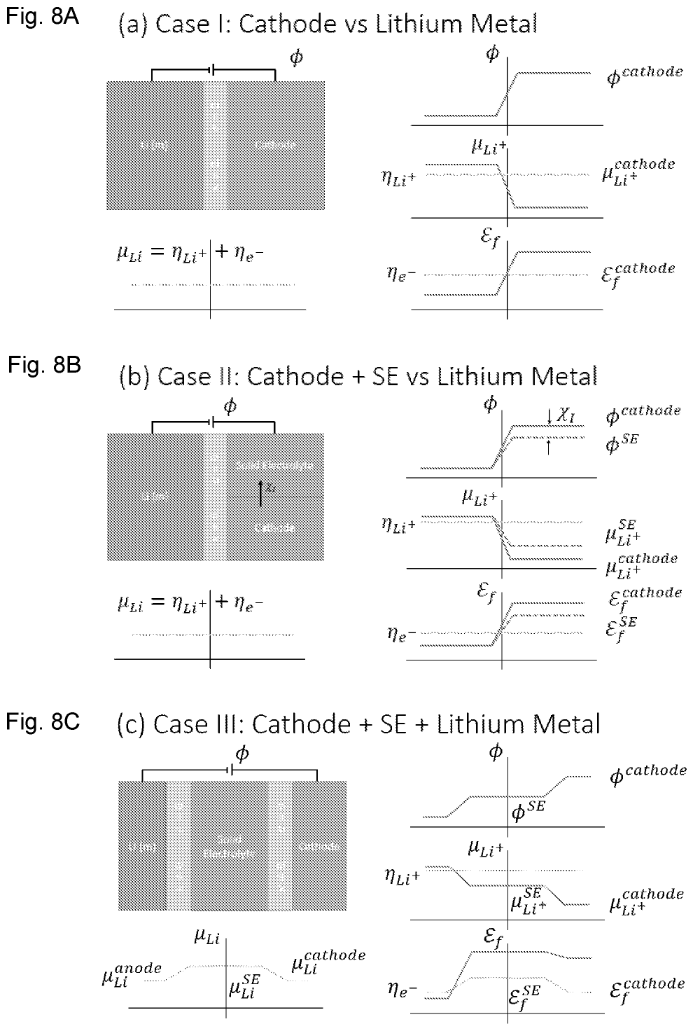

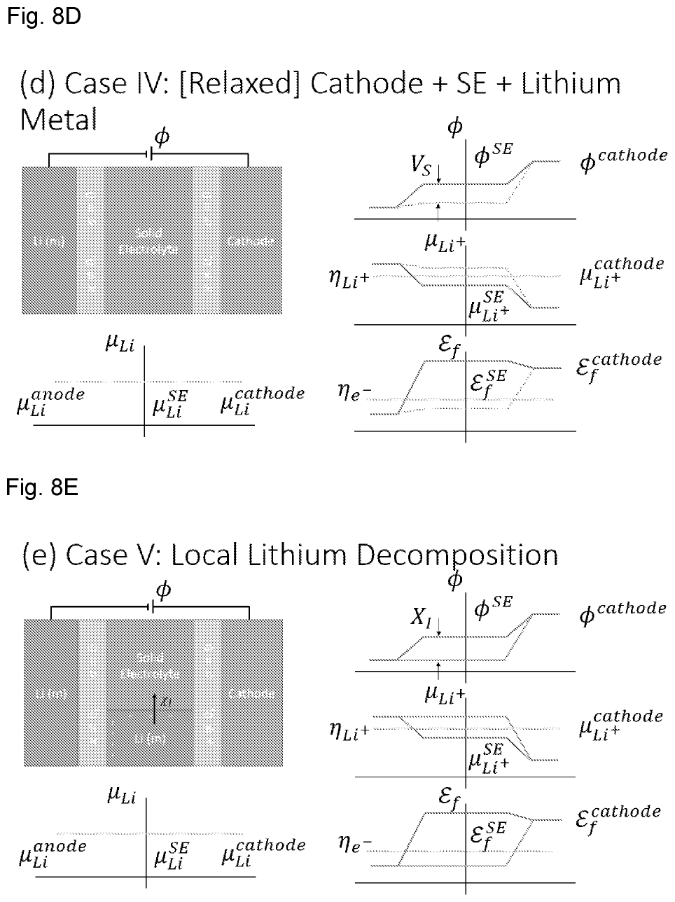

In FIG. 8A, the thermodynamic equilibrium state is given for the most basic battery half-cell model. A cathode is separated from lithium metal by an electrically insulating and ionically conducting material (σ=0, κ≠0, where σ, κ are the electronic and ionic conductivities) and a voltage ϕ is applied to the cathode relative to the lithium metal. The voltage of the lithium metal is defined to be the zero point. In terms of the number of electrons (n), the number of lithium ions (N), the Fermi level (ε_{f}) and the lithium ion chemical potential (μ_{Li}_{⁺}), the differential Gibbs energy can be written as equation 12 (superscripts a, c differentiate the anode from the cathode).

δG=μ_{Li}_{⁺}^{a}δN^{a}+(μ_{Li}_{⁺}^{c}+eϕ)δN^{c}+ε_{f}^{a}δn^{a}+(ε_{f}^{c}−eϕ)δn^{c} (12)

Applying conservation δN^{a}=−δN^{c}, δ^{a}=−δn^{c} gives the well-known equilibrium conditions:

$$δ G = ( {μ}_{{Li}^{+}}^{c} + e ϕ - {μ}_{{Li}^{+}}^{a} ) δ {N}^{c} + ( {ℰ}_{f}^{c} - e ϕ - {ℰ}_{f}^{a} ) δ {n}^{c} \\ \to \begin{matrix}{μ}_{{Li}^{+}}^{c} + e ϕ = {μ}_{{Li}^{+}}^{a} \\ {ℰ}_{f}^{c} - e ϕ = {ℰ}_{f}^{a}\end{matrix} \qquad ( 13 )$$

Or, in other words, the electrochemical potential (η=μ+zeϕ) of both the electrons and the lithium ions must be constant everywhere within the cell. As a result, the lithium metal potential (μ_{Li}=η_{Li}_{⁺}+ηₑ−) remains constant throughout the cell. The band diagrams found in FIG. 7A illustrate how the chemical potential of each species, as well as the voltage, varies throughout the cell, but the electrochemical potential remains constant.

FIG. 8B depicts the expected equilibrium state in the case of a solid-electrolyte cathode, where the cathode material is imbedded in a matrix of solid-electrolyte. In this case, the lower (i.e. more-negative) chemical potential of the cathode material relative to the electrolyte causes charge separation that results in an interface voltage χₗ. Analogous to the procedure following equation 12, it can be shown that the equilibrium points now include the anode (a), cathode (c) and the solid-electrolyte (SE):

$$\begin{matrix}{μ}_{{Li}^{+}}^{SE} + e ϕ = {μ}_{{Li}^{+}}^{a} \\ {ɛ}_{f}^{SE} - e ϕ = {ɛ}_{f}^{a}\end{matrix} + \begin{matrix}{μ}_{{Li}^{+}}^{c} + e ( ϕ + {χ}_{I} ) = {μ}_{{Li}^{+}}^{a} \\ {ɛ}_{f}^{c} - e ( ϕ + {χ}_{I} ) = {ɛ}_{f}^{a}\end{matrix} \qquad ( 14 )$$

Like equation 13, equation 14 leads to the condition that the lithium metal potential remains constant throughout the cell.

A speculated mechanism for passivation layer stabilization of sulfide electrolytes is depicted in FIG. 8C. In this case, the solid-electrolyte is coated in an electronically insulating material. Since the external circuitry does not directly contact the solid-electrolyte and there is no electron conducting pathway, the number of electrons within the solid-electrolyte is fixed. Hence the Fermi energy cannot equilibrate via electron flow. The speculation is that this effect could be utilized to allow a deviation of the lithium metal potential within the solid-electrolyte relative to the electrodes, leading to a wider operational voltage window. The band diagrams of FIG. 8C illustrate how the electron electrochemical potential can experience a local maximum (or minimum) in the solid-electrolyte due to a lack of electron conduction. This local maximum (or minimum) is carried over to the lithium metal potential.

The authors believe that while an electronically insulating passivation layer is a key design parameter, the above theory is missing a critical role of effective electron conduction that occurs due to the ‘lithium holes’ that are created when a lithium ion migrates out of the insulated region, leaving behind the corresponding electron. The differential Gibbs energy of this system is represented by adding a solid-electrolyte term to equation 12 (denoted by superscript SE).

δG=μ_{Li}_{⁺}^{a}+δN^{a}+(μ_{Li}_{⁺}+eϕ^{c})δN^{c}+(μ_{Li}_{⁺}+eϕ^{SE})δN^{SE}+ε_{f}^{a}δn^{a}+(ε_{f}^{c}−eϕ^{c})δn^{c}+(ε_{f}^{SE}−eϕ^{SE})δn^{SE} (15)

The electron and lithium conservation constraints are now:
1. δn^{SE}=−δN^{SE}: The effect of removing a lithium ion from the δE is that of placing the corresponding electron at the Fermi level of the remaining material.
2. δn^{a}=−δn^{c}+δN^{SE}: Gaining a lithium ion, but not the corresponding electron, at the anode reduces the number of electrons at the Fermi level.
3. δN^{a}=δN^{c}−δN^{SE}: Conservation of total lithium.

Constraints 1 and 2 represent the tethering of the electron and lithium density in the case of an insulated particle. Unlike the system governed by equation 12, the Fermi level of the solid-electrolyte is not fixed by an external voltage. The result is that by lowering the number of atoms within the solid-electrolyte by extracting lithium ions, and hence increasing the number of electrons per atom within the insulated region, the number of electrons per atom and the Fermi level increase. In effect, this represents the conduction of electrons by way of lithium-holes. Solving equation 15 for the equilibrium points given the above constraints lead to those of equation 14 between the anode/cathode as well as the following relation between the anode and solid-electrolyte.

$$\to \begin{matrix}{μ}_{{Li}^{+}}^{SE} + e {ϕ}^{SE} = {μ}_{{Li}^{+}}^{a} \\ {ℰ}_{f}^{SE} - e {ϕ}^{SE} = {ℰ}_{f}^{a}\end{matrix} \qquad ( 16 )$$

The total voltage experienced within the SE can be represented as ϕ^{SE}−ϕ₀^{SE}−V_{S} where ϕ₀^{SE} is the voltage in the absence of lithium extraction from the SE (the original voltage as depicted in FIG. 8C) and V_{S} is the voltage that results from the charge separation of lithium extraction. In other words, the system begins with a charge neutral solid-electrolyte at voltage ϕ₀^{SE}. However, equation 16 is not, in general, satisfied. Charge separation occurs lowering the voltage of the solid electrolyte relative to the anode. In terms of a geometrically determined capacitance C, this charge separation voltage is V_{S}=C⁻¹eN_{SE}. This effect is illustrated in FIG. 8D. Prior to charge separation within the SE region, the voltage and chemical potentials are given by the solid blue lines. As lithium ions are extracted from the SE by the anode, the voltage in the SE decreases from ϕ₀^{SE} to ϕ₀^{SE}−C⁻¹eN_{SE}.

The ultimate result of this voltage relaxation within the electronically insulated region is depicted in FIG. 8E. Because of the effective electron transport via lithium hole conduction, negatively charged lithium metal can form locally within the particle once the applied voltage exceeds the intrinsic stability of the solid-electrolyte. The negative charge is due to the lithium ions that have left the insulated region to equilibrate the lithium metal potential. As such, the local (i.e. within the insulated region) lithium metal is expected to have an interface voltage χₗ with the remaining solid-electrolyte. The voltage must be equal to the voltage between the anode lithium and the solid-electrolyte χₗ=ϕ^{SE} In short, from a thermodynamic perspective, applying a voltage ϕ^{SE} to an electronically insulated solid-electrolyte particle relative to a lithium metal anode is equivalent to applying a charged lithium metal directly in contact with the solid-electrolyte.

Intrinsically, this has no impact on the solid-electrolyte stability. However, in the limit of very low capacitances, as is expected, only a small fraction of the lithium ions would need to migrate to the anode for ϕ₀^{SE}−C⁻¹eN_{SE}≈0. Hence the electronically insulating shell traps the bulk of the lithium ions locally which maintains the high reaction strain needed for mechanical stabilization.

Results and Discussion

Electrochemical Stability

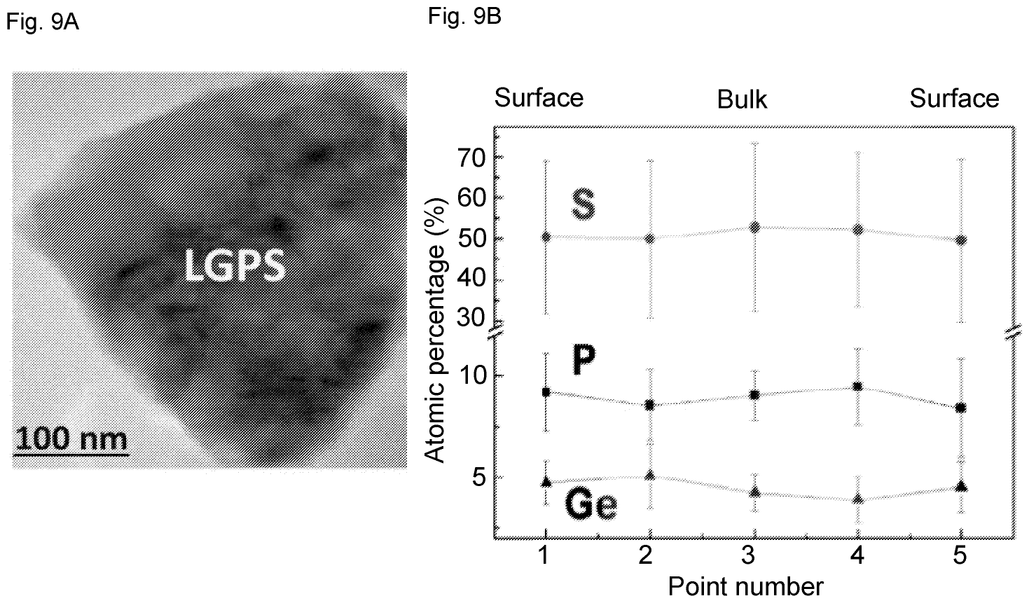

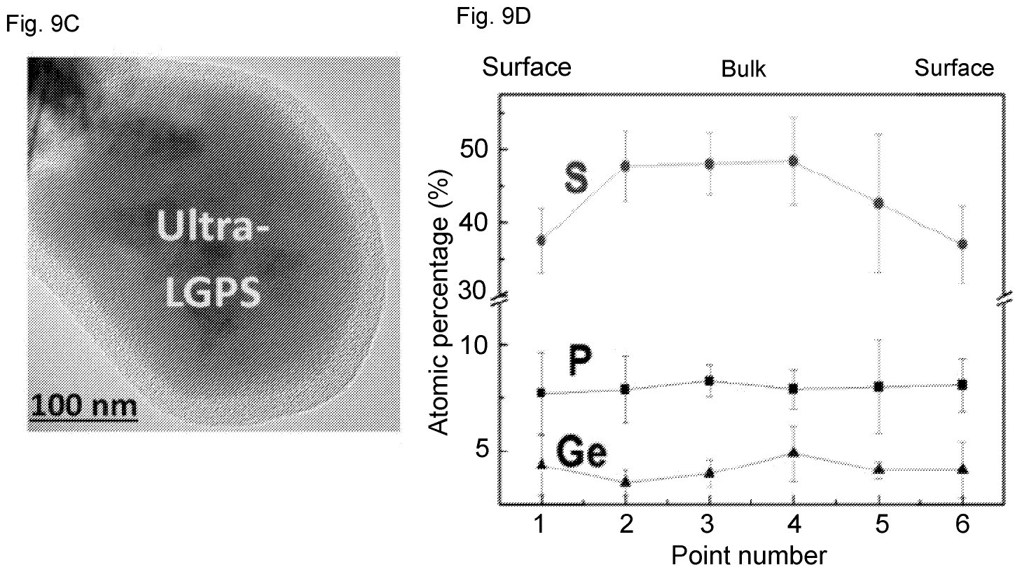

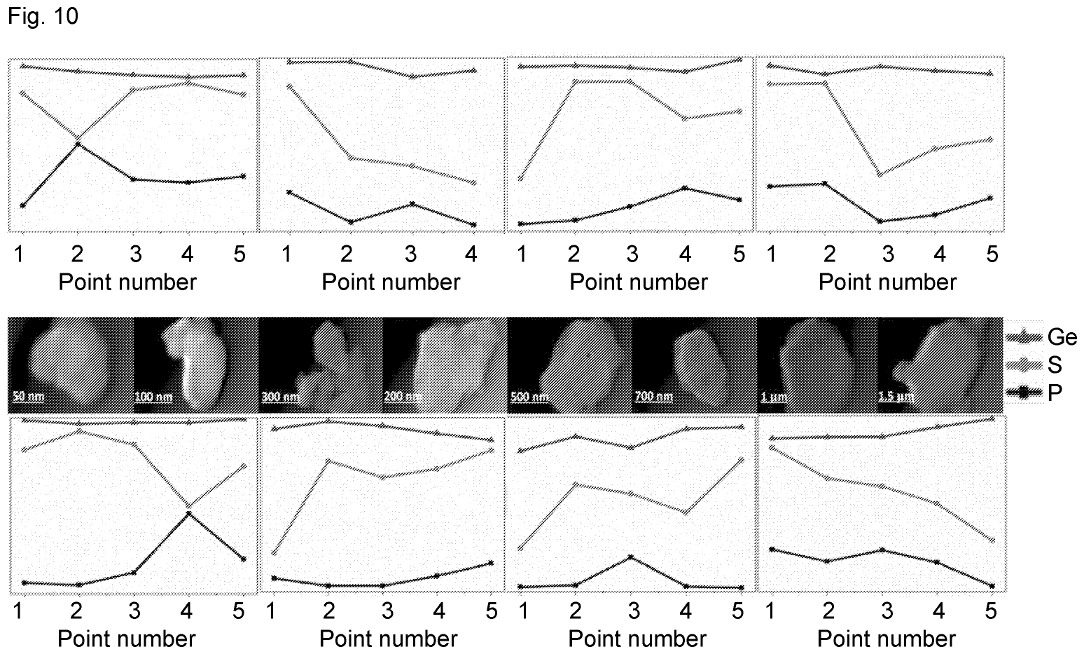

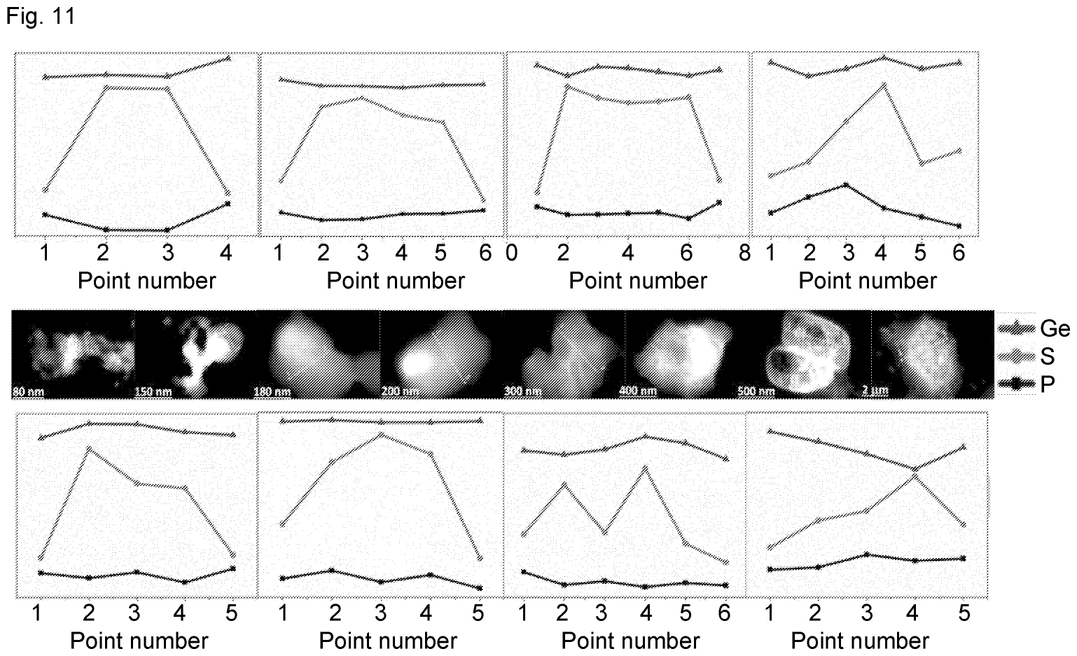

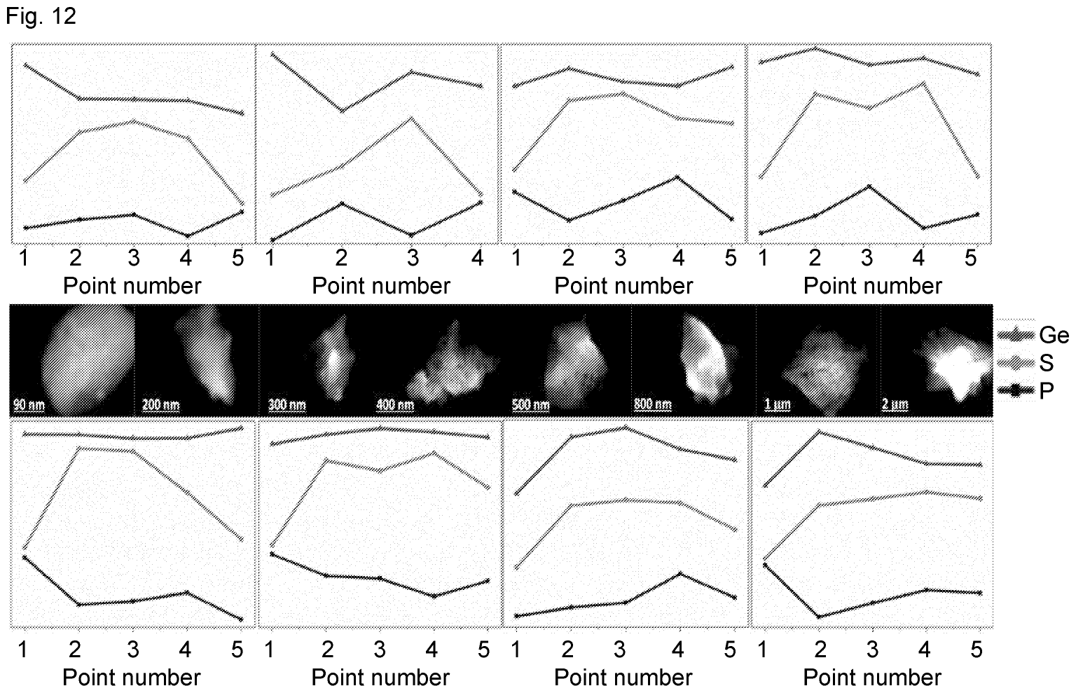

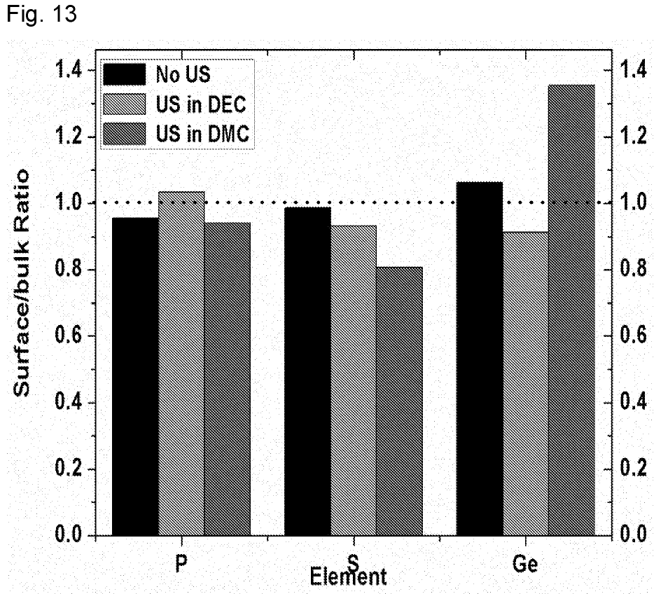

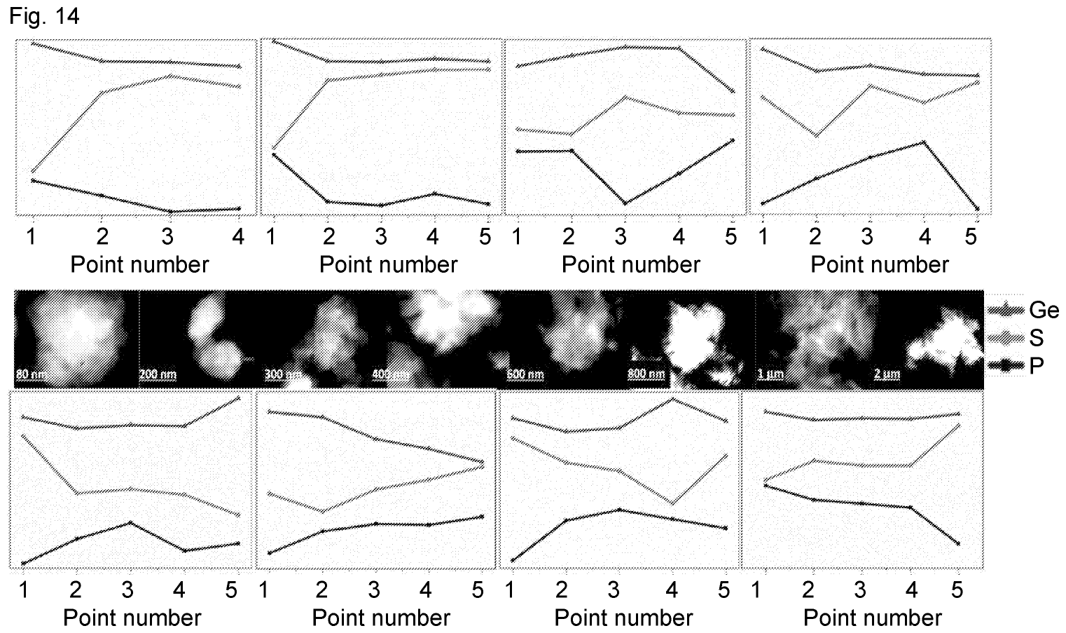

The impact of mechanical constriction on the stability of LGPS was studied by comparing decay metrics between LGPS and the same LGPS with an added core-shell morphology that provides a constriction mechanism. To minimize chemical changes, the constricting core-shell morphology was created using post-synthesis ultrasonication. This core-shell LGPS (“ultra-LGPS” hereafter) was achieved by high-frequency ultrasonication that results in the conversion of the outer layer of LGPS to an amorphous material. Bright-field transmission electron microscopy (TEM) images of the LGPS particles before (FIG. 9A) and after (FIG. 9C) sonication show the distinct formation of an amorphous layer. Statistically-analyzed energy dispersive X-ray spectroscopy (EDS) (FIGS. 9B and 9C) shows that this amorphous shell is slightly sulfur deficient whereas the bulk regions of LGPS and ultra-LGPS maintain nearly identical elemental distributions. EDS line-scans on individual [ultra-] LGPS particles (FIGS. 10-12) confirm that a sulfur-deficient surface layer exists for almost every ultra-LGPS particle whereas no such phenomenon is observed for LGPS particles. Note that this is true for LGPS sonication in both solvents tested, dimethyl carbonate (DMC) and diethyl carbonate (DEC) (FIGS. 11-13). Simply soaking LGPS in DMC without sonication had no obvious effect (FIG. 14). This method of post-synthesis core-shell formation minimizes structural changes to the bulk of the LGPS, allowing us to evaluate the effects of the volume constriction on stability without compositional changes.

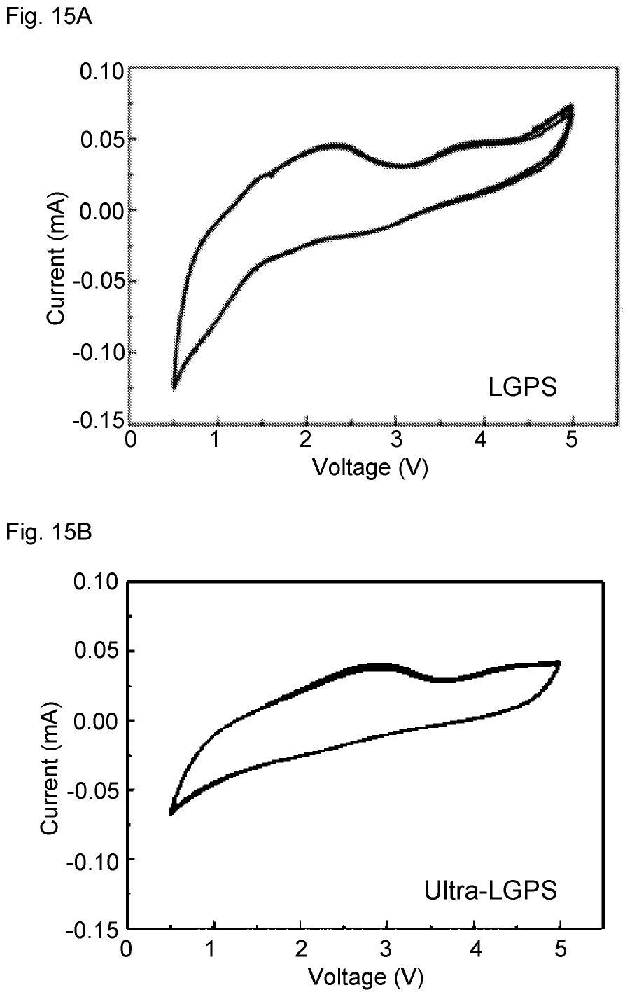

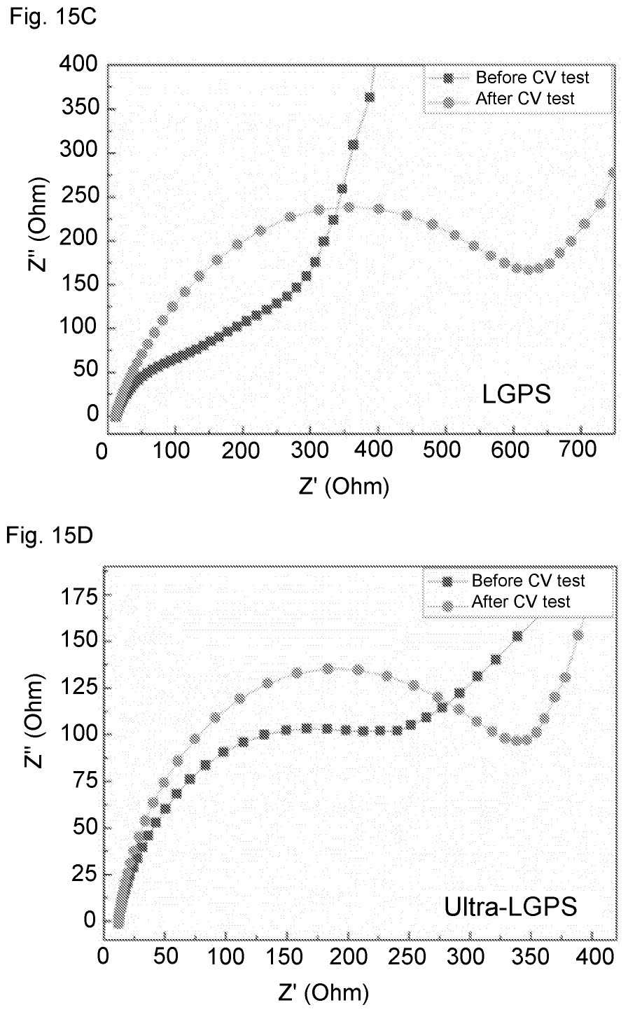

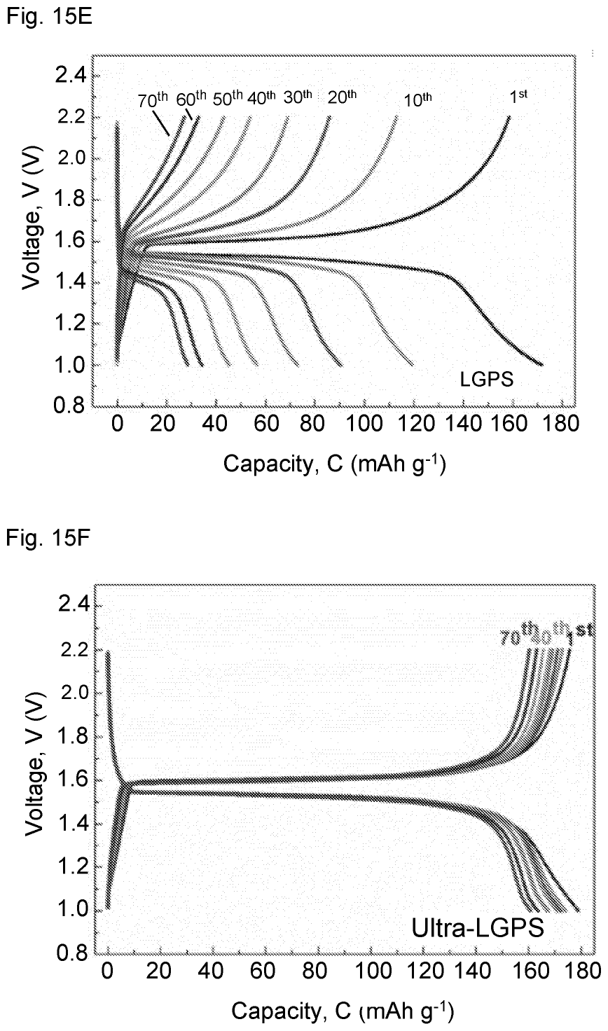

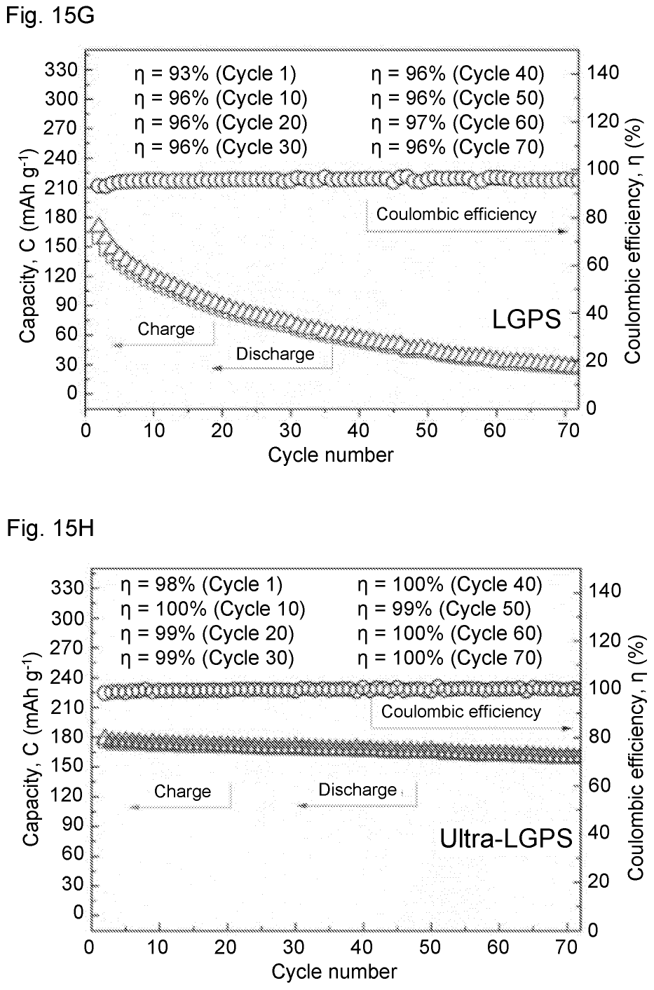

The electrochemical stabilities of non-constricted LGPS and constricted ultra-LGPS were evaluated using cyclic-voltammetry (CV) measurements of Li/LGPS/LGPS+C/Ta (FIG. 15A) and Li/ultra-LGPS/Ta (FIG. 15B) cells respectively, with a lithium reference electrode at a scan rate of 0.1 mVs-1 and a scan range of 0.5-5V. Carbon was introduced here to measure the intrinsic electrochemical stability window of the electrolytes without kinetic compromise.¹² For LGPS, oxidation peaks at 2.4V and 3.7V are observed during charging and multiple peaks below 1.6V are observed during discharging. These redox peaks can be attributed to the solid-solid phase transition of Li—S and Ge—S components in LGPS²⁴, confirming that LGPS is unstable and severe decomposition occurred during cycling.

In contrast, the decomposition of ultra-LGPS was largely suppressed, manifested by only one minor oxidation peak at a higher voltage (3V) during charging, and almost no reduction peak during discharging (FIG. 15B). In fact, the higher stability of ultra-LGPS is also confirmed by the sensitive electrochemical impedance spectra (EIS) before and after CV tests (FIGS. 15C, 15D). The EIS shows a typical Nyquist plot of battery-like behavior with charge-transfer semicircles in the medium frequency and a diffusion line in the low frequency. The results show that the total impedance of LGPS composite increased from 300Ω to 620Ω (107% increase) after 3 cycles of CV test (FIG. 15C), while that of ultra-LGPS composite only increases by 32% (from 250Ω to 330Ω, FIG. 15D). The smaller increase of impedance after cycling indicates that ultra-LGPS is more stable so that less solid phases and grain boundaries are generated due to decomposition.

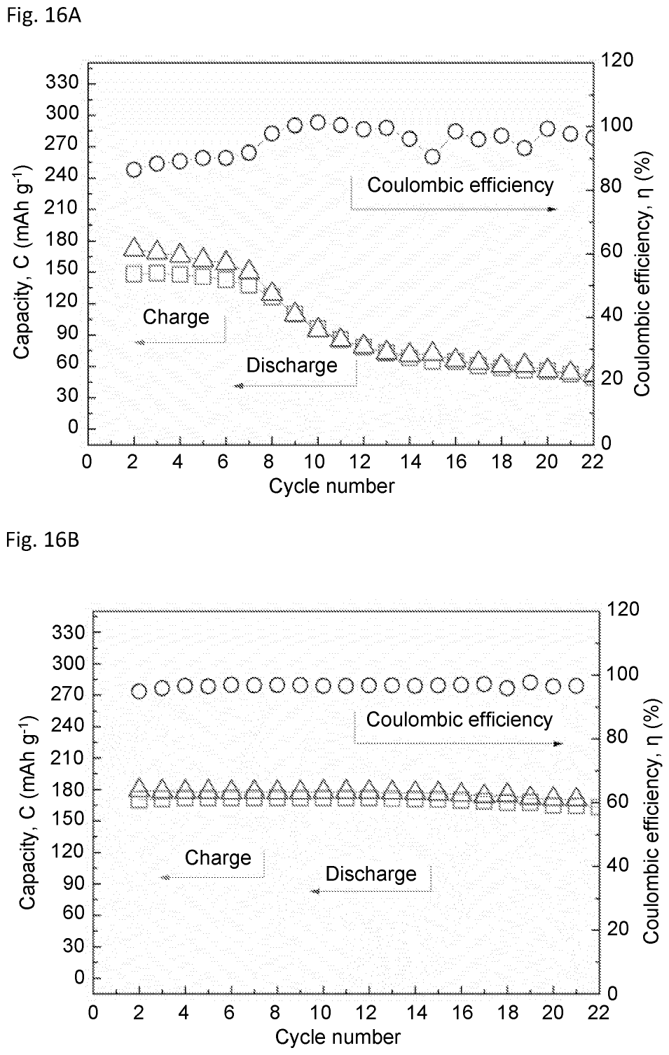

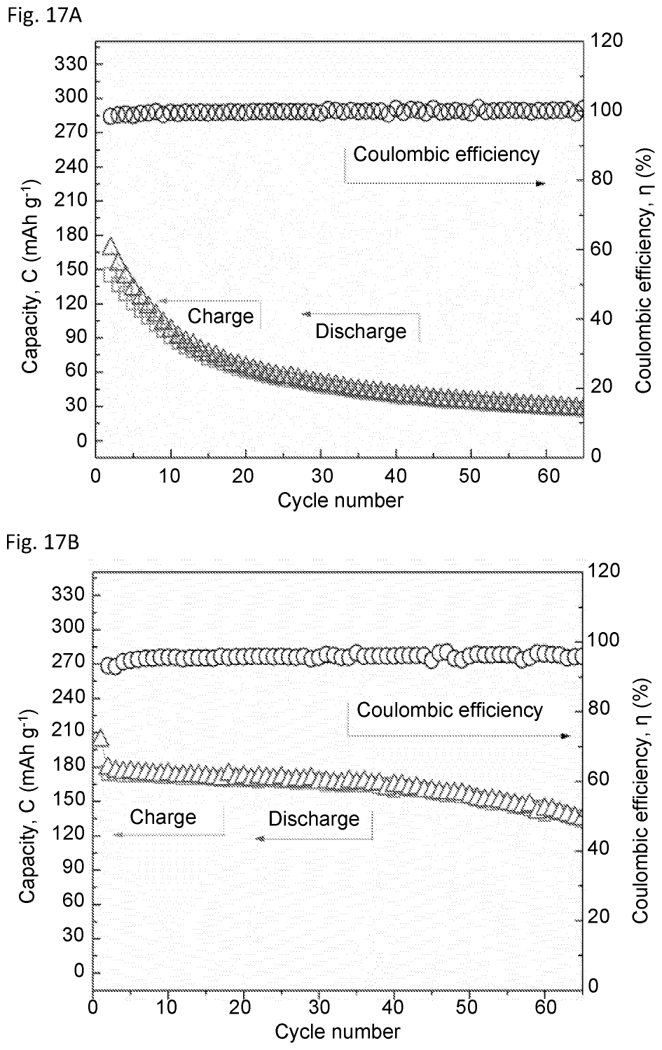

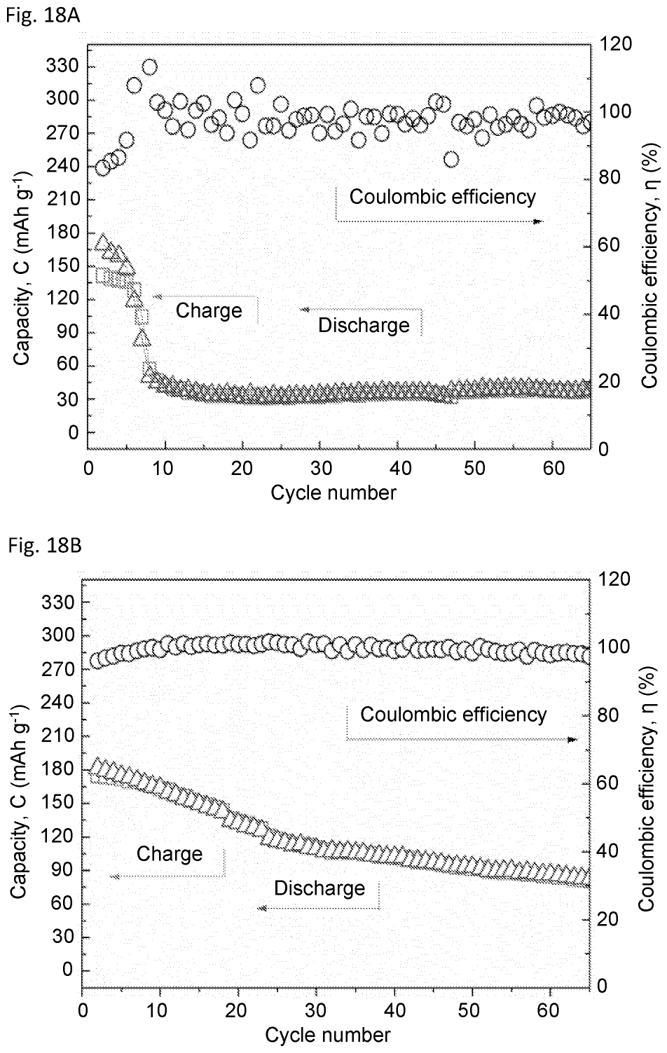

These stability advantages of ultra-LGPS over LGPS were found to be even more prominent when implemented in an all-solid-state half-cell battery. The cycling performance was measured for Li₄T₅O₁₂ (LTO) mixed with carbon and either ultra-LGPS or LGPS as a cathode, ultra-LGPS or LGPS as a separator, and lithium metal as the anode. The cycling performance of each configuration was taken at low (0.02C), medium (0.1C), and high (0.8C) current rates. The results, depicted in FIGS. 16A-18B, show that the cycling stability of the ultra-LGPS based half-cells substantially outperforms that of the LGPS based half-cells.

To isolate the decomposition of LGPS in the LTO cathode composite, the solid-electrolyte layers were replaced by a glass fiber separator. FIG. 15E shows the charge-discharge profiles of LGPS (LTO+LGPS+C/Glass fiber separator/Li) cycled at 0.5C in the voltage range of 1.0-2.2 V. A flat voltage plateau at 1.55 V appeared for 70 cycles, which can be ascribable to the redox of titanium. However, the plateau length decreases from cycle 1 to cycle 70 by almost 85.7%, indicating a large decay of the cathode. On the other hand, ultra-LGPS (LTO+ultra-LGPS+C/Glass fiber separator/Li) (FIG. 15F) shows the same flat voltage plateau remaining almost unchanged after 70 cycles. This increase in cathode stability is further confirmed by the cyclic capacity curves (FIGS. 15G and 15H). For LGPS, the specific charge and discharge capacities decrease from ˜159 mAh/g to ˜27 mAh/g, and ˜170 mAh/g to ˜28 mAh/g, respectively, after 70 cycle. However, ultra-LGPS demonstrates a much better cyclic stability than its LGPS counterpart. After 70 cycles the discharge capacity is still as high as 160 mAh/g, with only roughly 5% of capacity loss.

In each of these results, those ultra-LGPS particles with core-shell morphologies have outperformed the stability of LGPS counterparts. As discussed in ref²², core-shell designs are proposed to stabilize ceramic-sulfide solid-electrolytes via the volume constraint placed on the core by the shell. This experimental electrochemical stability data agrees with this theory. Sulfur deficient shells, as seen in the case of ultra-LGPS, are expected to lower the effective compressibility of the system and hence increase the volume constraint²². The solid-state half-cell (solid-state cathode+glass fiber/liquid electrolyte+lithium metal anode) performance in the voltage range of 1-2.2 V vs lithium demonstrates that ultra-LGPS has, in practice, improved stability over LGPS in the cases of both LGPS oxidation and reduction. Additionally, the Coulombic efficiency of ultra-LGPS is also higher than that of LGPS, indicating an improved efficiency of charge transfer in the system, and less charge participation in unwanted side reactions.

Decomposition Mechanism

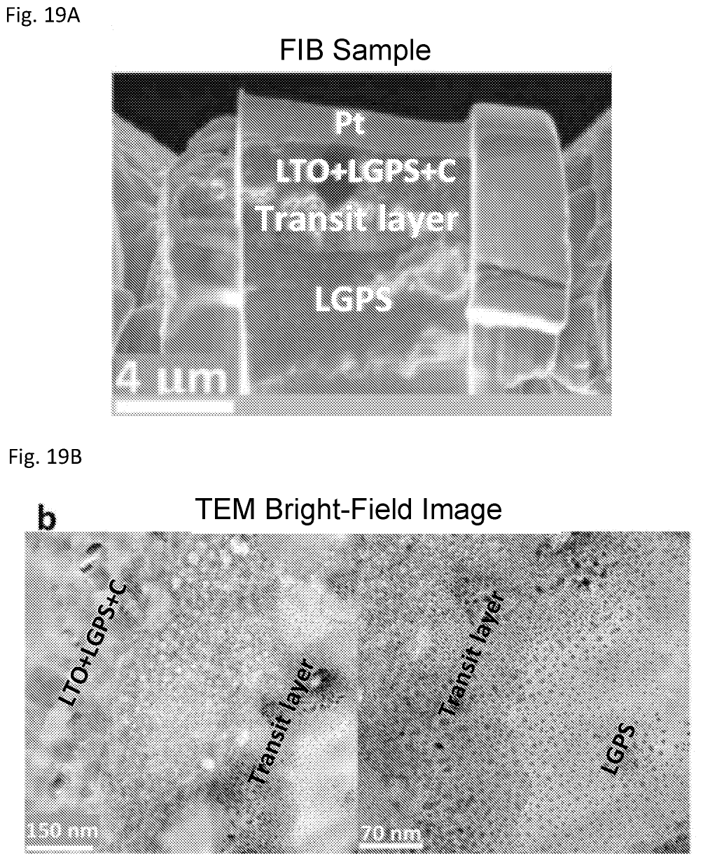

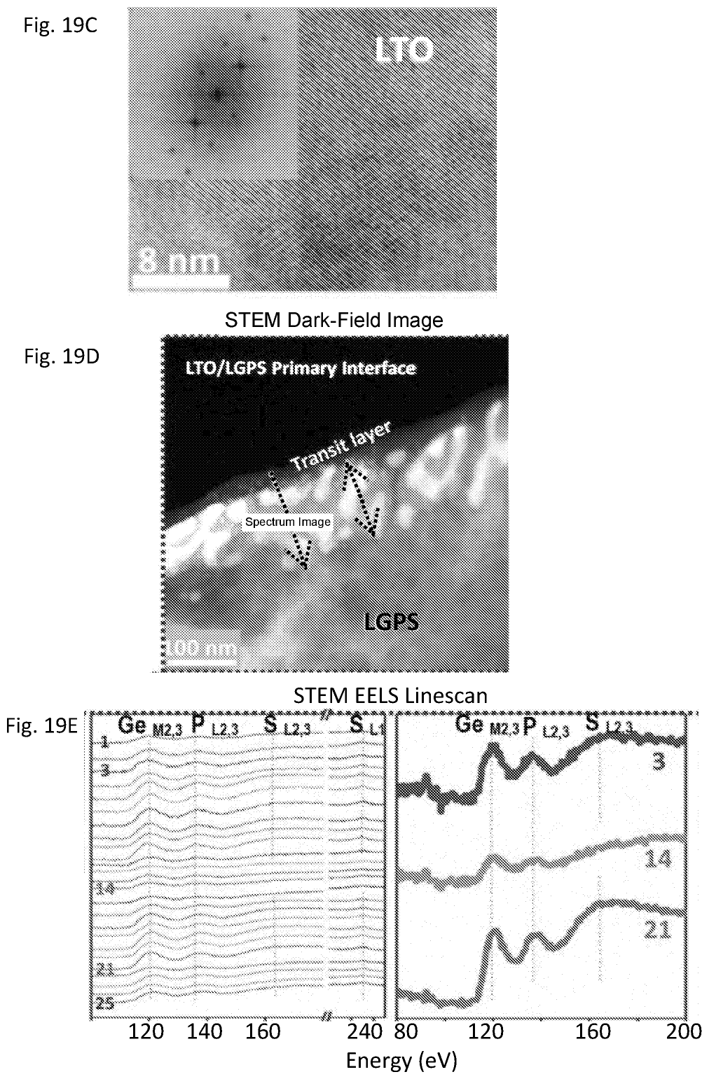

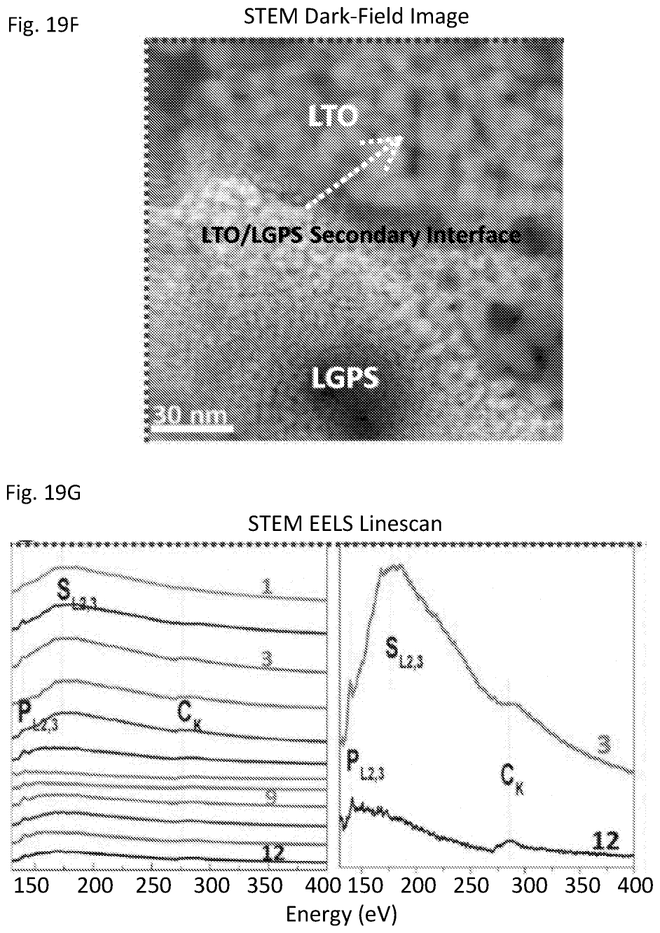

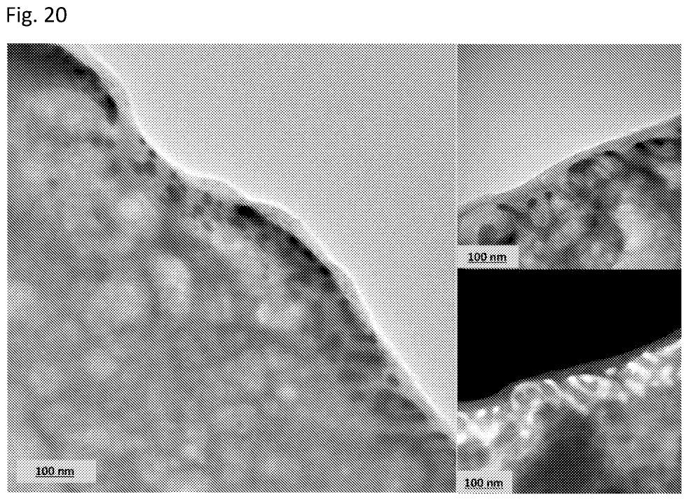

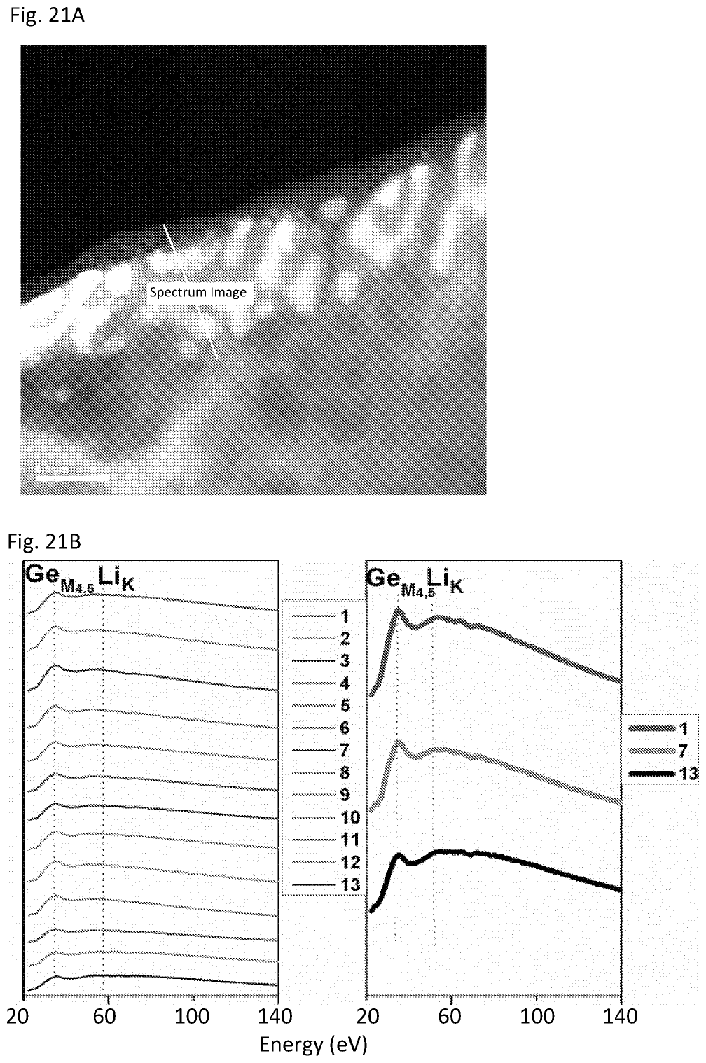

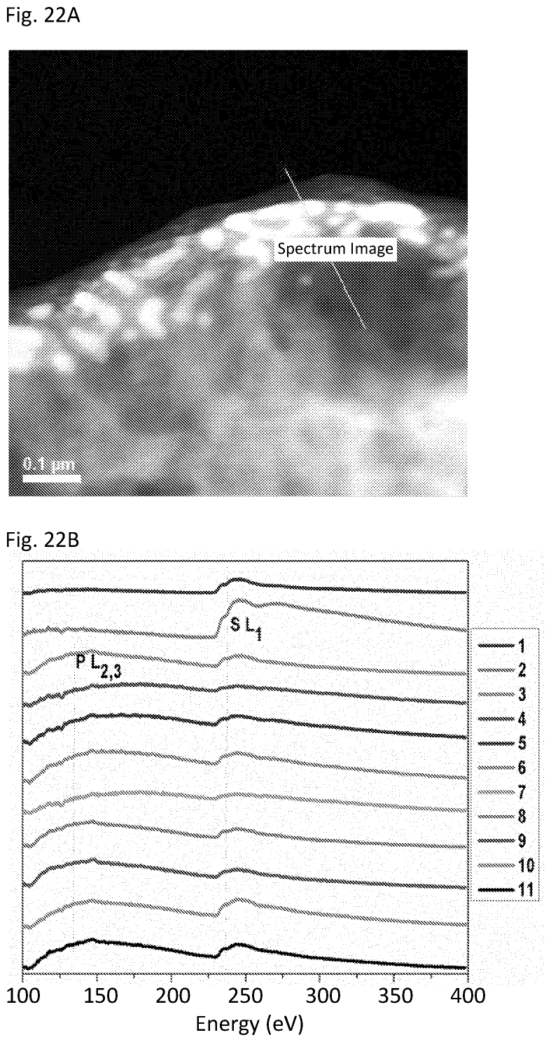

To better understand the mechanism by which LGPS decomposes, TEM analyses were performed to study the microstructure of LTO/[ultra-]LGPS interfaces after cycling. An FIB sample (FIG. 19A), in which the composite cathode (LTO+LGPS+C) and separating layer (LGPS) are included, was prepared after 1 charge-discharge cycle versus a lithium metal anode. A platinum layer was deposited onto the cathode layer during FIB sample preparation for protection from ion beam milling. A transit layer with multiple small dark particles exists at the cathode/separator interface (hereafter “LTO/LGPS primary interface), as manifested in the TEM bright-field (BF) images (FIG. 19B, FIG. 20) and STEM dark-field (DF) images (FIG. 19D, FIG. 20). The particles within the transit layer of STEM DF images show bright contrast, indicating the accumulation of heavy elements. To understand the chemical composition of this transit layer, STEM EELS (electron energy loss spectroscopy) line-scans were performed. The EELS spectra show that Liₖ, Ge_{M4,5} (FIGS. 21A-21B), Ge_{M2,3} and P_{L2,3} (FIG. 15E) peaks exist throughout the transit layer, but sulfur peaks (S_{L2,3}, S_{L1}) only show up inside the bright particles, and are absent in the regions outside the bright particles (EELS spectra 12-14 in FIG. 15E). This observation indicates that the bright particles within the transit layer are sulfur-rich, which is not only supported by the bright contrast in STEM image (sulfur is the heaviest element among Li, Ge, P and S), and EELS line-scan observation (FIGS. 19E, 21A, 21B, 22A, and 22B), but also corroborated by previous studies¹² reporting that the decomposition products of LGPS will be sulfur-rich phases including S, LiS, P₂S₅ and GeS₂.

Since the composite cathode layer is composed of LTO, LGPS and C, there will be minor LTO/LGPS interfaces (hereafter “LTO/LGPS secondary interface”) that are ubiquitous within the cathode layer. FIG. 19F demonstrates the typical STEM DF image of LTO/LGPS secondary interfaces, in which bright particles with similar morphology show up again. The density of such bright particles is much higher, due to higher carbon concentration within cathode layer and thus facilitated LGPS decomposition. The corresponding STEM EELS line-scan spectra (FIG. 19G) show that strong S_{L2,3} peaks exist at the interface region, corroborating again that the bright particles are sulfur-rich. Therefore, sulfur-rich particles exist at both primary and secondary LTO/LGPS interfaces in LGPS half-cells after 1 charge-discharge cycle.

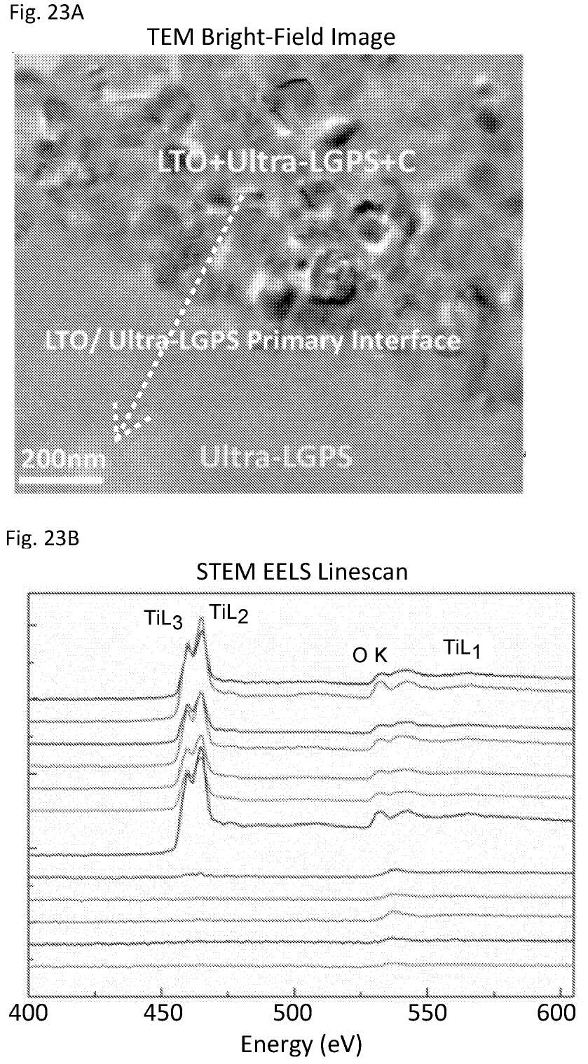

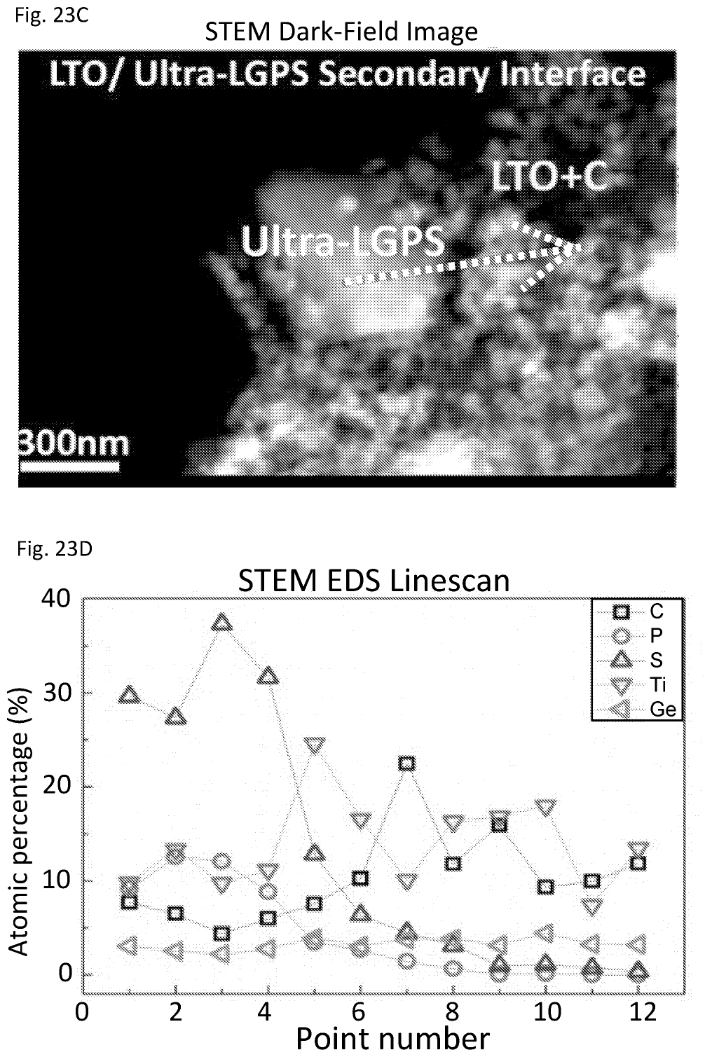

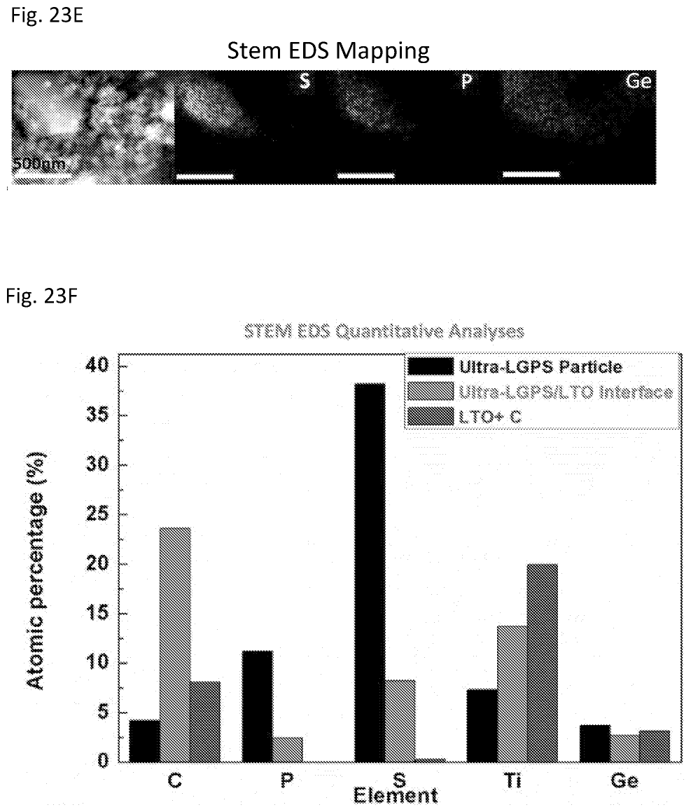

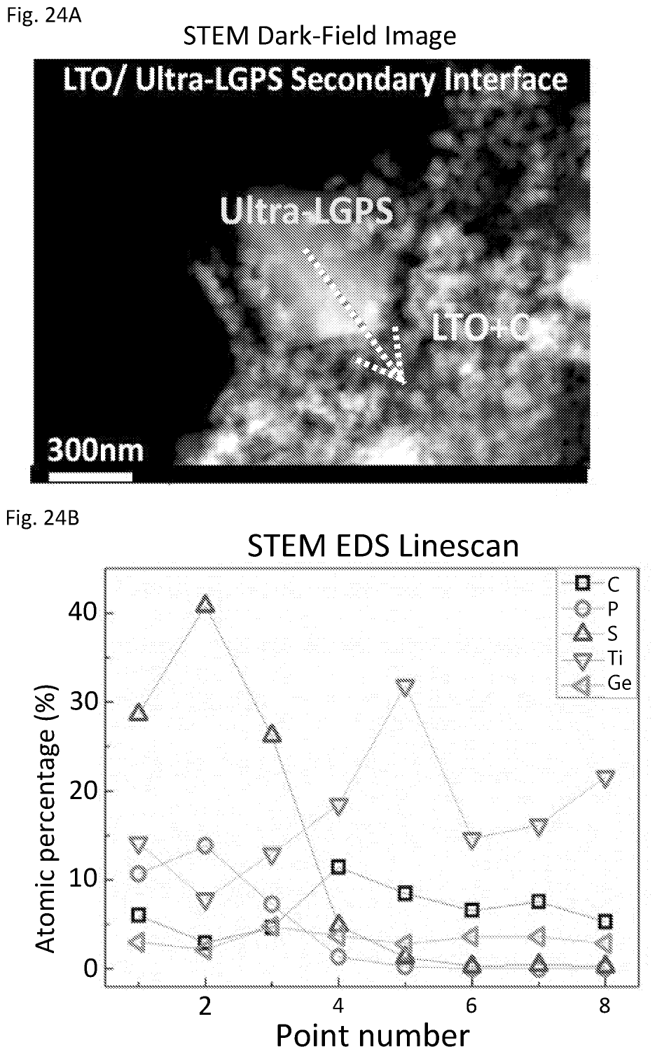

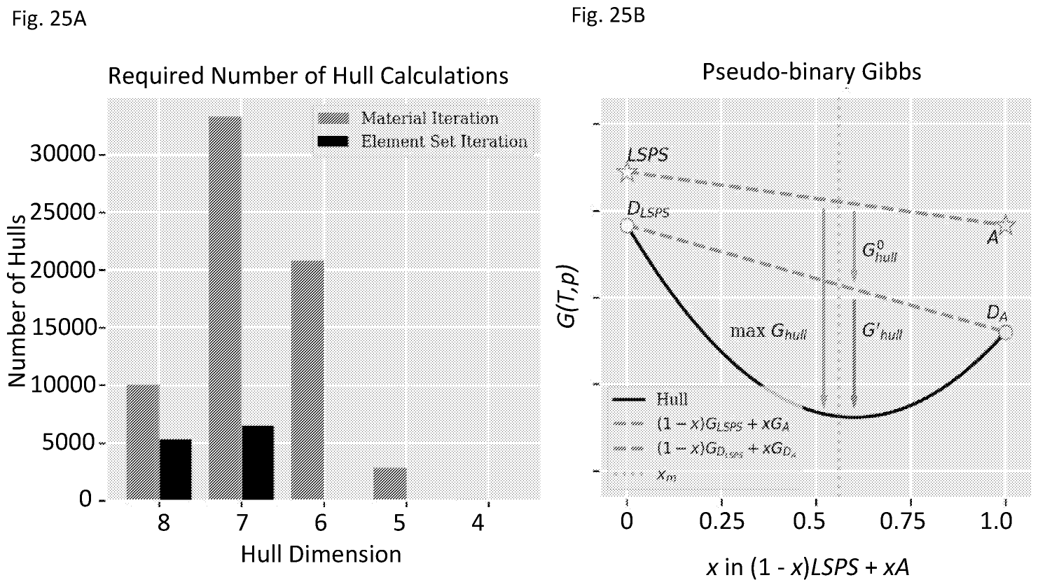

As comparison, FIGS. 23A-23F show the microstructural and compositional (S)TEM studies for ultra-LGPS half-cells. The primary LTO/ultra-LGPS interface after 1 charge-discharge cycle was characterized by TEM BF image (FIG. 23A). A smooth interface was observed between the ultra-LGPS separating layer and the composite cathode layer (FIG. 23B). The primary LTO/ultra-LGPS interface is clean and uniform, showing no transit layer or dark particles. The secondary LTO/ultra-LGPS interfaces were also investigated for comparison by STEM DF image, EDS line-scan and EDS mapping (FIGS. 23C-23E). Results show that the atomic percentage of sulfur continuously decreases, as the STEM EDS line-scan goes from inner ultra-LGPS particle to secondary LTO/ultra-LGPS interface, and finally into LTO+C composite region (FIG. 23D and FIGS. 24A, 24B). In other words, the sulfur-deficient-shell feature of ultra-LGPS particles is maintained after cycling, and no sulfur-rich transit layer is formed at the LTO/ultra-LGPS secondary interface. STEM EDS quantitative analyses (FIG. 23F) show that the atomic percentage of sulfur inside ultra-LGPS particle is as high as ˜38%, while that of secondary LTO/ultra-LGPS interface is as low as 8%.

These results suggest that the nucleation limit is a more faithful representation of the true decay process than the hydrostatic limit. The sulfur rich particles formed in LGPS have a length scale on the order of Rᵢ≈20 nm. In ultra-LGPS, the shell thickness is also roughly l≈20 nm. Hence if we consider the formation of such a sulfur particle near the core-shell boundary in ultra-LGPS, the minimum distance from the center of the sulfur rich particle to the exterior of the shell is Rₒ=Rᵢ+l≈40 nm. In this case R≈8Rᵢ³ which satisfies the condition Rᵢ<<Rₒ needed to apply the nucleated model. In summary, we know that the LGPS decays via a mechanism that leads to nucleation of sulfur rich particles on the surface. We also know that applying a shell layer with a thickness such that l≈Rᵢ inhibits such decay. These results suggest that the pristine core-shell state is at least metastable with respect to the decay towards the state with nucleated decay just below the core-shell interface.

Conclusions

In summary, we have developed a generalized strain model to show how mechanical constriction, given the nature of LGPS to expand upon decay, can lead to metastability in a significantly expanded voltage range. The precise level to which constriction expands the voltage window is depended on the morphology of the decay. We performed a theoretical analysis of two limits of the decay morphology, the minimally and maximally localized cases. The minimally localized case consisted of a mean field theory where every part of the particle decays simultaneously, whereas the maximally localized case consisted of a nucleated decay. It was demonstrated that, while the maximally localized case was best, both cases had the potential for greatly expanding the stability window. We also developed a theory for the role of an electrically insulating passivation layer in such a stain-stabilized system. This model suggests that such passivation layers aid in stability by keeping lithium ions localized within the particle, maximizing the reaction strain.

Experimental results for the stability performance of LGPS before and after the adding of a constricting shell supports this theory. After the formation of shell via ultrasonication, LGPS demonstrated remarkably improved performance cyclic voltammetry, solid-state battery cycling, and solid-state half-cell cycling. Because the shell was applied in a post-synthesis approach, chemical differences between the core-shell and pure LGPS samples, which might otherwise affect stability, were kept to a minimum. The core-shell is believed to be an instance of mechanically constrained LGPS as during any decomposition, the LGPS core will seek to expand whereas the shell will remain fixed. In order words, the shell provides a quasi-isovolumetric constraint on the core dependent on the biaxial modulus of the shell and the particle geometry.

Analysis of the decay morphology found in LGPS particles but not in ultra-LGPS particle suggests that the nucleated decay limit more accurately reflects the true thermodynamics. It was found that, in LGPS, nucleated sulfur-rich decay centers were embedded in the surface of the LGPS particles after cycling. Further, these nucleated decay centers were not found in the cycled ultra-LGPS. The ultra-LGPS maintained a shell thickness comparable to the decay cites in LGPS (approximately 20 nm), which was predicted to be sufficient for the high level of stabilization afforded by the nucleated model. These results, combined with the improved stability of ultra-LGPS, indicate that not only is strain-stabilization occurring, but that the magnitude at which it is occurring is dominated by maximally localized decay mechanism. This is a promising result as such nucleated decay has been shown to provide a larger value of ∂ₓ_{_{D}}Gₛₜᵣₐᵢₙ, opening up the door to solid-state batteries that operate at much higher voltages than what has been reported to date.

Methods

Sample Preparation

LGPS powder was purchased from MSE Supplies company. Ultra-LGPS was synthesized by soaking LGPS powder into organic electrolytes, such as dimethyl carbonate (DMC) and diethyl carbonate (DEC), and then sonicated for 70h in Q125 Sonicator from Qsonica company, a microprocessor based, programmable ultrasonic processor

Electrochemistry

The cyclic voltammograms (CV) of Li/LGPS/LGPS+C/Ta and Li/ultra-LGPS/ultra-LGPS/Ta cells were measured between 0.5 to 5 V at a scan rate of 0.1 mVs⁻¹ on a Solartron electrochemical potentiostat (1470E), using lithium as reference electrode. The electrochemical impedance spectrums of Li/LGPS/LGPS+C/Ta and Li/ultra-LGPS/ultra-LGPS/Ta cells were measured at room temperature both before and after CV tests, by applying a 50 mV amplitude AC potential in a frequency range of 1 MHz to 0.1 Hz. The composite cathode used were prepared by mixing LTO, (ultra-)LGPS, polyvinylidene fluoride (PVDF) and carbon black with a weight ratio of 30:60:5:5. This mixture of powders was then hand-grinded in a mortar for 30 minutes and rolled into a thin film inside an argon-filled glove box. SEs were prepared by mixing (ultra-)LGPS and PVDF with a weight ratio of 95:5, then hand-grinding the mixed powder in a mortar for 30 minutes and finally rolling it into a thin film inside an argon-filled glove box. To assemble a solid-state cell, the prepared composite cathode thin film, (ultra-)LGPS thin film, and Li metal foil were used as cathode, solid electrolyte, and the counter electrode, respectively. The thin films of composite cathode and (ultra-)LGPS were cold-pressed together before assembling into the battery. A piece of glass fiber separator was inserted between (ultra-)LGPS thin film and Li metal foil to avoid interfacial reaction between these two phases. Only 1 drop of 1 M LiPF6 in ethylene carbonate (EC) and dimethyl carbonate (DMC) solution (1:1) was carefully applied onto the glass fiber to allow lithium ion conduction through the separator. Swagelok-type cells were assembled inside an argon-filled glove box. Assembling process of an (ultra-)LGPS battery is the same with that of an (ultra-)LGPS solid-state battery, except that the (ultra-)LGPS δE layer is removed. The charge/discharge behavior was tested using an ArbinBT2000 workstation (Arbin Instruments, TX, USA) at room temperature. The specific capacity was calculated based on the amount of LTO (30 wt %) in the cathode film.

Characterization

For FIB sample preparation, the cold-pressed thin film of composite cathode and (ultra-)LGPS after 1 charge-discharge cycle in (ultra)LGPS solid-state battery was taken out inside an argon-filled glove box. It was then mounted onto a SEM stub and sealed into a plastic bag inside the same glove box. FIB sample preparation was conducted on an FEI Helios 660 dual-beam system. The prepared FIB sample was then immediately transferred into JOEL 2010F for TEM and STEM EDS/EELS characterization.

Density Functional Theory Calculations

In order to allow comparability with the Material Project crystal database, all DFT calculations were performed using the Material Project criteria. All calculations were performed in VASP using the recommended Projector Augmented Wave (PAW) pseudopotentials. An energy cutoff of 520 eV with k-point mesh of 1000/atom was used. Compressibility values were found by discretely evaluating the average compressibility of the material between 0 GPa and 1 GPa. Enthalpies were calculated at various pressures by applying external stresses to the stress tensor during relaxation and self-consistent field calculations

### Example 3—Computational Method to Select Optimum Interfacial Coating

Like liquid counterparts, the key performance metrics for solid-electrolytes are stability and ionic conductivity. For lithium systems, two very promising families of solid-electrolytes are garnet-type oxides and ceramic sulfides. These families are represented, respectively, by the high-performance electrolytes of LLZO oxide and LSPS sulfide. Oxides tend to maintain good stability in a wide range of voltages but often have lower ionic conductivity (<1 mS cm⁻¹)¹. Conversely, the sulfides can reach excellent ionic conductivities (25 mS cm⁻¹)^{6,20} but tend to decompose when exposed to the conditions needed for battery operation.

Instabilities in solid-electrolytes can arise from either intrinsic material-level bulk decompositions or surface/interfacial reactions when in contact with other materials. At the materials-level, solid-electrolytes tend to be chemically stable (i.e. minimal spontaneous decomposition) but are sensitive to electrochemical reactions with the lithium ion reservoir formed by a battery cell. The voltage stability window defines the range of the lithium chemical potential within which the solid-electrolyte will not electrochemically decompose. The lower limit of the voltage window represents the onset of reduction, or the consumption of lithium ions and the corresponding electrons, whereas the upper limit represents the onset of oxidation, or the production of lithium ions and electrons. The voltage window affects the bulk of any solid-electrolyte particle as the applied voltage is experienced throughout. While interfacial reactions occur between the solid-electrolyte and a second ‘coating’ material at the point of contact, these reactions can either be two-bodied chemical reactions, where only the solid-electrolyte and the coating material are reactants, or three-bodied electrochemical reactions, in which the solid-electrolyte, coating material and the lithium ion reservoir all participate. The two types of reactions are state-of-charge or voltage independent and dependent, respectively, as determined by the participation of the lithium ion reservoir.

Prior studies have revealed that the most common lithium ion electrode materials, such as LiCoO₂ (LCO) and LiFePO₄ (LFPO), form unstable interfaces with most solid electrolytes, particularly the high performance ceramic sulfides. Successful implementation of ceramic sulfides in solid-state batteries may employ suitable coating materials that can mitigate these interfacial instabilities. These coating materials may be both intrinsically electrochemically stable and form electrochemically stable interfaces with the ceramic sulfide in the full voltage range of operation. In addition, if different solid-electrolytes are to be used in different cell components for maximum material-level stability, then the coating materials may also change to maintain chemically stable interfaces.

In short, the choice of a coating material depends on both the type of solid-electrolyte and the intended use of operation voltage (anode film, separator, cathode film, etc.). Pseudo-binary computational methods can approximately solve for the stability of a given interface, but are computationally expensive and have not yet been developed in very-large scale. A major performance bottleneck for high-throughput analysis of interfacial stability has been the cost to construct and evaluate many high-dimensional convex hulls. In the case of material phase stability, the dimensionality of the problem is governed by the number of elements. For example, calculating the interfacial chemical stability of LSPS and LCO would require a 6-dimensional hull corresponding to the set of elements {Li, Si, P, S, Co, O}. The electrochemical stability of this interface is calculated with the system open to lithium, so that lithium is removed from the set and the required hull becomes 5-dimensional ({Si, P, S, Co, O}).

Here we introduce new computational schemata to more efficiently perform interfacial analysis and hence enable effective high-throughput search for appropriate coating materials given both a solid-electrolyte and an operation voltage range. We demonstrate these schema by applying them to search through over 67,000 material entries from the Materials Project (MP) in order to find suitable coating materials for LSPS, which has shown the highest lithium conductivity of around 25 mS cm⁻¹ , in the cases of both anode and cathode operations. Coating material candidates that are both intrinsically stable at the material level and form stable interfaces with LSPS within the prescribed voltage range are termed “functionally stable.”

To establish standards, we focus on finding anode coating materials which are functionally stable in a window of 0-1.5 volts versus lithium metal and cathode coating materials which are functionally stable in a window of 2-4 volts versus lithium metal. These voltage ranges are based on cycling ranges commonly found in today's lithium ion batteries. Within the anode range, we are particularly interested in finding materials that are stable at 0 volts versus lithium metal, as it could enable the use of lithium as a commercial anode material.

Due to remaining computational limitations, this work focuses only on those materials that require an LSPS interfacial hull-dimensionality of less than or equal to 8. In other words, materials were only considered if the elements present in that material consisted of {Li, Si, P, S} plus up to four additional elements. A total of 69,640 crystal structures in the MP database were evaluated for material-level voltage windows. Of those, 67,062 materials satisfied the less than 8-dimensional requirement and were accordingly evaluated for functional stability with LSPS. In total, over 1,000 MP entries were found to be functionally stable in the anode range and over 2,000 were functionally stable in the cathode range for LSPS. Experimental probing of interfacial stability is used for select materials to confirm these predictions.

Results and Discussion

Data Acquisition and Computational Efficiency

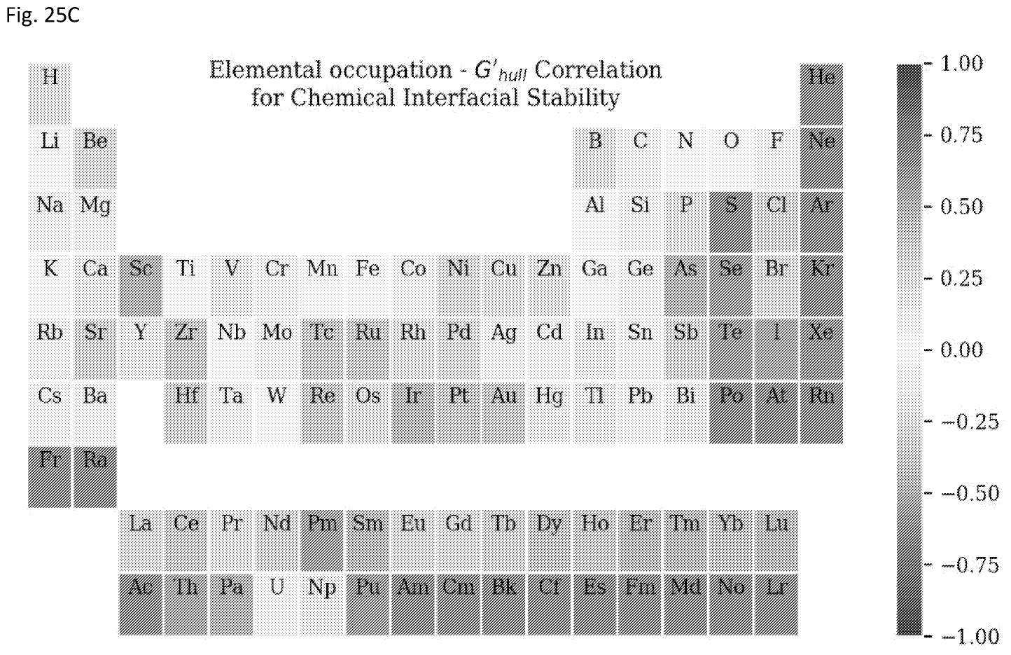

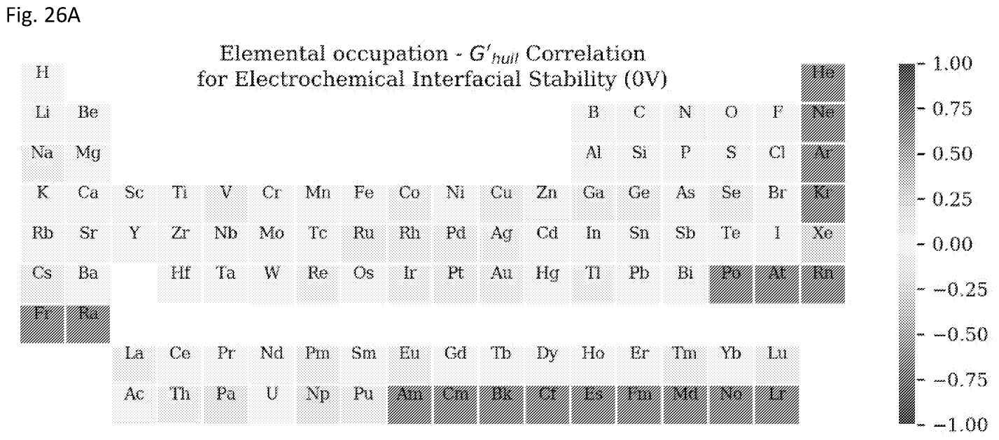

To efficiently evaluate the stability of the interface between each of these 67,062 potential coating materials and LSPS, two new computational schemata were developed. To minimize the number of hulls that must be calculated, the coating materials were binned based on elemental composition. Each unique set of elements requires a different hull, but elemental subsets can be simultaneously solved. For example, the calculation of interfacial stability between LSPS and iron-sulfate (Fe₂(SO₄)₃) requires solving for the convex hull of the 6-dimensional element set {Li, Si, P, S, Fe, O}. This hull is the same hull that must be calculated for the interface with LFPO and includes, as a subset, the 5-dimensional hull needed for the evaluation of iron-sulfide (FeS). To capitalize on this, rather than iterate through each of the 67,062 materials and calculate the hull needed for that material, the minimum number of elemental sets that spans the entirety of the materials were determined (FIG. 25A). Then for each elemental set, only one hull is needed to evaluate all of materials that can be constructed using those elements. This approach reduces the total number of hulls needed from 67,062 (one per material) to 11,935 (one per elemental set). As seen in FIG. 25A, few hulls with a dimensionality below 7 were needed. Those compounds that would otherwise require a low dimensional hull are solved as a subset of a larger element set. Additionally, the number of required 7 and 8 dimensional hulls are largely reduced due to multiple phases of the same compositional space requiring the same hull.

The second schema used to minimize computational cost was a binary search algorithm for determining the pseudo-binary once a hull was calculated. The pseudo-binary approach is illustrated in FIG. 25B. Since decomposition at an interface between two materials can consume an arbitrary amount of each material, the fraction of one of the two materials (x in equation 1) consumed can vary from 0-1.

(1−x)LSPS+xA→dᵢDᵢ (1)

The pseudo-binary is a computational approach that determines for which value of x the decomposition described by equation 1 is the most kinetically driven (e.g. when is the decomposition energy the most severe). The RHS of equation 1 represents the fraction ({dᵢ}) of each of the thermodynamically favored decay products and defines the convex hull for a given x in terms of the products' Gibbs energies (Hull(x)=Σdᵢ(x)Gᵢ). The total decomposition energy accompanying equation 1 is:

Gₕᵤₗₗ(x)=Σdᵢ(x)Gᵢ−(1−x)G_{LGPS}−xG_{A} (2)

The most kinetically driven reaction between LSPS and the coating material is the one that maximizes the magnitude (i.e. most negative) of equation 2, which defines the parameter xₘ.

max|Gₕᵤₗₗ(x)|≡|Gₕᵤₗₗ(xₘ) (3)

This maximum decomposition energy is the result of two factors. The first, denoted Gₕᵤₗₗ⁰, is the portion of the decomposition energy that is due to the intrinsic instability of the two materials. In terms of the decomposed products of LSPS (D_{LSPS}) and the coating material (D_{A}), Gₕᵤₗₗ⁰(x) is the decomposition energy corresponding to the reaction (1−x)LSPS+xA→(1−x)D_{LSPS}+xD_{A}. By subtracting this materials-level instability from the total hull energy, the effects of the interface (G′ₕᵤₗₗ) can be isolated as defined in equation 4.

G′ₕᵤₗₗ(x)=Gₕᵤₗₗ(x)−Gₕᵤₗₗ⁰(x) (4)

Physically, Gₕᵤₗₗ⁰(x) represents the instability of the materials when separated and G′ₕᵤₗₗ(x) represents the increase in instability caused by the interface once the materials are brought into contact.

In this work, to determine the added instability of each interface at the most kinetically driven fraction (G′(xₘ)), we implement a binary search algorithm (see Methods) that uses the concavity of the hull to find xₘ to within 0.01% error. This binary search approach finds the xₘ value in 14 steps of hull evaluations. A more traditional linear evaluation of the hull to 0.01% accuracy would require 10,000 equally spaced evaluations from x=0 to x=1. This increase of speed is leveraged to efficiently search the 67,062 material entries for functional stability.

Functional Stability

Functional stability at a given voltage was determined for each of the 67,062 materials by requiring that (i) the material's intrinsic electrochemical stability per atom at that voltage was below thermal energy (|Gₕᵤₗₗ(x=1)|≤k_{B}T) and (ii) that the added interfacial instability at the given voltage was below thermal energy (|G′ₕᵤₗₗ(xₘ)|≤k_{B}T). Under these conditions, the only instability in the system is that of the LSPS intrinsic material-level instability, which can be stabilized via strain induced methods²². Of the 67 k materials, 1,053 were found to be functionally stable in the anode range (0-1.5 V vs. lithium metal) and 2,669 were found to be functionally stable in cathode range (2-4 V vs. lithium metal). Additionally, 152 materials in the anode range and 142 materials in the cathode range were determined to violate condition (i) but only decompose by lithiation/delithation. The practical use of such materials as an LSPS coating material depends on the reversibility of this lithiation/delithiation process, as such these materials are referred to as potentially functionally stable. All functionally stable and potentially functionally stable materials are cataloged in the supplementary information and indexed by the corresponding Materials Project (MP) id.

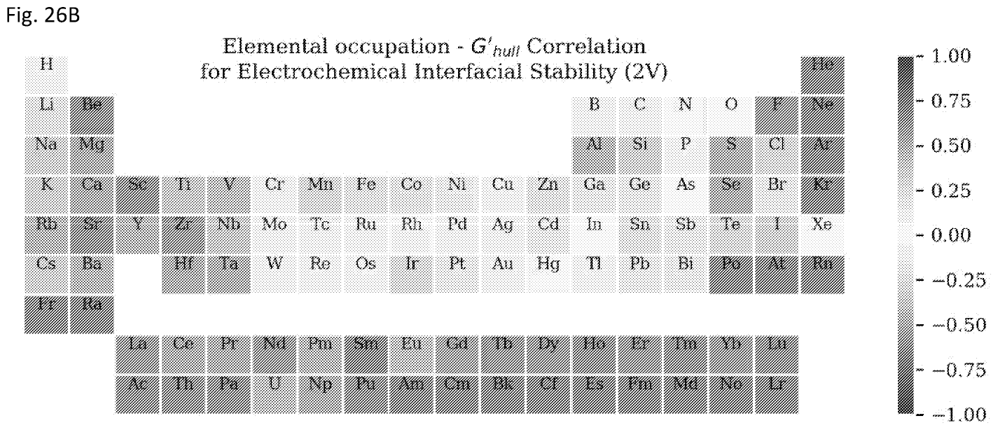

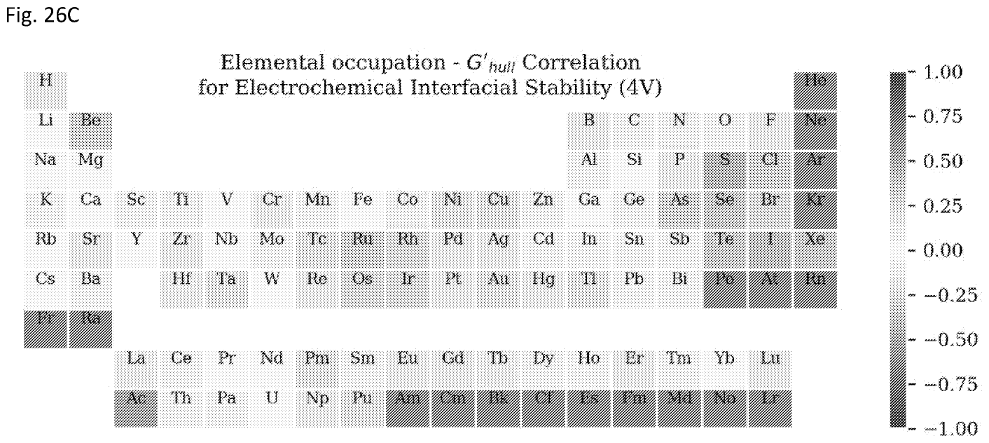

The correlation between each element's atomic fraction and the interfacial stability is depicted in FIG. 25C and FIGS. 26A-26C. FIG. 25C depicts the correlation of each element with G′ₕᵤₗₗ(xₘ) for chemical reactions whereas FIGS. 26A-26C depict the correlations with G′ₕᵤₗₗ(xₘ) for electrochemical reactions at 0, 2 and 4 V versus lithium metal, respectively. A negative correlation between elemental composition and G′ₕᵤₗₗ(xₘ) implies that increasing the content of that element improves the interfacial stability. FIG. 25C indicates that chemical stability is best for those compounds that contain large anions such as sulfur, selenium and iodine. In general, FIGS. 26A and 26C indicate that there is reduced correlation between elemental species and G′ₕᵤₗₗ(xₘ) at low and high voltages, respectively. This suggests that at these voltage extremes, the interfacial decomposition is dominated by intrinsic materials-level reduction/oxidation (Gₕᵤₗₗ⁰) rather than interfacial effects (G′ₕᵤₗₗ). At 2 V vs. lithium (FIG. 26B) positive correlation (higher instability) is seen for most elements with the notable exception of the chalcogen and halogen anion groups, which are negatively correlated.

Anionic Species Impact on Material-Level Stability

Given the high correlation contrast for anionic species with respect to interfacial stability, analysis of the dataset in terms of anionic composition was performed. To eliminate overlap between the datapoints, the only compounds that were considered were those that are either monoanionic with only one of {N, P, O, S, Se, F, 1} or oxy-anionic with oxygen plus one of {N, S, P}. 45,580 MP entries met one of these criteria as is outlined in Table 3. The percentage of each anionic class that was found to be electrochemically stable at the material-level is also provided.

TABLE 3
Sizes of monoanionic and oxy-anionic datasets and the percentage of each that is electrochemically stable in the
anode range (0-1.5 V) and the cathode range (2-4 V). For example, F represents all compounds that contain F in
the chemical formula, while O + N represents all compounds that contain both O and N in the chemical formula.

| Anion(s) | F | I | N | O | O + N | O + P | O + S | P | S | Se |
|---|---|---|---|---|---|---|---|---|---|---|
| Number | 2,902 | 911 | 1,808 | 24,241 | 1,171 | 7,469 | 1,220 | 982 | 3,150 | 1,726 |
| of Entries | | | | | | | | | | |
| Anode | 0.6% | 1.1% | 0.3% | 0.01% | 4.1% | 0.5% | 0.3% | 9.3% | 4.0% | 5.7% |
| Stable | | | | | | | | | | |
| (%) | | | | | | | | | | |
| Cathode | 17.3% | 13.4% | 12.5% | 5.7% | 83.9% | 64.8% | 13.3% | 35.7% | 73.9% | 55.8% |
| Stable | | | | | | | | | | |
| (%) | | | | | | | | | | |

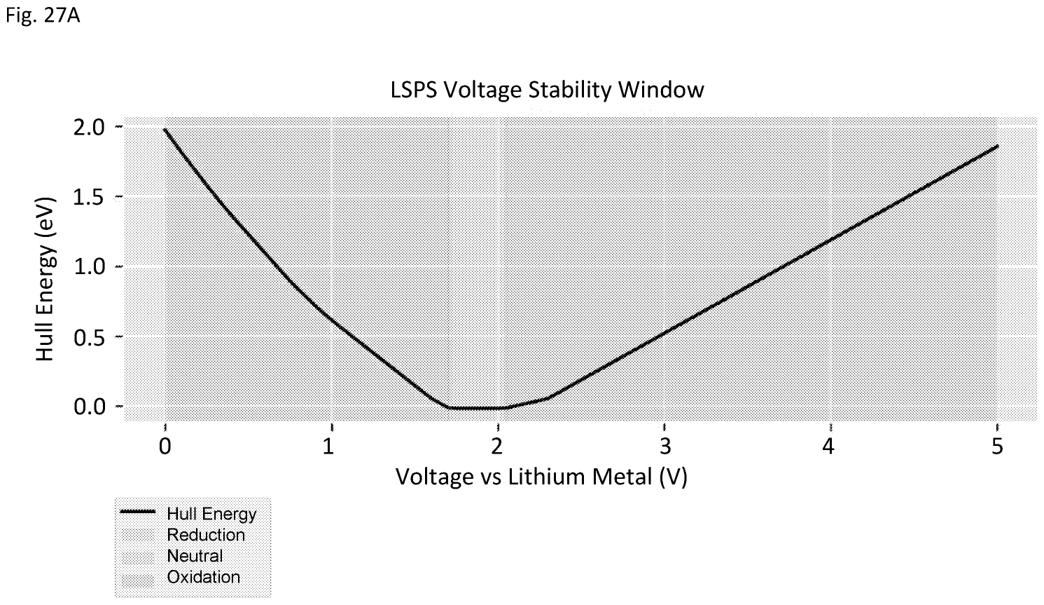

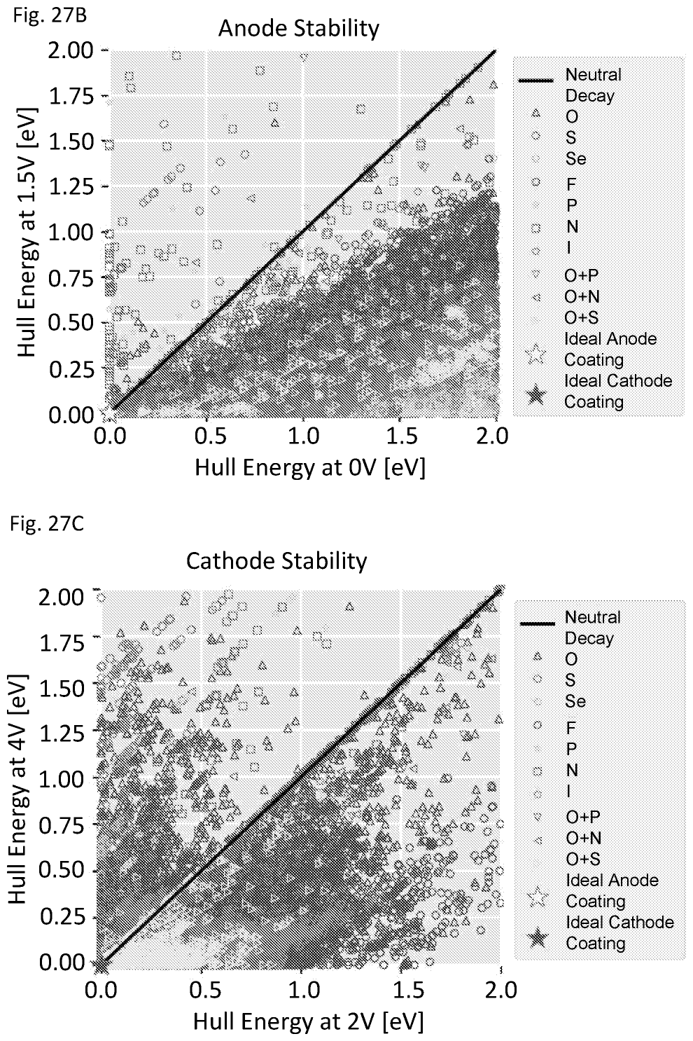

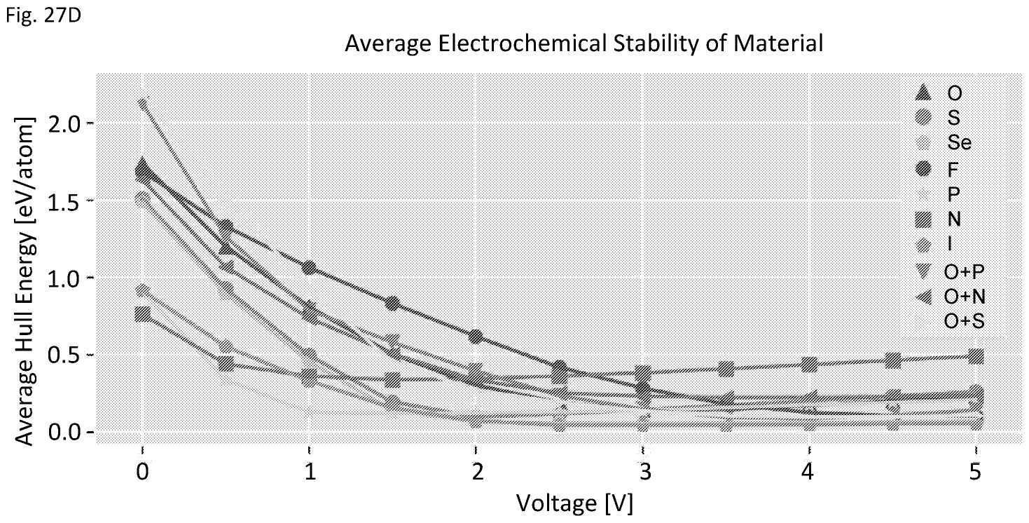

FIG. 27A illustrates the impact of applied voltage on the hull energy of a material, in this case LSPS. When the slope of the hull energy with respect to voltage is negative, the corresponding decomposition is a reduction, whereas it is an oxidation if the slope is positive. In the middle there is a region where the hull slope is zero, implying there is no reaction with the lithium ion reservoir (i.e. the reaction is neutral with respect to lithium). Considering this, FIGS. 27B and 27C plot the characteristic redox behavior of each anionic class in the anode and cathode ranges, respectively. The “neutral decay” line at 450 represents those compounds that have the same hull energy at both voltage extremes and hence aren't reacting with the lithium ions. Datapoints above [below] this line are increasing [decreasing] in hull energy with respect to voltage and are hence are characteristically oxidative [reductive] in the plotted voltage range.

FIG. 27B indicates that, in agreement with expectations, most compounds are reduced in the anode voltage range of 0-1.5 V vs. lithium metal. Nitrogen containing compounds are seen to disproportionately occupy the y-axis, indicating a higher level of stability when in direct contact with lithium metal. This is in line with prior computation work that indicates binary and ternary nitrides are more stable against lithium metal than sulfides or oxides³³. Within the cathode voltage range (FIG. 27C), however, much more variance in anionic classes is seen. The oxy-anionic and fluorine containing compounds remain principally reductive whereas the phosphorous, sulfide, and selenium containing compounds are characteristically oxidative. Oxygen containing compounds are found on both side of the neutral decay line, implying that oxides are likely to lithiate/delithiate in this 2-4V range.

The average hull energy of each anionic class is given in 0.5V steps from 0-5V in FIG. 27D. Nitrogen containing compounds are confirmed to be the most stable at 0V with iodine and phosphorous compounds maintaining comparable stability. Phosphorous and iodine surpass nitrogen in average stability for voltages above 0.5V and 1.0V, respectively. At high voltages (>4V), it is seen that fluorine and iodine containing compounds are stable whereas nitrogen containing compounds are the least stable.

Anionic Species Impact on Interface-Level Stability

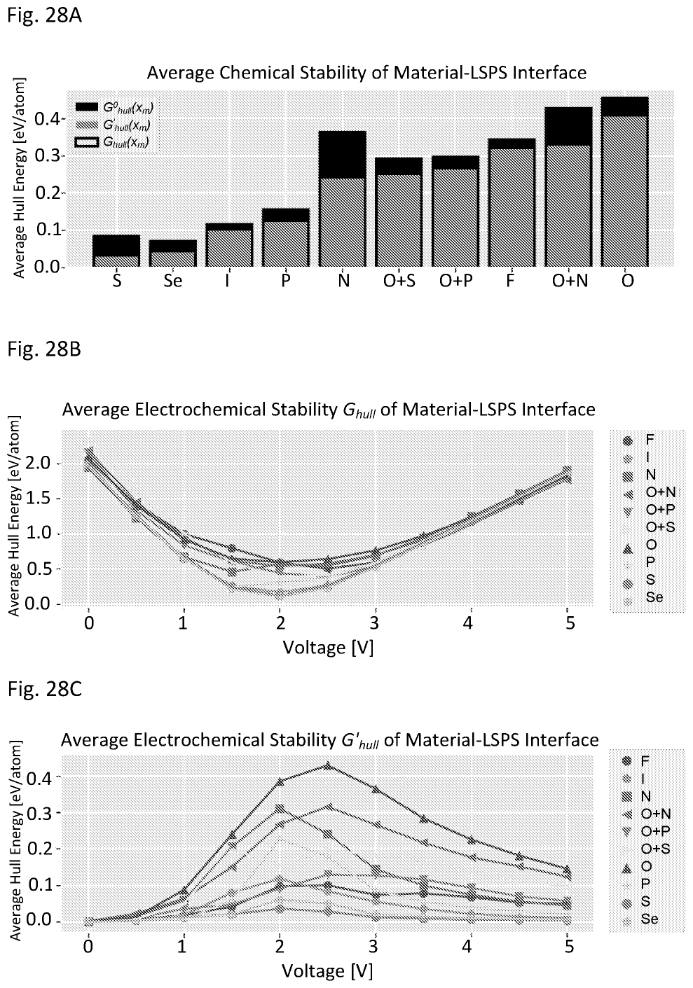

The average values of total decomposition energy (Gₕᵤₗₗ(xₘ)) and the fraction that is a result of the interface instability (G′ₕᵤₗₗ(xₘ)) are depicted in FIGS. 28A-28C for each anionic class. FIG. 28A shows the average instability due to chemical reactions between the anionic classes and LSPS. Sulfur and selenium containing compounds form, on average, the most chemically inert interfaces with LSPS. Conversely, fluorine and oxygen containing compounds are the most reactive. As a general trend, those compound classes that are more unstable in total terms (higher Gₕᵤₗₗ(xₘ)) also maintain a higher interfacial contribution (G′ₕᵤₗₗ(xₘ)) relative to the intrinsic material contribution (Gₕᵤₗₗ⁰(xₘ)). This implies that the difference of each class's intrinsic chemical stability plays a less significant role than its reactivity with LSPS in determining the chemical stability of the interface.

FIG. 28B shows the average total electrochemical decomposition energy for the interfaces in 0.5V steps from 0-5V. In general, each anionic class follows a path that appears to be dominated by the materials-level electrochemical stability of LSPS (FIG. 27A). This is particularly true in the low voltage (<1V) and high voltage (>4V) regimes, where electrochemical effects will be the most pronounced. The biggest deviations of the interfacial stability from LSPS's intrinsic stability occur in the region of 1-3V. Those compounds with the lowest chemical decomposition energies (compounds containing S, Se, I, P) deviate the least from LSPS within this ‘middle’ voltage range, while those with large decomposition energies (compounds containing N, F, O, O⁺) deviate more significantly. This trend suggests that the low and high voltage ranges are dominated by materials-level electrochemical reduction and oxidation, respectively, while the middle range is dominated by interface-level chemical reactions. For example, at 0V the interface between Al₂O₃ and LSPS is expected to decay to {Li₉Al₄,Li₂O,Li₃P,Li₂S,Li₂₁Si₅} which is the same set of decay products that would result from each material independently decomposing at 0V. Hence the existence of the interface has no energetic effect.

The average interface-level contribution for electrochemical decomposition is shown in FIG. 28C. All anionic classes trend to G′ₕᵤₗₗ(xₘ)=0 at 0V, implying that the materials tend to become fully reduced at 0V, in which case interfacial effects are negligible compared to material-level instabilities. Significant interfacial instabilities arise in the middle voltage range and lower again in the high voltages. Again, this implies that interface-level chemical effects are dominant in the middle voltage range whereas material-level reduction [oxidation] dominate at low [high] voltages. At high voltage, the interfacial contribution to the instability approaches the reaction energy between the maximally oxidized material and LSPS. As a result, for any voltage above 4V, the interface will add an instability of energy equal to this chemical reaction. This explains the high-voltage asymptotic behavior, whereas the low-voltage behavior always trends towards 0 eV atom⁻¹. For example, for any voltage above 4V, LFPO will decompose to {Li, FePO₄} whereas LSPS will decompose to {Li,P₂S₅,SiS₂,S}. The introduction of the interface allows these oxidized products to chemically react and form FeS₂ and SiO₂.

Anionic Species Impact of Functional Stability

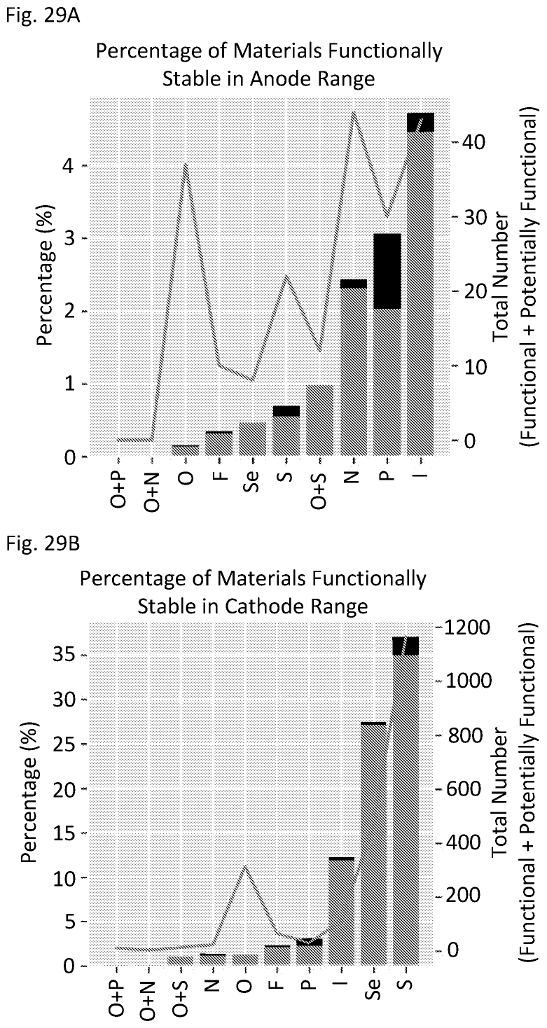

The total number of each anionic class that were determined to be functionally stable or potentially functionally stable are given in FIG. 29A (anode range) and FIG. 29B (cathode range), where they are both intrinsically stable at the material level and form stable interfaces with LSPS within the prescribed voltage range. For the anode range, nitrogen, phosphorous, and iodine containing compounds have the highest percentage of stable compounds (2-4%), whereas all other classes are below 1%. The cathode range showed much higher percentages with sulfur containing compounds reaching 35%. Iodine and selenium were both above 10%.

Experimental Comparison

The chemical compatibility between various coating materials and LSPS were tested experimentally by hand-milling the mixture powder of LSPS and coating materials with/without high-temperature annealing, followed by X-ray diffraction (XRD) measurements at room temperature. Any chemical reaction between the powder will cause compositional and structural changes in the original phases, which can be detected by the change of peak positions and intensities in XRD patterns. It is worth noting that even interfacial reactions are predicted to happen based on thermodynamic calculations, a certain amount of energy may be needed to overcome the kinetic energy barrier for these reactions to happen⁴. Therefore, the mixed powders were annealed at high temperatures (300° C., 400° C., 500° C.) to determine the onset temperature of interfacial reactions as well as the reaction products, and to further assess the role of kinetics by comparing these results with the DFT computed thermodynamic reaction products.

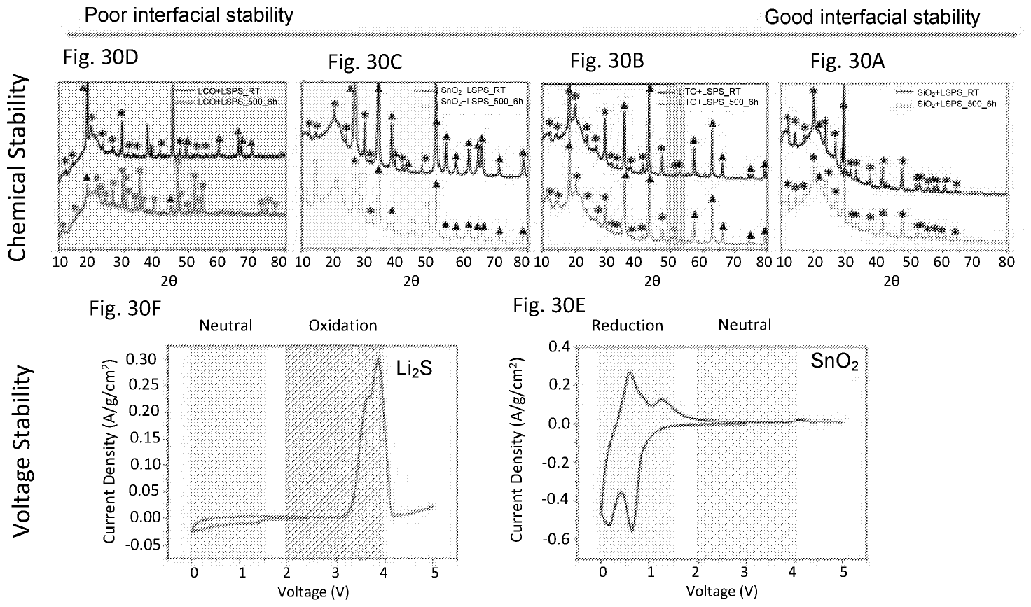

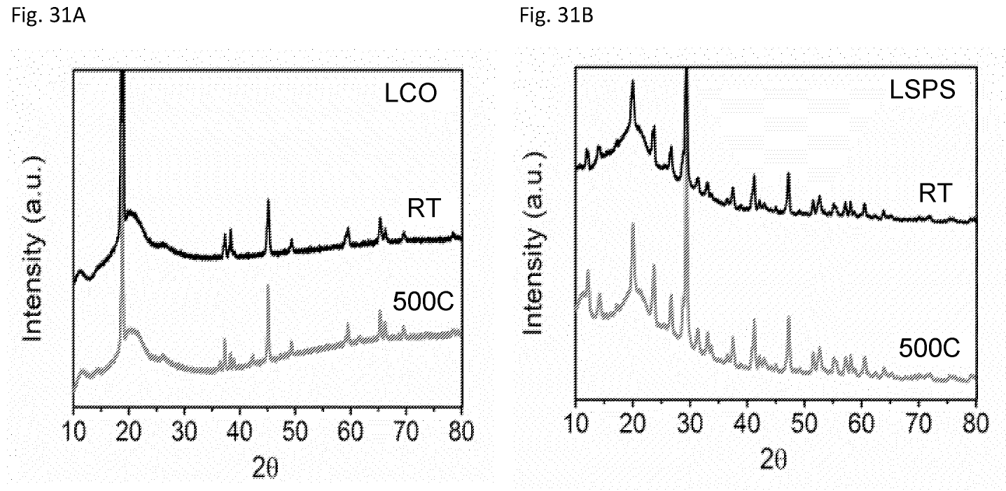

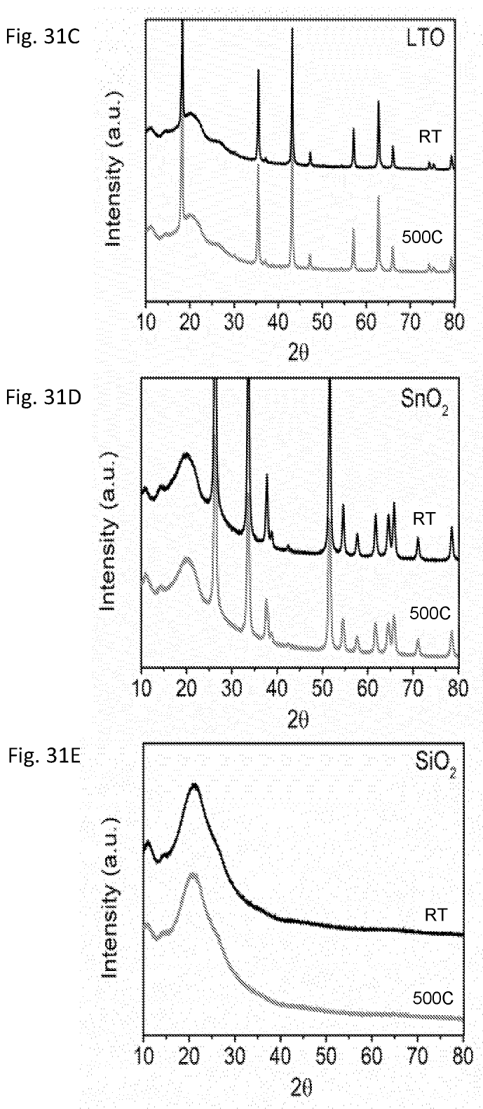

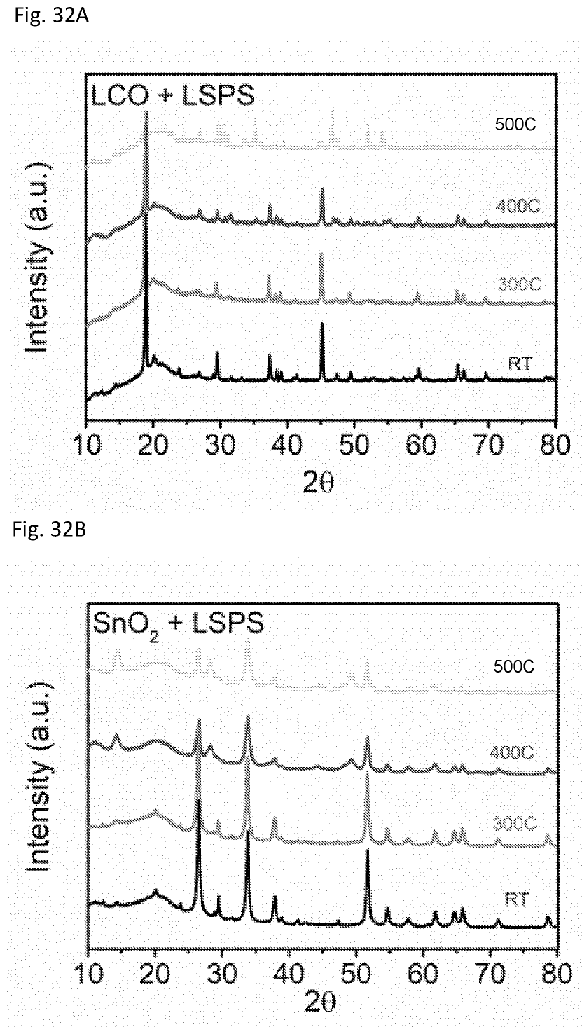

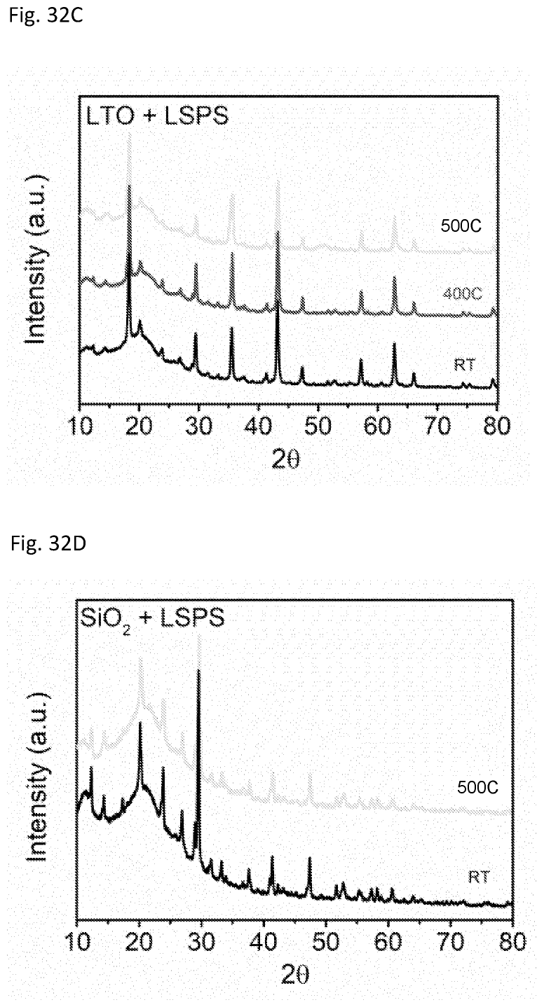

FIGS. 30A-30D compares the XRD patterns of such room-temperature and 500° C.-annealed powder mixtures. Several candidate coating materials (i.e. SnO₂, Li₄Ti₅O₁₂, SiO₂) were mixed with LSPS (FIGS. 30C-30D), while the mixed powder of LCO+LSPS was for comparison (FIG. 30A). The XRD patterns for each individual phase (i.e. SnO₂, Li₄Ti₅O₁₂, LiCoO₂, SiO₂ and LSPS) at room temperature and 500° C. are used as reference (FIGS. 31A-31E). By comparing these XRD patterns, it is obvious that at room temperature, no coating materials reacts with LSPS, since the XRD patterns only show peaks of the original phases. However, after being annealed at 500° C. for 6h, different materials show completely different reaction capabilities with LSPS. LCO is observed to react severely with LSPS, because the peak intensities and positions of the XRD pattern for the mixed powders changed completely in the whole 2-theta range of 10-80 degrees (FIG. 309A). The original LCO and LSPS peaks either disappeared or decreased, while extra peaks belonging to new reaction products appeared (such as SiO₂, Li₃PO₄, cubic Co₄S₃ and monoclinic CO₄S₃), indicating that LCO is not compatible with LSPS. As a sharp contrast, peak intensities and positions of the XRD patterns for SiO₂+LSPS mixture never change, showing only original peaks both before and after 500° C. annealing. This is the direct evidence to show that no interfacial reaction happens when SiO₂ is in contact with LSPS, despite large external energy provided. SnO₂ and LTO also show incompatibility with LSPS, as new peaks belonging to reaction products appeared in the XRD patterns for their 500° C.-annealed sample, however, the peaks of reaction products are much weaker than the case of LCO+LSPS. The 2-theta ranges, where peak positions and intensities change for four materials, are highlighted by color regions in FIGS. 30A-30D, as an indication of the incompatibility of different materials with LSPS. It can be observed from FIGS. 30A-30D that such incompatibility order is LCO>SnO₂>LTO>SiO₂, which is in perfect agreement with our theoretical prediction based on thermodynamic calculations. The onset temperature for interfacial reactions of various materials with LSPS are shown in FIGS. 32A-32D.

The electrochemical stability of typical coating materials is characterized by Cyclic Voltammetry (CV) technique, in which the decomposition of the tested coating material can be manifested by current peaks at certain voltages relevant to Lithium. Two typical coating materials were used as a demonstration to show good correspondence between our theoretical prediction and experimental observation. The CV test of Li₂S (FIG. 30E) shows a relevantly flat region between 0-1.5V, while a large oxidation peak dominates the region of 2-4V. In contrast, the CV test of SiO₂ (FIG. 30F) demonstrates net reduction in the region of 0-1.5V, and a neutral region with little decomposition between 2 and 4V. These results are again direct evidence to corroborate our theoretical predictions based on thermodynamic calculations.

Methods

Data Acquisition

The data used in this work was the result of prior Density Functional Theory calculations that were performed as part of the Materials Project (MP) and was interfaced with using the Materials Application Programming Interface (API). The Python Materials Genomics (pymatgen) library was used to calculate convex hulls. Of the initial 69,640 structures that were evaluated, 2,578 structures were not considered due to requiring hulls of dimension equal to or greater than 9.

Elemental Set Iterations

To minimize the computational cost of analyzing all 67,062 structures, the smallest number of elemental sets that spanned all the materials were determined. To do this, the set of elements in each structure were combined with the elements of LSPS, resulting in a list of element sets with each set's length equal to the dimensionality of the required hull for that material. This list was ordered based on decreasing length of the set (e.g. ordered in decreasing dimensionality of the required hull). This set was then iterated through and any set that equals to or is a subset of a previous set was removed. The result was the minimum number of elemental sets, in which every material could be described.

Chemical decomposition hulls were calculated using the energies and compositions from the MP. Changes in the volume and entropy were neglected (ΔG≈ΔE). Similarly, electrochemical decomposition hulls were founded by using the lithium grand canonical free energy and subtracting a term μ_{Li}N_{Li} from the energies (ΔΦ≈ΔE−μ_{Li}ΔN_{Li}), where μ_{Li} is the chemical potential of interest and N_{Li} is the number of lithium ions in the structure. After a hull was calculated, it was used to evaluate every material that exists within the span of its elemental set.

The Pseudo-Binary

The pseudo-binary, as described in section 2, seeks to find the ratio of LSPS to coating material such that the decomposition energy is the most severe and, hence, is the most kinetically driven. This problem is simplified by using a vector notation to represent a given composition by mapping atomic occupation to a vector element. For example, LiCoO₂→(1 1 2) in the basis of (Li Co O), meaning that there are 1 lithium, 1 cobalt, and 2 oxygen in the unit formula. Using this notation, the decomposition in equation 1 can be written in vector form.

$$( 1 - x ) ( \begin{matrix}\vert \\ L S P S \\ \vert\end{matrix} ) + x ( \begin{matrix}\vert \\ A \\ \vert\end{matrix} ) = \sum {d}_{i} ( \begin{matrix}\vert \\ {D}_{i} \\ \vert\end{matrix} ) \qquad ( 5 )$$

Using ū to represent a vector and Ū to represent a matrix, equation 5 becomes:

$$( 1 - x ) \overline{LGPS} + x \overline{A} = ( \begin{matrix}\vert & & \vert \\ {D}_{1} & … & {D}_{n} \\ \vert & & \vert\end{matrix} ) ( \begin{matrix}{d}_{1} \\ ⋮ \\ {d}_{n}\end{matrix} ) = \overline{\overline{D}} \overline{d} \qquad ( 6 )$$

The relative composition derivatives for each decay product can be found by inverting D̅ in equation 6.

∂ₓd̅=D̅⁻¹(Ā−L̅G̅P̅S̅) (7)

Equation 7 allows for the calculation of the derivative of the hull energy with respect to the fraction parameter x.

$$\frac{\partial {G}_{hull}}{\partial x} = {G}_{A} - {G}_{L G P S} + ( {G}_{{D}_{1}} … {G}_{{D}_{n}} ) ( \begin{matrix}\begin{matrix}{\partial }_{x} {d}_{1} \\ ⋮\end{matrix} \\ {\partial }_{x} {d}_{n}\end{matrix} ) \qquad ( 8 )$$

By using equation 7, and the fact that the hull is a convex function of x, a binary search can be performed to find the maximum value of Gₕᵤₗₗ and the value at which it occurs xₘ. This process consists of first defining a two-element vector that defines the range in which xₘ is known to exist x_{range}=(0,1) and an initial guess x_{D}=0.5. Evaluating the convex hull at the initial guess yields the decomposition products {Dᵢ} and the corresponding energies {G_{D}_{ᵢ}}. Equations 7 and 8 can then be used to find the slope of the hull energy. If the hull energy is positive, x_{range}→(x₀, 1), whereas if it is negative x_{range}→(0, x₀). This process is repeated until the upper and lower limits differ by a factor less than the prescribed threshold of 0.01%, which will always be achieved in 14 steps (2₋₁₄≈0.006%).

Equations 5-8 are defined for chemical stability. In the case of electrochemical (lithium open) stability, the free energy is replaced with Φᵢ=Gᵢ−μNᵢ where μ is the chemical potential and Nᵢ is the number of lithium in structure i. Additionally, lithium composition is not included in the composition vectors of equation 6 to allow for the number of lithium atoms to change.

X-Ray Diffraction

The compatibility of the candidate materials and solid electrolyte was investigated at room temperature (RT) by XRD. The XRD sample was prepared by hand-milling the candidate materials (LCO, SnO₂, SiO₂, LTO) with LSPS powder (weight ratio=55:30) in an Ar-filled glovebox. To test the onset temperature of reactions for candidate materials and LSPS solid electrolyte, the powder mixtures were well spread on a hotplate to heat to different nominal temperatures (300, 400 and 500 degree Celsius) and then characterized by XRD.

XRD tests were performed on Rigaku Miniflex 600 diffractometer, equipped with Cu Kα radiation in the 2-theta range of 10-80°. All XRD sample holders were sealed with Kapton film in Ar-filled glovebox to avoid air exposure during the test.

Cyclic Voltammetry

Candidate coating materials (Li₂S and SiO₂), carbon black, and poly(tetra-fluoroethylene) (PTFE) were mixed together in a weight ratio of 90:5:5 and hand-milled in an Ar-filled glovebox. The powder mixtures were sequentially hand-rolled into a thin film, out of which circular disks ( 5/16-inch in diameter, ˜1-2 mg loading) were punched out to form the working electrode for Cyclic Voltammetry (CV) test. These electrodes were assembled into Swagelok cells with Li metal as the counter electrode, two glass fiber separators and commercial electrolyte (1 M LiPF₆ in 1:1 (volumetric ratio) ethylene carbonate/dimethyl carbonate (EC/DMC) solvent).

CV tests were conducted by Solartron 1455A with a voltage sweeping rate of 0.1 mV/s in the range of 0-5V at room temperature, to investigate the electrochemical stability window of the candidate coating materials (Li₂S and SiO₂).

Conclusion

Our high-throughput pseudo-binary analysis of Material Project DFT data has revealed that interfaces with LSPS decay via dominantly chemical means within the range of 1.5 to 3.5 V and electrochemical reduction [oxidation] at lower [higher] voltages. The fraction of decomposition energy attributed to interfacial effects disappears as the voltage approaches 0V. This result suggests that all material classes tend to decay to maximally lithiated Li binary and elemental compounds at low voltage, in which case the presence of the interface has no impact.

In terms of anionic content, we see that appropriately matching operational conditions to the coating material is paramount. Sulfur and selenium containing compounds, for example, demonstrate a very high chance to be functionally stable (>25% among all sulfides and selenides) in the 2-4V cathode range. However, less than 1% of these same materials form a functionally stable coating material in the 0-1.5V anode range, where iodine, phosphorous and nitrogen have the highest performance. Oxygen containing compounds have a high number of phases that are functionally stable in both voltage regions, but the percentage is low due to the even higher number of oxygen containing datapoints.

### Example 4

We show that an advanced mechanical constriction method can improve the stability of lithium metal anode in solid state batteries with LGPS as the electrolyte. More importantly, we demonstrate that there is no Li dendrite formation and penetration even after a high rate test at 10 mA cm⁻² in a symmetric battery. The mechanical constriction method is technically realized through applying an external pressure of 100 MPa to 250 MPa on the battery cell, where the Li metal anode is covered by a graphite film (G) that separates the LGPS electrolyte layer in the battery assembly. At the optimal Li/G capacity ratio, it exhibits excellent cyclic performances in both Li/G-LGPS-G/Li symmetric batteries and Li/G-LGPS-LiCoO₂ (LiNbO₃ coated) batteries. Upon cycling, Li/G anode transforms from two layers into one integrated composite layer. Comparison between Density Functional Theory (DFT) data and X-ray Photoelectron Spectroscopy (XPS) analysis yields the first ever direct observation of mechanical constriction controlling the decomposition reaction of LGPS. Moreover, the degree of decomposition is seen to become significantly suppressed under optimum constriction conditions.

Design of Li/Graphite Anode

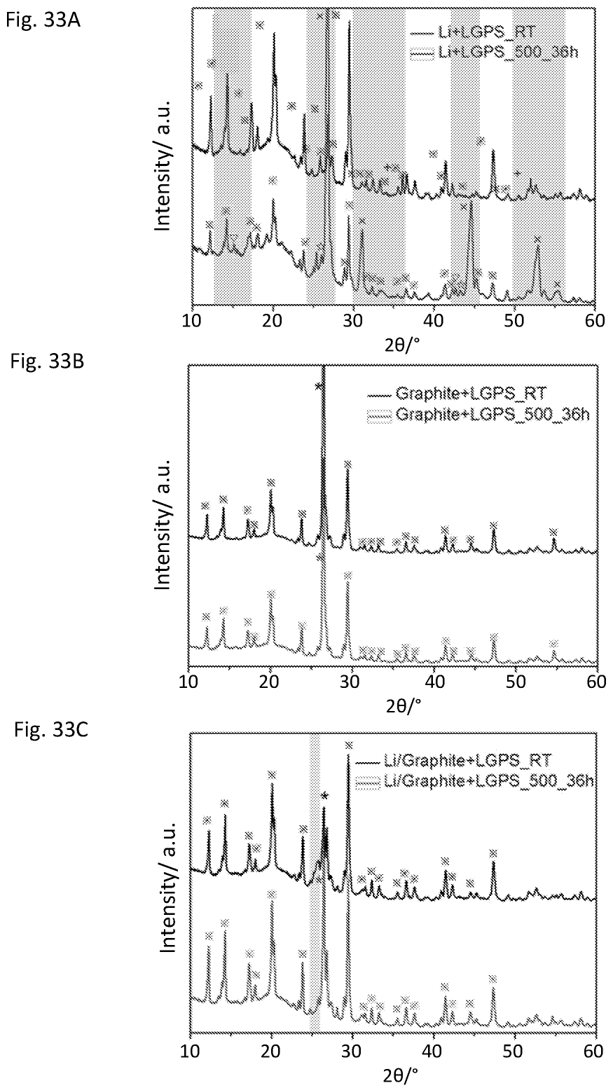

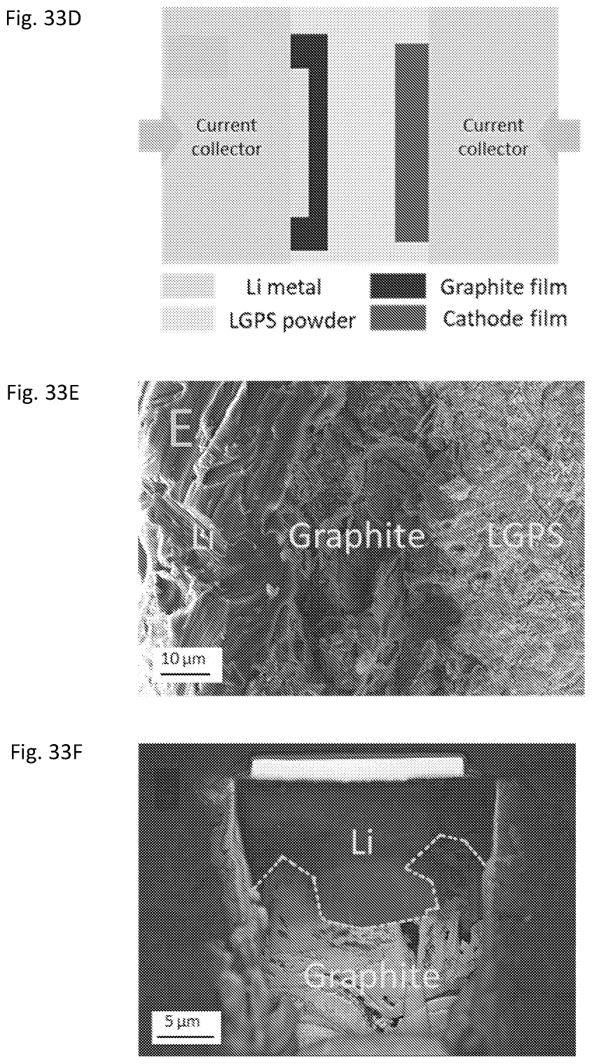

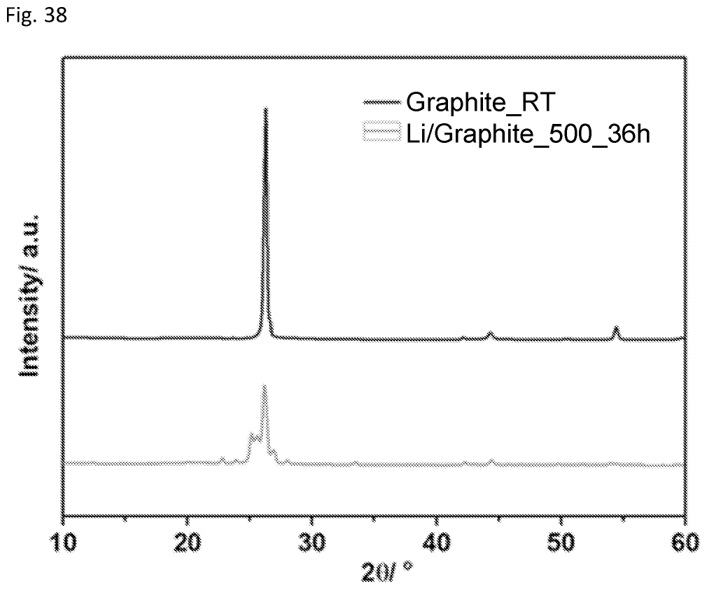

We first investigated the chemical stability between LGPS and (lithiated) graphite through the high temperature treatment of their mixtures at 500° C. for 36 hours inside the argon filled glovebox for an accelerated reaction. XRD measurements were performed on different mixtures before and after heat treatment, as shown in FIGS. 33(A, B, C). Severe decomposition of LGPS in contact with lithium was observed accompanied with Li₂S, GeS₂ and Li₅GeP₃ formation (FIG. 33A). In contrast, no peak change occurred for the mixture of LGPS and graphite after heating, as shown in FIG. 33B, demonstrating that graphite was chemically stable with LGPS. After heating the mixture of Li and graphite powders, lithiated graphite was synthesized (FIG. 38). When the lithiated graphite was further mixed with LGPS, it was chemically stable as shown in FIG. 33C, with only a slight intensity change for the 26° peak.

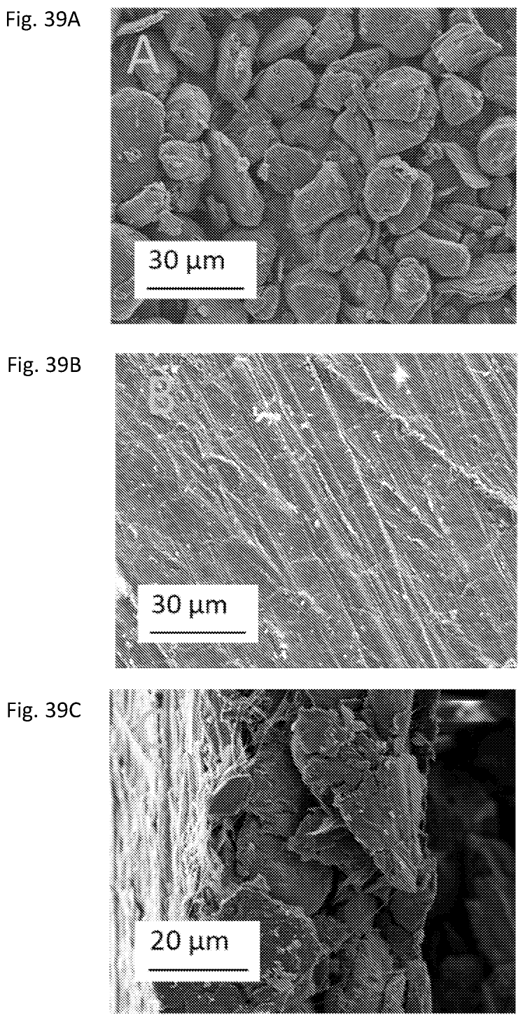

The Li/graphite anode was designed as shown in FIG. 33(D). The protective graphite film was made by mixing graphite powder with PTFE and then covering onto the lithium metal. The three layers of Li/graphite, electrolyte and cathode film were stacked together sequentially, followed by a mechanical press. The pressure was maintained at 100-250 MPa during the battery test. Such pressure helps obtain a good contact between anode and electrolyte based on the conventional wisdom in this field, but more importantly, it serves a mechanical constriction for improved electrochemical stability of solid electrolyte. Scanning electron microscopy (SEM) shows that the graphite particles transform into a dense layer under such high pressure (FIG. 39). The as-prepared anode before battery test can be directly observed via SEM and focused ion beam (FIB)-SEM in FIG. 33E, 33F). The three layers of Li, graphite and LGPS were clear with close interface contact.

Cyclic and Rate Performance of Li/Graphite Anode

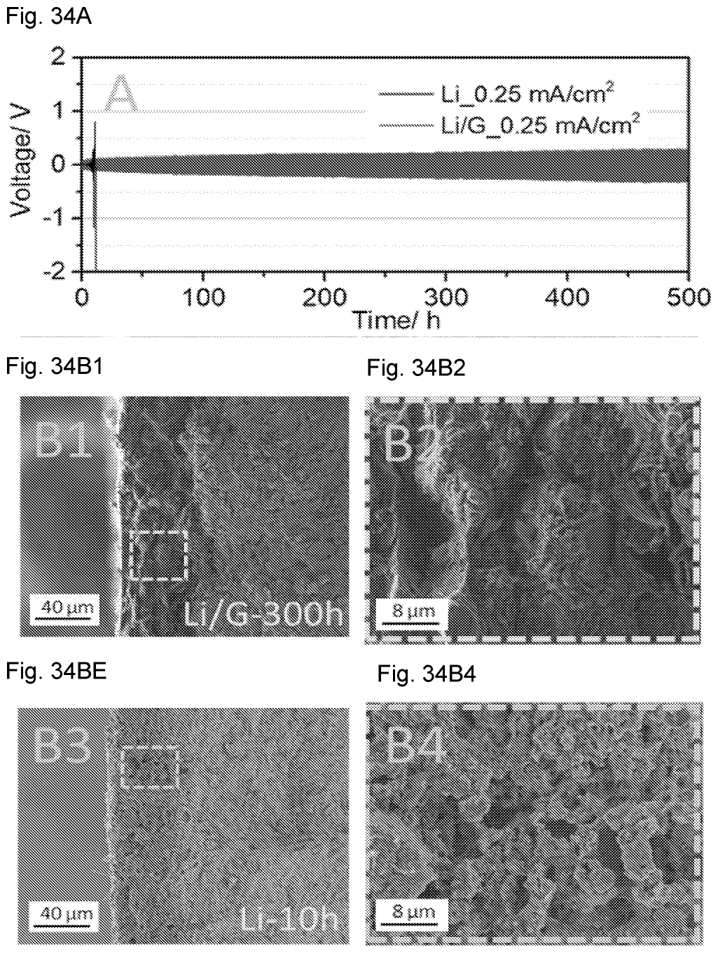

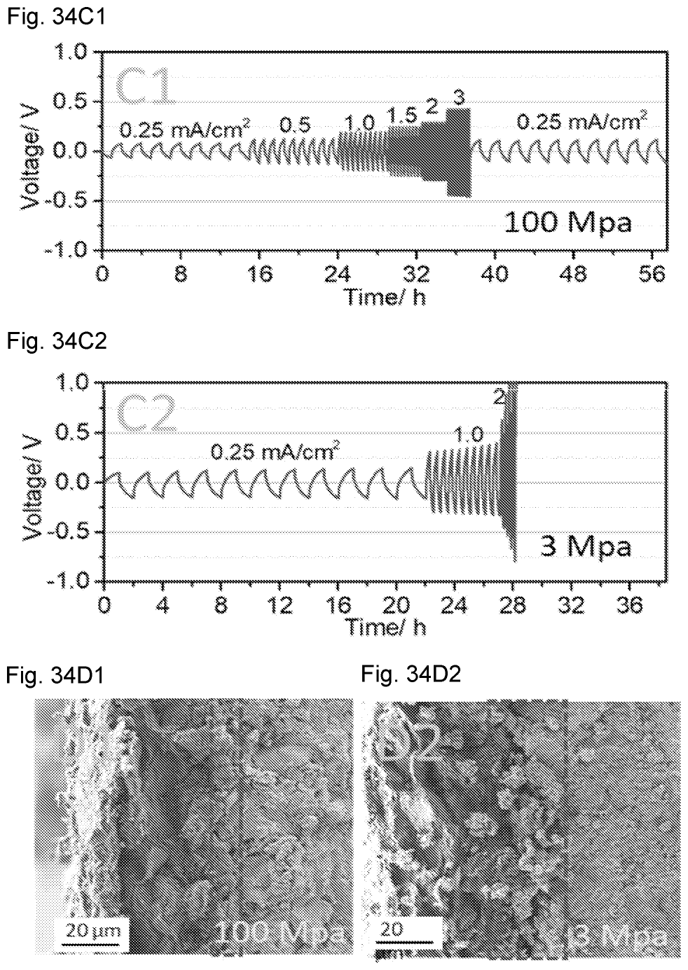

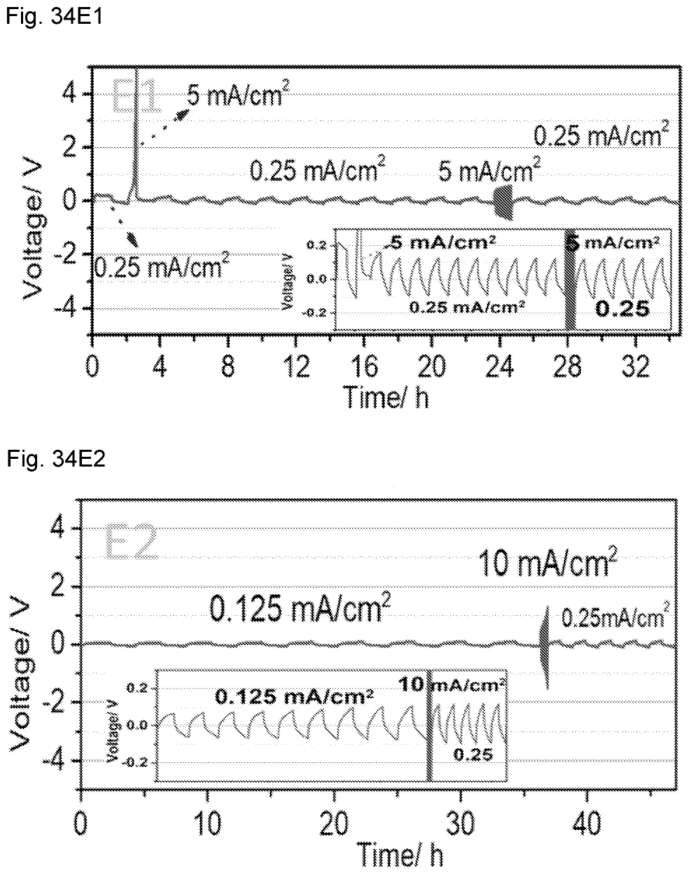

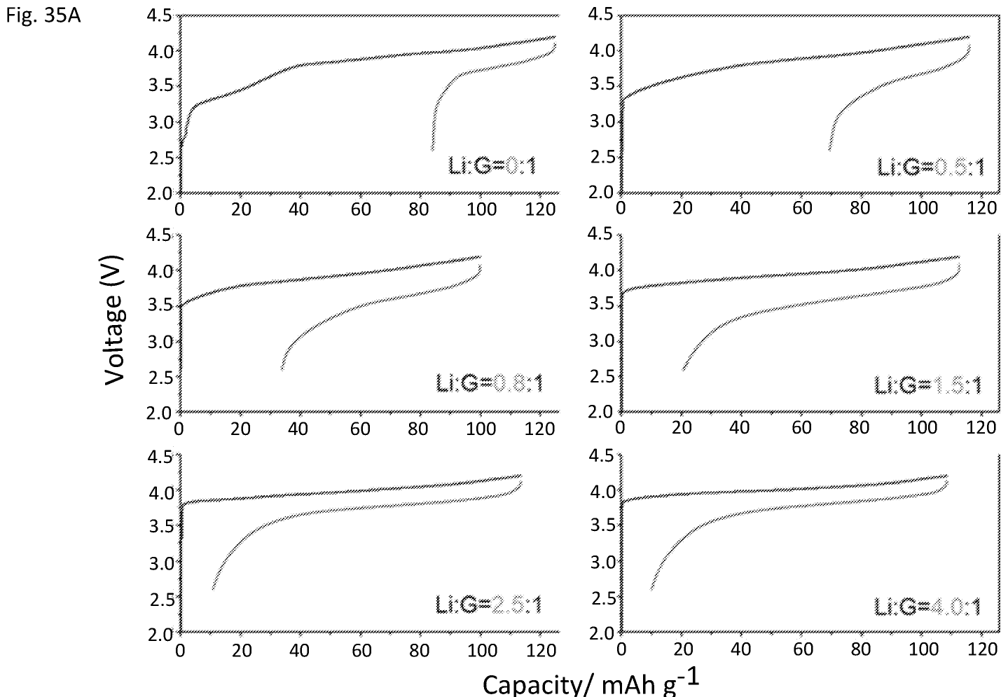

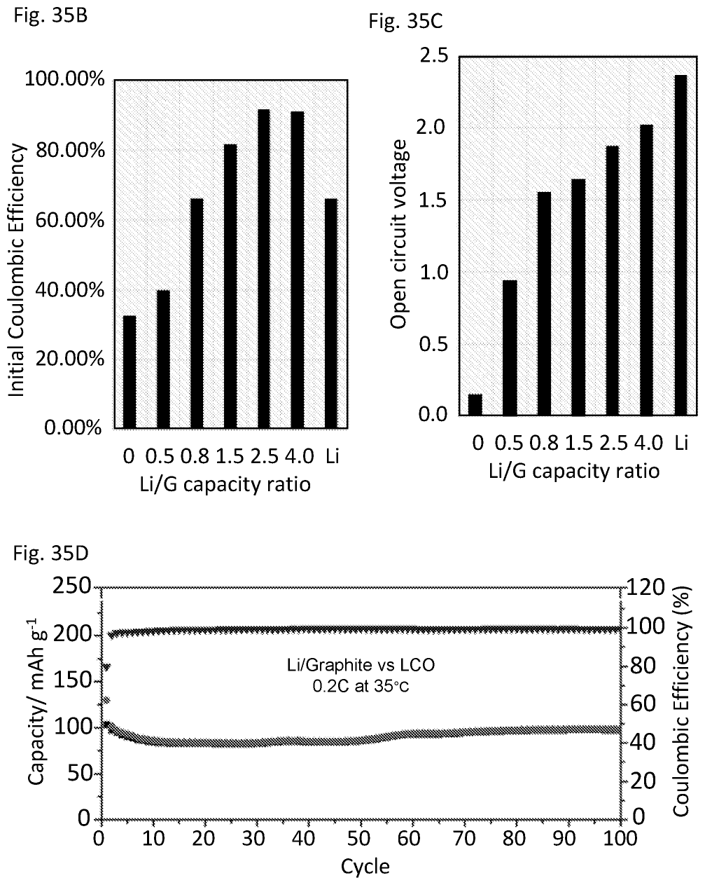

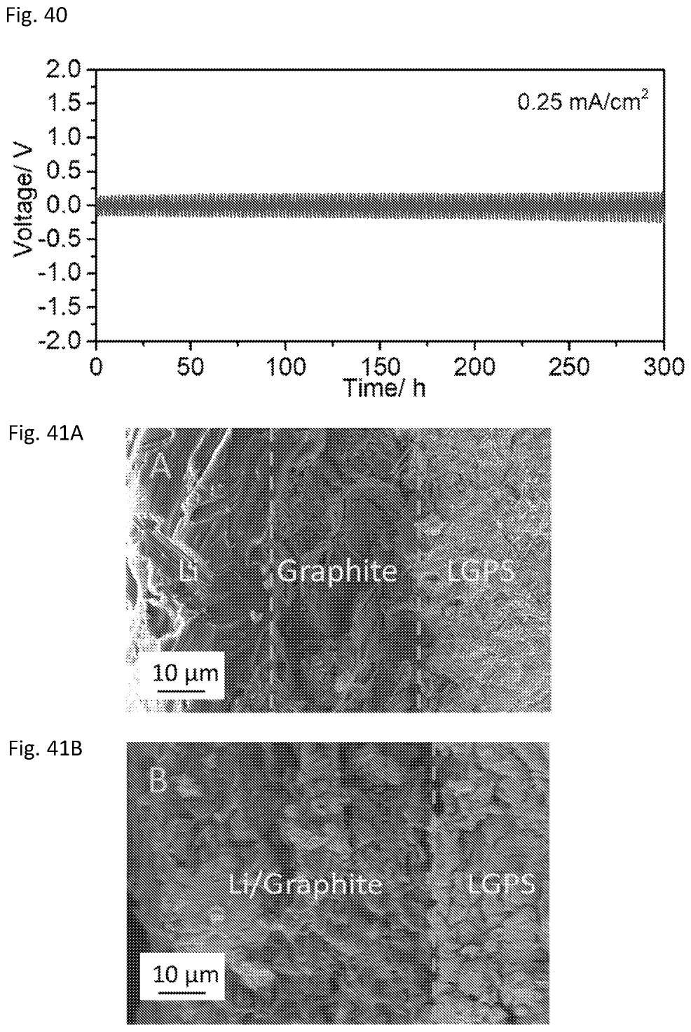

The electrochemical stability and rate capability of Li/graphite (Li/G) anode was tested with anode-LGPS-anode symmetric battery design under 100 MPa external pressure. The comparison of cyclic performance between Li/G-LGPS-G/Li and Li-LGPS-Li batteries is shown in FIG. 34A. Li symmetric battery works only for 10 hours at a current density of 0.25 mA cm² before failure, while Li/G symmetric battery was still running after 500 hours of cycling with the overpotential increasing slowly to 0.28 V. The stable cyclic performance was repeatable, as shown in FIG. 40 from another battery with a slower overpotential increase from 0.13 V to 0.19 V after 300 hours' cycling, indicating such slight overpotential change varies from battery assembly. SEM shows that Li/Graphite anode transforms from two layers to one integrated layer of composite without notable change of total thickness after long-term cycling (FIG. 41). The SEM images of Li/G anode after 300 hours' cycling in a symmetric battery were compared with the Li anode after 10 hours' cycling in FIG. 34B. The Li/G anode maintained a dense layer of lithium/graphite composite after the long-term cycling (FIG. 34B1, B2). In comparison, countless pores appeared in the Li anode after 10 hours of test, which were most probably induced by severe decomposition reaction of LGPS with Li metal. The pores were harmful to both ionic and electronic conductivities, which might be responsible for the sharp voltage increase when Li symmetric battery fails at 10 hours.

We also compared the rate performance of Li/G symmetric battery under different external pressures of 100 MPa or 3 MPa as shown in FIG. 34C. Same charging and discharging capacities were set for different current densities by changing the working time per cycle. The Li/G symmetric battery can cycle stably from 0.25 mA cm⁻² up to 3 mA cm⁻² with an overpotential increase from 0.1 V to 0.4 V. It can then cycle back normally to 0.25 mA cm⁻² (FIG. 34C1). While at 3 MPa, the battery failed during the test at 2 mA cm⁻² (FIG. 34C2). Note that at the same current density, the overpotential at 100 MPa was only around 63% of that under 3 MPa. The SEM images of the Li/G-LGPS interface after the rate test up to 2 mA cm⁻² showed a close interface contact at 100 MPa (FIG. 34D1), while cracks and voids were observed after the test at 3 MPa (FIG. 34D2). Thus, the external pressure plays the role of maintaining the close interface contact during the battery test, contributing to the better rate performance.

To further understand the influence of the Li/G composite formed by battery cycling on its high rate performance, a battery test was designed like FIG. 34(E1). Here, a higher external pressure of 250 MPa was kept during the test. It starts at 0.25 mA cm⁻² for 1 cycle and then directly goes to 5 mA cm⁻² charge, which shows a sharply increased voltage that leads to the safety stop. We then restarted the battery instantly, running at 0.25 mA cm⁻² again for ten cycles followed by 5 mA cm⁻² for the next ten. This time the battery runs normally at 5 mA cm⁻² with an average overpotential of 0.6 V, and it can still go back to cycle at 0.25 mA cm⁻² without obvious overpotential increase. At fixed current, the initial voltage surge at 5 mA cm⁻² indicates a resistance jump, which is most probably related to the fact that Li and graphite are two layers as assembled, and hence there is not sufficient Li in graphite to support such a high current density. However, after 20 hours' cycling at 0.25 mA cm⁻², Li/G was on the track of turning into a composite, as shown in FIG. 34B and FIG. 41, with much more Li storage to support the high rate cycling test.

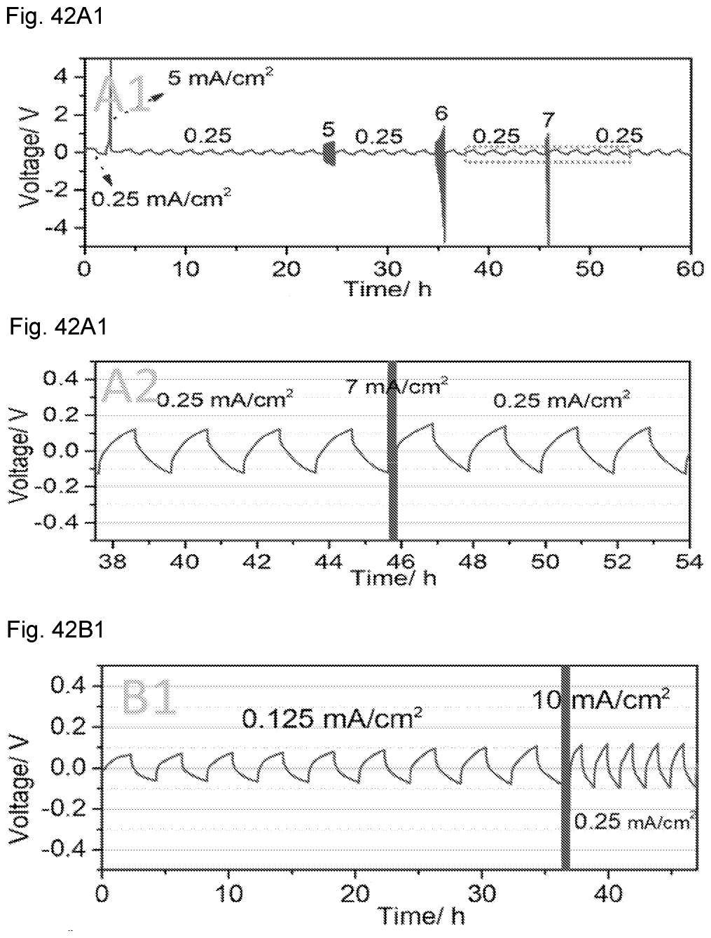

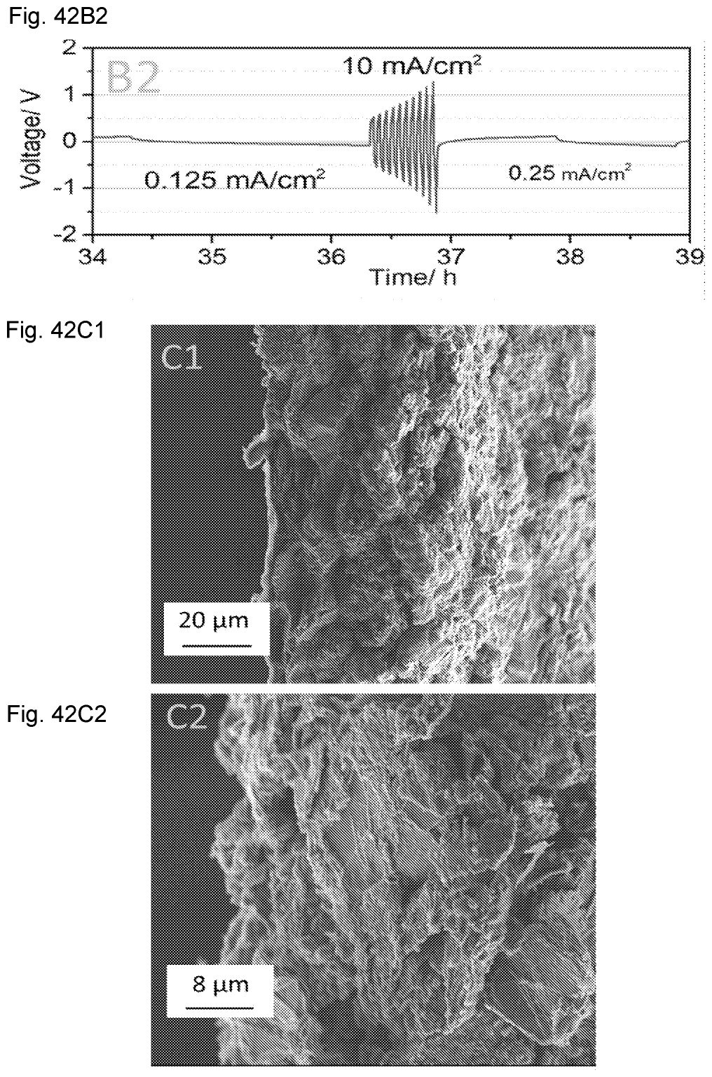

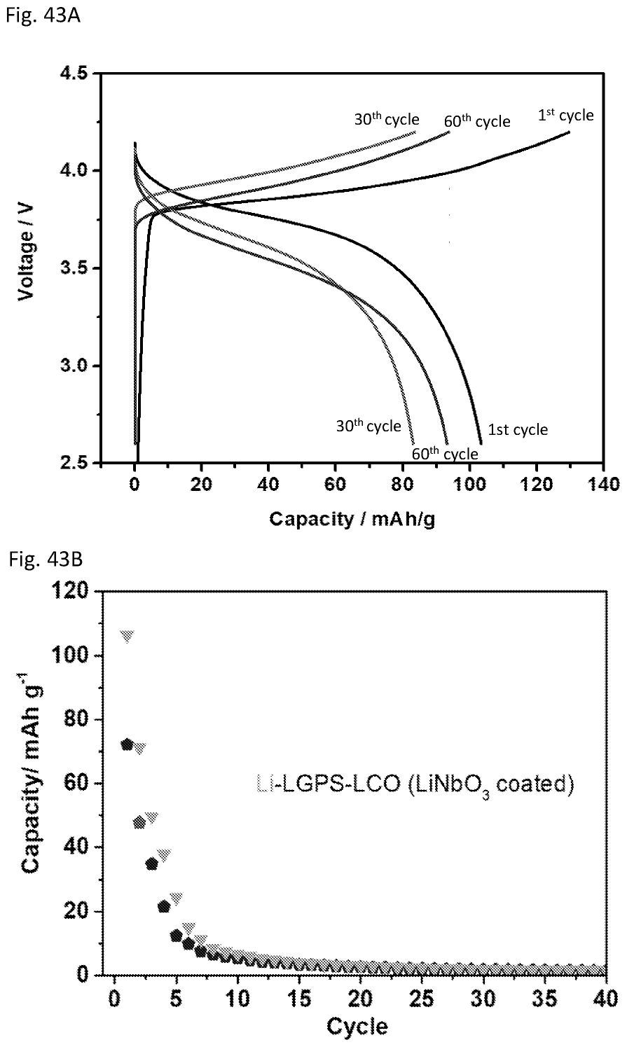

Based on the above understanding, we further lowered the current density for the initial cycles to 0.125 mA cm⁻² and cycled with the same capacity of 0.25 mAh cm⁻² for a more homogeneous Li distribution and storage in the Li/G composite for improved lithium transfer kinetics. As shown in FIG. 34(E2), the battery could cycle at a current density of 10 mA cm⁻² and cycle normally when the current density was set back to 0.25 mA cm⁻². Note that there was no obvious overpotential increase at the same low current rate before and after the high rate test, as shown in the insets of FIG. 34E and FIG. 42, where the SEM of Li/G anode of this battery also showed a clear formation of Li/G composite without obvious Li dendrite observed on the interface.

Li/Graphite Anode in all-Solid-State Battery

We first performed DFT simulations of LGPS decomposition pathways in the low voltage range of 0.0-2.2V versus lithium metal. Mechanical constriction on the materials level was parameterized by an effective bulk modulus (K_{eff}) of the system. Based on the value of this modulus, the system could range from isobaric (K_{eff}=0) to isovolumetric (K_{eff}=∞). Expected values of K_{eff} in real battery systems were on the order of 15 GPa. In the following, these simulation results were used to interpret XPS results of the valence changes of Ge and P from LGPS in the solid state batteries after CV, rate and cycling tests.

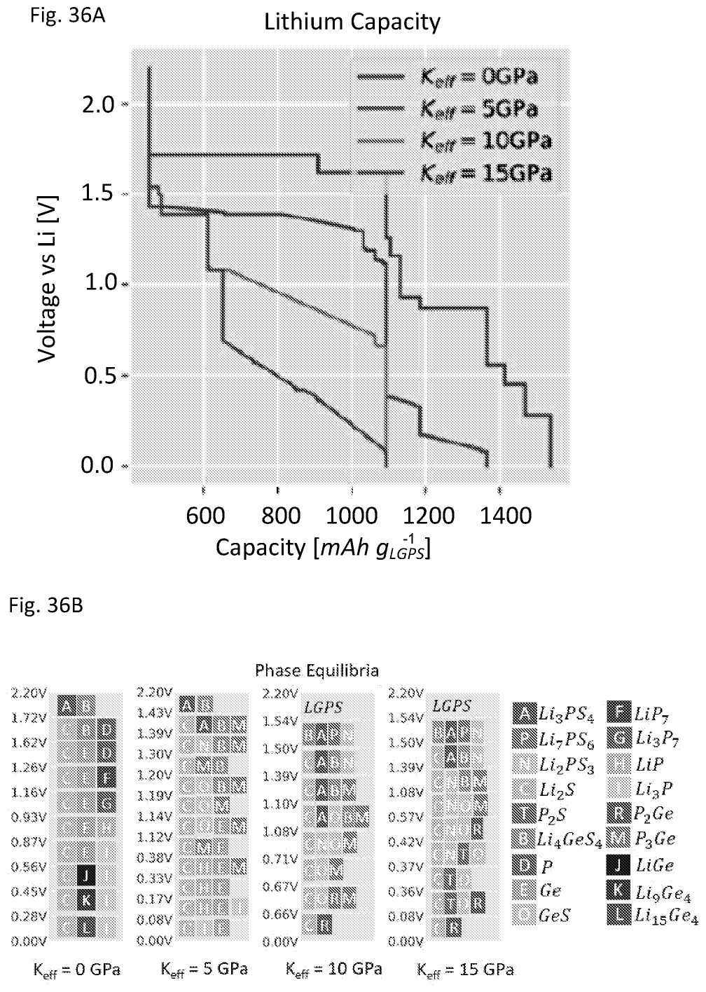

As shown in FIG. 36A, the decomposition capacity of LGPS was lower at high effective moduli, indicating that the decomposition of LGPS at low voltage was largely inhibited by mechanical constriction. The predicted decomposition products and fraction number are listed in FIG. 36B and Table 4, respectively. At K_{eff}=0 GPa (i.e. no applied mechanical constraint/isobaric), the reduction products approached the lithium binaries Li₂S, Li₃P, and Li₁₅Ge₄ as the voltage approaches zero. However, after mechanical constriction was applied and the effective modulus was set at 15 GPa, the formation of Ge element, LiₓP_{y} and LiₓGe_{y} were suppressed, while compounds like PₓGe_{y}, GeS, and P₂S were emergent. This is also in agreement with the fact that PₓGe_{y} is known to be a high pressure phase. The voltage profiles and reduction products at different K_{eff} shown in FIG. 36 indicate that the decomposition of LGPS follows different reduction pathways at low voltage after the application of mechanical constriction.

TABLE 4
(A)-(D) LGPS decomposition products with fraction
numbers down to low voltages at different K_{eff}

| | |
|---|---|
| LGPS + xLi (Reactants) | Decomposition products |

(A) K_{eff} = 0 GPa

| | | |
|---|---|---|
| 2.20 V | LGPS + 0.000Li | 1.000 Li₄GeS₄ + 2.000 Li₃PS₄ |
| 1.73 V | LGPS + 0.000Li | 1.000 Li₄GeS₄ + 2.000 Li₃PS₄ |
| 1.72 V | LGPS + 10.000Li | 2.000 P + 8.000 Li₂S + 1.000 Li₄GeS₄ |
| 1.63 V | LGPS + 10.000Li | 2.000 P + 8.000 Li₂S + 1.000 Li₄GeS₄ |
| 1.62 V | LGPS + 14.000Li | 1.000 Ge + 2.000 P + 12.000 Li₂S |
| 1.27 V | LGPS + 14.000Li | 1.000 Ge + 2.000 P + 12.000 Li₂S |
| 1.26 V | LGPS + 14.286Li | 1.000 Ge + 0.286 LiP₇ + 12.000 Li₂S |
| 1.17 V | LGPS + 14.286Li | 1.000 Ge + 0.286 LiP₇ + 12.000 Li₂S |
| 1.16 V | LGPS + 14.858Li | 1.000 Ge + 0.286 Li₃P₇ + 12.000 Li₂S |
| 0.94 V | LGPS + 14.858Li | 1.000 Ge + 0.286 Li₃P₇ + 12.000 Li₂S |
| 0.93 V | LGPS + 16.000Li | 1.000 Ge + 2.000 LiP + 12.000 Li₂S |
| 0.88 V | LGPS + 16.000Li | 1.000 Ge + 2.000 LiP + 12.000 Li₂S |
| 0.87 V | LGPS + 20.000Li | 1.000 Ge + 2.000 Li₃P + 12.000 Li₂S |
| 0.57 V | LGPS + 20.000Li | 1.000 Ge + 2.000 Li₃P + 12.000 Li₂S |
| 0.56 V | LGPS + 21 .000Li | 1.000 LiGe + 2.000 Li₃P + 12.000 Li₂S |
| 0.46 V | LGPS + 21 .000Li | 1.000 LiGe + 2.000 Li₃P + 12.000 Li₂S |
| 0.45 V | LGPS + 22.250Li | 0.250 Li₉Ge₄ + 2.000 Li₃P + 12.000 Li₂S |
| 0.29 V | LGPS + 22.250Li | 0.250 Li₉Ge₄ + 2.000 Li₃P + 12.000 Li₂S |
| 0.28 V | LGPS + 23.750Li | 0.250 Li15Ge₄ + 2.000 Li₃P + 12.000 Li₂S |
| 0.00 V | LGPS + 23.750Li | 0.250 Li15Ge₄ + 2.000 Li₃P + 12.000 Li₂S |

(B)K_{eff} = 5 GPa

| | | |
|---|---|---|
| 2.20 V | LGPS + 0.000Li | 1.000 Li₄GeS₄ + 2.000 Li₃PS₄ |
| 1.44 V | LGPS + 0.000Li | 1.000 Li₄GeS₄ + 2.000 Li₃PS₄ |
| 1.43 V | LGPS + 0.000Li | 0.606 Li₂S + 0.038 GeP₃ + 0.962 Li₄GeS₄ + 1.886 Li₃PS₄ |
| 1.40 V | LGPS + 0.000Li | 3.747 Li₂S + 0.234 GeP₃ + 0.766 Li₄GeS₄ + 1.297 Li₃PS₄ |
| 1.39 V | LGPS + 7.106Li | 6.734 Li₂S + 0.364 GeP₃ + 0.636 Li₄GeS₄ + 0.907 Li₂PS₃ |
| 1.31 V | LGPS + 12.170Li | 10.261 Li₂S + 0.635 GeP₃ + 0.365 Li₄GeS₄ + 0.094 Li₂PS₃ |
| 1.30 V | LGPS + 12.666Li | 10.667 Li₂S + 0.667 GeP₃ + 0.333 Li₄GeS₄ |
| 1.21 V | LGPS + 12.666Li | 10.667 Li₂S + 0.667 GeP₃ + 0.333 Li₄GeS₄ |
| 1.20 V | LGPS + 12.860Li | 10.958 Li₂S + 0.667 GeP₃ + 0.097 GeS + 0.236 Li₄GeS₄ |
| 1.20 V | LGPS + 12.860Li | 10.958 Li₂S + 0.667 GeP₃ + 0.097 GeS + 0.236 Li₄GeS₄ |
| 1.19 V | LGPS + 13.334Li | 11.667 Li₂S + 0.667 GeP₃ + 0.333 GeS |
| 1.15 V | LGPS + 13.334Li | 11.667 Li₂S + 0.667 GeP₃ + 0.333 GeS |
| 1.14 V | LGPS + 13.382Li | 0.025 Ge + 11.691 Li₂S + 0.667 GeP₃ + 0.309 GeS |
| 1.13 V | LGPS + 13.824Li | 0.246 Ge + 11.912 Li₂S + 0.667 GeP₃ + 0.088 GeS |
| 1.12 V | LGPS + 14.000Li | 0.333 Ge + 12.000 Li₂S + 0.667 GeP₃ |
| 0.39 V | LGPS + 14.000Li | 0.333 Ge + 12.000 Li₂S + 0.667 GeP₃ |
| 0.38 V | LGPS + 14.291Li | 0.430 Ge + 0.291 LiP + 12.000 Li₂S + 0.570 GeP₃ |
| 0.34 V | LGPS + 15.726Li | 0.909 Ge + 1.726 LiP + 12.000 Li₂S + 0.091 GeP₃ |
| 0.33 V | LGPS + 16.000Li | 1.000 Ge + 2.000 LiP + 12.000 Li₂S |
| 0.18 V | LGPS + 16.000Li | 1.000 Ge + 2.000 LiP + 12.000 Li₂S |
| 0.17 V | LGPS + 16.254Li | 1.000 Ge + 1.873 LiP + 0.127 Li₃P + 12.000 Li₂S |
| 0.09 V | LGPS + 19.628Li | 1.000 Ge + 0.186 LiP + 1.814 Li₃P + 12.000 Li₂S |
| 0.08 V | LGPS + 20.000Li | 1.000 Ge + 2.000 Li₃P + 12.000 Li₂S |
| 0.00 V | LGPS + 20.000Li | 1.000 Ge + 2.000 Li₃P + 12.000 Li₂S |

(C) K_{eff} = 10 GPa

| | | |
|---|---|---|
| 2.20 V | Stable | 1.000 Li₁₀Ge(PS₆)₂ |
| 1.59 V | Stable | 1.000 Li₁₀Ge(PS₆)₂ |
| 1.54 V | LGPS + 0.529Li | 1.000 Li₄GeS₄ + 1.204 Li₃PS₄ + 0.531 Li₂PS₃ + 0.265 Li₇PS₆ |
| 1.51 V | LGPS + 0.529Li | 1.000 Li₄GeS₄ + 1.204 Li₃PS₄ + 0.531 Li₂PS₃ + 0.265 Li₇PS₆ |
| 1.50 V | LGPS + 0.717Li | 0.717 Li₂S + 1.000 Li₄GeS₄ + 1.283 Li₃PS₄ + 0.717 Li₂PS₃ |
| 1.40 V | LGPS + 0.717Li | 0.717 Li₂S + 1.000 Li₄GeS₄ + 1.283 Li₃PS₄ + 0.717 Li₂PS₃ |
| 1.39 V | LGPS + 3.474Li | 3.197 Li₂S + 0.092 GeP₃ + 0.908 Li₄GeS₄ + 1.724 Li₂PS₃ |
| 1.09 V | LGPS + 3.560Li | 3.266 Li₂S + 0.097 GeP₃ + 0.903 Li₄GeS₄ + 1.708 Li₂PS₃ |
| 1.08 V | LGPS + 4.696Li | 5.497 Li₂S + 0.050 GeP₃ + 0.950 GeS + 1.851 Li₂PS₃ |
| 0.72 V | LGPS + 13.296Li | 11.640 Li₂S + 0.664 GeP₃ + 0.336 GeS + 0.008 Li₂PS₃ |
| 0.71 V | LGPS + 13.334Li | 11.667 Li₂S + 0.667 GeP₃ + 0.333 GeS |
| 0.68 V | LGPS + 13.334Li | 11.667 Li₂S + 0.667 GeP₃ + 0.333 GeS |
| 0.67 V | LGPS + 13.498Li | 11.749 Li₂S + 0.502 GeP₃ + 0.248 GeP₂ + 0.251 GeS |
| 0.67 V | LGPS + 13.498Li | 11.749 Li₂S + 0.502 GeP₃ + 0.248 GeP₂ + 0.251 GeS |
| 0.66 V | LGPS + 14.000Li | 12.000 Li₂S + 1.000 GeP₂ |
| 0.00 V | LGPS + 14.000Li | 12.000 Li₂S + 1.000 GeP₂ |

(D) K_{eff} = 15 GPa

| | | |
|---|---|---|
| 2.20 V | Stable | 1.000 Li₁₀Ge(PS₆)₂ |
| 1.56 V | Stable | 1.000 Li₁₀Ge(PS₆)₂ |
| 1.54 V | LGPS + 0.529Li | 1.000 Li₄GeS₄ + 1.204 Li₃PS₄ + 0.531 Li₂PS₃ + 0.265 Li₇PS₆ |
| 1.51 V | LGPS + 0.529Li | 1.000 Li₄GeS₄ + 1.204 Li₃PS₄ + 0.531 Li₂PS₃ + 0.265 Li₇PS₆ |
| 1.50 V | LGPS + 0.717Li | 0.717 Li₂S + 1.000 Li₄GeS₄ + 1.283 Li₃PS₄ + 0.717 Li₂PS₃ |
| 1.40 V | LGPS + 0.717Li | 0.717 Li₂S + 1.000 Li₄GeS₄ + 1.283 Li₃PS₄ + 0.717 Li₂PS₃ |
| 1.39 V | LGPS + 3.474Li | 3.197 Li₂S + 0.092 GeP₃ + 0.908 Li₄GeS₄ + 1.724 Li₂PS₃ |
| 1.09 V | LGPS + 3.474Li | 3.197 Li₂S + 0.092 GeP₃ + 0.908 Li₄GeS₄ + 1.724 Li₂PS₃ |
| 1.08 V | LGPS + 4.368Li | 5.263 Li₂S + 0.026 GeP₃ + 0.974 GeS + 1.921 Li₂PS₃ |
| 0.58 V | LGPS + 6.148Li | 6.535 Li₂S + 0.154 GeP₃ + 0.846 GeS + 1.539 Li₂PS₃ |
| 0.57 V | LGPS + 6.362Li | 6.653 Li₂S + 0.236 GeP₂ + 0.764 GeS + 1.528 Li₂PS₃ |
| 0.43 V | LGPS + 8.690Li | 8.283 Li₂S + 0.469 GeP₂ + 0.531 GeS + 1.062 Li₂PS₃ |
| 0.42 V | LGPS + 9.166Li | 9.306 Li₂S + 1.000 GeS + 0.861 P₂S + 0.277 Li₂PS₃ |
| 0.38 V | LGPS + 9.918Li | 9.932 Li₂S + 1.000 GeS + 0.986 P₂S + 0.027 Li₂PS₃ |
| 0.37 V | LGPS + 10.000Li | 10.000 Li₂S + 1.000 GeS + 1.000 P₂S |
| 0.37 V | LGPS + 10.000Li | 10.000 Li₂S + 1.000 GeS + 1.000 P₂S |
| 0.36 V | LGPS + 10.110Li | 10.055 Li₂S + 0.027 GeP₂ + 0.973 GeS + 0.973 P₂S |
| 0.09 V | LGPS + 13.900Li | 11.950 Li₂S + 0.975 GeP₂ + 0.025 GeS + 0.025 P₂S |
| 0.08 V | LGPS + 14.000Li | 12.000 Li₂S + 1.000 GeP₂ |
| 0.00 V | LGPS + 14.000Li | 12.000 Li₂S + 1.000 GeP₂ |

It is worth noting that while the applied pressure and the effective modulus (K_{eff}) were both measured in units of pressure, they are independent. The effective modulus represents the intrinsic bulk modulus of the electrolyte added in parallel with the finite rigidity of the battery system. Accordingly, K_{eff} measures the mechanical constriction that can be realized on the materials level in any single particle, while the external pressure applied on the operation of solid state battery enforced the effectiveness of such constriction on the interface between particles or between electrode and electrolyte layers. This is because exposed surface was the most vulnerable to chemical and electrochemical decompositions, while a close interface contact enforced by external pressure will minimize such surface. Thus, even though the applied pressure was only on the order of 100 MPa, the effective bulk modulus was expected to be much larger. In-fact, close packed LGPS particles should experience a K_{eff} of approximately 15 GPa. The applied pressure of 100-250 MPa was an effective tool for obtaining this close packed structure. In short, the applied pressure minimizes gaps in the bulk electrolyte, allowing for the effective modulus that represents the mechanical constriction on the materials level to approach its ideal value of circa 15 GPa.

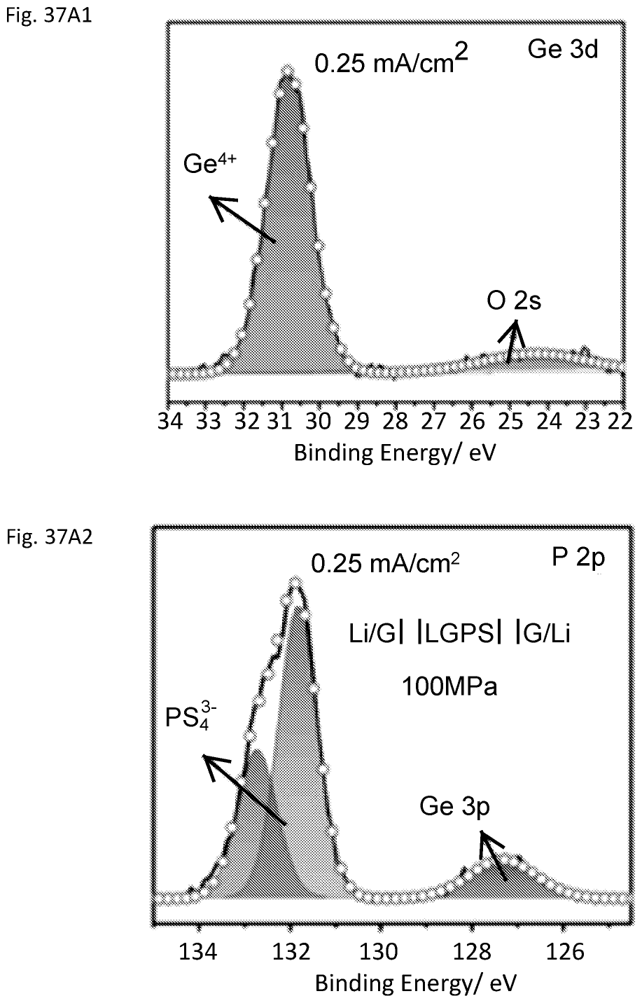

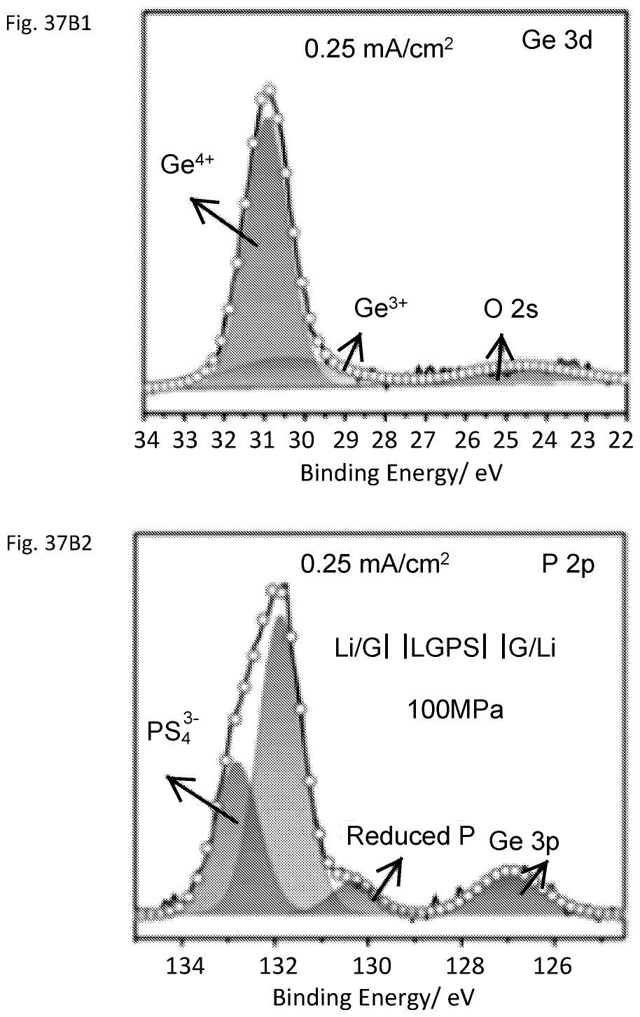

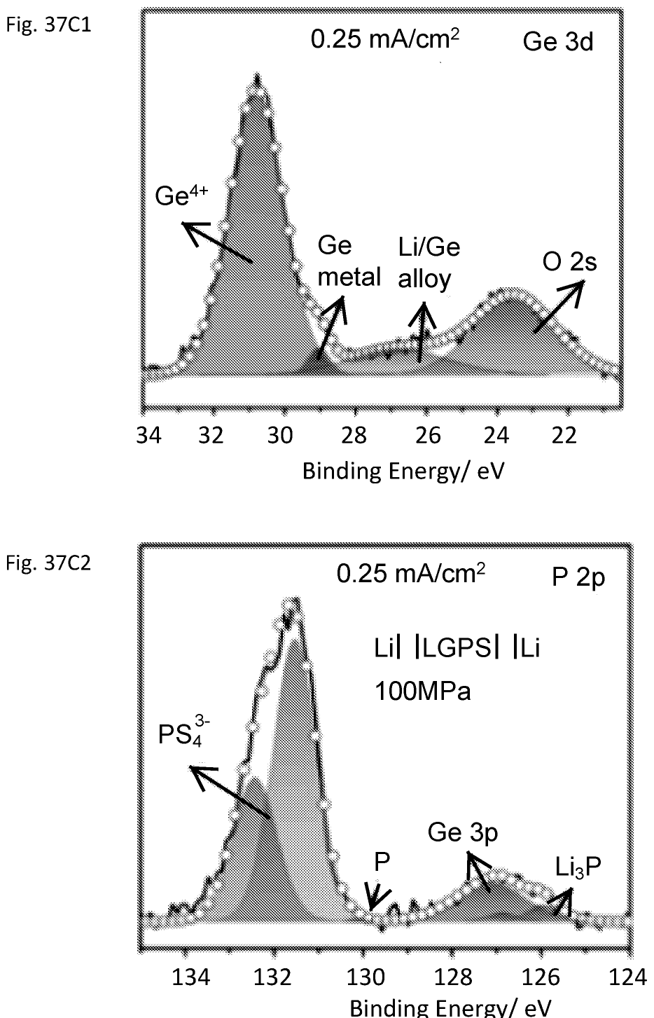

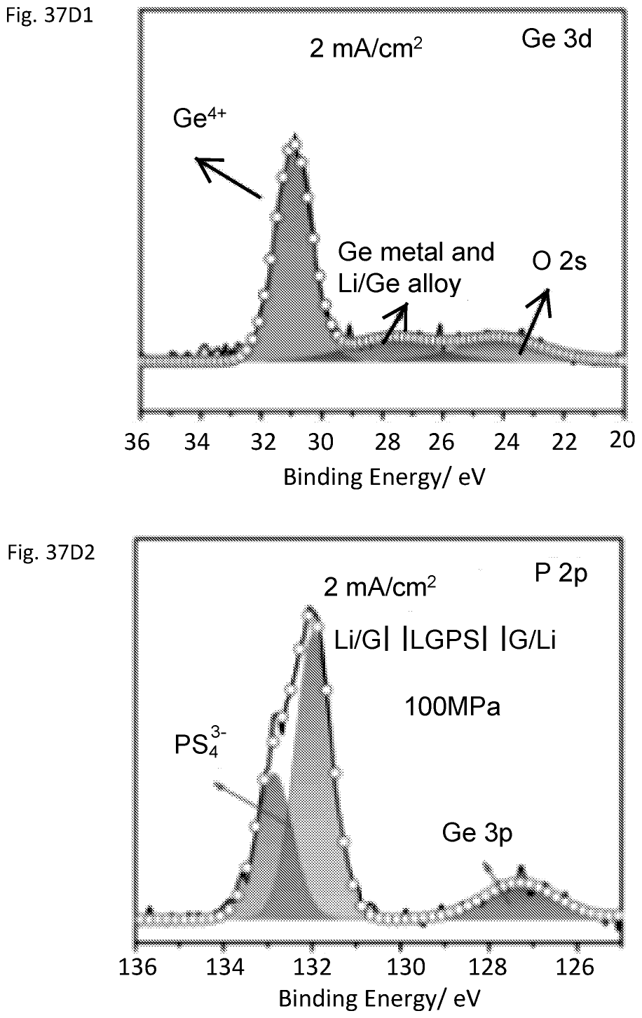

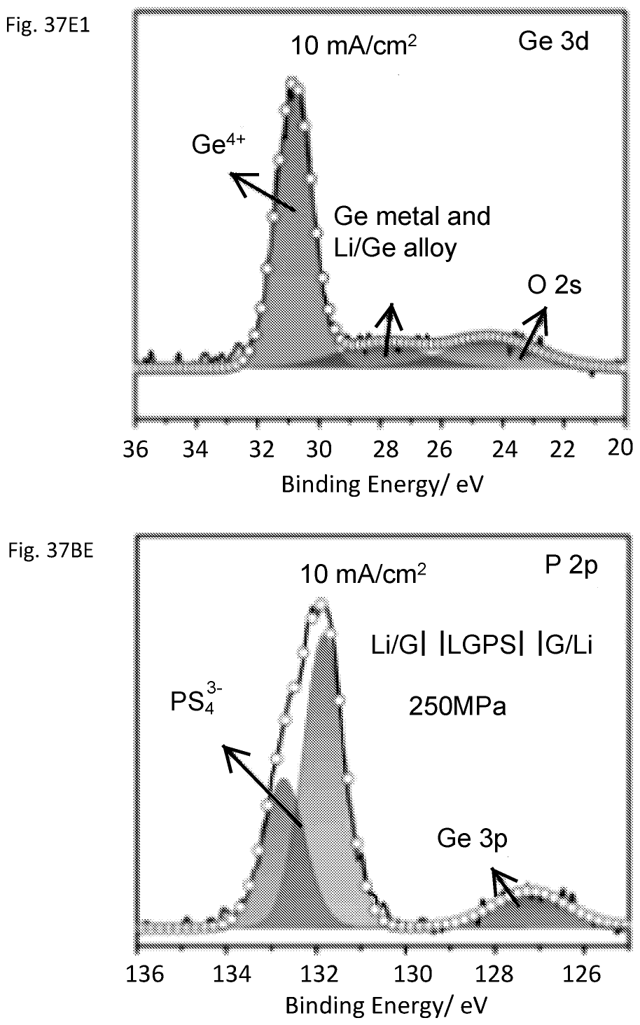

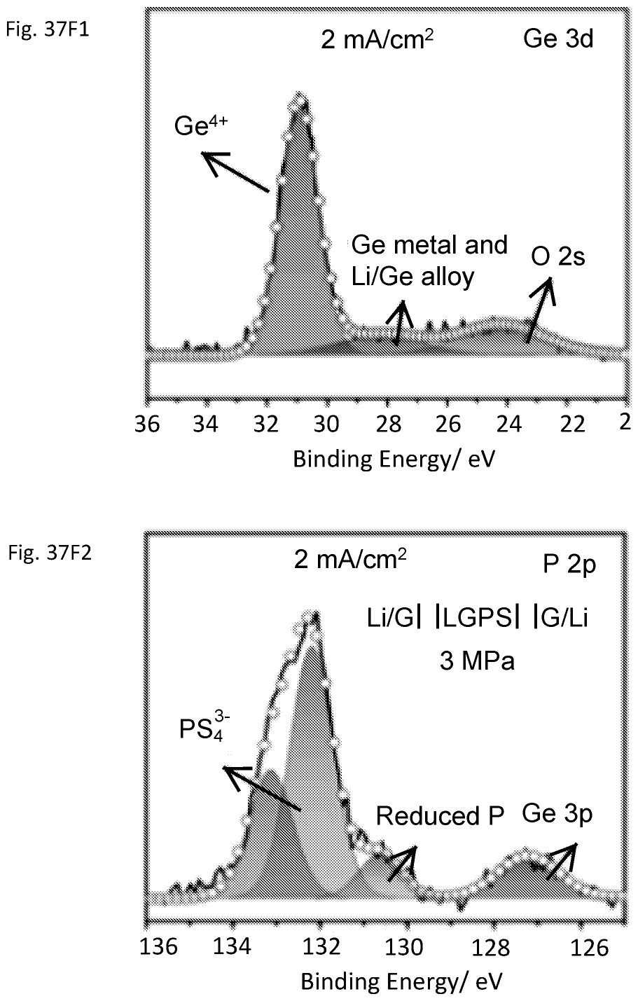

The XPS results of LGPS that was either in direct contact with a lithium or lithium-graphite anode, as well as bulk LGPS during battery cycling are provided in FIG. 37. These measurements of valence change can be well understood in light of the phase predictions of FIG. 36B. LGPS in the separator region far from the anode interface showed Ge and P peaks identical to the pristine LGPS (FIG. 37A).

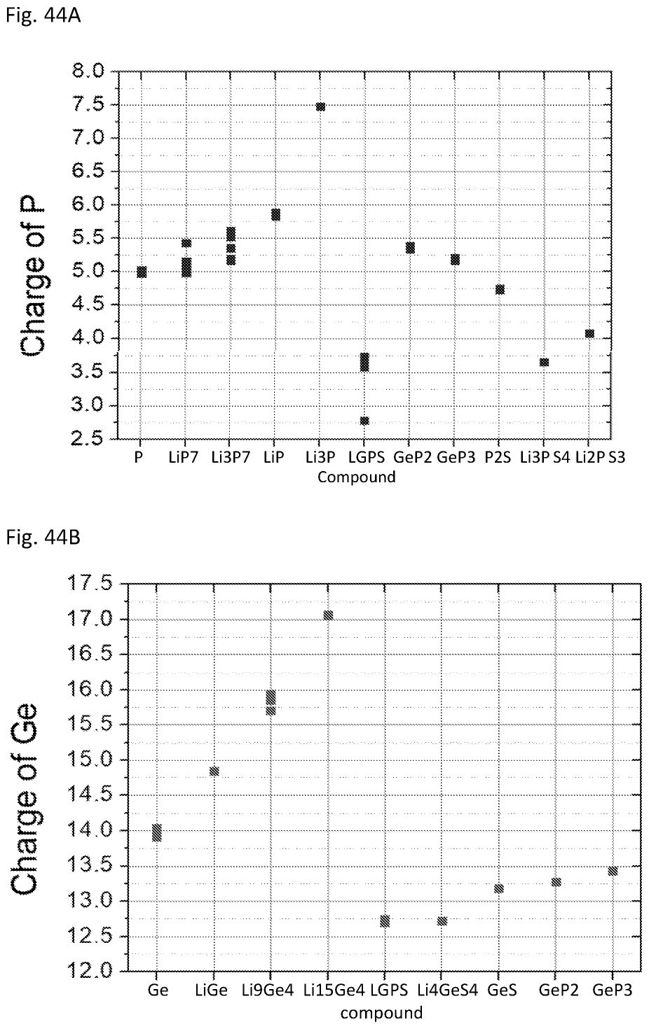

We first investigate the function of Li/G composite in comparison with pure lithium metal at a slow rate of 0.25 mA/cm² under 100 MPa external pressure (FIG. 37B, C). With pure lithium metal (FIG. 37C) the reductions of both Ge and P were significant on the Li-LGPS interface, showing the formation of LiₓGe_{y} alloy, elemental Ge, and Li₃P. Note that Ge valence in LiₓGe_{y} and P valence in Li₃P are negative or below zero valence, consistent with the Bader charge analysis from DFT simulations (FIG. 44.) In contrast, with the Li/G anode the reductions were inhibited on the Li/G-LGPS interface, with both Ge and P valences remaining above zero in the decomposed compounds (FIG. 37B). The Li and LGPS interface was chemically unstable, leading to decompositions that include the observed compounds in FIG. 37C. These decompositions were also consistent with the predicted ones in FIG. 36B at K_{eff} at 0 GPa. Further electrochemical cycling of such chemically decomposed interface will cause the decomposed volume fraction to grow, ultimately consuming all of the LGPS. On the contrary, graphite layer in Li/G anode prevented the chemical interface reaction between LGPS and Li, while under proper mechanical constriction the electrochemical decomposition seems to go through a pathway of high K_{eff} 10 GPa in FIG. 36B, where GeS, PₓGe, P₂S match the observed valences from XPS in FIG. 37B.

When the cycle rate was increased to 2 mA/cm² and 10 mA/cm², the observed decompositions on the L/G-LGPS interface under external pressures in FIG. 37D, 37E changed to a metastable pathway that was different from the low rate one at 0.25 mA/cm² in FIG. 37B. This implies that while FIG. 37B agrees with the thermodynamics predicted in FIG. 36, at high current densities the decomposition becomes kinetically dominated. Moreover, it was concluded that the Li/Ge alloy formation seen in FIGS. 37D, 37E was the kinetically preferred phase in place of reduced P. Specifically, Ge⁰ and LiₓGe_{y} together with Li₃PS₄ and Li₇PS₆ were the most possible decompositions based on the valences from XPS. Note that at an external pressure of 3 MPa and hence reduced K_{eff} on the interfaces, both Ge and P reductions were observed even at a high rate of 2 mA/cm² (FIG. 37F), consistent with the general trend predicted at low K_{eff} in FIG. 36B. However, the P reduction might still be kinetically rate-limited, as the most reduced state of Li₃P, as predicted in FIG. 36B at K_{eff}=0 GPa and observed in FIG. 37C from interface chemical reaction, was not observed.

These two competing reactions with thermodynamic and kinetic preferences, respectively, can be understood by considering a current dependent overpotential (η′(i)) for each of these two competing reactions (η→η+η′(i)). This η′ term would arise from kinetic effects such as ohmic losses, etc. When current is small (i≈0), η′ disappears, thus the thermodynamic overpotential (7) dominates and favors the ground state decomposition products of FIG. 36. However, at high currents, η′ begins to dominate and favors those metastable phases, such as LiₓGe_{y} at high K_{eff}, in our computations, which are not shown in FIG. 36 as those are all ground state phases in each voltage range.

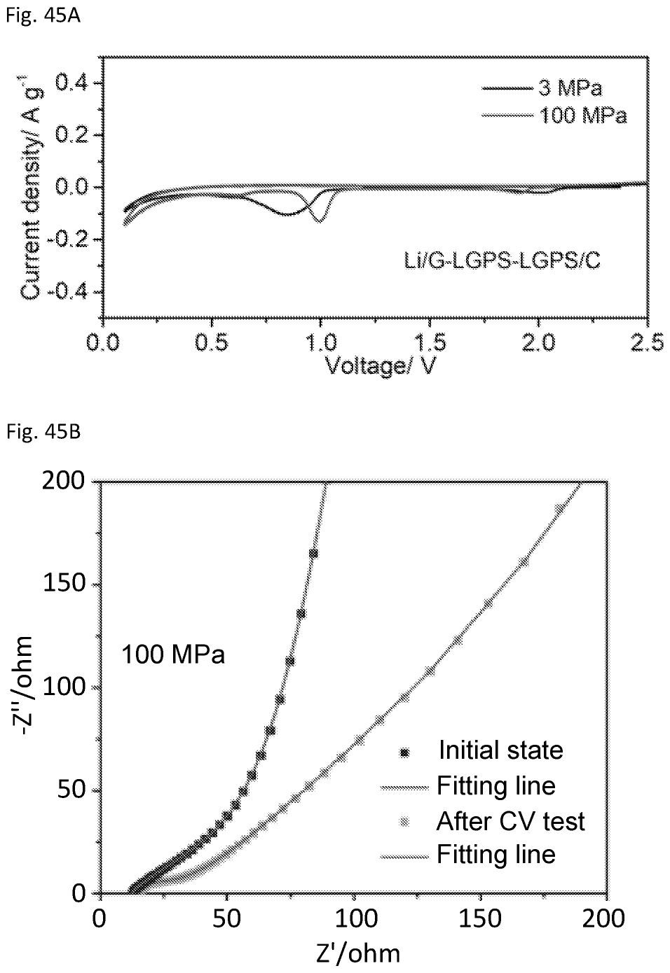

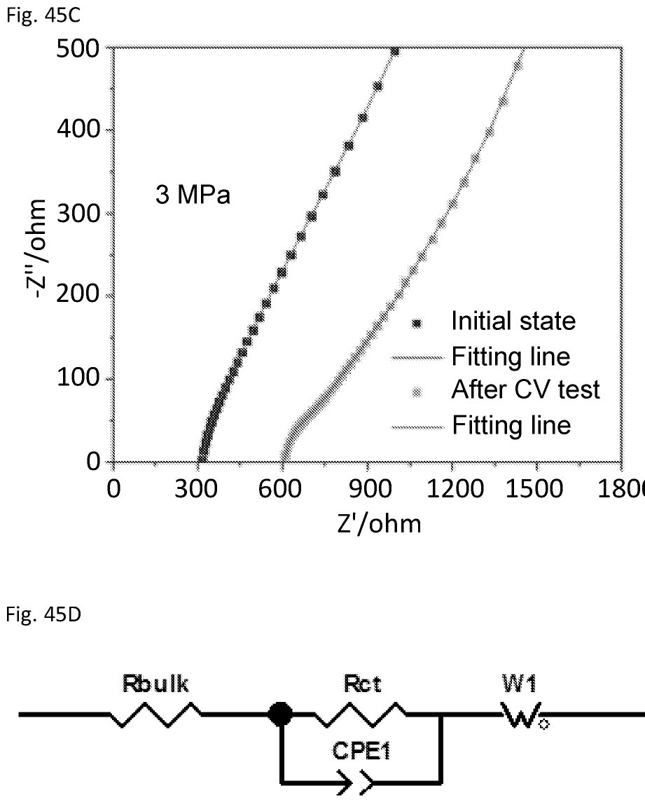

The impedance profiles before and after CV test (FIG. 45A) under 100 MPa or 3 MPa were compared in FIGS. 45B and 45C after fitting with the model shown in FIG. 45D. The calculated R_{bulk} (bulk resistance) and R_{ct} (charge transfer resistance, here was majorly interface resistance) are listed in Table 5. The Ret (38.8Ω) under 100 MPa is much smaller than that under 3 MPa (395.4Ω) due to a better contact at high pressure. After CV test, there is hardly any change of R_{bulk} for the battery under 100 MPa, while that of battery under 3 MPa increases from 300Ω to 600Ω. The significantly elevated resistance was attributed to more severe decomposition of LGPS under ineffective mechanical constriction. Again, from electrochemical test, it is proven that the degree of decomposition is significantly inhibited under optimum constriction conditions.

TABLE 5
Calculated R_{bulk} and R_{ct}

| | R_{BULK}/Ω | R_{CT}/Ω | R_{T}/Ω |
|---|---|---|---|
| 100 MPa-Initial | 13.4 | 38.8 | 52.2 |
| 100 MPa -CV | 13.7 | 20.7 | 34.4 |
| 3 MPa -Initial | 313.7 | 395.4 | 709.1 |
| 3 MPa -CV | 606.0 | 285.3 | 891.3 |

Conclusion

A lithium-graphite composite allows the application of a high external pressure during the test of solid-state batteries with LGPS as electrolyte. This creates a high mechanical constriction on the materials level that contributes to an excellent rate performance of Li/G-LGPS-G/Li symmetric battery. After cycling at high current densities up to 10 mA cm⁻² for such solid-state batteries, cycling can still be performed normally at low rates, suggesting that there is no lithium dendrite penetration or short circuit. The reduction pathway of LGPS decomposition under different mechanical constrictions are analyzed by using both experimental XPS measurements and DFT computational simulations. It shows, for the first time, that under proper mechanical constraint, the LGPS reduction follows a different pathway. This pathway, however, can be influenced kinetically by the high current density induced overpotential. Therefore, the decomposition of LGPS is a function of both mechanical constriction and current density. From battery cycling performance and impedance test, it is shown that high mechanical constriction along with the kinetically limited decomposition pathway reduces the total impedance and realizes a LGPS-lithium metal battery with excellent rate capability.

Methods

Electrochemistry

Graphite thin film is made by mixing active materials with PTFE. The weight ratio of graphite film is graphite:PTFE=95:5. All the batteries are assembled using a homemade pressurized cell in an argon-filled glovebox with oxygen and water <0.1 ppm. The symmetric battery (Li/G-LGPS-G/Li or Li-LGPS-Li) was made by cold pressing three layers of Li(/graphite)-LGPS powder-(graphite/)Li together and keep at different pressures during battery tests. The batteries were charged and discharged at different current densities with the total capacity of 0.25 mAh cm⁻² for each cycle. A LiCoO₂ half battery was made by cold pressing Li/graphite composite-LGPS powder-Cathode film using a hydraulic press and keep the pressure at 100-250 MPa. The LiCoO₂ were coated with LiNbO₃ using sol-gel method. The weight ratio of all the cathode films was active materials:LGPS:PTFE=68:29:3. Battery cycling data were obtained on a LAND battery testing system. The cyclic performance was tested at 0.1 C at 25° C. The CV test (Li/G-LGPS-LGPS/C) was conducted on a Solartron 1400 cell test system between OCV to 0.1V with the scan rate of 0.1 mV/s. The LGPS cathode film for CV test is made with LGPS:super P:PTFE=87:10:3.

Material Characterization

XRD: The XRD sample was prepared by hand milling LGPS powder with lithium metal and/or graphite with weight ratio=1:1 in a glovebox. The powder mixtures were put on a hotplate and heated to the nominal temperature (500° C.) for 36 hours and then characterized by XRD. XRD data were obtained using a Rigaku Miniflex 6G. The mixtures of LGPS and graphite before and after high temperature treatment were sealed with Kapton film in an argon-filled glovebox to prevent air contamination.

SEM and XPS: Cross-section imaging of the pellet of Li/graphite-LGPS-graphite-Li was obtained by a Supra 55 SEM. The pellet was broken into small pieces and attached onto the side of screw nut with carbon tape to make it perpendicular to the beam. The screw nuts with samples were mounted onto a standard SEM stub and sealed into two plastic bags inside an argon-filled glove box. FIB-SEM imaging was conducted on an FEIHelios 660 dual-beam system. The XPS was obtained from a Thermo Scientific K-Alpha+. The samples were mounted onto a standard XPS sample holder and sealed with plastic bags as well. All samples were transferred into vacuum environment in about 10 seconds. All XPS results are fitted through peak-differentiating and imitating via Avantage.

Computational Methods All DFT calculations were performed using the Vienna Ab-initio Simulation Package (VASP) following the Material Project calculation parameters.³² A K-point density of 1000 kppa, a cutoff of 520 eV, and the VASP recommended pseudopotentials were used. Mechanically constrained phase diagrams were calculated using Lagrange minimization schemes as outlined in Ref. 13 for effective moduli of 0, 5, 10 and 15 GPa. All Li—Ge—P—S phases in the Material Project database were considered. Bader charge analysis and spin polarized calculations were used to determine charge valence.

### Example 5

In this work, we focused on how the external application of either high-pressure or isovolumetric conditions can be used to stabilize LGPS at the materials level through the control at the cell-level. This advances beyond the microstructural level mechanical constraints present in previous works, where particle coatings were used to induce metastability. Under proper mechanical conditions, we show that the stability window of LGPS can be widened up to the tool testing upper limit of 9.8 V. Synchrotron X-ray diffraction (XRD) and x-ray absorption spectroscopy (XAS) that measure the structure changes of LGPS before and after high-voltage holding show, for the first time, direct evidence of LGPS straining during these electrochemical processes. Both thermodynamic and kinetic factors are further considered by comparing density functional theory (DFT) simulations and x-ray photoelectron spectroscopy (XPS) measurements for decomposition analysis beyond the voltage stability window. These results suggest that mechanically-induced metastability stabilizes the LGPS up to approximately 4V. Additionally, from 4-10V, the local stresses experienced by decomposition amid rigid mechanical constraints leads to kinetic stability. Combined, mechanically-induced metastability and kinetic stability allow expansion of the voltage window from 2.1V to nearly 10V. To demonstrate the utility of this approach for practical battery systems, we construct fully solid-state cells using this method with various cathodes materials. Li₄Ti₅O₁₂ (LTO) anodes are paired with LiCo_{0.5}Mn_{1.5}O₄ (LCMO), LiNi_{0.5}Mn_{1.5}O₄ (LNMO) and LiCoO₂ (LCO) cathodes to demonstrate the high-voltage stability of constrained LGPS. To further probe the electrochemical window of LGPS, we report the first all-solid-state battery based on lithium metal and LiCo_{0.5}Mn_{1.5}O₄, which can be charged to 6-9 V and cycled up to 5.5 V.

Results

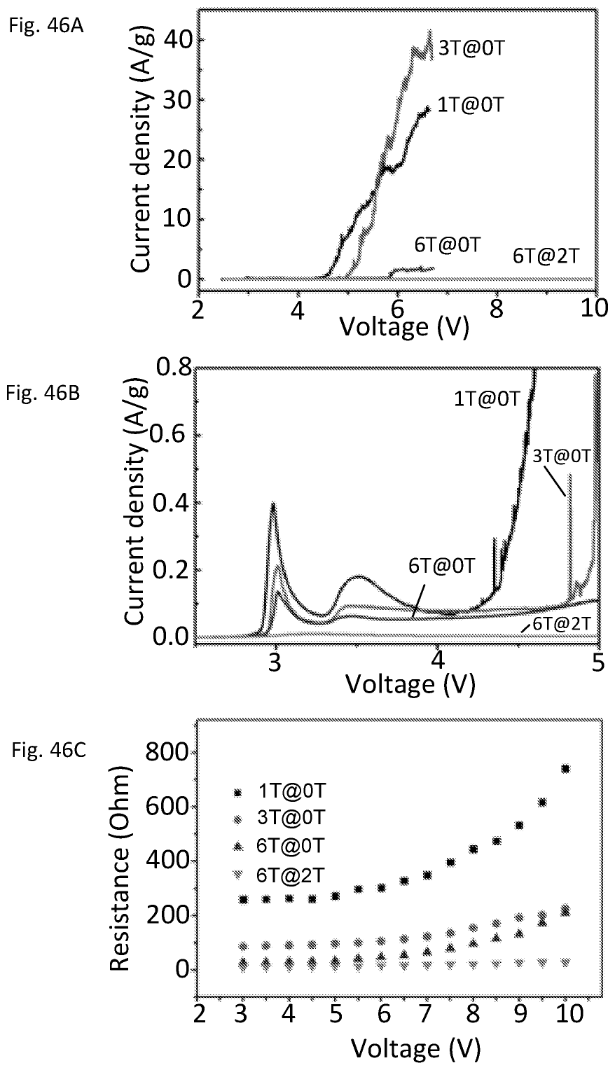

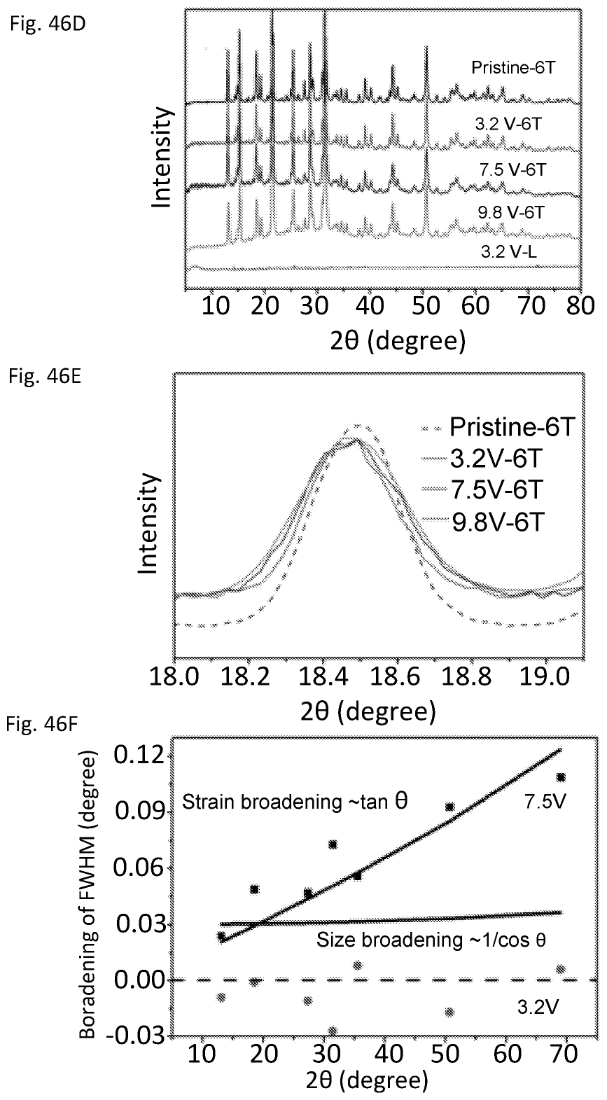

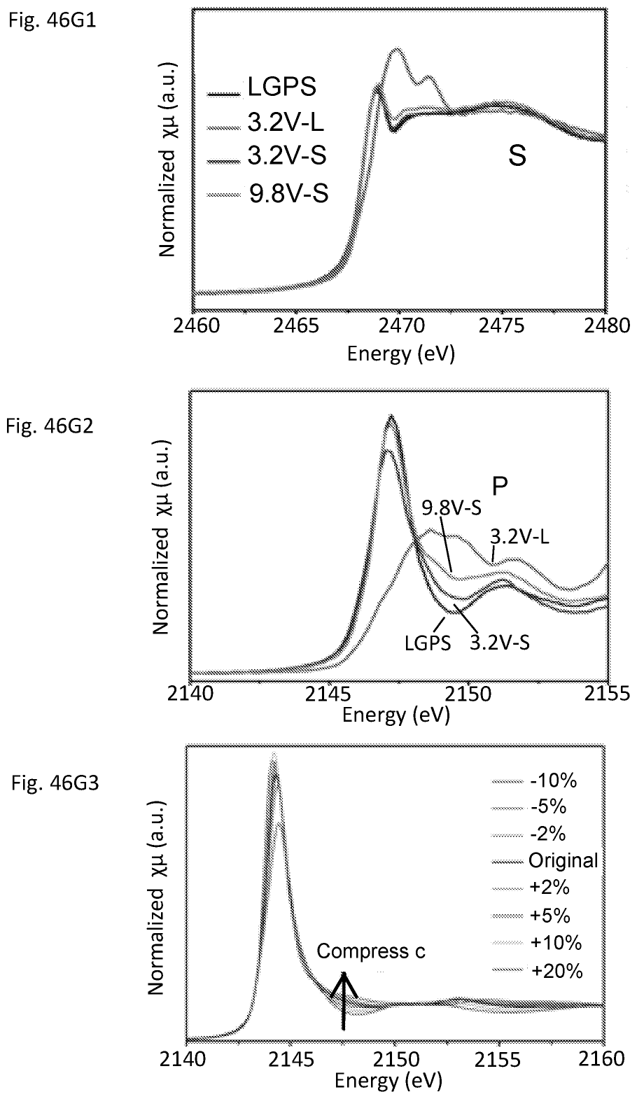

To illustrate how mechanical constraint influences the electrochemical stability of LGPS, cyclic voltammetry (CV) tests of LGPS+C/LGPS/Li cells were performed (FIG. 46A). Three batteries were pre-pressed with 1, 3, or 6 tons (T) of force (78 MPa, 233 MPa and 467 MPa, respectively) in the assembly and then tested in normal Swagelok batteries. The external pressure of a tightened Swagelok battery was calibrated as a few MPa, giving a quasi-isobaric battery testing condition. In addition, one battery was initially pressed at 6 T and then fastened in a homemade pressurized cell with a constantly applied external pressure calibrated as about 200 MPa during the battery test, enforcing a quasi-isovolumetric battery testing environment. The density of the LGPS pellets after being pre-pressed at 1, 3, and 6 T were 62%, 69% and 81%, respectively, of the theoretical density of single crystal LGPS. The morphology of LGPS pellets after pressing is shown in FIG. 51A. The density of pellet in the pressurized cell calculated from an in-situ force-displacement measurement (FIG. 51B), however, was already close to 100% beyond 30 MPa external pressure.

As shown in FIG. 46A, in Cyclic Voltammetry (CV) test there exists a threshold voltage beyond which each cell begins to severely decompose. These thresholds were 4.5 V, 5V and 5.8V for those isobaric cells pre-pressed at 1 T, 3 T and 6 T, respectively. The isovolumetric cell, however, was charged up to 9.8V and showed no obvious decomposition. In the low-voltage region (FIG. 46B), two minor decomposition peaks can be seen at ˜3 V and ˜3.6 V for the isobaric cells, where decreasing peak intensity was observed at increasing pressure in the pre-press step. On the contrary, the isovolumetric cell completely avoids these peaks. The in-situ resistance of batteries in these four cells were measured by impedance spectroscopy at different voltages during the CV tests (FIG. 46C). Higher pressure in pre-press here was found to improve the contact among particles and thus reduce the initial resistance in solid-state battery systems (at 3V in FIG. 46C). However, when the CV test was conducted toward high voltages, the resistance increased much faster in the isobaric cells, indicating that the LGPS in cathode undergoes certain decomposition in the condition of weak mechanical constriction. In contrast, there was almost no change of resistance for the battery tested using the isovolumetric cell. It is worth noting that the voltage stability window of crystalline LGPS toward high voltage was expanded from 2.1 V to around 4.0 V by mechanical constriction induced metastability, the stabilities of 5V to 10V observed in the batteries in FIG. 46A far beyond 4 V suggest a different phenomenon.

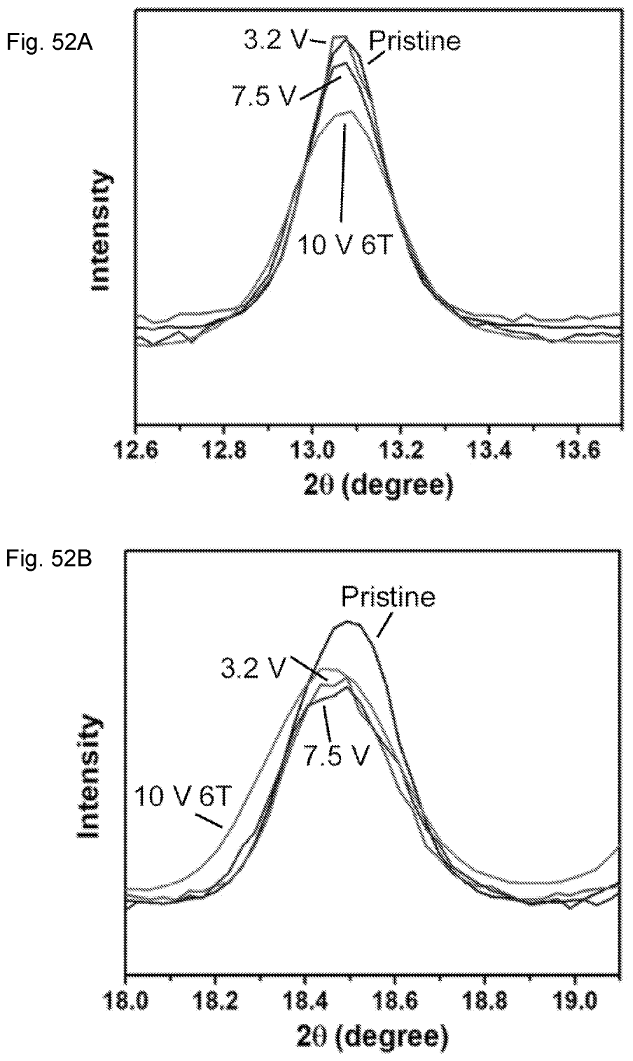

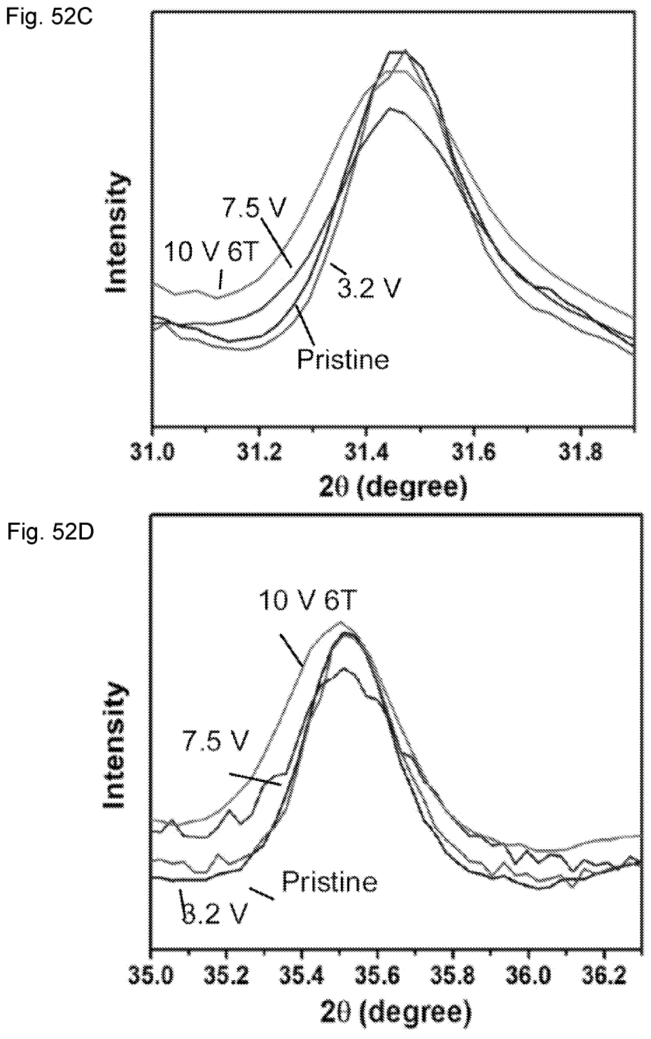

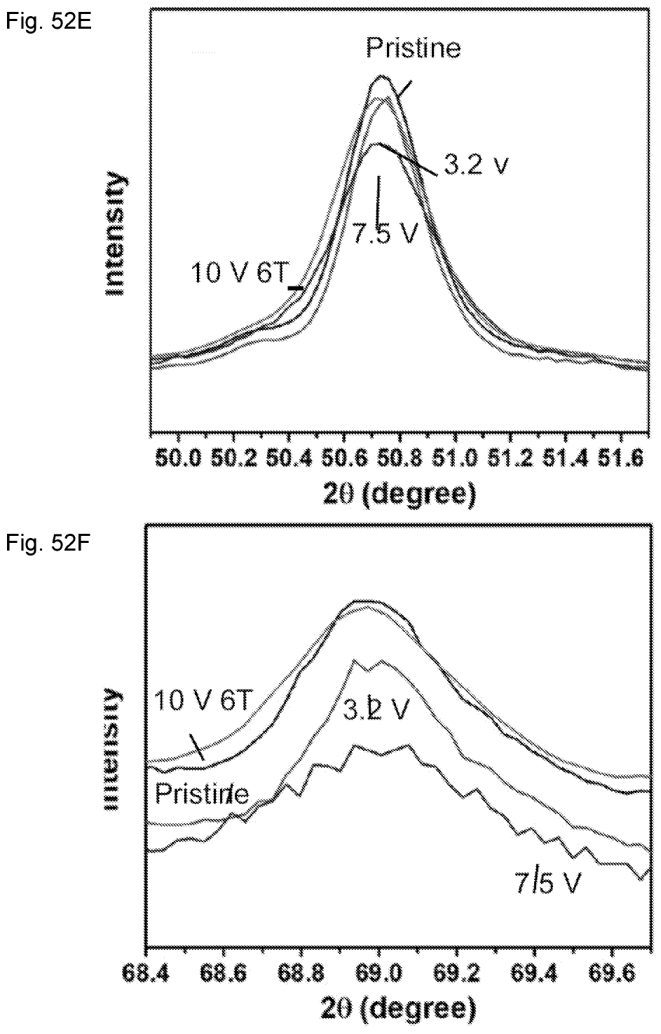

The synchrotron XRD of LGPS from the isovolumetric cell, as shown in FIG. 46D, indicates the general crystal structure of LGPS after CV test up to 9.8 V remains unchanged. However, the broadening of XRD peaks was observed after high-voltage CV scan at 7.5V and 10V (FIGS. 46E and 52). The peak broadening with increasing 20 angles (FIG. 46F) was found to follow the strain broadening mechanism rather than the size broadening. Note that no obvious strain broadening was observed at 3.2V.

This strain effect was further elucidated from XAS measurement and analysis. FIG. 46G shows the P and S XAS peaks of pristine LGPS compared with the ones after CV scan up to 3.2V and 9.8V in liquid or solid-state batteries. In the conditions of no mechanical constraint (denoted as 3.2V-L), where LGPS and carbon were mixed with binder and tested in a liquid battery, both P and S show obvious peak shift toward high energy and the shape change, indicating significant global oxidation reaction and rearrangement of local atomic environment in LGPS in the liquid cell. Whereas the P and S peaks don't show any sign of global oxidation in solid state batteries, as no peak shift is observed. However, it is worth noting that the shoulder intensity increases at 2470 eV and 2149 eV in P and S spectra, respectively. An ab initio multiple scattering simulation of P XAS in LGPS with various strain applied to the unit cell is shown in FIG. 46H. A comparison between experiment and simulation suggests that the increase of shoulder intensity in XAS here might be caused by the negative strain, i.e., the compression experienced by crystalline LGPS after CV scan and holding at high voltage. If we connect the strain broadening in XRD with the shoulder intensity increase in XAS, and simultaneously considering that no obvious decomposition current was observed in the CV test up to 10V, a physical picture emerges related to the small local decomposition under proper mechanical constriction. Under a constant external pressure around 150 MPa with nearly zero porosity in the LGPS pellet, macroscopic voltage decomposition of LGPS was largely inhibited kinetically beyond the voltage stability window, i.e. 4.0 V, giving no global transfer of Li⁺ ion and electron, and hence no decomposition current in CV test. However, small local decomposition inside and between LGPS particle was still able to form. Since decomposition in LGPS is with positive reaction strain, such small local decomposition will exert a compression to the neighboring crystalline LGPS under a mechanically constrictive environment, inducing the strain broadening observed in XRD and the shoulder intensity increase observed in XAS. The fact that both XRD and XAS are ex situ measurements supports our picture on the materials level that such local decomposition induced local strain, once formed, won't be easily released due to kinetic barriers, even after the external pressure on the battery cell level has been removed. Namely, proper mechanical conditions can lead to a mechanically-induced metastability in LGPS from 4.0V to 10V without obvious decomposition current in the CV test. Our results here provide direct evidences that the electrochemical window of ceramic sulfides can be significantly widened by the proper application of mechanical constraints.

In theory, given an unconstrained reaction in which LGPS decomposes with a Gibbs energy change of ΔG_{chem}<0, the reaction can be inhibited by the application of a mechanical constraint with effective bulk modulus (K_{eff}) if:

ΔG_{chem}+K_{eff}ϵ_{RXN}>0 (1)

Where V is the reference state volume and E_{RXN} is the stress-free reaction dilation—in other words ϵ_{RXN} is the fractional volume change of LGPS following decomposition in the absence of any applied stress. The effective bulk modulus of equation one is the bulk modulus of the ceramic sulfide (Kₘₐₜₑᵣᵢₐₗ) added in parallel with the mechanical constraint as given in equation 2⁸:

K_{eff}⁻¹=Kₘₐₜₑᵣᵢₐₗ⁻¹+K_{constraint}⁻¹ (2)

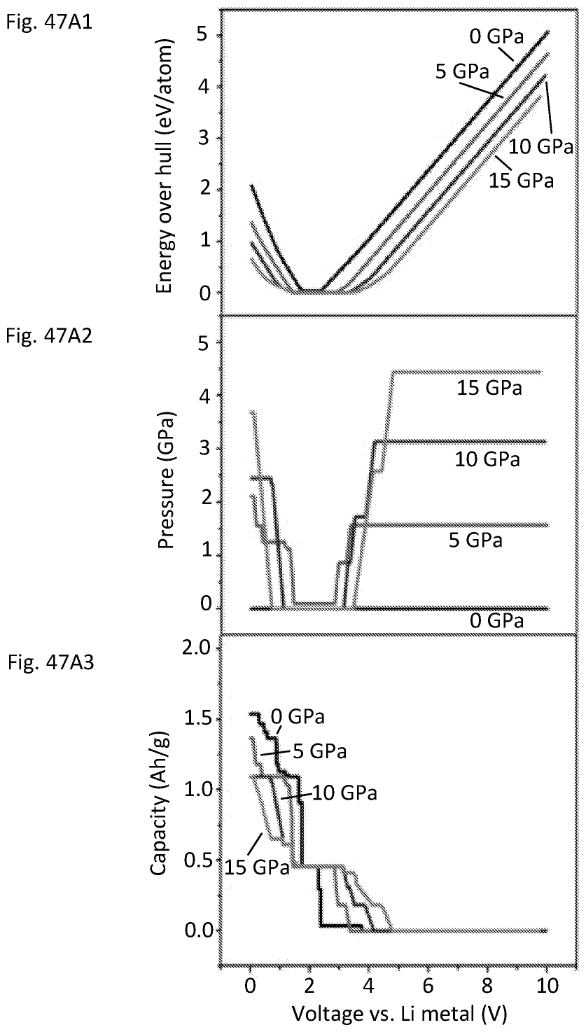

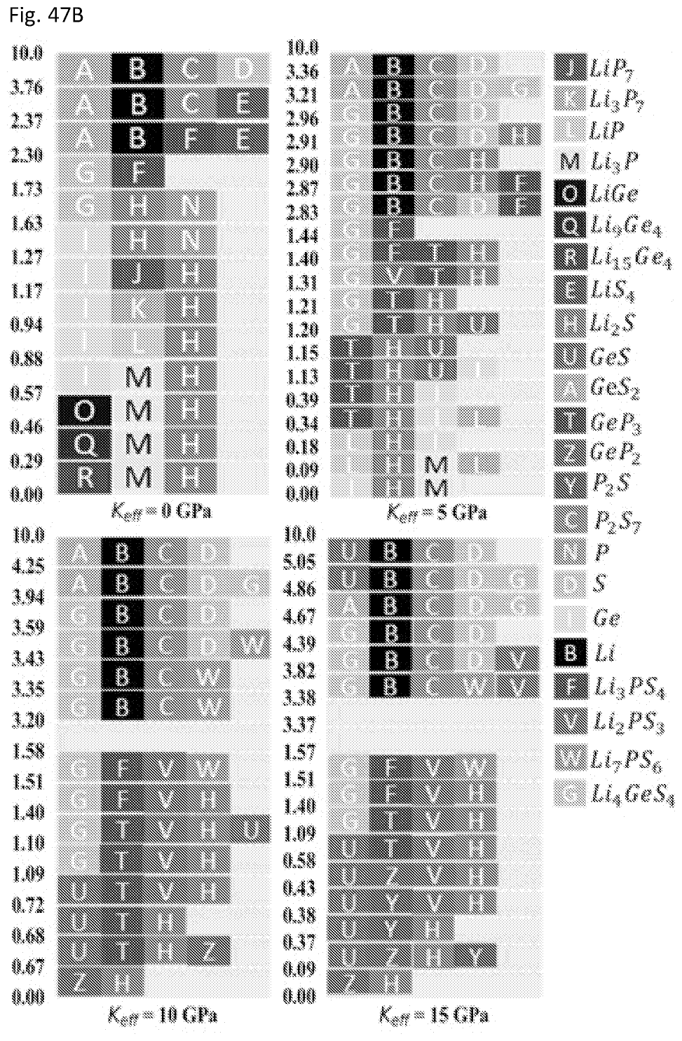

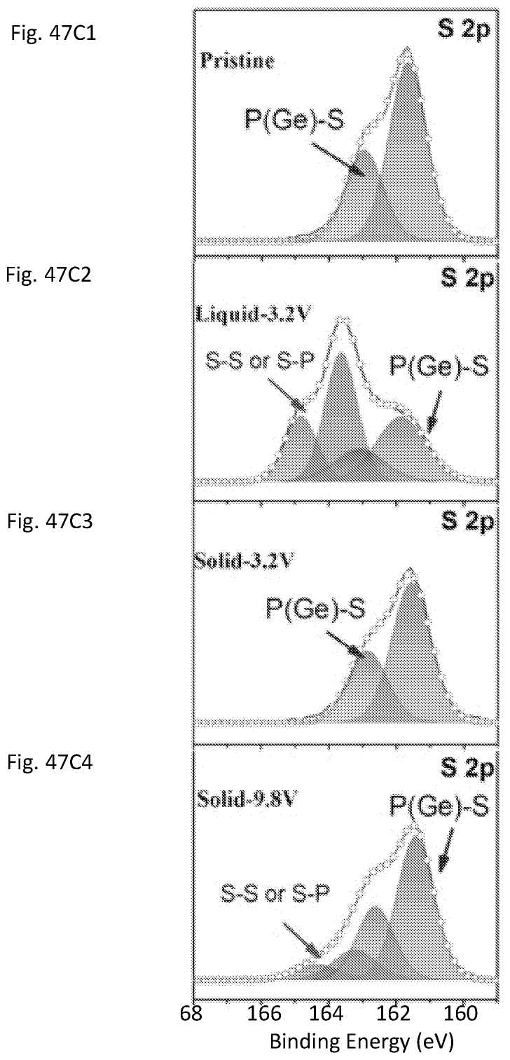

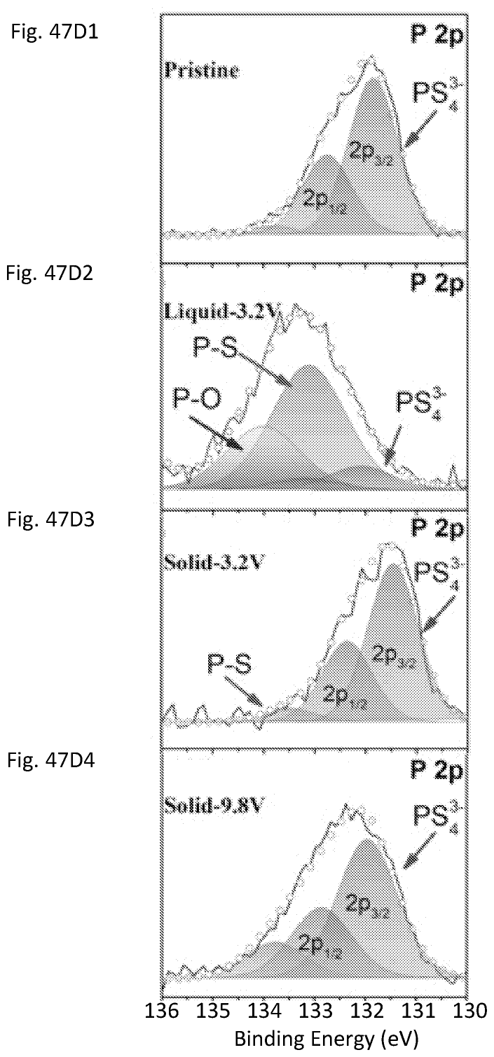

Minimization of free energy in the mechanically constrained ensemble allows for calculating the expanded voltage window and the ground state decomposition products. Using ab-initio data, FIG. 47A shows the results of such calculations for LGPS at four levels of mechanical constraint (K_{eff}=0, 5, 10.15 GPa) in the voltage range of 0-10V. FIG. 47A1 shows the energy above the hull, or the magnitude of the decomposition energy. An energy above the hull of 0 eV atom⁻¹ indicates that thermodynamically the LGPS is the ground state product, whereas an elevated value indicates that the LGPS will decay. The region in which the energy above the hull is nearly zero (<50 meV for thermal tolerance) is seen to increase in upper voltage limit from approximately 2.1 V to nearly 4V. FIG. 47A2 shows the ground state pressure corresponding to the free energy minimization. The pressure is given by K_{eff}ϵ_{RXN} where E_{RXN} corresponds to the fraction volume transformation of LGPS to the products that minimize the free energy. The ground state pressure reaches 4 GPa in the high voltage limit at K_{eff}=15 GPa, corresponding well to the level of local strain used in the XAS simulation of strained LGPS in FIG. 46H. FIG. 47A3 shows the total specific lithium capacity of the ground state products, which predicts that LGPS electrolyte will not provide more lithium capacity, or make further decomposition, beyond 5V under any K_{eff} below 15 GPa.

The exact decomposition products predicted by DFT without considering the thermal tolerance are shown in FIG. 47B in the entire voltage range at different K_{eff}, with the exact reaction equations listed in Table 7. This simulation actually predicts thermodynamically how the small local decomposition reaction induced by electrochemical driving force, as discussed in FIG. 46, quantitively changes under mechanical constrictions. The elemental valence states in the decomposition can thus be directly compared with the XPS measurement that is sensitive to the chemical valence information on the particle surface (FIG. 47C, D), providing complementary information to the bulk sensitive XAS. Stoichiometric LGPS is comprised of valence states Li¹⁺, Ge⁴⁺, P⁵⁺, S²⁻. As LGPS undergoes the formation of lithium metal (Li¹⁺→Li⁰) at high voltages, remaining elements must become oxidized. For K_{eff}=0 GPa, our simulation in FIG. 47B suggests that sulfur is the most likely to be oxidized, forming S₄¹⁻(LiS₄) above 2.3V and S° (elemental sulfur) above 3.76V. From the DFT simulation of Bader charge, S₄¹⁻ or S shows very similar charge state, and obviously higher than S²⁻ in LGPS, which is consistent with the large amount of oxidized S observed in XPS for LGPS in the liquid cell after CV scan to 3.2V and hold for 10 hours (FIG. 47C2). Similarly, the oxidization of P in the same 3.2V liquid cell is observed to form P⁵⁺ in PS₄³⁻ (FIG. 47D2). This suggests that the thermodynamically favored decomposition is in fact representative of the decomposition that occurs experimentally in the liquid cell with K_{eff}=0 (as opposed to an alternative kinetically favored decomposition under mechanical constriction).

In contrast, the calculated thermodynamic stability limit of LGPS reaches nearly 4V at K_{eff}=15 GPa. Accordingly, there was no oxidization of S and a very small amount of oxidized P was observed in the condition of strongly constrained LGPS at 3.2V in FIGS. 47C3 and D3. This small amount of oxidized P could be attributed to the ineffective constraint from the device or the voltage is close to the thermodynamic voltage. Furthermore, beyond the voltage stability limit for the case of 9.8 V, the solid-state battery showed less oxidized S or P than it was expected. Note that from FIG. 47B, there is supposed to be the decomposition of LGPS into S element and oxidized P in Li₇PS₆ or Li₂PS₃. However, this thermodynamic pathway was bypassed. Beyond this thermodynamic stability, there is kinetical factor to stabilize sulfide electrolyte under high mechanical constraint.

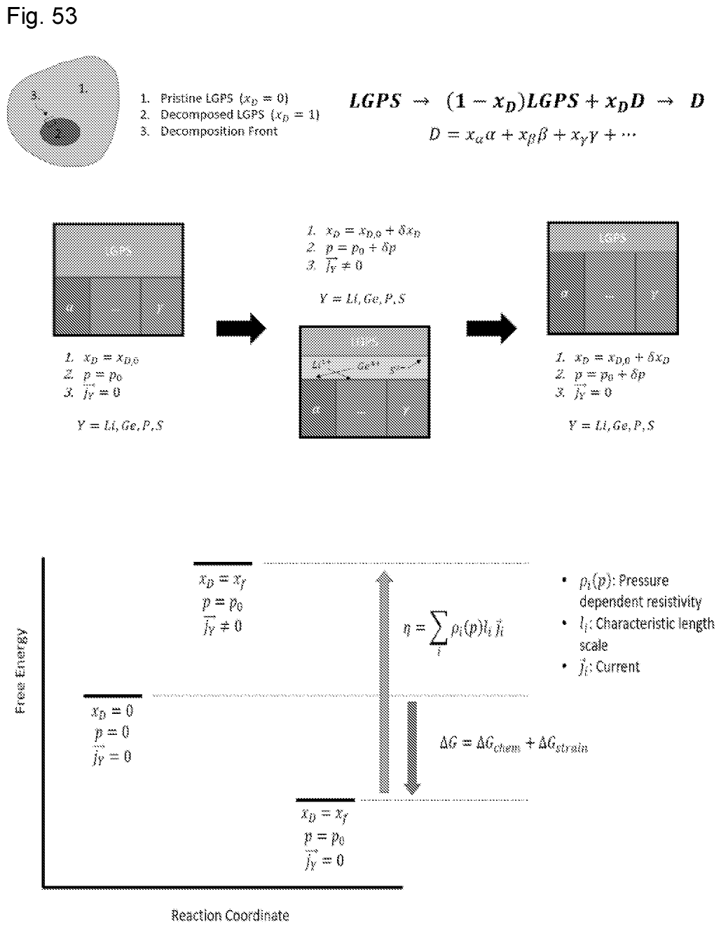

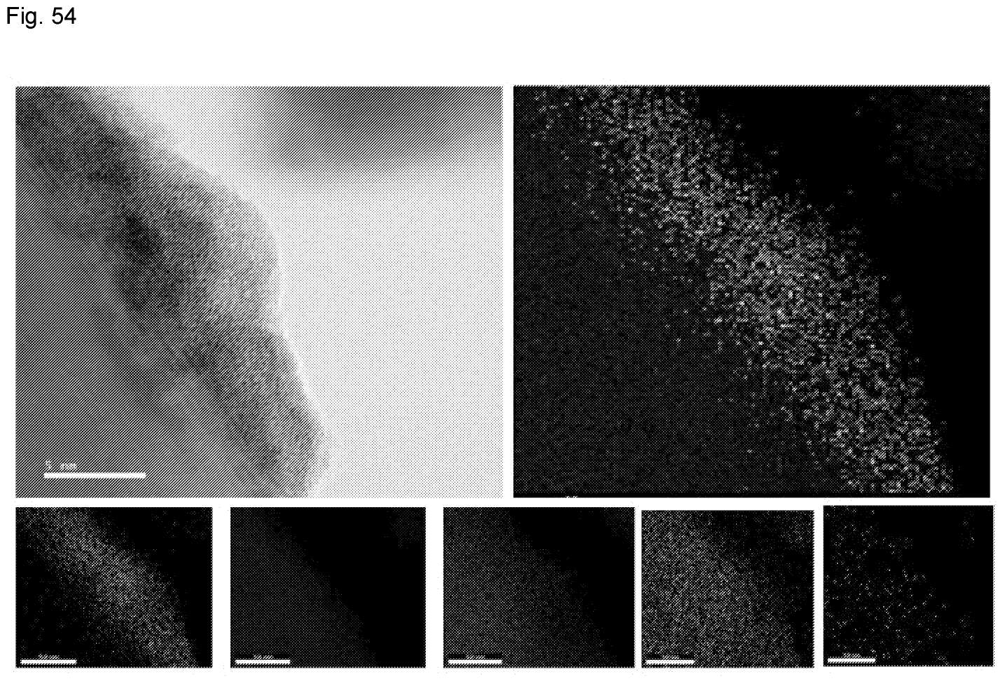

The application of the mechanical constraint can greatly reduce the speed at which ceramic sulfides decay as depicted in FIG. 53. Upon sufficient slowing of the decay rate, the effective stability—the “mechanically-induced kinetic stability”—was sufficiently high as to allow battery operation. For example, if the electrolyte only decays one part per million per charge cycle, then it was sufficiently stable for practical battery designs that only need last thousands of cycles.

The proposed mechanism for mechanically-induced kinetic stability is depicted in FIG. 53. Within a given particle of LGPS that is undergoing decomposition, the particle can be partitioned into three regions. The first two are the decomposed and pristine regions, which are indicated in FIG. 53 (top) by the mole fraction of decomposed LGPS (x_{D}=1 for purely decomposed, x_{D}=0 for pristine). The third region is the interface, where the mole fraction transitions from 0 to 1. The propagation direction of the decomposition front is controlled by thermodynamic relation of Equation 1. If Equation 1 is satisfied, the front will propagate inwards, preferring the pristine LGPS. Accordingly, the LGPS will not decompose. When Equation 1 is violated, the front will propagate into the LGPS and ultimately consume the particle.

However, even when Equation 1 is violated, the speed with which the front propagates into the pristine LGPS will still be influenced by the application of mechanical constraint. This is illustrated in FIG. 53 (bottom). As the decomposition front propagates, there must exist ionic currents tangential to the front's curvature. This requires the presence of an overpotential to accommodate the finite conductivity of the front for each elemental species. The ohmic portion of the overpotential is given by the sum of equation 3, where ρᵢ(p) is the resistivity of the front for each species i at the pressure (p) that is present at the front, lᵢ is the characteristic length scale of the decomposed morphology, and jᵢ is the ionic current density.

$$η = {\sum }_{i} {ρ}_{i} ( p ) {l}_{i} {j}_{i} \qquad ( 3 )$$

Given that ρᵢ(p) can quickly grow with constriction, it is to be expected that this overpotential becomes significant at high pressures. This effect can be seen by comparing the expected constriction with prior molecular dynamics results of constricted cells. The pressure on the decomposition front is given by p=K_{eff}ϵ_{RXN} and the elastic volume strain of the material at that pressure is p=Kₘₐₜₑᵣᵢₐₗϵ_{V}. Since the strain of a single lattice vector is approximately ϵ=⅓ϵ_{y}, the strain of the ab-plane of LGPS near the front is expected to be on the order of

$${ϵ}_{ab} \approx \frac{{K}_{e f f}}{{K}_{material}} \frac{{ϵ}_{RXN}}{3} .$$

For well constrained systems where K_{eff}≈Kₘₐₜₑᵣᵢₐₗ, this strain can easily reach 4%, as ϵ_{RXN} exceeds 30% at high voltages. Given that the activation energy for Li migration in LGPS is predicted to increase from 230 meV to 590 meV upon constriction by 4%, the rate at which lithium reordering can occur decreases by a factor of:

$$\frac{exp ( - \frac{590 meV}{{k}_{B} T} )}{exp ( - \frac{230 meV}{{k}_{B} T} )} \approx 1 {0}^{- 6} \qquad ( 4 )$$

This many order of magnitude reduction in the possible reordering rate can explain why, for any voltage below 10V, the isovolumetric cell showed virtually no decomposition current.

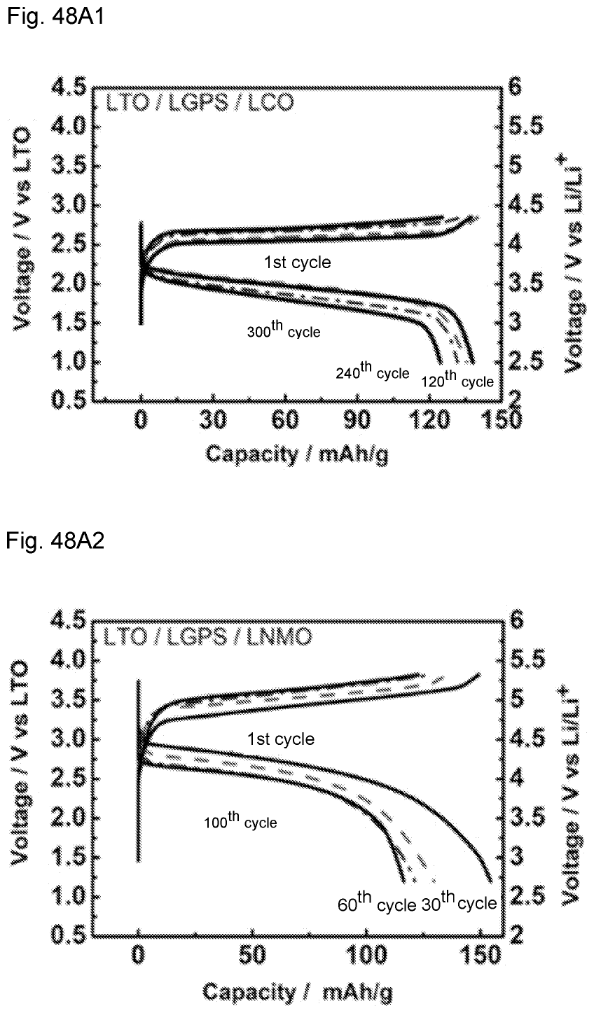

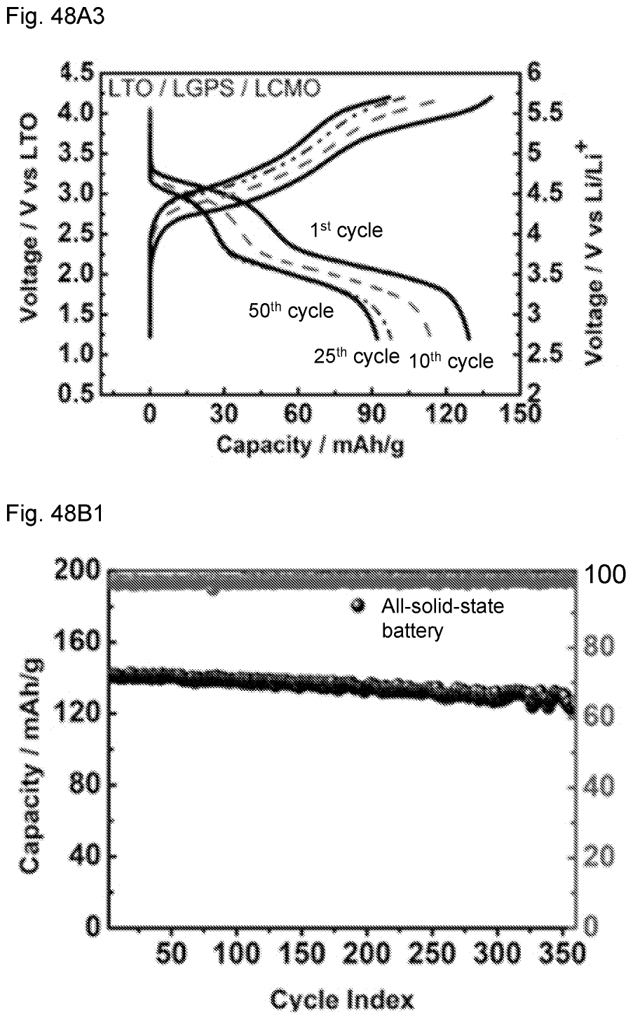

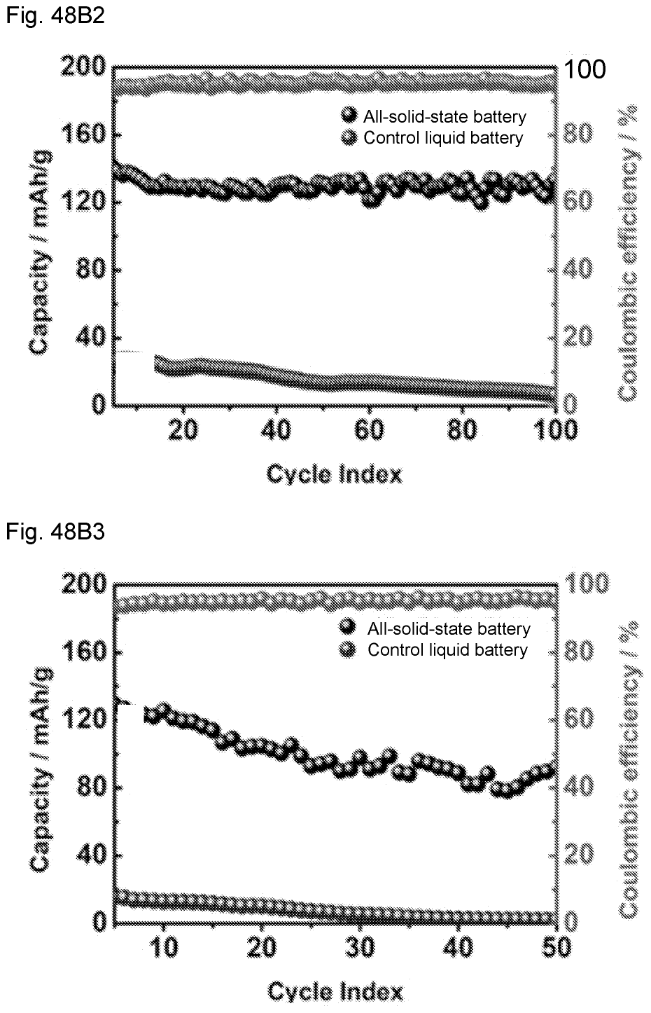

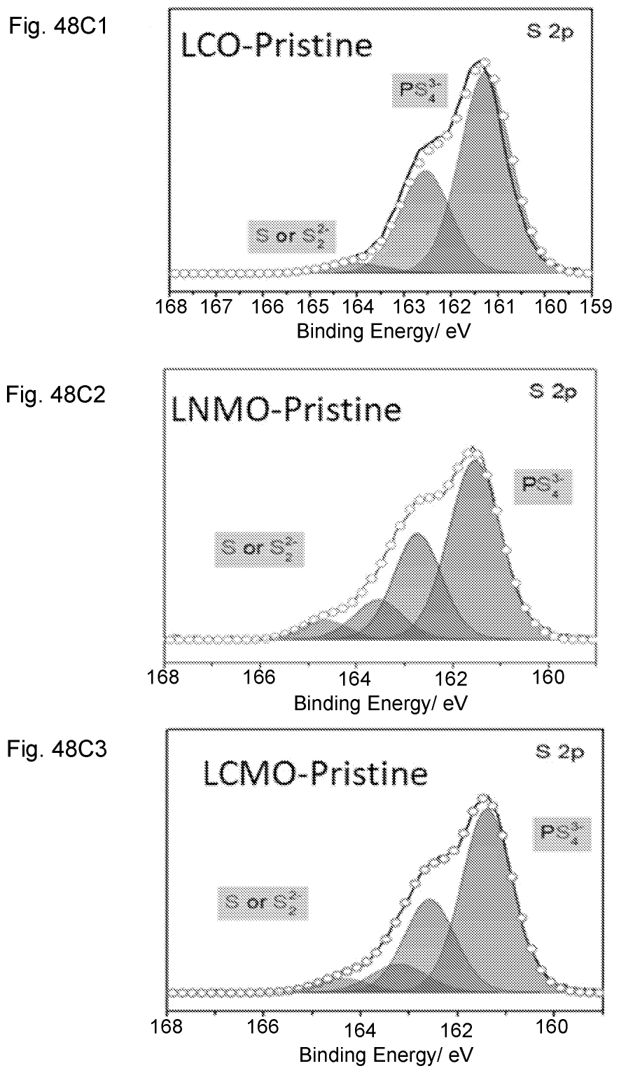

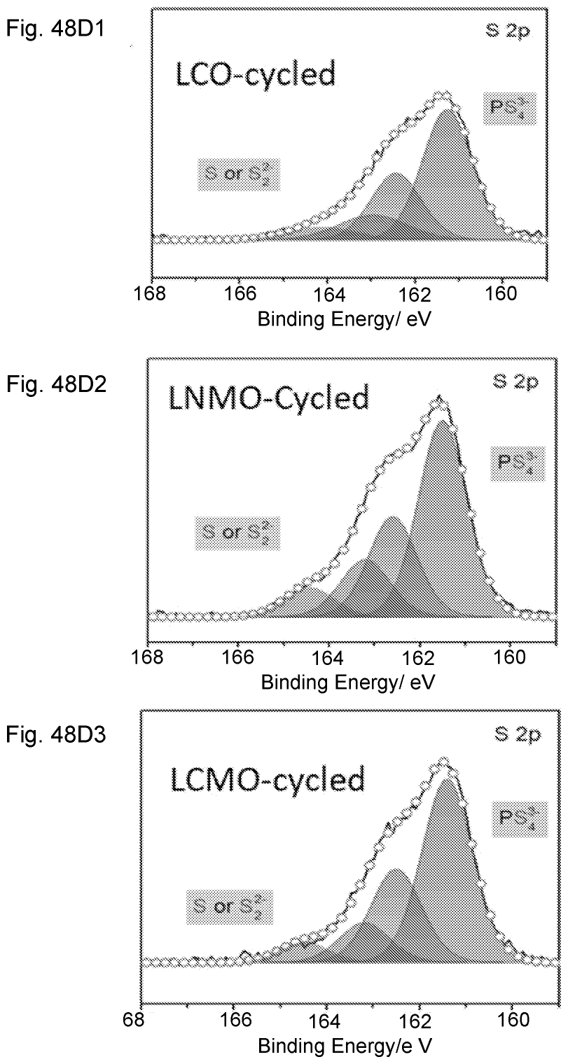

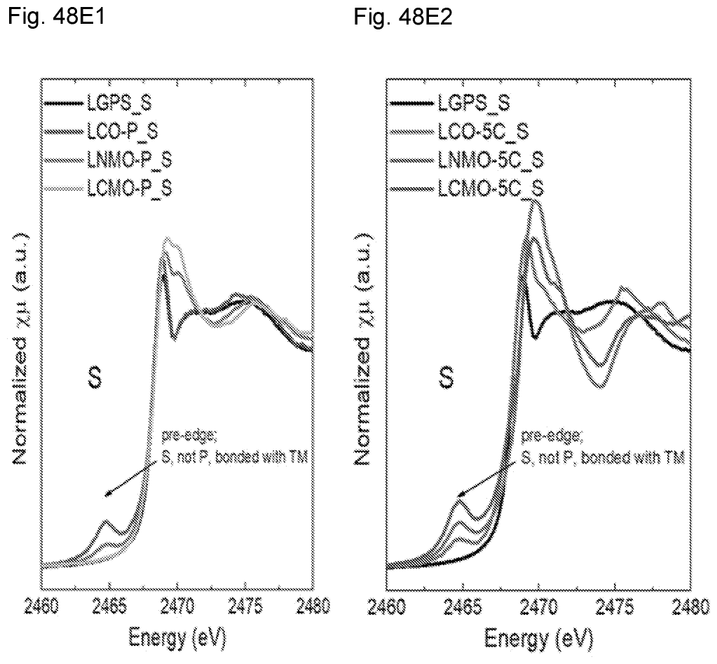

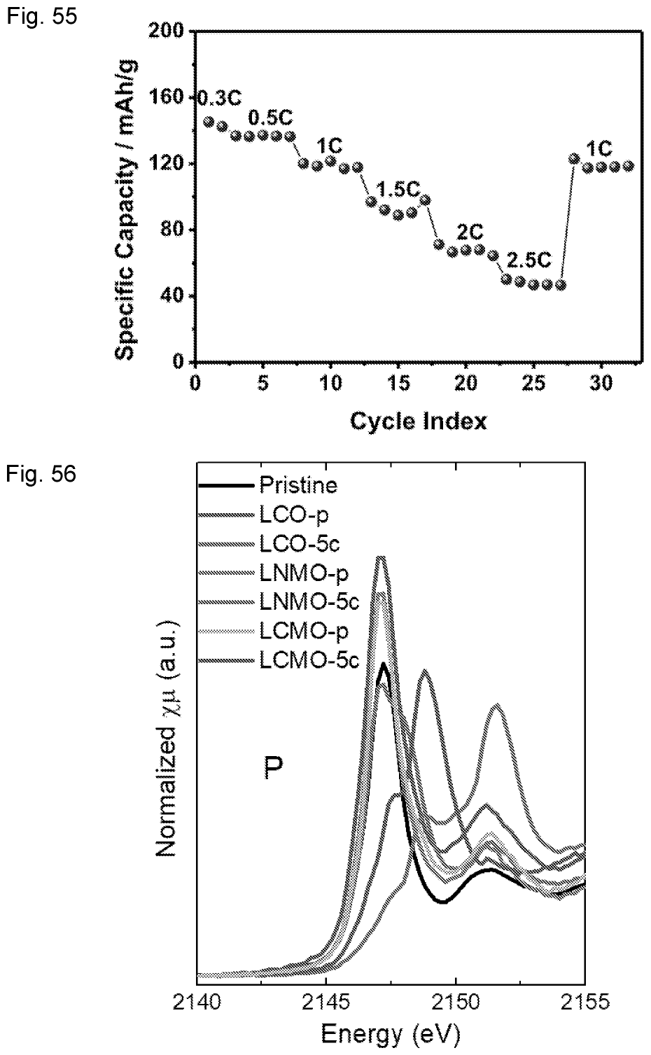

FIG. 48 shows the galvanostatic cycling along with their cyclability performance of all-solid-state batteries, using LCO, LNMO and LCMO as cathode, LGPS as a separator and LTO as anode. The battery tests were performed in the pressurized cell, where the cells were initially pressed with 6T then fastened in bolted [quasi]-isovolumetric cell. It should be noted that LCO is the most common and widely used cathode material, included in commercial Li-ion batteries, with a plateau at approximately 4 V against Li⁺/Li, whereas LNMO is considered one of the most promising high voltage cathode materials with a flat operating voltage at 4.7 V versus Li⁺/Li. The high rate test of LCO full battery is shown in FIG. 55. The charge and discharge curves of LCO and LNMO are depicted in FIGS. 48A1 and 48B1, respectively. Both batteries show a flat working plateau centered at 2 V (3.5 V vs Li⁺/Li) for LCO and 2.9 V (4.4 V vs. Li⁺/Li) for LNMO in the first discharge cycle. Moreover, both of them exhibit excellent cyclability performance, as can be observed in FIGS. 48A2 and B2, with a capacity fading of just 9% in the first 360 cycles for LCO and 18% in the first 100 cycles for LNMO. This is an indication that the decomposition or interfacial reaction of the cathode materials with LGPS was not very severe. These results are in good agreement with the CV tests reported in FIG. 46, where it was shown that mechanical constraint can inhibit the decomposition of LGPS and widen its operational voltage range to much higher values than those previously reported. Moreover, to further probe the stability of LGPS, previously synthesized LCMO was chosen as cathode due to the fact that it presents even a higher operating working plateau than LNMO. FIG. 48A3 depicts the battery test curves of LCMO versus LTO. In both charge and discharge profiles, two plateaus can be observed centered at approximately 2.2 V and 3.2 V (3.7 V and 4.7 V versus Li⁺/Li) in the discharge curve of the first cycle, which are associated to the oxidation reactions of Mn³⁺/Mn⁴⁺ and Co³⁺/Co⁴⁺, respectively. As it is shown in FIG. 48B3, upon cycling some capacity fading was observed, which may be attributed to the side reactions between LCMO and LGPS at high voltage state and corresponds to an 33% in the 50^{th} cycle. Therefore, in contrast to previously reported results, which claims that the stability window of LGPS was limited to a low voltage range, here we show that LGPS can be used as the electrolyte material in high-voltage-cathode all-solid-state batteries, showing a relatively good cycling performance even when the charging plateau is as high as 3.8 V (5.3 V versus Li⁺/Li). FIGS. 48C1-48D3 show the XPS measured binding energy of electrons in LGPS before and after battery cycles using LCO, LNMO and LCMO as cathodes. Each element can become oxidized either by chemical reaction with the cathode material (chemical oxidation) or the delithiation of the LGPS by the application of a voltage (electrochemical oxidation). As depicted in FIGS. 48C1-48D3, those electrons in the characteristic region of sulfur bonded electrons show a peak shift towards a higher energy state after cycling, indicating that the sulfur has become electrochemically oxidized. The presence of oxidized sulfur in the pristine samples is indiciative of the degree of chemical reaction with the cathode material.

XAS measurement shows a pre-edge on the intensity of S element while no pre-edge is found from P (FIGS. 48E and 56), given that S, instead P, is bonded with transition metal, no matter from coating materials or cathode materials. Although the interface reaction is evaluated by the mechanical constraint, there is still a ceterin amount of side reactions happens from the direct contract between cathode materials and LGPS. More interface reactions occur after battery cycles.

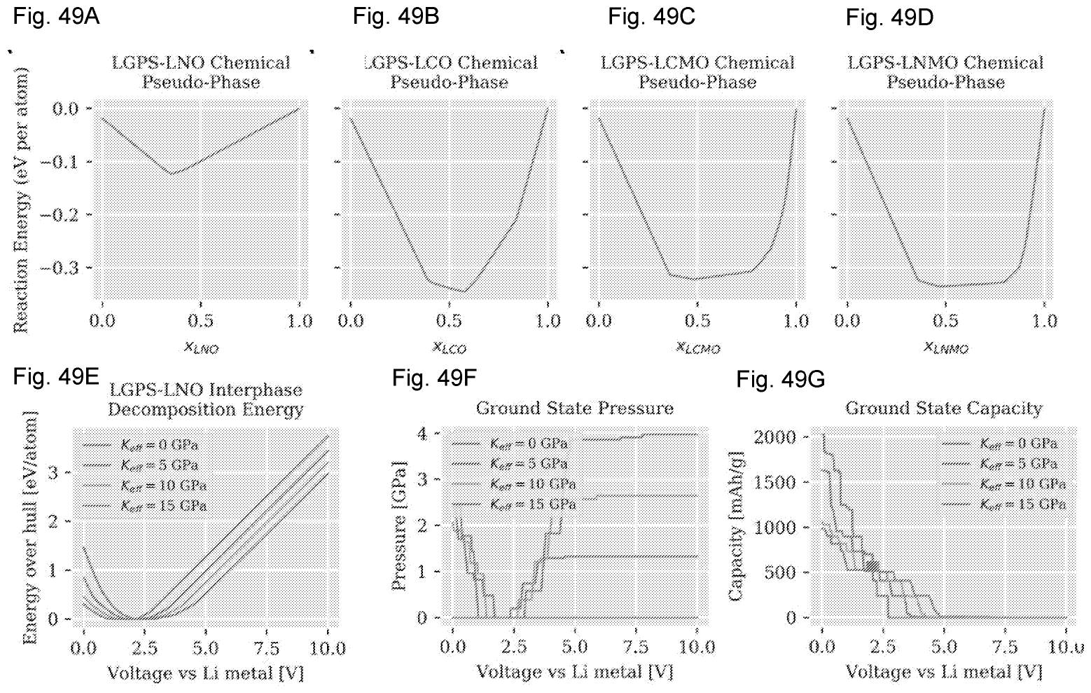

Interfacial reactions between two materials (i.e. LGPS and a cathode material) present computational challenges as ab-initio simulations of the interface present unique burdens. Instead, the preferred method to simulate both chemical and electrochemical stabilities of interfaces are the so-called pseudo-phase (also known as pseudo-binary) methods. In these methods, a linear combination of the materials of interest are taken and represented as a single phase with both composition and energy given by the linear combination. This phase is the pseudo-phase. Conventional stability calculations can then be applied to the pseudo-phase to estimate the reaction energy of the interface. FIGS. 49A-D and Table 6 give the results for chemical reaction pseudo-phase calculations for LGPS+LNO, LCO, LNMO, and LCMO. In FIGS. 49A-D, the atomic fraction of the cathode material (or LNO) is swept from 0 to 1 (representing pure LGPS to pure cathode or LNO). Whichever value of atomic fraction makes the reaction energy the most negative represents the worst-case reaction and is termed xₘ. Table 6 gives these xₘ values for each interface, along with the worst-case reaction energy, the decomposed products, and an additional pseudo-phase that represents the decomposed interface. This pseudo-phase that represents the decomposed interface, also known as the interphase, can be used to calculate how the decomposed interface will further decay as the battery is cycled. FIG. 49E-G show the electrochemical stability of the LGPS+LNO interphase. Note that the chemical reaction between LGPS and the cathode material happens as soon as the materials come in contact during cathode film assembly. This is in contrast with the electrochemical reactions which do not occur until the external circuit assembly is attached. Thus, a major difference between the two is that chemical reactions occur before pressurization/cell assembly whereas the electrochemical reactions occur afterwards. Since the chemical reactions occur in the absence of a fully assembled cell, the initial reactions always occur at K_{eff}=0 (the electrochemical reactions occur at the K_{eff} of the completed assembly).

TABLE 6
Chemical reaction data for the interface between LGPS and either LNO, LCO, LCMO, or LNMO.
E_{RXN} is the worst-case reaction energy between the two phases and xₘ is the atomic fraction
of the non-LGPS phase that is consumed in this worst-case scenario. ‘Products’ lists
the phases that result from this worst-case reaction. ‘Chemical decomp pseudo-phase’
is the application of pseudo-phase theory to the set of products in ‘products.’ It represents
an artificial phase with a linear combination of composition, energy, and volume of its constituent phases.

| LGPS+ | E_{RXN} | xₘ | Products | Chemical decomp pseudo-phase |
|---|---|---|---|---|
| LNO | −0.124 | 0.35 | ‘Li₅Nb₇S₁₄’, ‘Nb₁S₃’, | S_{0.312}Ge_{0.026}Li_{0.33}O_{0.21}Nb_{0.07}P_{0.052} |
| | | | ‘Li₂O₄S₁’, ‘Li₄S₄Ge₁’, | |
| | | | ‘Li₂S₁’, ‘Li₃O₄P₁’ | |
| LCO | −0.345 | 0.58 | ‘Li₄O₄Ge₁’, ‘Co₉S₈’, | Ge_{0.0168}S_{0.2016}Li_{0.313}O_{0.29}Co_{0.145}P_{0.0336} |
| | | | ‘Li₂O₄S₁’, ‘Li₂O₃Ge₁’, | |
| | | | ‘Li₂S₁’, ‘Li₃O₄P₁’ | |
| LCMO | −0.322 | 0.48 | ‘Li₂O₄S₁’, ‘CO₉S₈’, | Ge_{0.0208}Li_{0.2766}O_{0.2743}P_{0.0416}S_{0.2496}Mn_{0.1029}Co_{0.0343} |
| | | | ‘Mn₁S₂’, ‘Mn₁O₁’, | |
| | | | ‘Li₂Mn₁Ge₁O₄’, | |
| | | | ‘Li₂S₁’, ‘Li₃O₄P₁’ | |
| LNMO | −0.335 | 0.47 | ‘Li₂Mn₁Ge₁O₄’, | Ge_{0.0212}Li_{0.2791}O_{0.2686}P_{0.0424}S_{0.2544}Mn_{0.1007}Ni_{0.0336} |
| | | | ‘Ni₃S₄’, ‘Ni₉S₈’, | |
| | | | ‘Mn₁S₂’, ‘Li₂O₄S₁’, | |
| | | | ‘Li₂S₁’, ‘Li₃O₄P₁’ | |

FIGS. 49B-D show that the chemical reaction energies for LCO, LNMO, and LCMO are 345, 322, and 335 meV atom⁻¹, respectively. Despite being coated with LNO, which has a much lower reaction energy of 124 meV atom⁻¹ (FIG. 49A), the coating is not perfect allowing some contact with LGPS which results in the chemical oxidation of sulfur seen in the pristine samples of FIGS. 48C-48E. FIGS. 49E-G show that the products that result from the chemical reaction of LGPS and LNO (which constitute the LGPS-LNO interphase) also experience mechanically-induced metastability. Thus, in a full cell in which the cathode particles are coated with LNO, proper constriction (such as those batteries depicted in FIG. 48) should lead to mechanically-induced metastability both within the bulk of the solid-electrolyte as well as at the interface with the cathode materials. As a general rule, LGPS interfaces were more likely to experience mechanically-induced metastabilities with insulators (such as LNO) than with conductors (such as LCO, LNMO, and LCMO). The reason for this is that when the interphase oxidizes to form lithium metal, the lithium metal will form locally if the interface is between two electronically insulating materials. If one of the two phases is conducting, however, the lithium ions can migrate to the anode and thus form a non-local phase. In the latter case, the local reaction dilation will be greatly reduced as the volume of the formed lithium phase will not be included in the local volume change. In contrast, if the lithium metal phase forms locally, it contributes to a larger local volume change and, hence, a larger reaction dilation. For this reason, coating cathode materials in an insulator such as LNO is needed in order for constraints to lead mechanically-induced metastability on the interface of the LGPS.

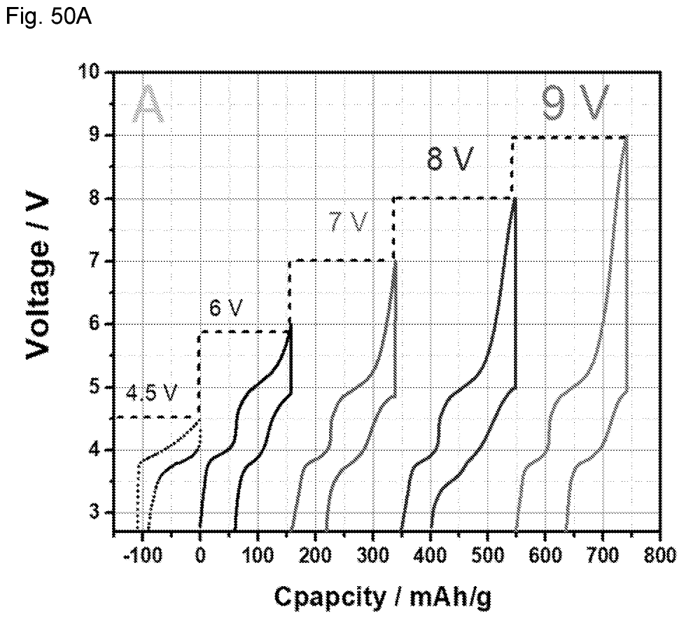

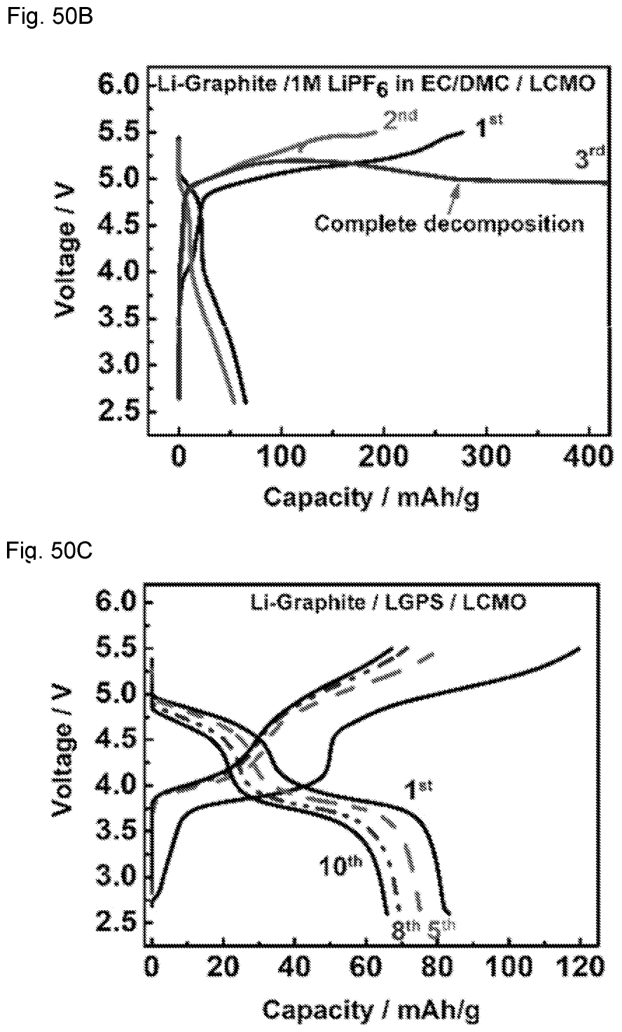

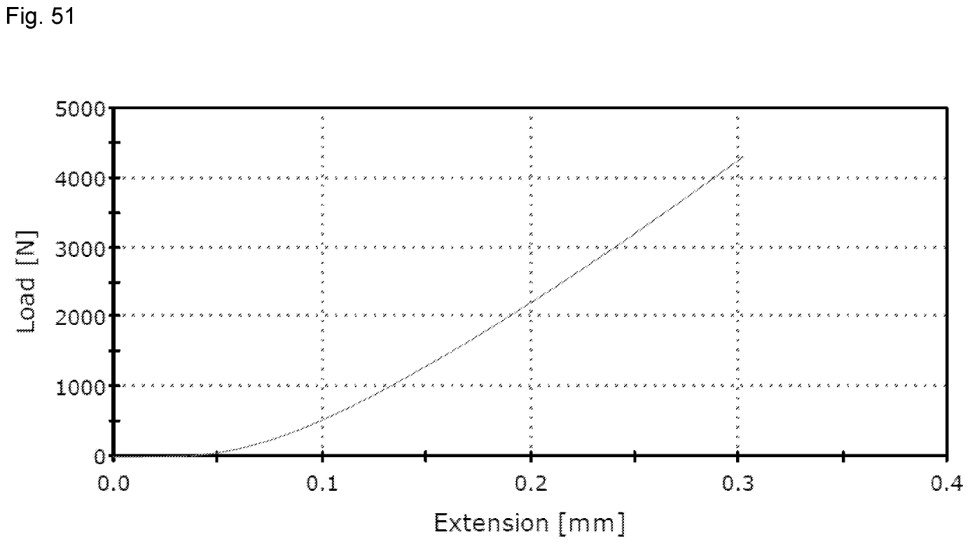

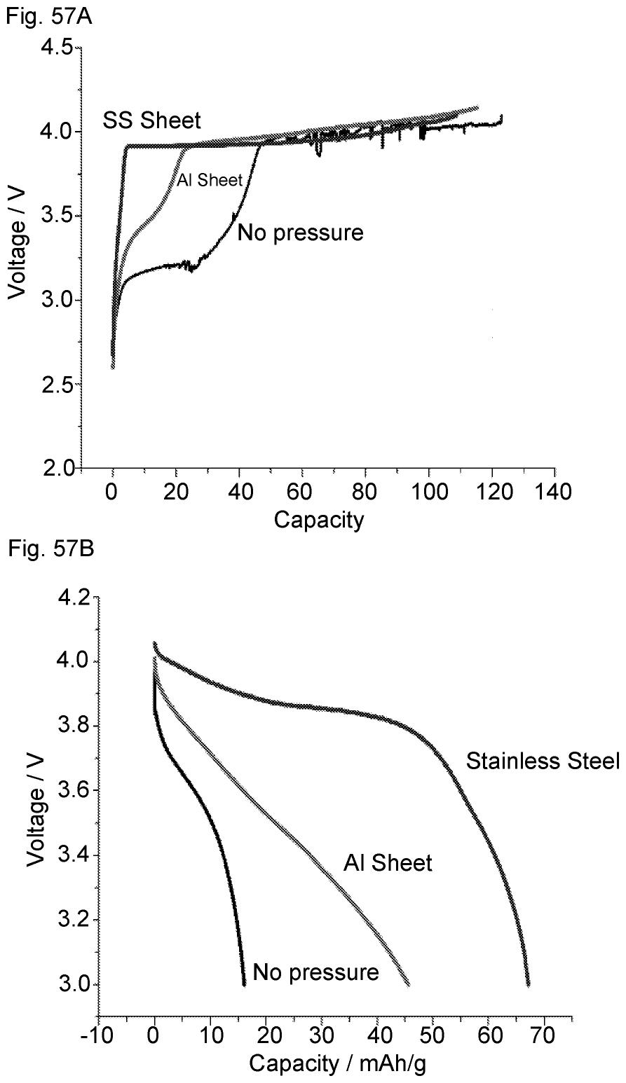

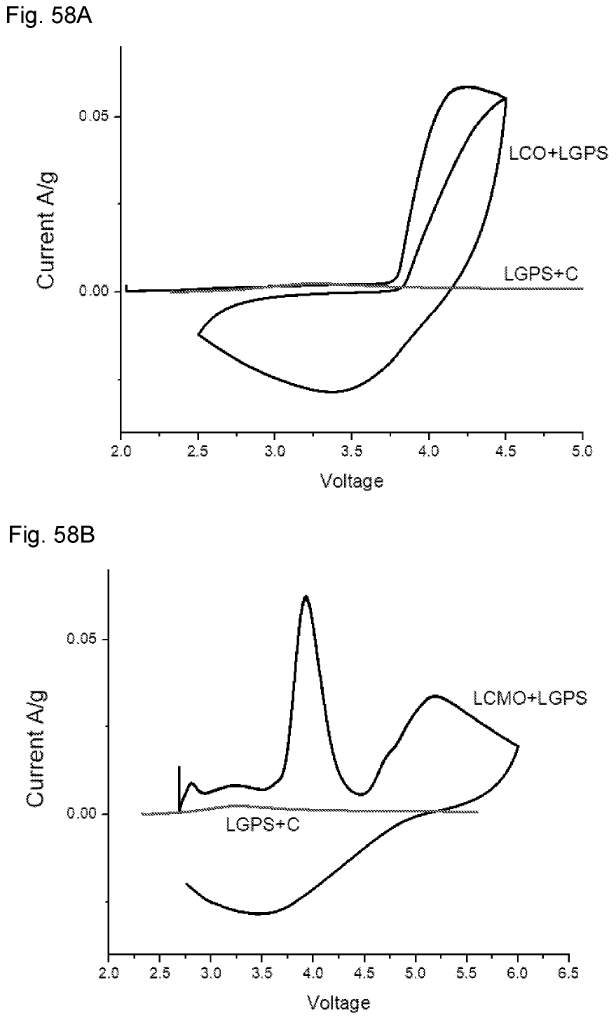

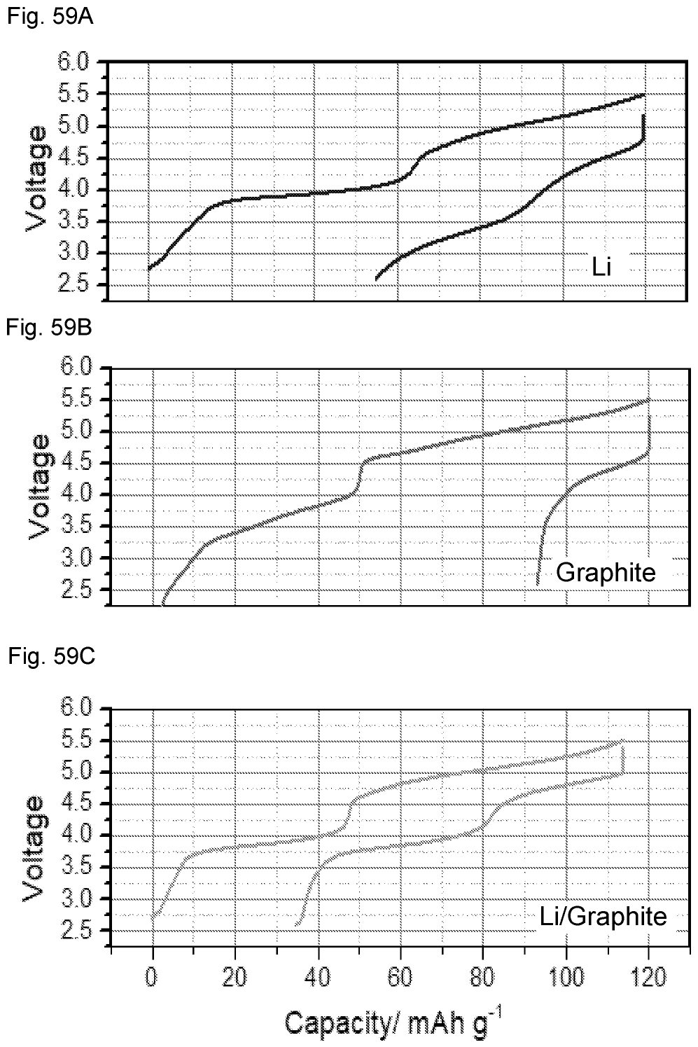

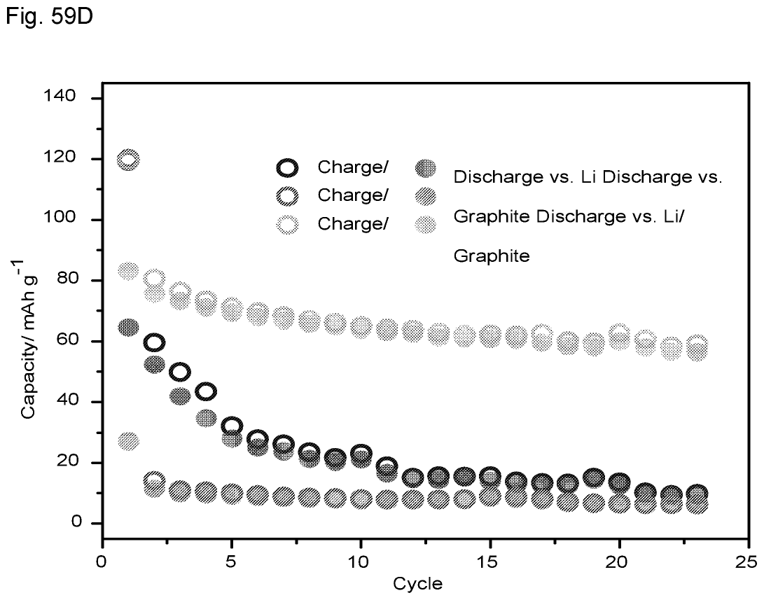

Usually, lithium metal is soft and which leads to the difficulty of applying pressure due to the immediate short of lithium through the bulk solid electrolyte. In order to probe the high voltage capability of pressurized LGPS in the system of lithium metal solid-state battery, lithium metal was used as anode with a graphite layer as a protection layer, which allows high pressure applied during battery test. Firstly, lithium metal-LCO batteries were made at different mechanical conditions using Swagelok, aluminum pressurized cell and stainless-steel pressurized cell, as shown in FIG. 57. Again, the interface reaction and decomposition reaction in the strongest constraint condition is the lowest. A similar structure was applied to make a higher-voltage lithium metal battery using LCMO as cathode, where the cell was initially pressed with 6T. It is shown in Figure. 58 that graphite protection layer alleviate the interface reaction between lithium metal and LGPS. As shown in FIG. 59, The decomposition of LGPS itself is very small in the condition of strong mechanical constraint, it contributes very small decomposition current as shown in FIG. 59. As depicted in FIG. 50A, the LCMO cathode then can be charged up to 9 V, which simulates the high-voltage charge status of not-yet-discovered high-voltage redox chemistries. Discharging capacities of 99, 120, 146, 111 mAh/g are obtained by charging LCMO at 6, 7, 8, 9 V, respectively (FIG. 50A). This indicates that the extra lithium capacity comes from the LCMO's higher voltage state. Although there are more side reactions after the battery is charged to voltages above 8 V, the battery is seen to maintain the capability of cycling even up to 9V. This high-voltage cycling demonstrates the high electrochemical window of over 9 V for constrained LGPS. At highly delithiated state, cathode materials usually show poor electrochemical stability and the reaction between cathode materials and electrolyte is also more severe.

To contrast this performance with conventional electrolytes, FIG. 50B depicts organic liquid electrolyte failing at nearly 5V. However, the solid-state battery tested under isovolumetric conditions can be charged up to 9 V (FIG. 50A) without evidence of a decomposition plateau. Moreover, a battery cycling at 5.5 V and tested under isovolumetric conditions (initially pressed with 6T) (FIG. 50C), shows a stable cycling performance and high Columbic efficiency even at high cut-off voltage of 5.5 V, in contrast to the liquid battery (FIG. 50B). Although the performance of lithium metal-LCMO battery is not as good as full battery due to the mechanical softness of lithium metal, this result still shows that, unlike liquid electrolytes, solid-state electrolytes are a better platform to run high-voltage cathode materials.

In summary, we demonstrate how mechanical constraint widens the stability of ceramic solid electrolyte, pushing up its electrochemical window to levels beyond organic liquid electrolytes. A CV test shows that properly designed solid-state electrolytes working under isovolumetric conditions can operate up to nearly 10 V, without clear evidence of decomposition. A mechanism for this mechanically induced kinetic stability of sulfides solid-electrolytes is proposed. Moreover, based on this understanding, it has been shown how several high-voltage solid-state battery cells, using some of the most commonly used and promising cathode materials, can operate up to 9 V under isovolumetric conditions. Therefore, the development of high-voltage solid-state cells is not compromised by the stability of the electrolyte anymore. We anticipate that this work is an import breakthrough for the development of new energy storage systems and cathode materials focused on very-high voltage (>6V) electrochemistry.

Method

Sample Characterization

Structural Analysis

Routine XRD data were collected in a Rigaku Miniflex 6G diffractometer working at 45 kV and 40 mA, using CuKα radiation (wavelength of 1.54056 Å). The working conditions were 26 scanning between 10-80°, with a 0.02° step and a scan speed of 0.24 seconds per step.

Electrochemical Characterization

The LGPS+C/LGPS part of the cells were pellets which were made by pressing the powder at 1T, 3T, 6T, respectively, and put into Swagelok or the homemade pressurized cell. In the CV test, voltage starting from the open circuit voltage to 10 V was ramped, during which the decomposition currents at each voltage were measured. The CV test was conducted on a Solartron 1400 electrochemical test system between OCV to 3.2V, 7.5V, and 9.8V, respectively, with the scan rate of 0.1 mV/s. The CV scan was followed by a voltage hold for 10 hours to make sure the decomposition is fully developed, and it was scanned back to 2.5V before any other characterizations. The electrochemical impedance spectroscopy (EIS) was conducted on the same machine in the range of 3 MHz to 0.1 Hz.

For all-solid-state batteries, the electrode and electrolyte layers were made by a dry method which employs Polytetrafluoroethylene (PTFE) as a binder and allows to obtain films with a typical thickness of 100-200 μm. Additionally, two different kinds of all-solid-state batteries were assembled, using Li₄Ti₅O₁₂ (LTO) or lithium (Li) metal as anode. In any case, the composite cathode was prepared by mixing the active materials (LiCo₀.5Mn_{1.5}O₄, LiNi_{0.5}Mn_{1.5}O₄ or LiCoO₂) and Li₁₀GeP₂S₁₂ (LGPS) powder in a weight ratio of 70:30 and 3% extra of PTFE. This mixture was then rolled into a thin film. On the one hand, for those all-solid-state batteries which use LTO as anode, a separator of LGPS and PTFE film was employed with a weight ratio of 95:5. The anode composition consists in a mixture of LGPS, LTO and carbon black in weight ratio 60:30:10 and 3% extra of PTFE. Finally, the Swagelok battery cell of cathode film (using LiCo_{0.5}Mn_{1.5}O₄, LiNi_{0.5}Mn_{1.5}O₄ or LiCoO₂ as active material)/LGPS film/LTO film was then assembled in an argon-filled glove box. The specific capacity was calculated based on the amount of LTO (30 wt %) in the anode film. The galvanostatic battery cycling test was performed on an ArbinBT2000 work station at room temperature. On the other hand, when lithium metal was used as anode, a Li metal foil with a diameter and thickness of ½″ and 40 μm, respectively, was connected to the current collector. In order to prevent interface side reactions, the Li foil was covered by a 5/32″ diameter carbon black film with a weight ratio of carbon black and PTFE of 96:4. After loading the negative electrode into a Swagelok battery cell, 70 mg of pure LGPS powder, which acts as a separator, was added and slightly pressed. Finally, −1 mg film of the cathode composite LCMO was inserted and pressed up to 6 Tn (0.46 GPa) to form the battery, which final configuration was LCMO/LGPS pellet/graphite film+Li metal. For high voltage test in FIG. 50A, the battery is charged to 0.3C followed by 30 mins rest and discharged at 0.1C. All batteries in FIG. 50 are test at high temperature of 55° C.

Computational Simulation

All ab-initio calculations and phase data were obtained following the Material Project calculation guidelines in the Vienna Ab-initio Software Package (VASP). The mechanically-induced metastability calculations were performed following the LaGrangian optimization methods outlined in Small 1901470, 1-14 (2019) and J. Mater. Chem. A (2019). doi:10.1039/C9TA05248H). Pseudo-phase calculations were performed following the methods of J. Mater. Chem. A 4, 3253-3266 (2016), Chem. Mater. 28, 266-273 (2016), and Chem. Mater. 29, 7475-7482 (2017).

Other embodiments are in the claims.

What is claimed is:

1. A rechargeable battery, comprising a first electrode, a second electrode, and a solid state electrolyte disposed therebetween, wherein the solid state electrolyte comprises a sulfide comprising an alkali metal, wherein the solid state electrolyte is under a volumetric constraint sufficient to stabilize the solid state electrolyte during electrochemical cycling.

2. The rechargeable battery of claim 1, wherein the volumetric constraint exerts a pressure between about 70 and about 1,000 MPa on the solid state electrolyte.

3. The rechargeable battery of claim 1, wherein the volumetric constraint exerts a pressure between about 100 and about 250 MPa on the solid state electrolyte.

4. The rechargeable battery of claim 1, wherein the volumetric constraint provides a voltage stability window of between 1 and 10 V.

5. The rechargeable battery of claim 1, wherein the solid state electrolyte has a core shell morphology.

6. The rechargeable battery of claim 1, where the alkali metal is Li, Na, K, Rb, or Cs.

7. The rechargeable battery of claim 1, wherein the solid state electrolyte comprises SiPS, GePS, SnPS, PSI, or PS.

8. The rechargeable battery of claim 1, wherein the solid state electrolyte is Li₁₀SiP₂S₁₂, Li₁₀GeP₂S₁₂, or Li_{9.54}Si_{1.74}P_{1.44}S_{11.7}Cl_{0.3}.

9. The rechargeable battery of claim 1, wherein the first electrode is the cathode and comprises LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄.

10. The rechargeable battery of claim 1, wherein the second electrode is anode and comprises lithium metal, lithiated graphite, or Li₄Ti₅O₁₂.

11. The rechargeable battery of claim 1, wherein the volumetric constraint provides a mechanical constriction on the solid state electrolyte between about 1 to about 100 GPa.

12. A rechargeable battery comprising a first electrode, a second electrode, and a solid state electrolyte disposed therebetween, wherein the second electrode is an anode comprising an alkali metal and graphite.

13. The rechargeable battery of claim 12, wherein the battery is under a pressure of about 70-1000 MPa.

14. The rechargeable battery of claim 13, wherein the battery is under a pressure of about 100-250 MPa.

15. The rechargeable battery of claim 12, wherein the alkali metal and graphite form a composite.

16. The rechargeable battery of claim 12, where the alkali metal is Li, Na, K, Rb, or Cs.

17. The rechargeable battery of claim 12, wherein the solid state electrolyte comprises SiPS, GePS, SnPS, PSI, or PS.

18. The rechargeable battery of claim 12, wherein the solid state electrolyte is Li₁₀SiP₂S₁₂, Li₁₀GeP₂S₁₂, or Li_{9.54}Si_{1.74}P_{1.44}S_{11.7}Cl_{0.3}.

19. The rechargeable battery of claim 12, wherein the first electrode is the cathode and comprises LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄.

20. The rechargeable battery of claim 12, wherein the battery is under an external stress that provides a mechanical constriction on the solid state electrolyte between about 1 to about 100 GPa.

21. A rechargeable battery comprising a first electrode, a second electrode, and a solid state electrolyte disposed therebetween, wherein the solid state electrolyte comprises a sulfide comprising an alkali metal; and the battery is under isovolumetric constraint.

22. The rechargeable battery of claim 21, wherein the isovolumetric constraint is provided by compressing the solid state electrolyte under a pressure of about 3-1000 MPa.

23. The rechargeable battery of claim 21, where the alkali metal is Li, Na, K, Rb, or Cs.

24. The rechargeable battery of claim 21, wherein the solid state electrolyte comprises SiPS, GePS, SnPS, PSI, or PS.

25. The rechargeable battery of claim 21, wherein the solid state electrolyte is Li₁₀SiP₂S₁₂, Li₁₀GeP₂S₁₂, or Li_{9.54}Si_{1.74}P_{1.44}S_{11.7}Cl_{0.3}.

26. The rechargeable battery of claim 21, wherein the first electrode is the cathode and comprises LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄.

27. The rechargeable battery of claim 12, wherein the isovolumetric constraint provides a mechanical constriction on the solid state electrolyte between about 1 to about 100 GPa.

28. A rechargeable battery, comprising a first electrode, a second electrode, and a solid state electrolyte disposed therebetween, wherein:
a) the solid state electrolyte comprises a sulfide comprising an alkali metal; and
b) at least one of the first or second electrodes comprises an interfacially stabilizing coating material.

29. The rechargeable battery of claim 28, wherein the first electrode is the cathode and comprises a material selected from Table 1.

30. The rechargeable battery of claim 28, wherein the coating material of the first electrode comprises a material selected from Table 2.

31. The rechargeable battery of claim 28, where the alkali metal is Li, Na, K, Rb, or Cs.

32. The rechargeable battery of claim 28, wherein the solid state electrolyte comprises SiPS, GePS, SnPS, PSI, or PS.

33. The rechargeable battery of claim 28, wherein the solid state electrolyte is Li₁₀SiP₂S₁₂, Li₁₀GeP₂S₁₂, or Li_{9.54}Si_{1.74}P_{1.44}S_{11.7}Cl_{0.3}.

34. The rechargeable battery of claim 28, wherein the first electrode is the cathode and comprises LiCoO₂, LiNi_{0.5}Mn_{1.5}O₄, V Li₂CoPO₄F, LiNiPO₄, Li₂Ni(PO₄)F, LiMnF₄, LiFeF₄, or LiCo_{0.5}Mn_{1.5}O₄.

35. The rechargeable battery of claim 28, wherein the battery is under an external stress that provides a mechanical constriction on the solid state electrolyte between about 1 to about 100 GPa.

36. The rechargeable battery of claim 28, wherein the battery is under a pressure of about 70-1000 MPa.

37. The rechargeable battery of claim 36, wherein the battery is under a pressure of about 100-250 MPa.

38. A method of storing energy comprising applying a voltage across the first and second electrodes and charging the rechargeable battery of any one of claims 1-37.

39. A method of providing energy comprising connecting a load to the first and second electrodes and allowing the rechargeable battery of any one of claims 1-37 to discharge.
